(19) United States
(12) Patent Application Publication
(10) Pub. No.: US 2011/0077999 A1
(43) Pub. Date: Mar. 31, 2011

(54) MANAGING CONSISTENT INTERFACES FOR RETAIL EVENT BUSINESS OBJECTS ACROSS HETEROGENEOUS SYSTEMS

(75) Inventors: Markus Becker, Saarlouis (DE); Ruediger Zuerl, Eschelbronn (DE); Thomas Veit, Kirchheimbolanden (DE)

(73) Assignee: SAP AG, Walldorf (DE)

(21) Appl. No.: 12/571,154

(22) Filed: Sep. 30, 2009

(51) Int. Cl. G06Q 30/00; G06Q 10/00; G06F 3/048

(52) U.S. Cl. 705/10; 705/14.72; 705/14.1; 715/764

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to retail event and retail incentive business objects.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer readable medium includes program code for providing a message-based interface for exchanging information for retail events, including business activity, demand management, planning and optimization of sales, and promotions to increase retail sales. The medium comprises program code for receiving a first message and program code for sending a second message. Receipt of the first message is via a message-based interface that exposes at least one service as defined in a service registry. The first message is received from a heterogeneous application executing in an environment of computer systems providing message-based services. The first message provides a notification of one or more retail events. The notification includes a message package. The message package is hierarchically organized as a retail event message entity and a retail event package. The retail event package comprises a retail event entity. The retail event entity includes an ID, a complete transmission indicator, and a superior indicator. The second message is sent to the heterogeneous application responsive to the first message.

Implementations can include any, all or none of these features. The retail event package further comprises at least one of the following: a description entity, a receiving store package, a sales area package, a theme package, and an offer package. The retail event entity further includes an action code, a type code, a planning currency code, a sales period, a data origin type code, a retail predecessor transaction ID, a predecessor business transaction ID, an advertising medium type code, a retail event target group type code, a sales price specification level code, and a superior retail event ID.

In a second aspect, a computer readable medium includes program code for providing a message-based interface for exchanging information among all offer nodes of a retail bonus buy business object and a retail event business object. The medium comprises program code for receiving a first message and program code for sending a second message. Receipt of the first message is via a message-based interface that exposes at least one service as defined in a service registry. The first message is received from a heterogeneous application executing in an environment of computer systems providing message-based services. The first message provides a notification of one or more retail incentives. The notification includes a message package. The message package is hierarchically organized as a retail incentive ERP store offer replication bulk request message entity and a retail incentive ERP store offer replication request message package. The retail incentive ERP store offer replication request message package comprises a retail incentive ERP store offer replication request message entity and a retail incentive package. The retail incentive package comprises a retail incentive entity. The retail incentive entity includes a complete transmission indicator. The second message is sent to the heterogeneous application responsive to the first message.

Implementations can include any, all or none of these features. The retail incentive package comprises a description entity, a receiving store package, a sales area package, and an offer package. The retail incentive entity comprises an action code, a retail event ID, a retail bonus buy ID, a type code, a retail event type code, a planning currency code, a sales period, a data origin type code, a retail predecessor transaction ID, an advertising medium type code, a retail event target group type code, and a sales price specification level code.

In a third aspect, a distributed system operating in a landscape of computer systems provides message-based services defined in a service registry. The system comprises a graphical user interface, a first memory, and a second memory. The graphical user interface comprises computer readable instructions, embedded on tangible media. The instructions are used for exchanging information for retail events, including business activity, demand management, planning and optimization of sales, and promotions to increase retail sales. The first memory stores a user interface controller for processing the request and involving a message including a message package. The message package is hierarchically organized as a retail event message entity and a retail event package. The retail event package comprises a retail event entity. The retail event entity includes an ID, a complete transmission indicator, and a superior indicator. The second memory, remote from the graphical user interface, stores a plurality of service interfaces. One of the service interfaces is operable to process the message via the service interface.

Implementations can include any, all or none of these features. The first memory is remote from the graphical user interface. The first memory is remote from the second memory.

In a fourth aspect, a distributed system operating in a landscape of computer systems provides message-based services defined in a service registry. The system comprises a graphical user interface, a first memory, and a second memory. The graphical user interface comprises computer readable instructions, embedded on tangible media. The instructions are used for exchanging information among all offer nodes of a retail bonus buy business object and a retail event business object. The first memory stores a user interface controller for processing the request and involving a message including a message package. The message package is hierarchically organized as a retail incentive ERP store offer replication bulk request message entity and a retail incentive ERP store offer replication request message package. The retail incentive ERP store offer replication request message package comprises a retail incentive ERP store offer replication request message entity and a retail incentive package. The retail incentive package comprises a retail incentive entity. The retail incentive entity includes a complete transmission indicator. The second memory, remote from the graphical user interface, stores a plurality of service interfaces. One of the service interfaces is operable to process the message via the service interface.

Implementations can include any, all or none of these features. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 depicts an example RetailEvent to RetailEventManagement to POSManagement Message Choreography.

FIG. 33 depicts an example RetailEvent to RetailEventManagement Message Choreography.

FIGS. 34-1 through 34-8 depict an example RetailEventMessage Message Data Type.

FIG. 35 depicts an example RetailEventCreateRequest Message Data Type.

FIGS. 36-1 through 36-8 depict an example RetailEventERPStoreReplicationRequestMessage Message Data Type.

FIGS. 37-1 through 37-8 depict an example RetailEventReplicationRequestMessage Message Data Type.

FIG. 38 depicts an example RetailEventReplicationConfirmationMessage Message Data Type.

FIG. 39 depicts an example RetailEventOfferActivationRequestMessage Message Data Type.

FIG. 40 depicts an example RetailEventOfferActivationConfirmationMessage Message Data Type.

FIG. 41 depicts an example RetailEventOfferDeactivationRequestMessage Message Data Type.

FIGS. 42-1 through 42-33 depict an example RetailEventMessage Element Structure.

FIGS. 43-1 through 43-9 depict an example RetailEventCreateRequest Element Structure.

FIGS. 44-1 through 44-24 depict an example RetailEventERPStoreReplicationRequestMessage Element Structure.

FIGS. 45-1 through 45-17 depict an example RetailEventReplicationRequestMessage Element Structure.

FIG. 46 depicts an example RetailEventReplicationConfirmationMessage Element Structure.

FIGS. 47-1 through 47-2 depict an example RetailEventOfferActivationRequestMessage Element Structure.

FIGS. 48-1 through 48-2 depict an example RetailEventOfferActivationConfirmationMessage Element Structure.

FIGS. 49-1 through 49-2 depict an example RetailEventOfferDeactivationRequestMessage Element Structure.

FIG. 50 depicts an example RetailIncentive Message Choreography.

FIGS. 51-1 through 51-6 depict an example RetailIncentiveERPStoreOfferReplicationBulkRequestMessage Message Data Type.

FIGS. 52-1 through 52-28 depict an example RetailIncentiveMessage Element Structure.

FIGS. 53-1 through 53-28 depict an example RetailIncentiveERPStoreOfferReplicationBulkRequestMessage Element Structure.

### DETAILED DESCRIPTION

### A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g., hourly, daily, every three months, etc.). Each customer may plan the services on demand or reschedule service execution upon request.

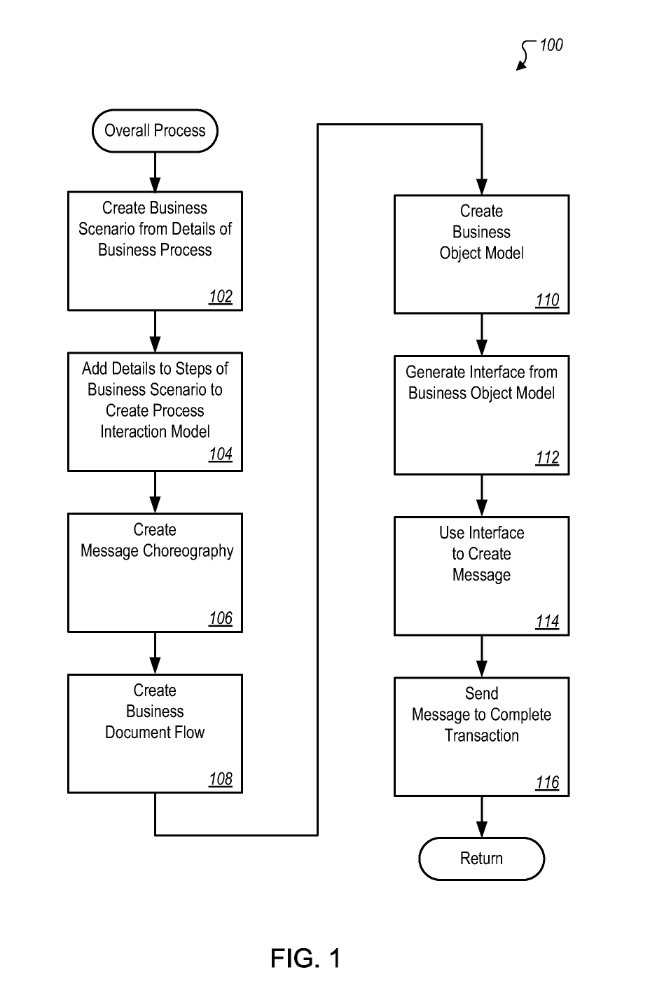

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

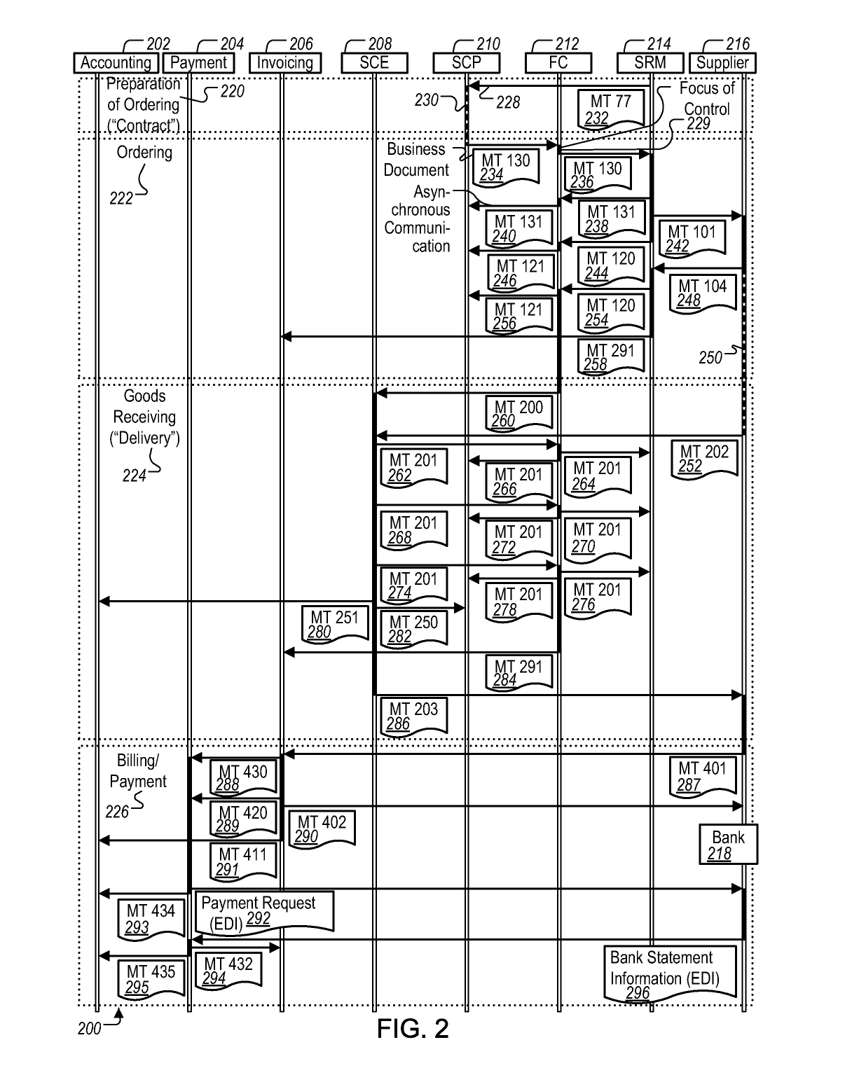

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

### B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

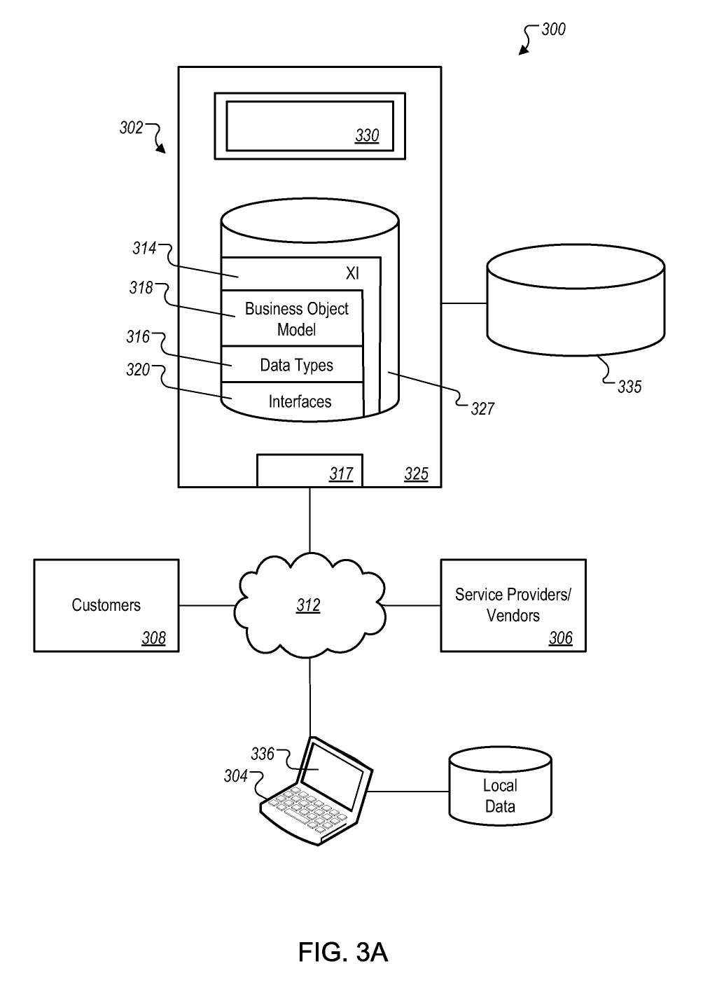

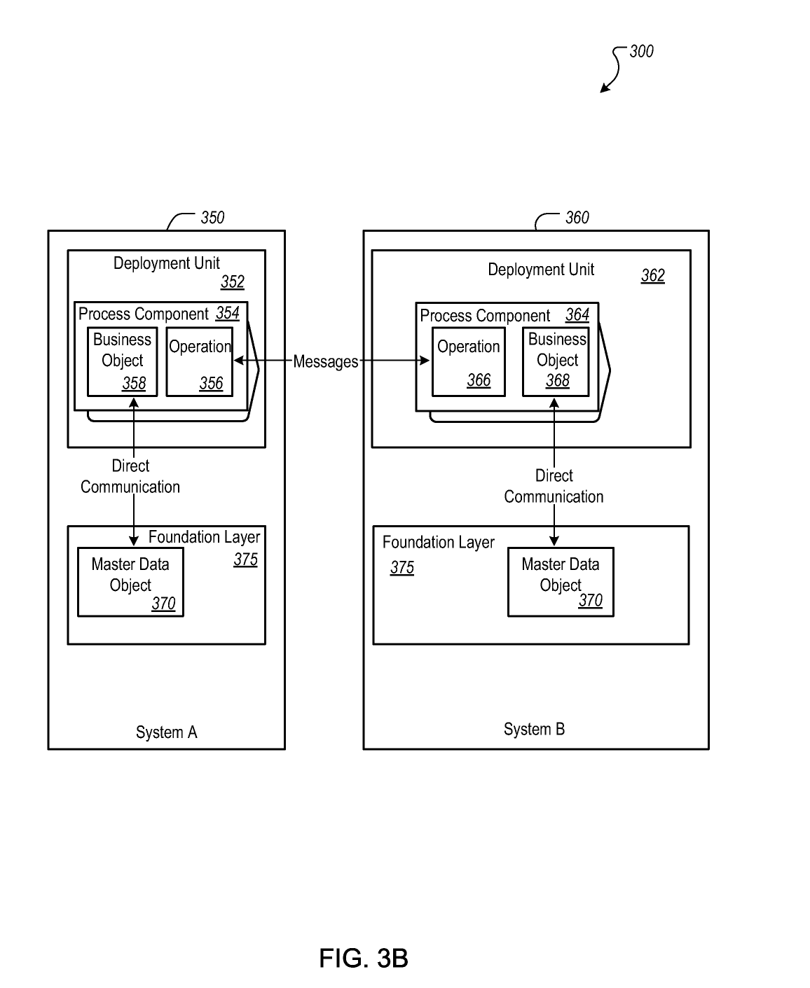

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

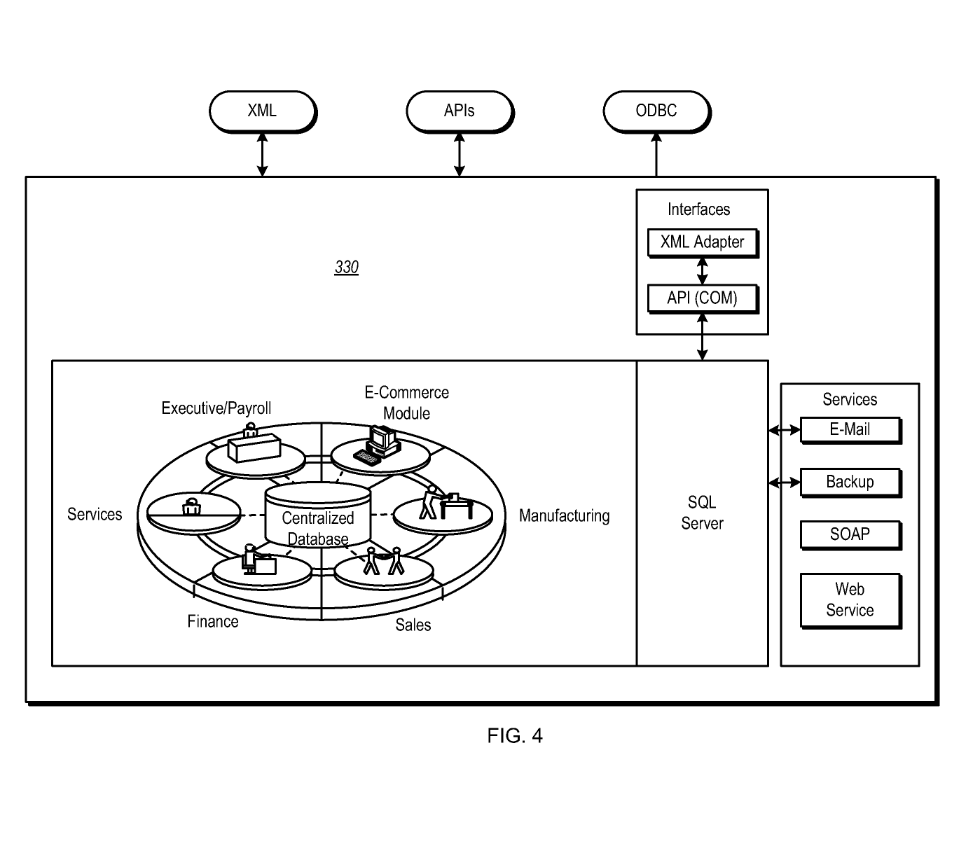

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

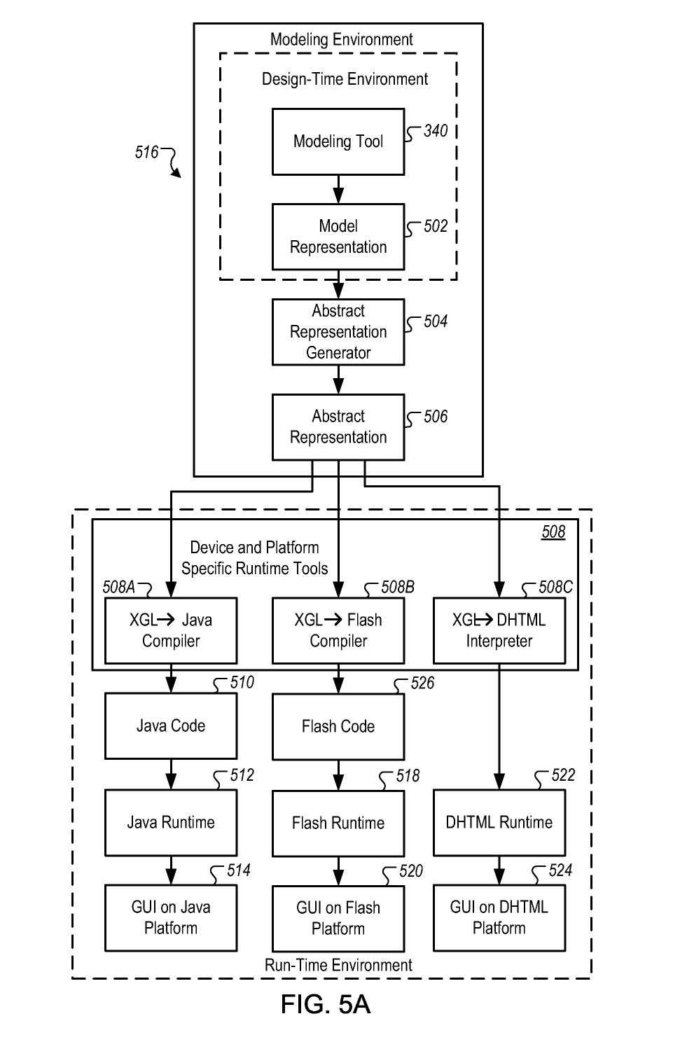

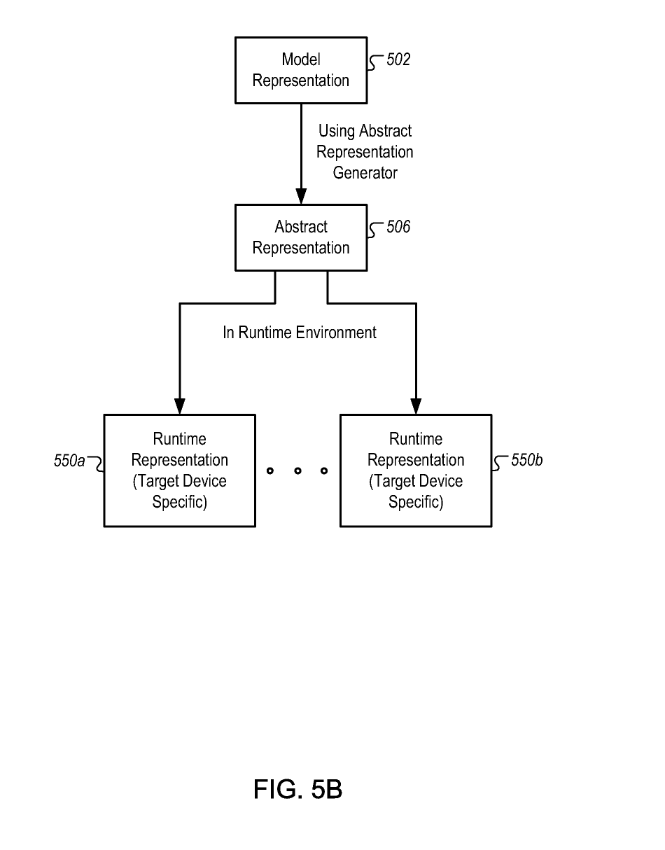

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

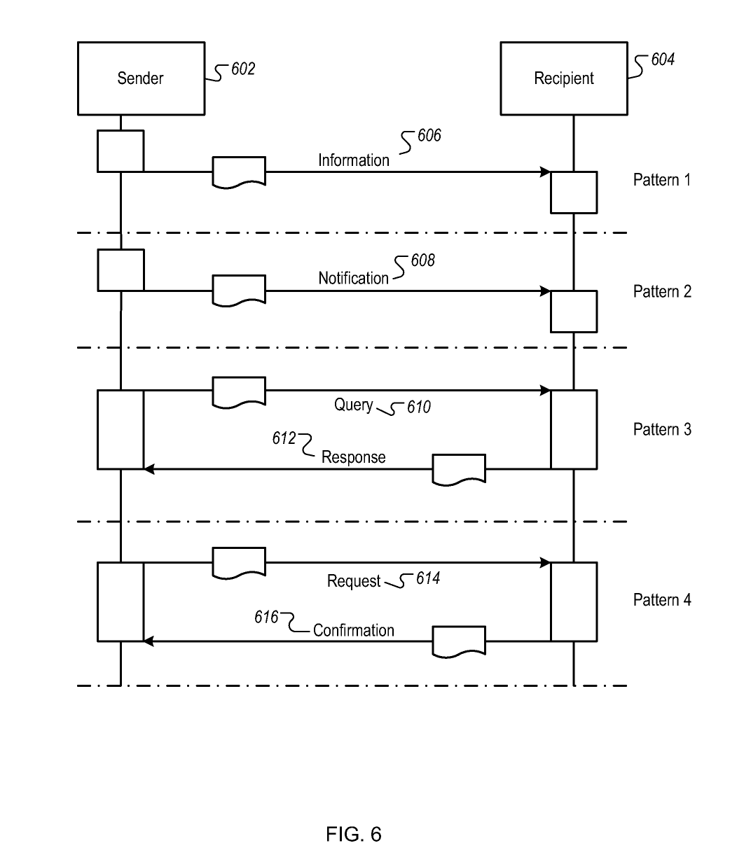

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

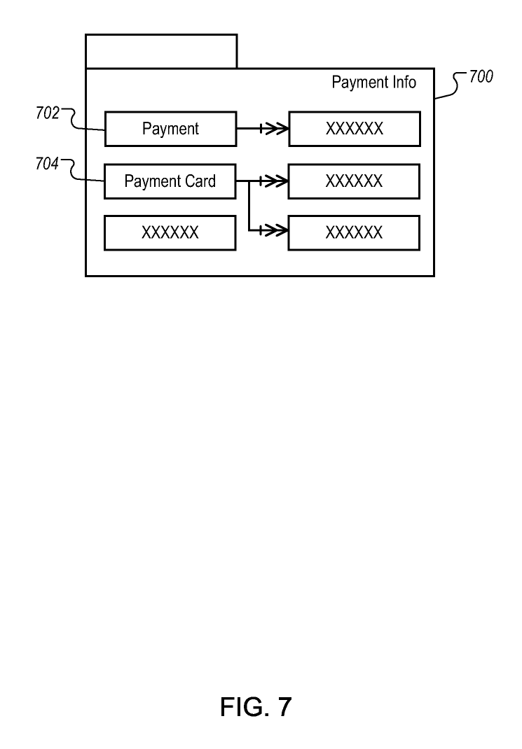

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

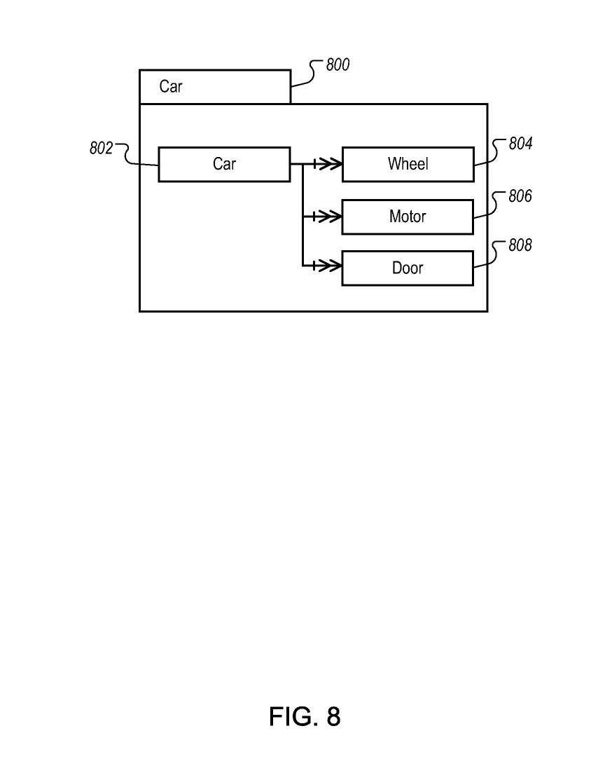

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

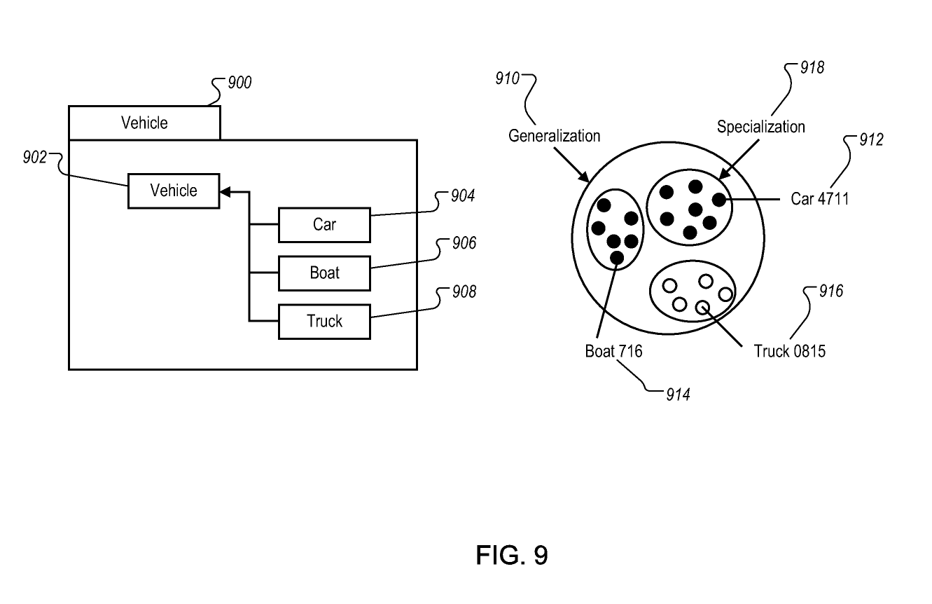

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

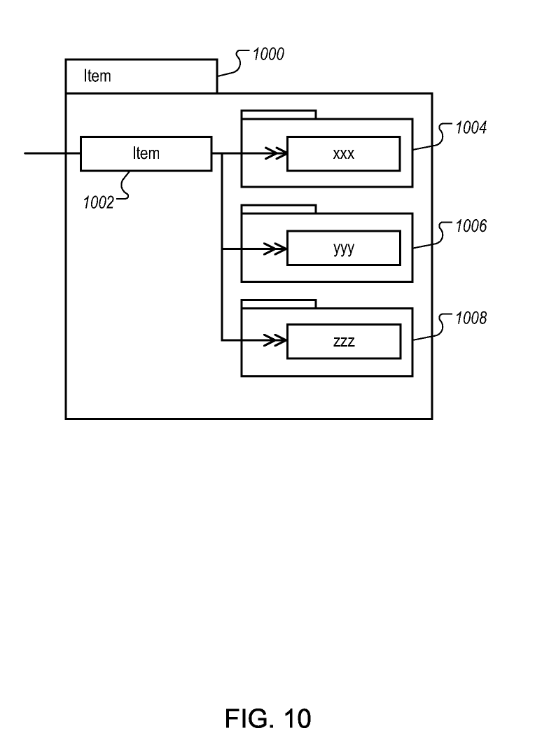

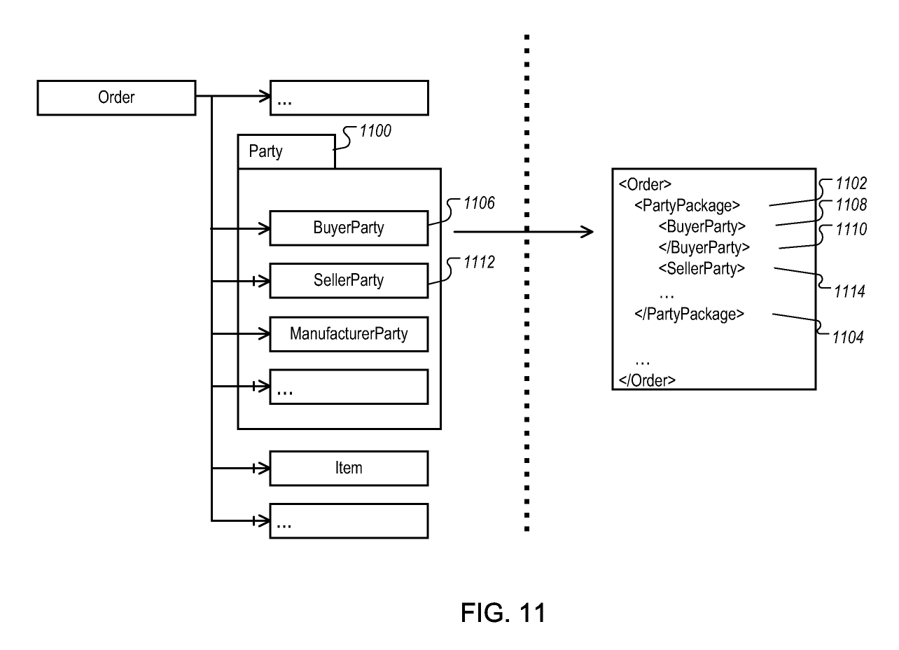

Packages also may be used to represent hierarchy levels. For example, as depicted in FIG. 10, the Item Package 1000 includes Item 1002 with subitem xxx 1004, subitem yyy 1006, and subitem zzz 1008.

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

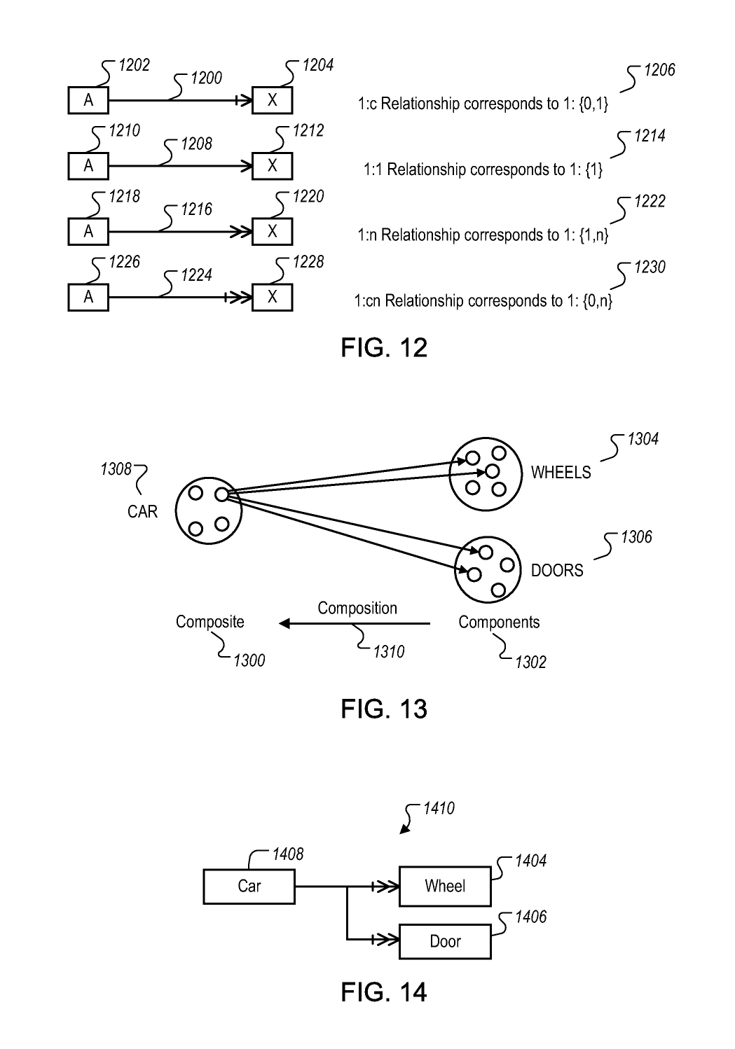

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

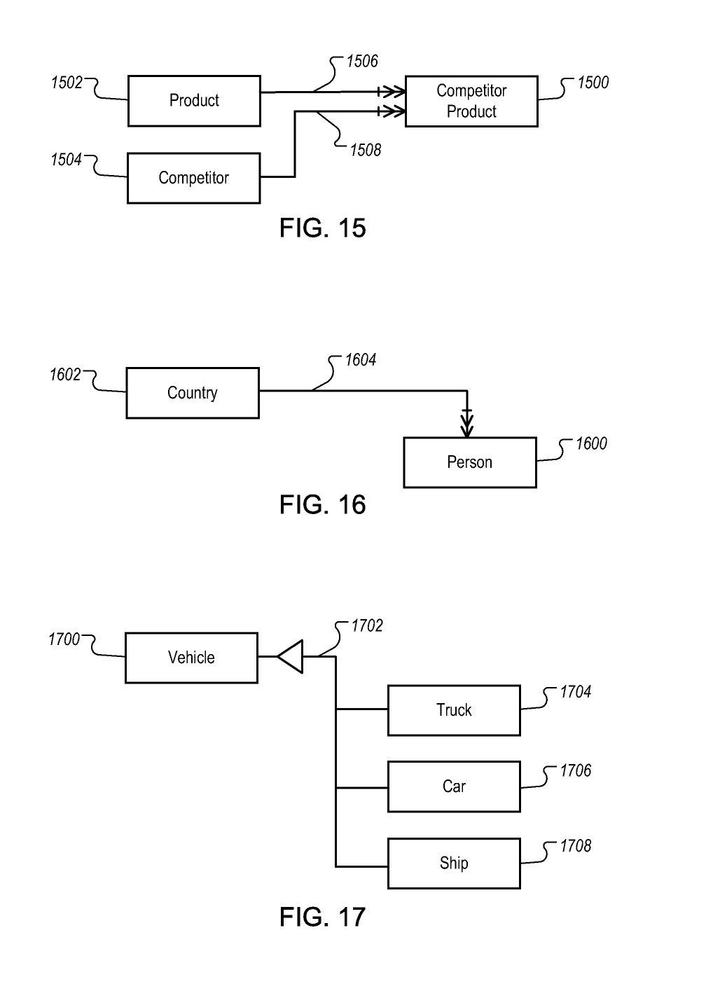

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

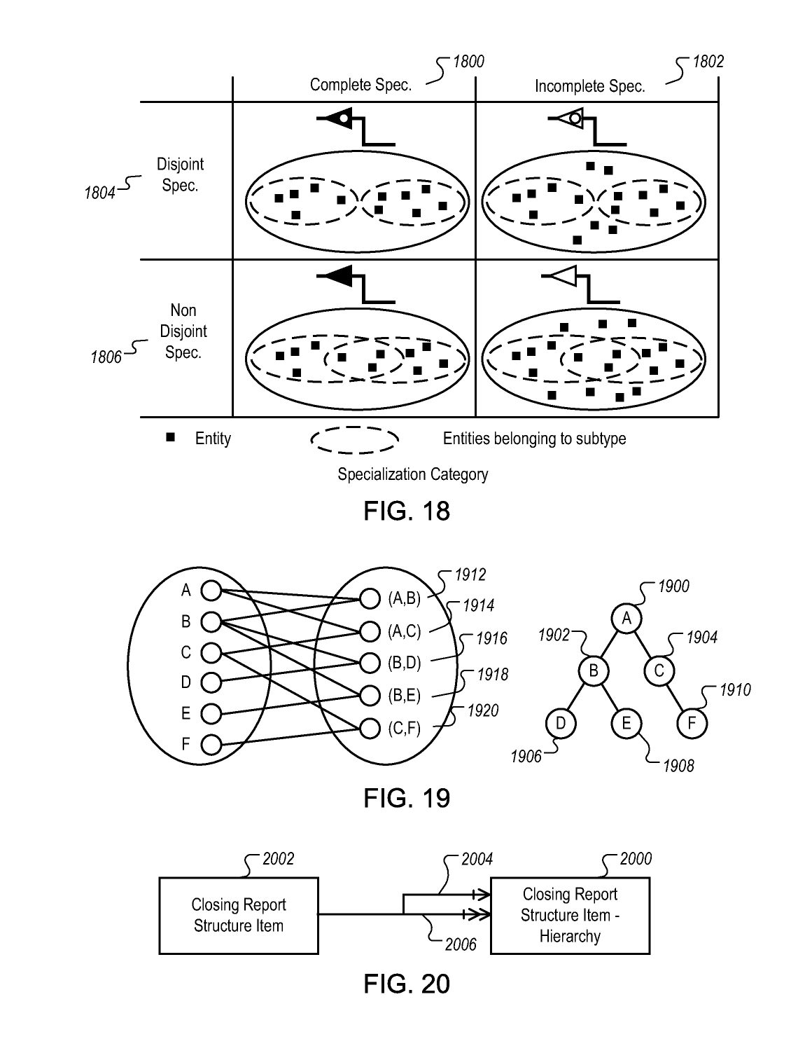

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

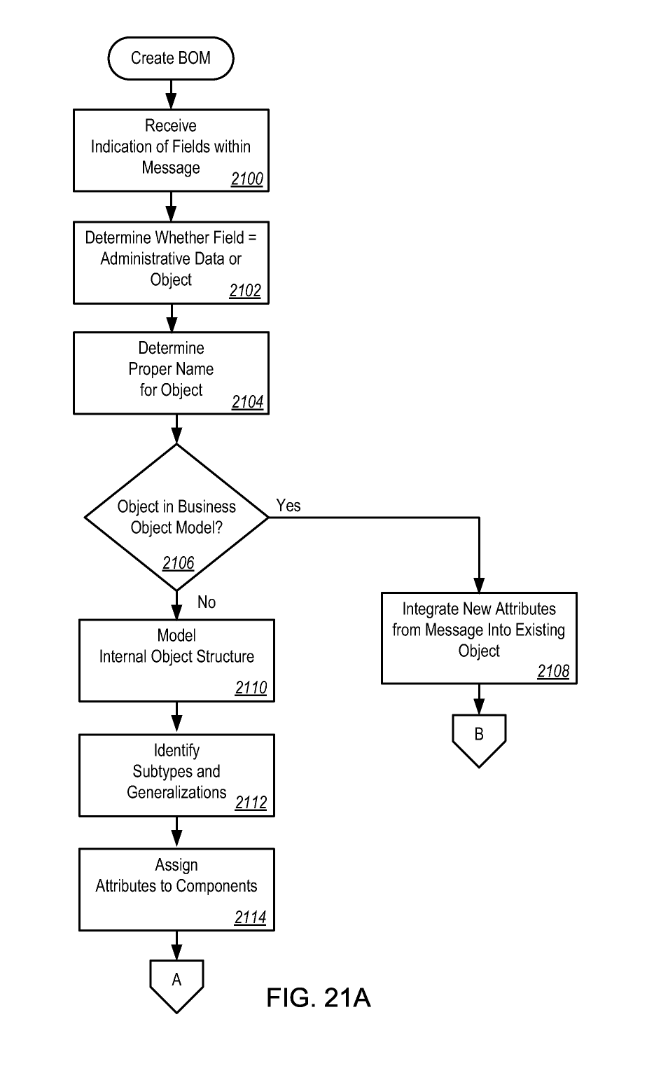

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

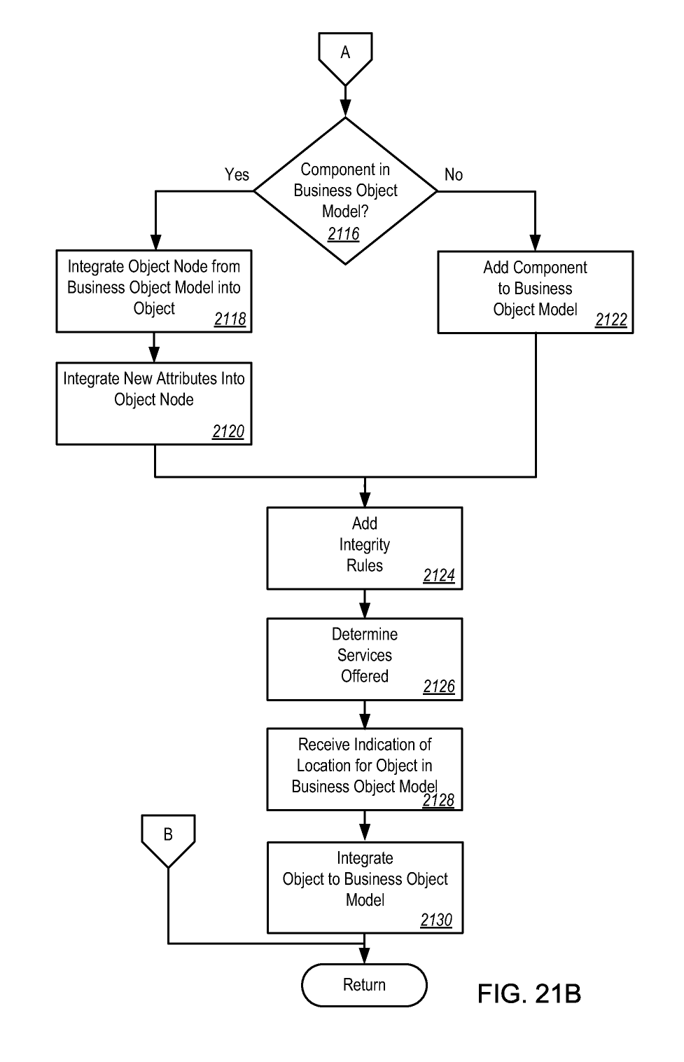

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase | | |
| AdditionalID | Order | | |
| PostingDate | | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliyeryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase Order | |
| ParentItemID | | Item | |
| HierarchyType | | | |
| ProductID | | | Product |
| ProductType | | | |
| ProductNote | | | |
| ProductCategoryID | | | Product |
| | | | Category |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0..1 |
| | | Address | | 0..1 |
| | | ContactPerson | | 0..1 |
| | | | Address | 0..1 |
| | Seller | | | 0..1 |
| | Location | | | 0..1 |
| | | Address | | 0..1 |
| | Delivery | | | 0..1 |
| | Terms | | | |
| | | Incoterms | | 0..1 |
| | | PartialDelivery | | 0..1 |
| | | QuantityTolerance | | 0..1 |
| | | Transport | | 0..1 |
| | CashDiscount | | | 0..1 |
| | Terms | | | |
| | | MaximumCash | | 0..1 |
| | | Discount | | |
| | | NormalCash | | 0..1 |
| | | Discount | | |
| | PaymentForm | | | 0..1 |
| | | PaymentCard | | 0..1 |
| | Attachment | | | 0..n |
| | Description | | | 0..1 |
| | Confirmation | | | 0..1 |
| | Description | | | |
| | Item | | | 0..n |
| | | Hierarchy | | 0..1 |
| | | Relationship | | |
| | | Product | | 0..1 |
| | | ProductCategory | | 0..1 |
| | | Price | | 0..1 |
| | | | NetunitPrice | 0..1 |
| | | ConfirmedPrice | | 0..1 |
| | | | NetunitPrice | 0..1 |
| | | Buyer | | 0..1 |
| | | Seller | | 0..1 |
| | | Location | | 0..1 |
| | | DeliveryTerms | | 0..1 |
| | | Attachment | | 0..n |
| | | Description | | 0..1 |
| | | Confirmation | | 0..1 |
| | | Description | | |
| | | ScheduleLine | | 0..n |
| | | | Delivery | 1 |
| | | | Period | |
| | | ConfirmedSchedule | | 0..n |
| | | Line | | |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase | | | | 1 |
| Order | | | | |
| | ID | | | 1 |
| | SellerID | | | 0 . . . 1 |
| | BuyerPosting | | | 0 . . . 1 |
| | DateTime | | | |
| | BuyerLast | | | 0 . . . 1 |
| | ChangeDate | | | |
| | Time | | | |
| | SellerPosting | | | 0 . . . 1 |
| | DateTime | | | |
| | SellerLast | | | 0 . . . 1 |
| | ChangeDate | | | |
| | Time | | | |
| | Acceptance | | | 0 . . . 1 |
| | StatusCode | | | |
| | Note | | | 0 . . . 1 |
| | ItemList | | | 0 . . . 1 |
| | Complete | | | |
| | Transmission | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product | | | 0 . . . 1 |
| | RecipientParty | | | |
| | VendorParty | | | 0 . . . 1 |
| | Manufacturer | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an arrow into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

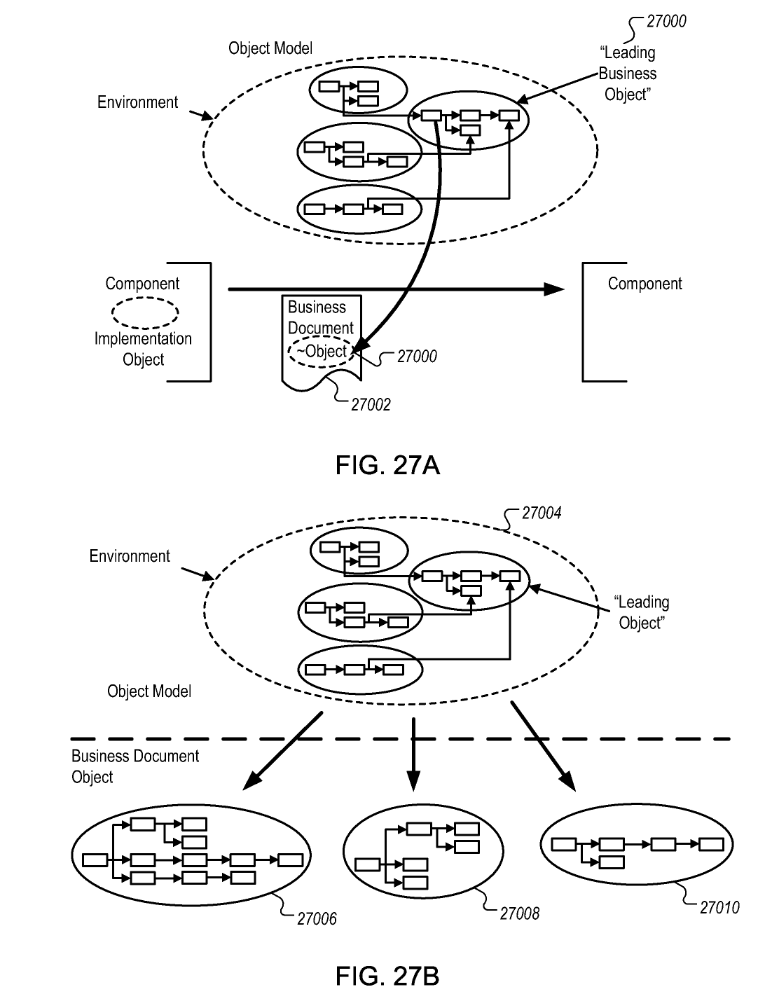

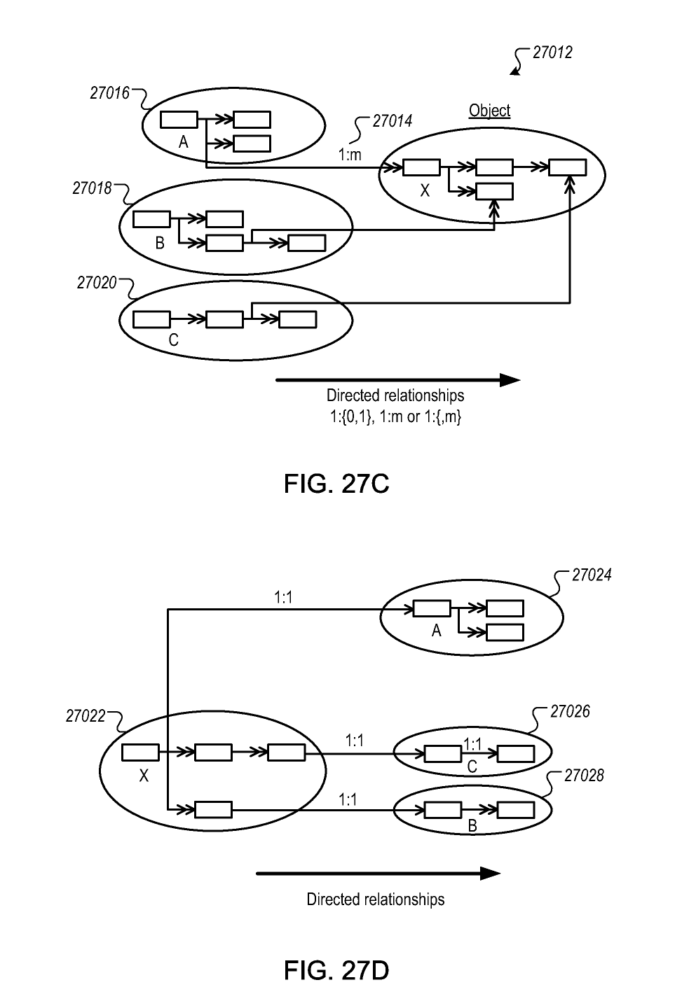

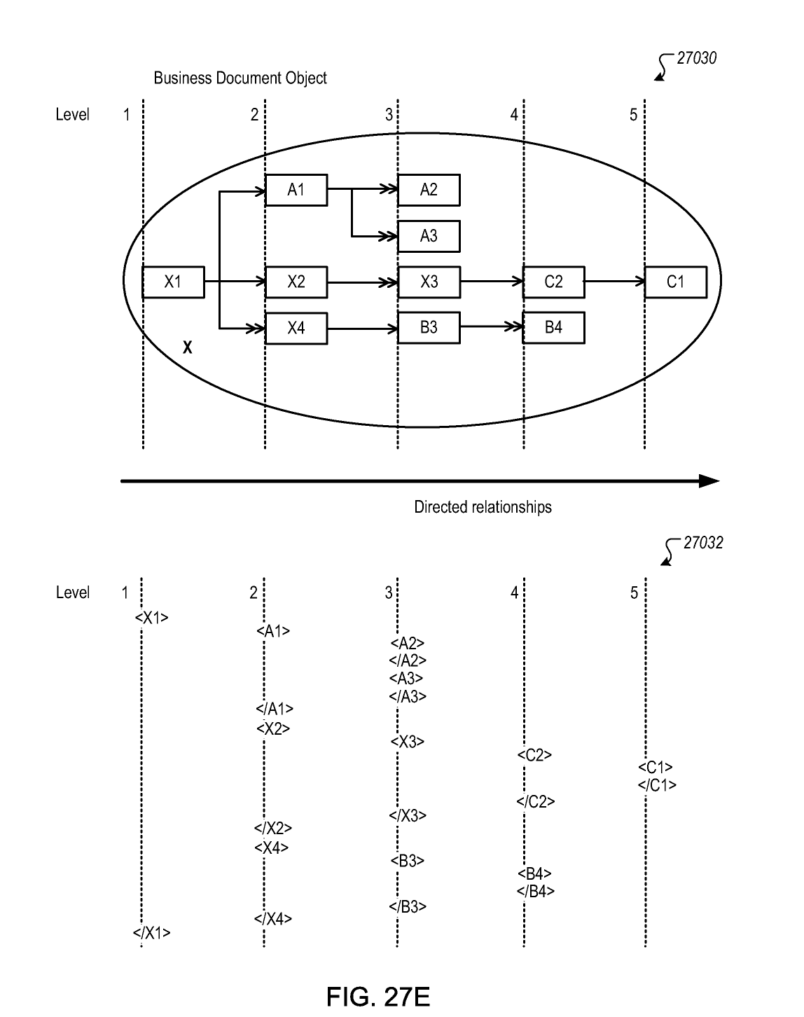

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. Accordingly, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) is hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

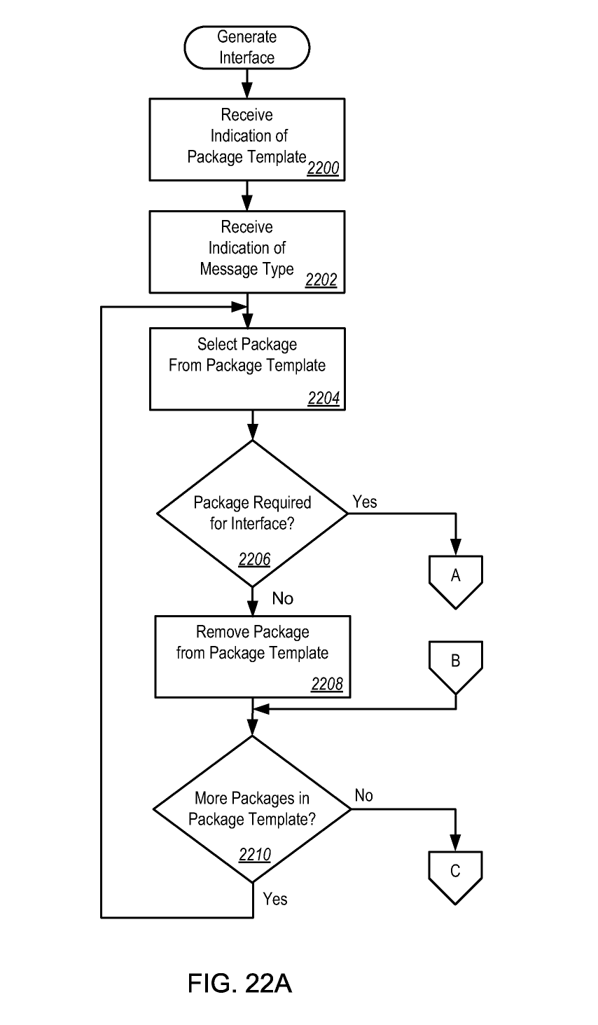

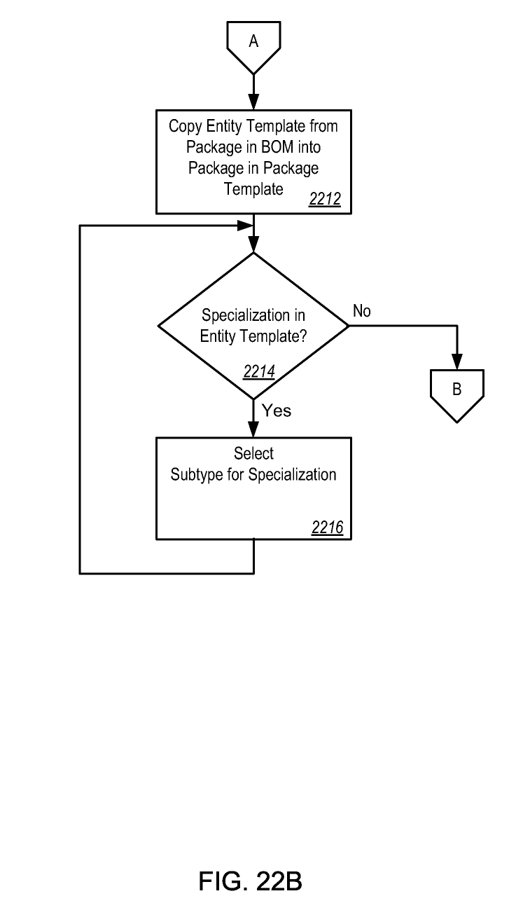

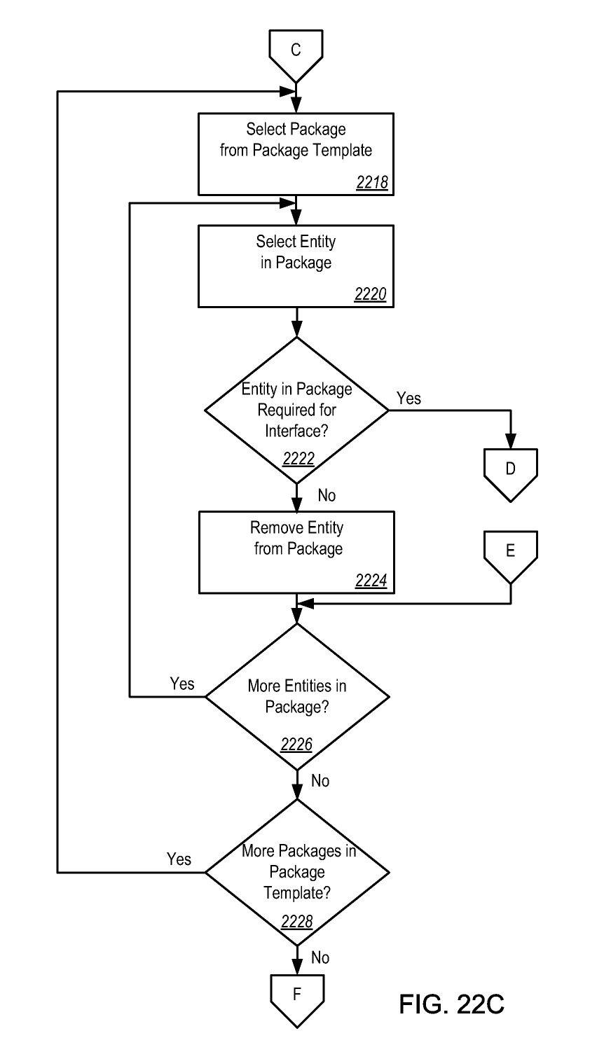

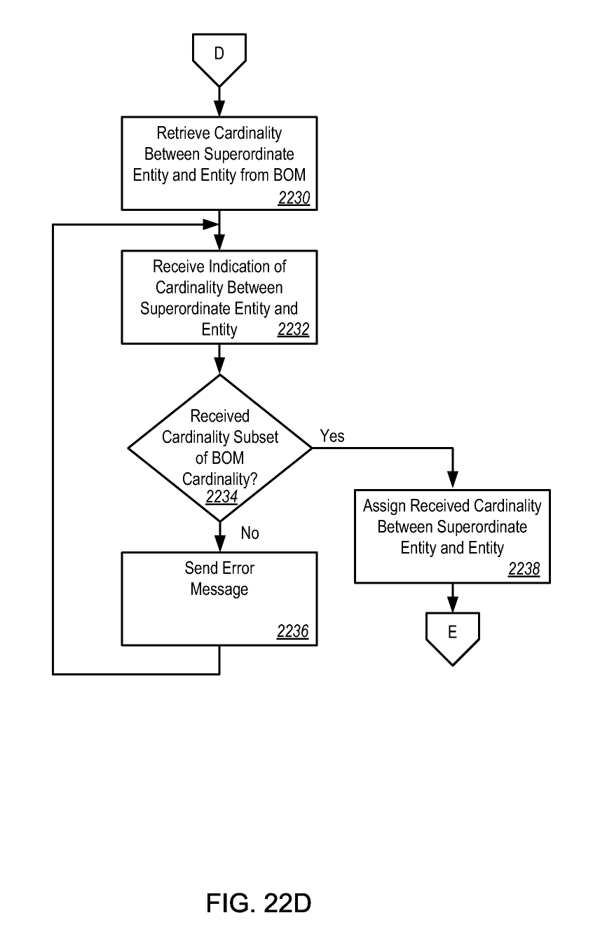

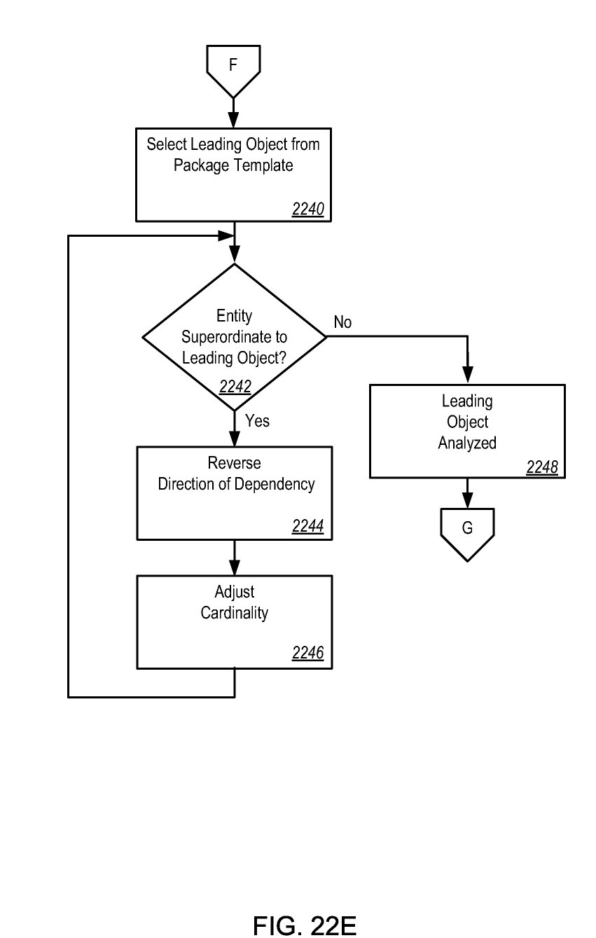

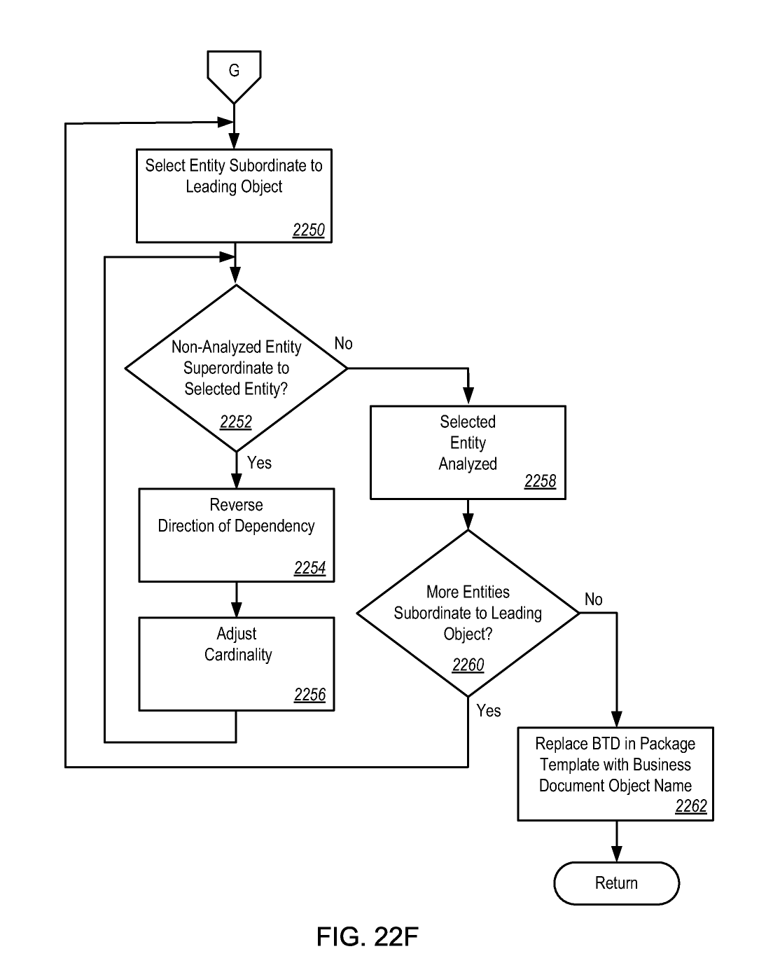

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

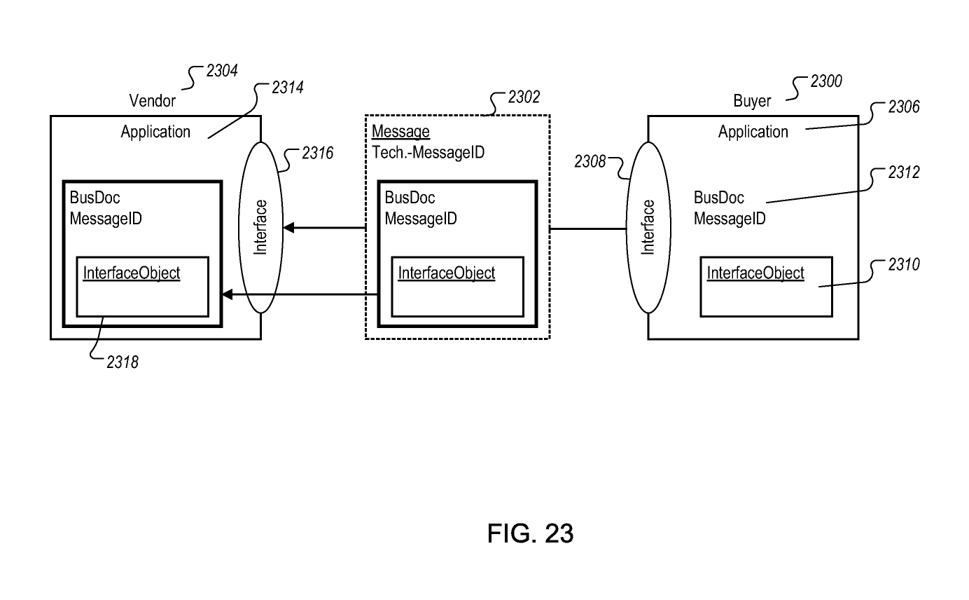

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

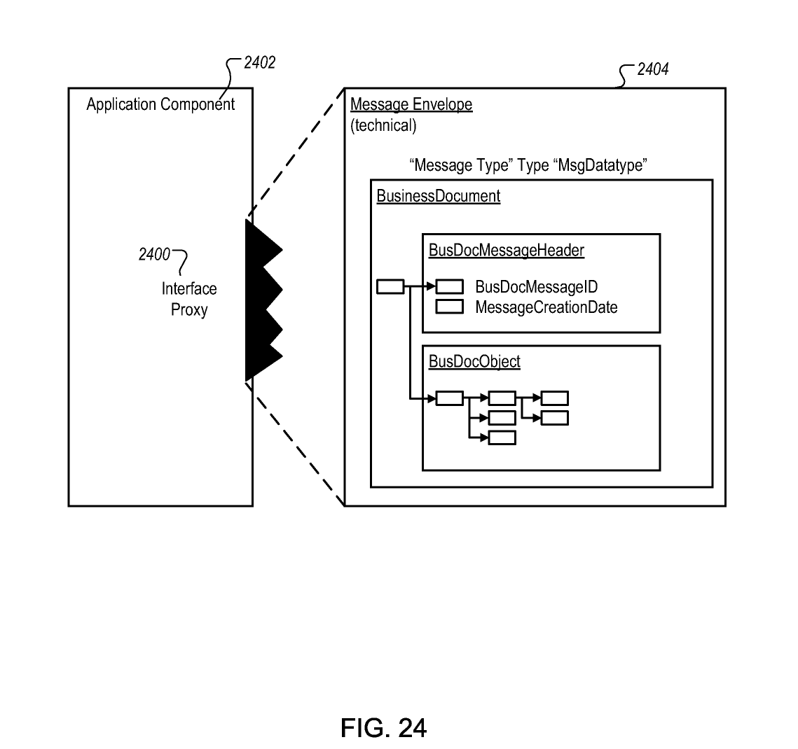

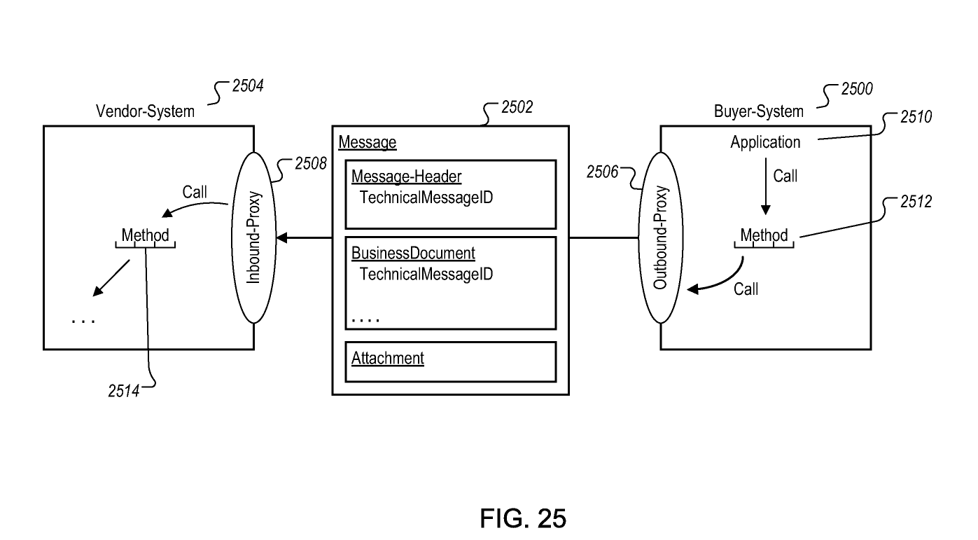

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

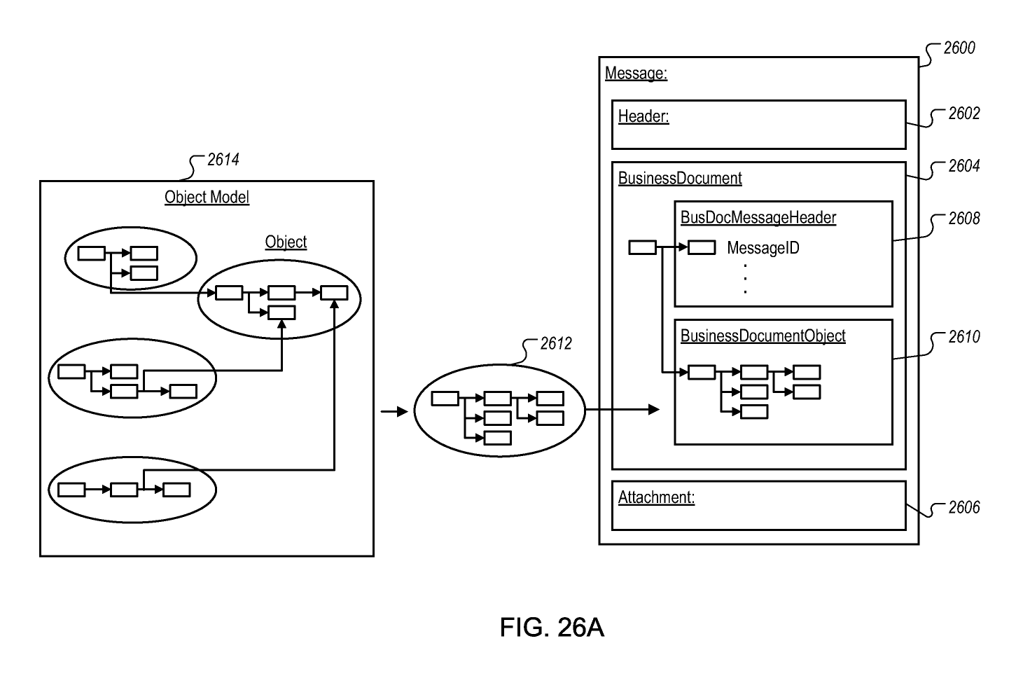

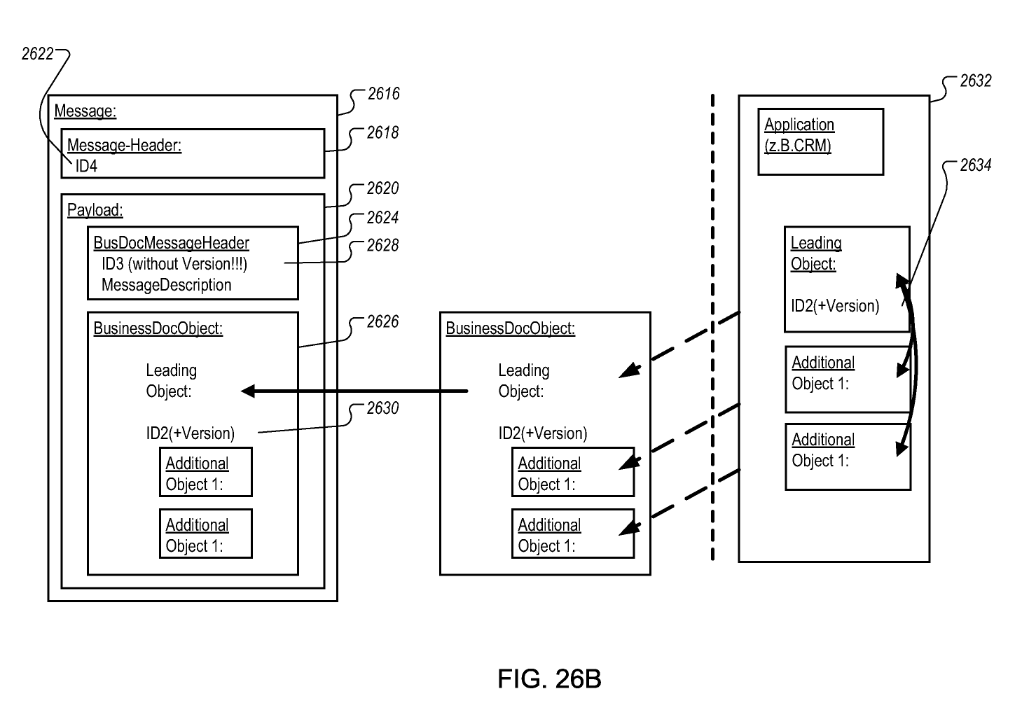

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

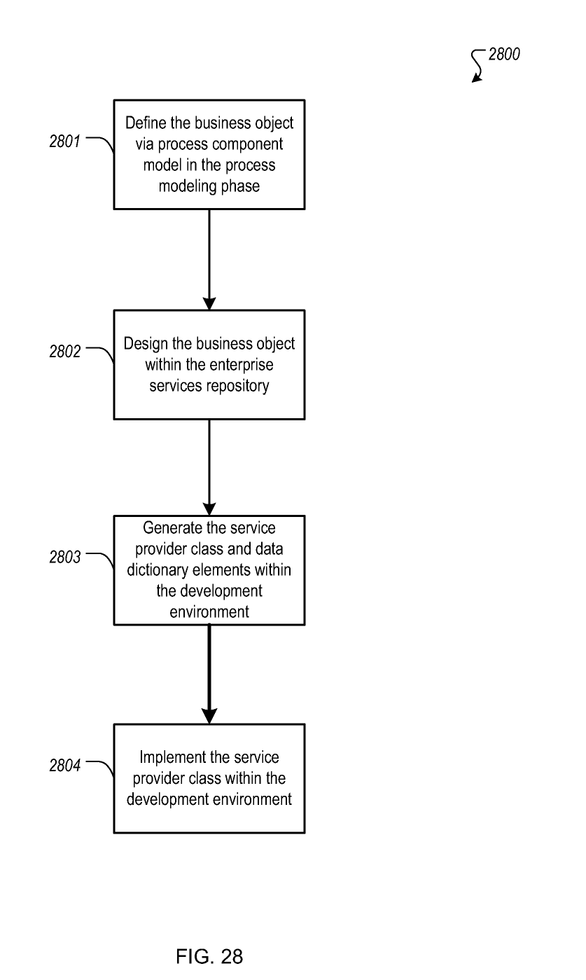

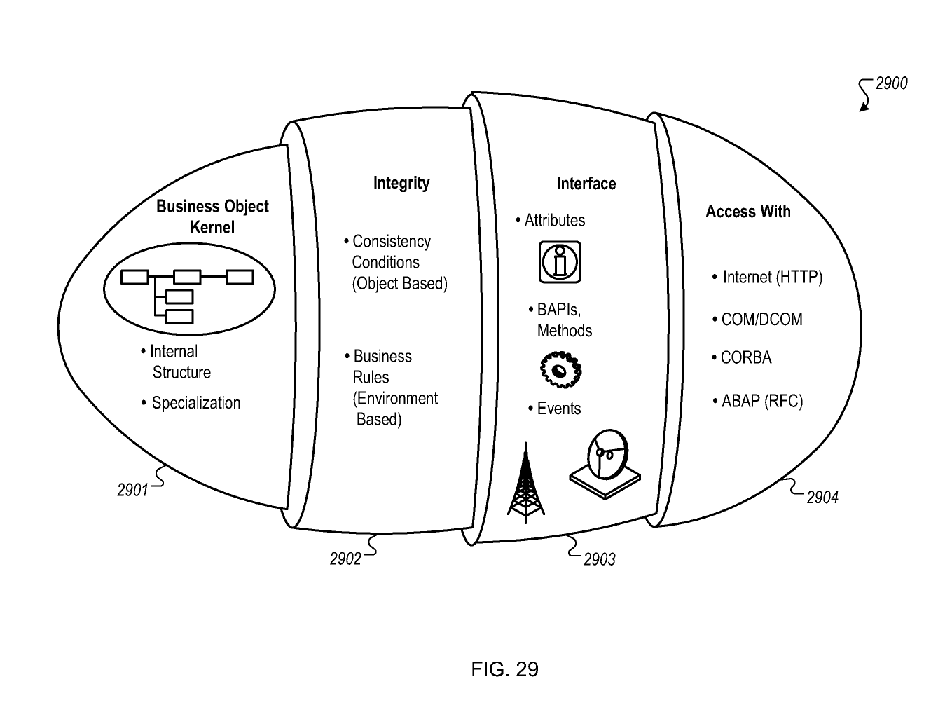

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

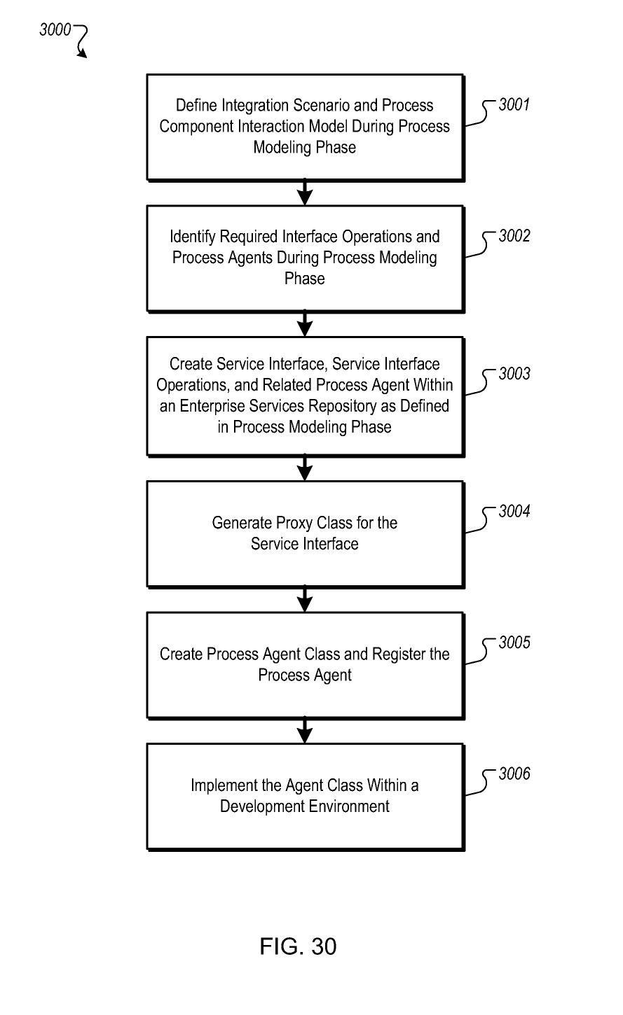

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

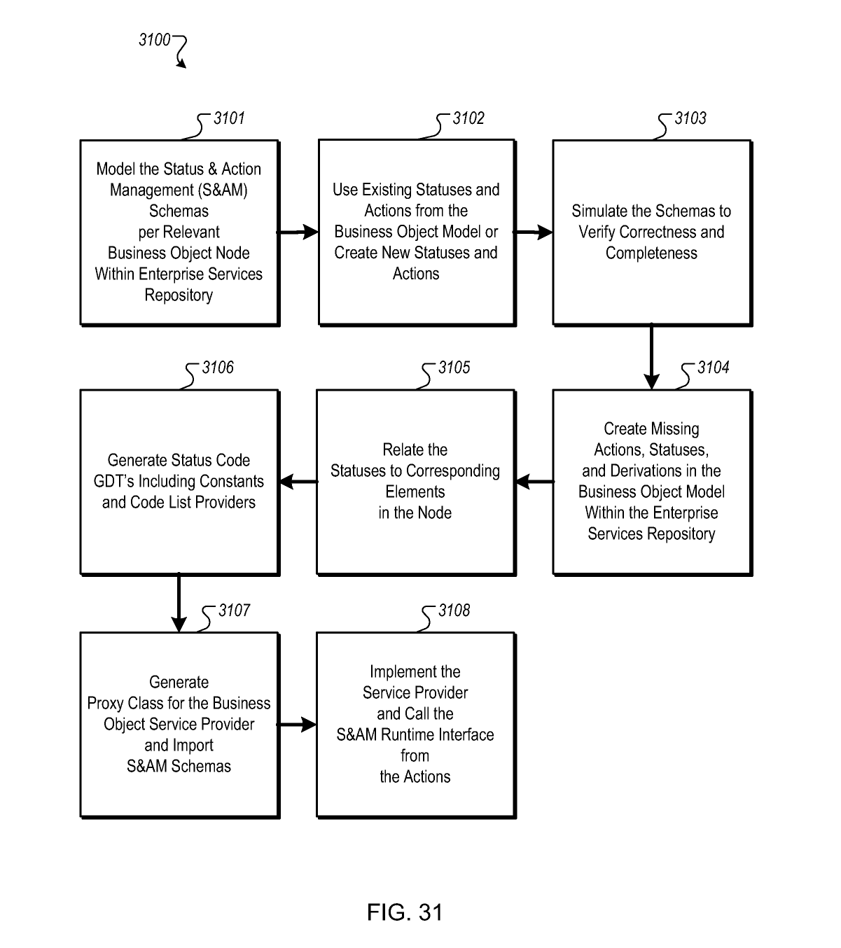

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

### RetailEvent Interfaces

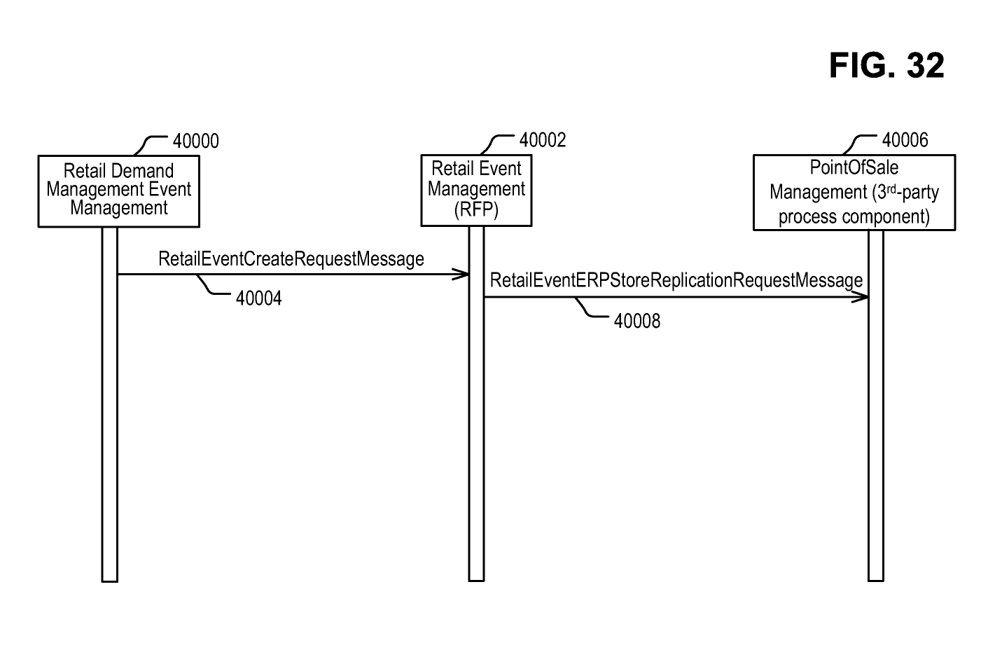

The message choreography of FIG. 32 describes a possible logical sequence of messages that can be used to realize a Retail Event business scenario.

A “Retail Demand Management Retail Event Management” system 40000 can send a request to create a retail event to increase sales to a “Retail Event Management” system 40002, using a RetailEventCreateRequest message 40004 as shown, for example, in FIG. 32. The RetailEventCreateRequest message 40004 can be sent by a RetailEventCreateRequest_In operation that is included in a Retail Event_In interface. The RetailEventCreateRequest_In operation can enable the use of 3^{rd}-party planning and optimization tools (demand management systems). This can improve the efficiency of the retail events and increase sales.

The “Retail Event Management” system 40002 can send a request to activate retail event offers to the “PointOfSale Management (3^{rd}-party process component)” system 40006, using a RetailEventERPStoreReplicationRequest message 40008 as shown, for example, in FIG. 32. The RetailEventERPStoreReplicationRequest message 40006 can be sent by a RetailEventERPStoreReplicationRequest_Out operation that is included in Retail Event_Out interface. The RetailEventERPStoreReplicationRequest_Out operation can be used in trading industries to provide a POS system in a Store with Retail Event master data.

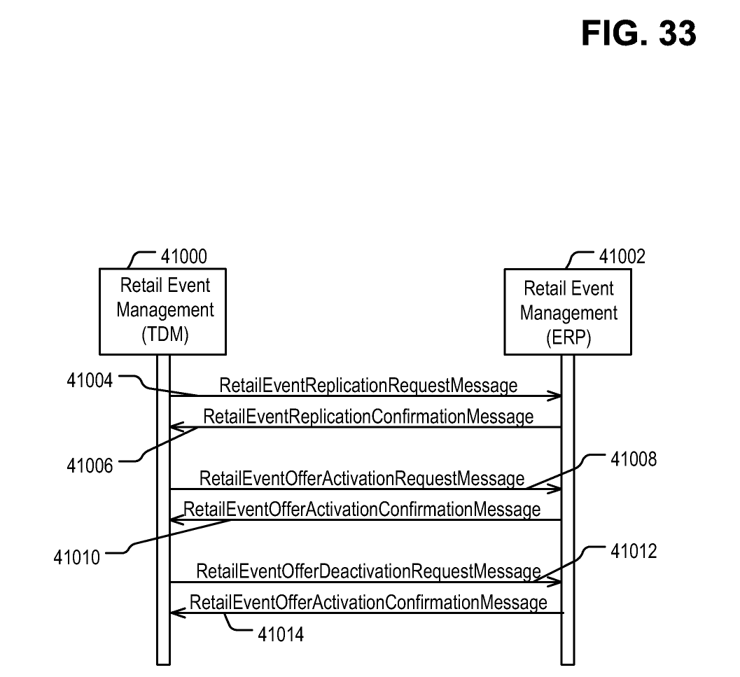

The message choreography of FIG. 33 describes another possible logical sequence of messages that can be used to realize a Retail Event business scenario.

A “Retail Event Management (TDM)” system 41000 can send a request to replicate a Retail Event to a “Retail Event Management (ERP)” system 41002, using a RetailEventReplicationRequest message 41004 as shown, for example, in FIG. 33. The RetailEventReplicationRequest message 41004 can be sent by a RetailEventReplicationRequest_In operation that is included in a Retail Event_In interface. The RetailEventReplicationRequest_In operation can be used to enable an external system. For example, a 3^{rd}-party system or Promo to create, change or delete a Retail Event in ERP.

The “Retail Event Management (ERP)” system 41002 can request the confirmation of a replication of a Retail Event from the “Retail Event Management (TDM)” system 41000, using a RetailEventReplicationConfirmation message 41006 as shown, for example, in FIG. 33. The RetailEventReplicationConfirmation message 41006 is received by the RetailEventReplicationConfirmation_Out operation that is included in the Retail Event_Out interface.

The “Retail Event Management (TDM)” system 41000 can send a request to activate retail event offers to the “Retail Event Management (ERP)” system 41002, using a RetailEventOfferActivationRequest message 41008 as shown, for example, in FIG. 33. The RetailEventOfferActivationRequest message 41008 can be sent by a RetailEventOfferActivationRequest_In operation that is included in the Retail Event_In interface. The RetailEventOfferActivationRequest_In operation is used to activate Retail Event offers in ERP.

The “Retail Event Management (ERP)” system 41002 can request the confirmation of the activation of retail event offers from the “Retail Event Management (TDM)” system 41000, using a RetailEventOfferActivationConfirmation message 41010 as shown, for example, in FIG. 33. The RetailEventOfferActivationConfirmation message 41010 is received by the RetailEventOfferActivationConfirmation_Out operation. The RetailEventOfferActivationConfirmation_Out operation can confirm the activation of retail event offers.

The “Retail Event Management (TDM)” system 41000 can send a request to deactivate retail event offers from the “Retail Event Management (ERP)” system 41002, using a RetailEventOfferActivationRequest message 41012 as shown, for example, in FIG. 33. The RetailEventOfferActivationRequest message 41012 can be sent by a RetailEventOfferDeactivationRequest_In operation. The RetailEventOfferDeactivationRequest_In operation can be used to deactivate Retail Event offers in ERP.

The “Retail Event Management (ERP)” system 41002 can request the confirmation of the deactivation of retail event offers from the “Retail Event Management (TDM)” system 41000, using a RetailEventOfferActivationConfirmation message 41014 as shown, for example, in FIG. 33. The RetailEventOfferActivationConfirmation message 41014 is received by the RetailEventOfferActivationConfirmation_Out operation. The RetailEventOfferActivationConfirmation_Out operation can confirm the deactivation of retail event offers.

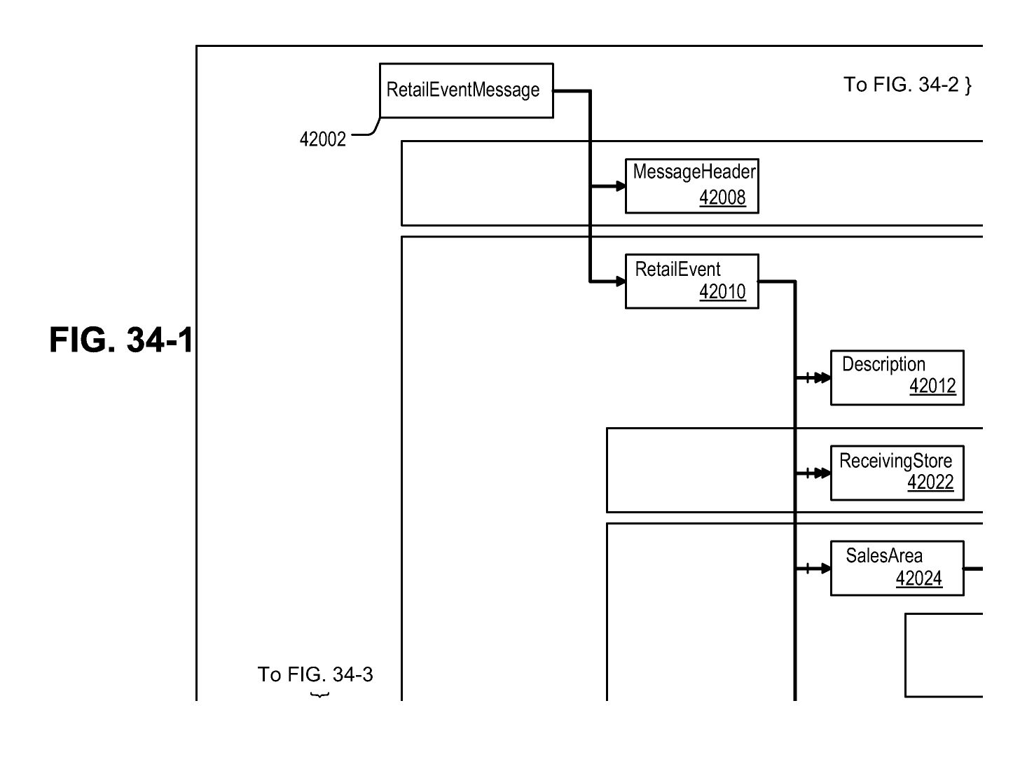

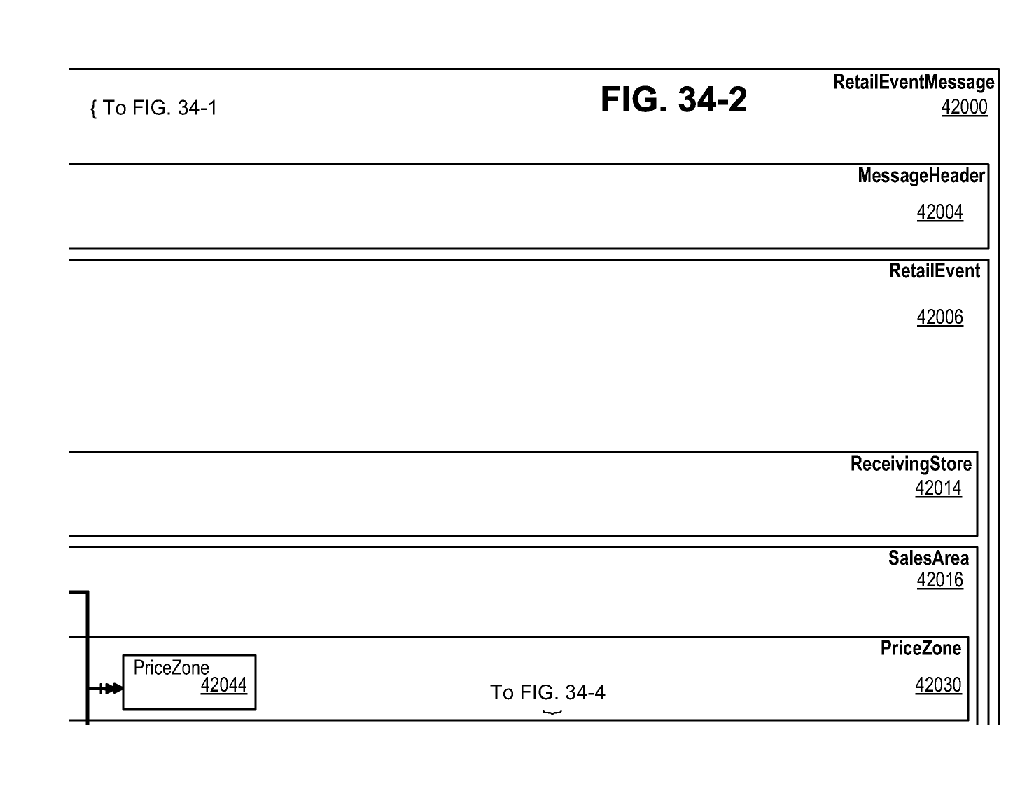

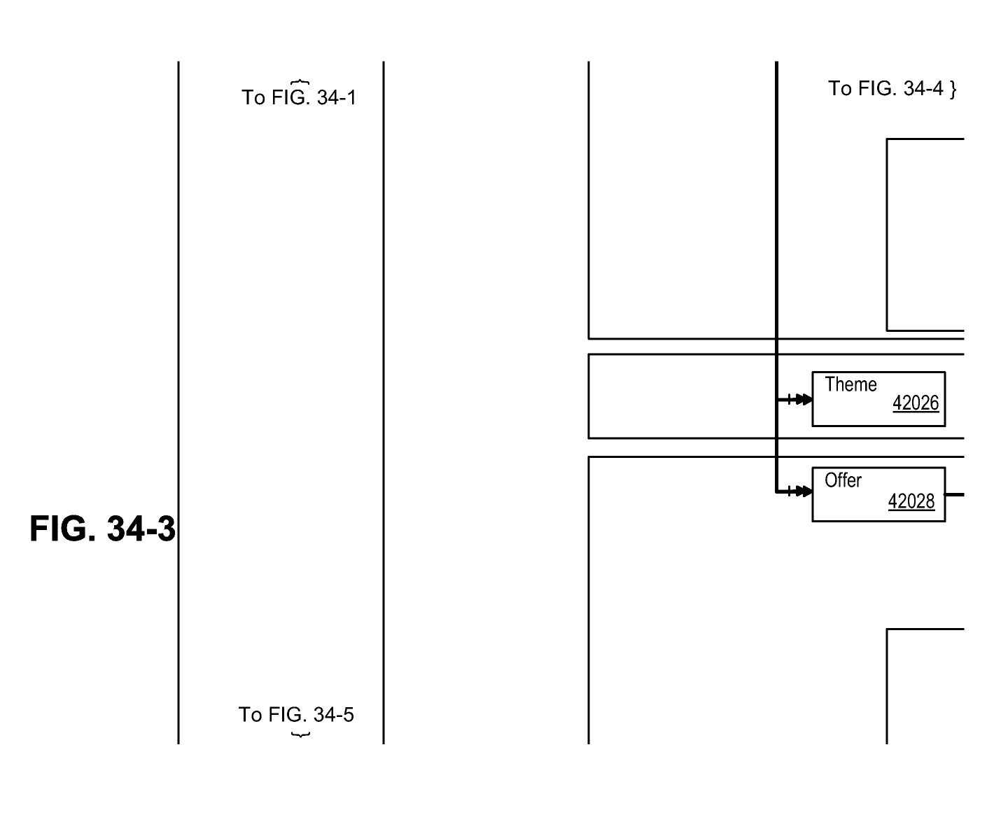

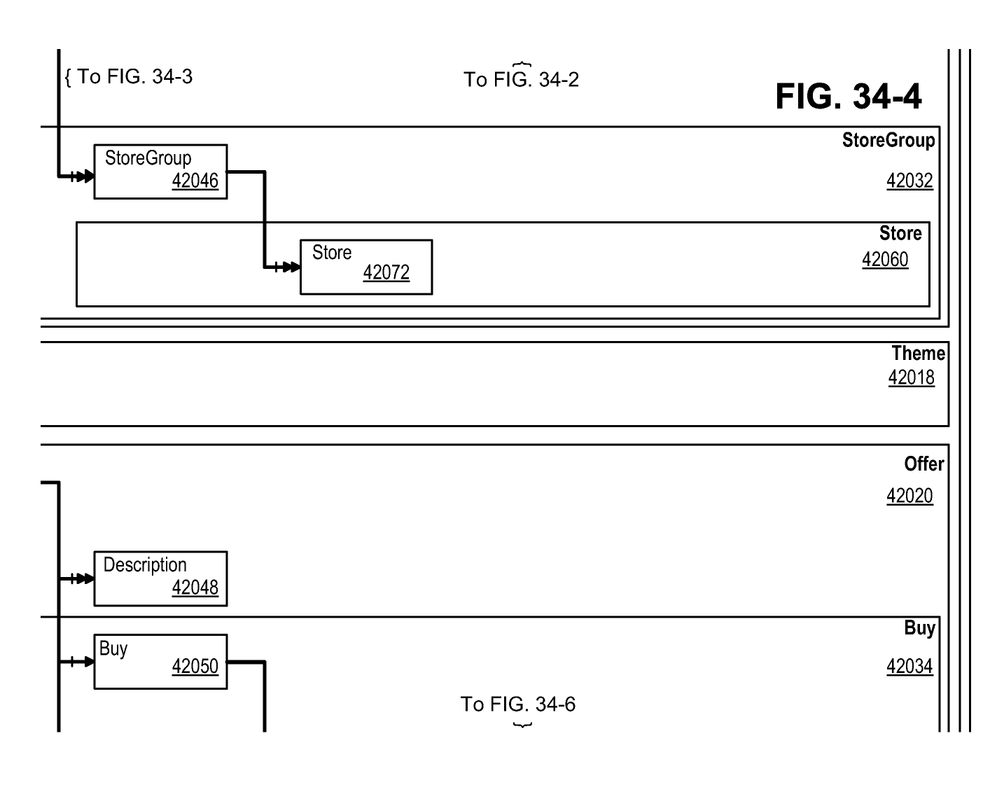

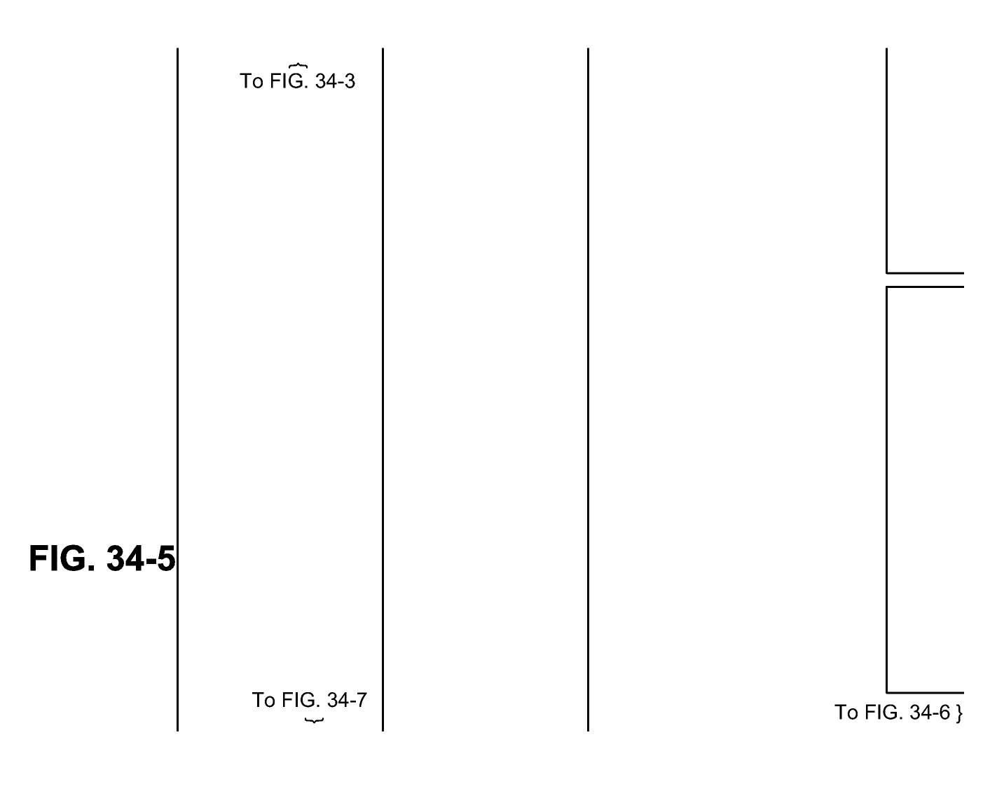

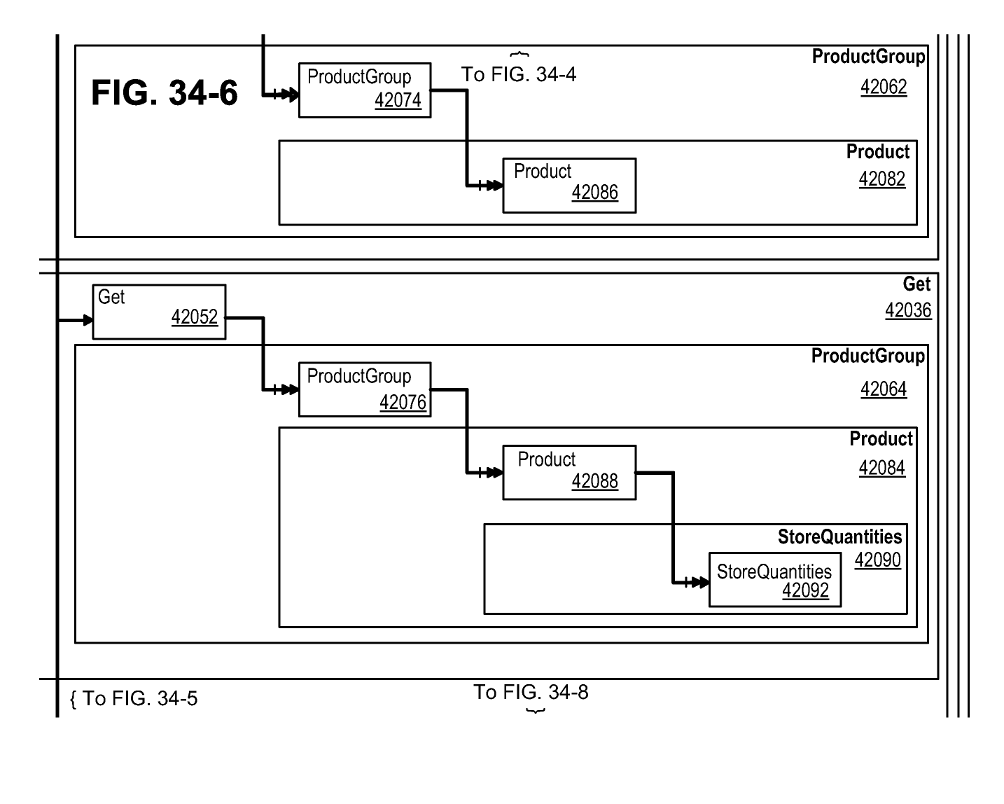

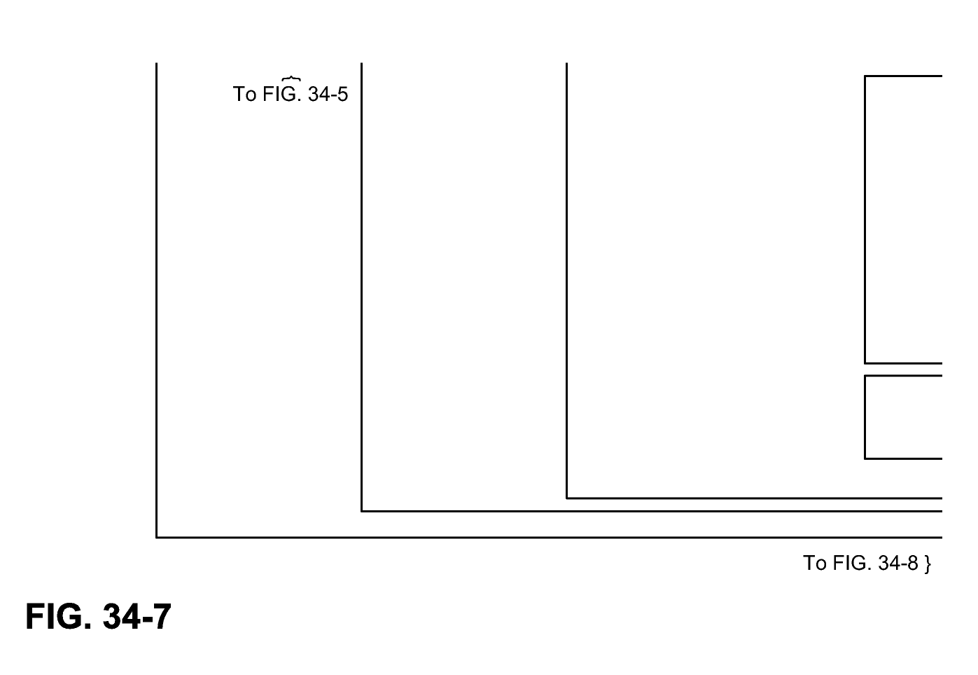

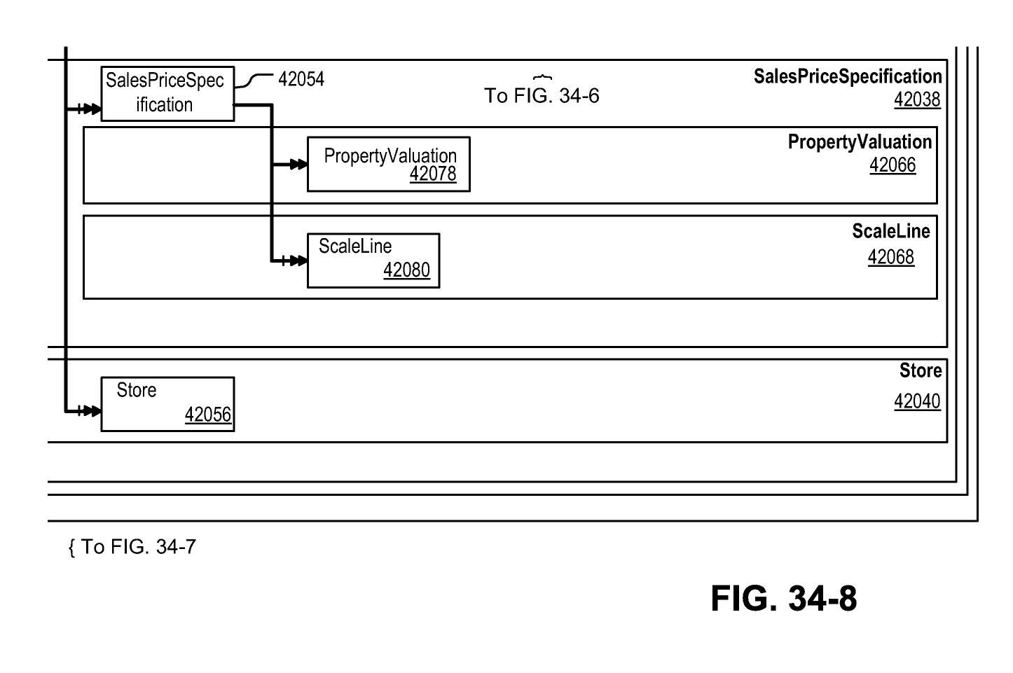

FIGS. 34-1 to 34-8 illustrate one example logical configuration of RetailEventMessage message 42000. Specifically, this figure depicts the arrangement and hierarchy of various components such as one or more levels of packages, entities, and datatypes, shown here as 42002 through 42092. As described above, packages may be used to represent hierarchy levels. Entities are discrete business elements that are used during a business transaction. Data types are used to type object entities and interfaces with a structure. For example, RetailEventMessage message 42000 includes, among other things, RetailEvent 42006. Accordingly, heterogeneous applications may communicate using this consistent message configured as such.

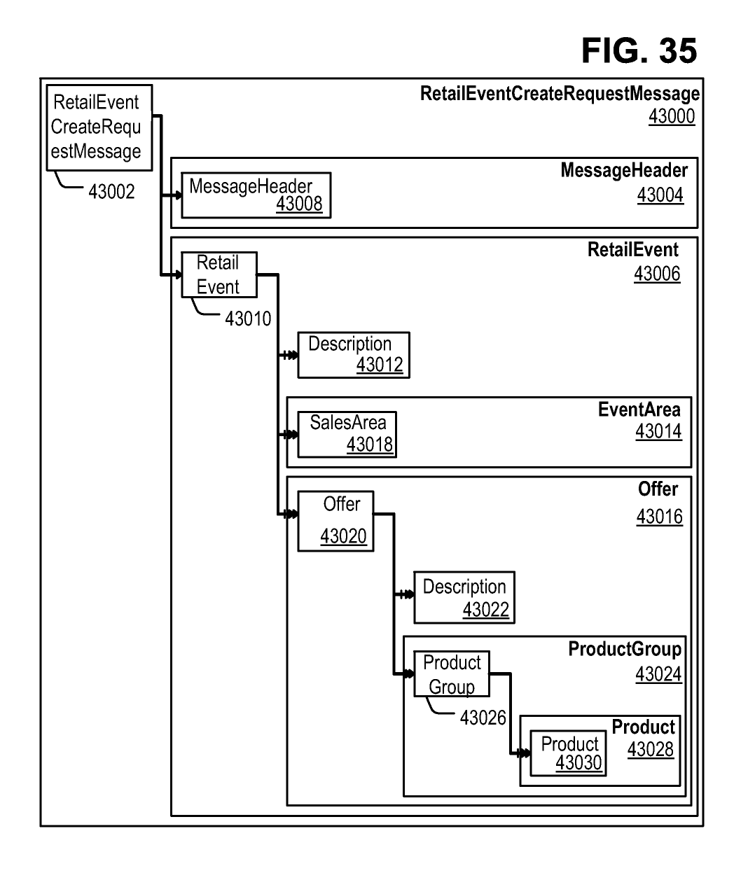

Additionally, FIG. 35 illustrates one example logical configuration of RetailEventCreateRequestMessage message 43000. Specifically, this figure depicts the arrangement and hierarchy of various components such as one or more levels of packages, entities, and datatypes, shown here as 43002 through 43030. As described above, packages may be used to represent hierarchy levels. Entities are discrete business elements that are used during a business transaction. Data types are used to type object entities and interfaces with a structure. For example, RetailEventCreateRequestMessage message 43000 includes, among other things, RetailEvent 43006. Accordingly, heterogeneous applications may communicate using this consistent message configured as such.

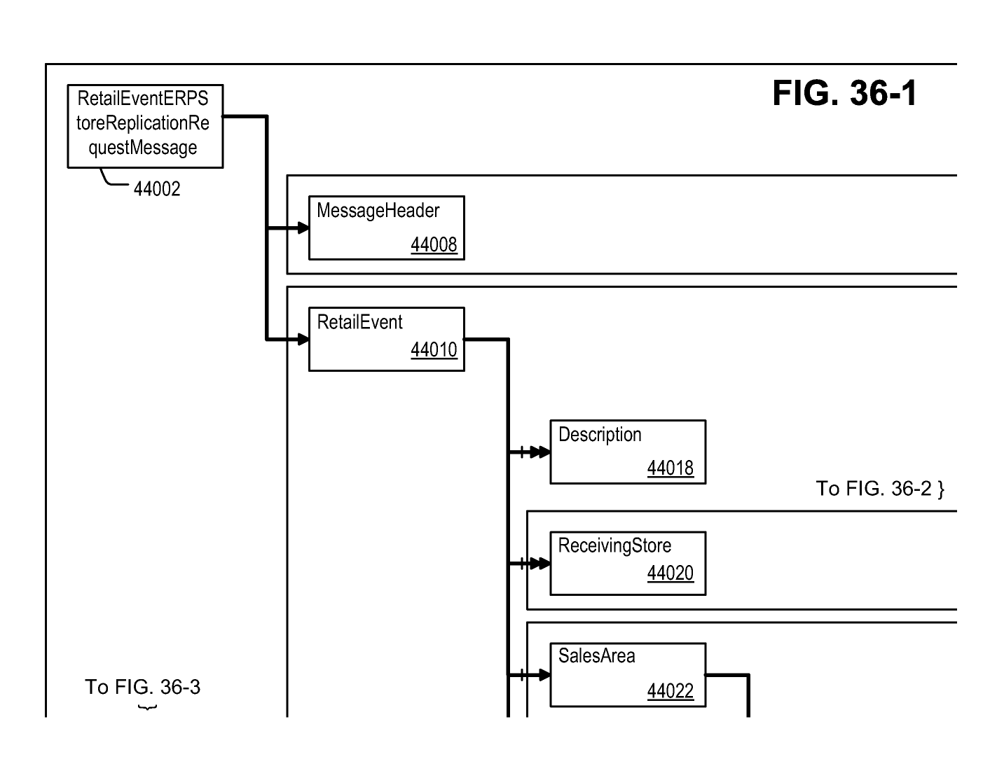

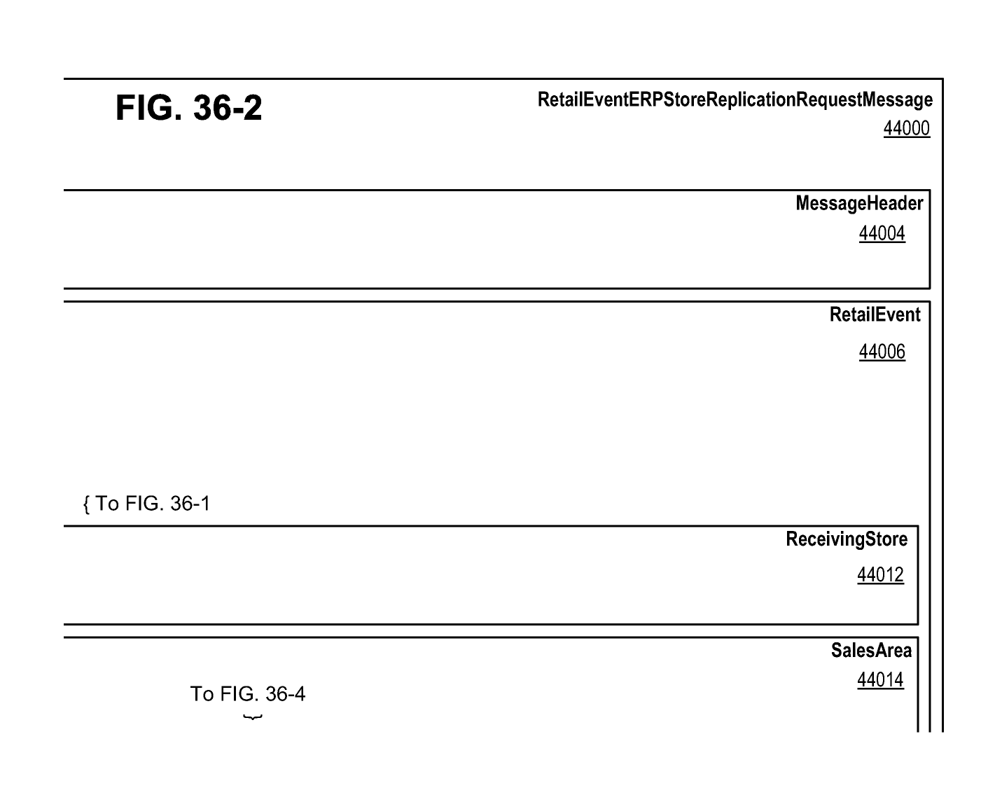

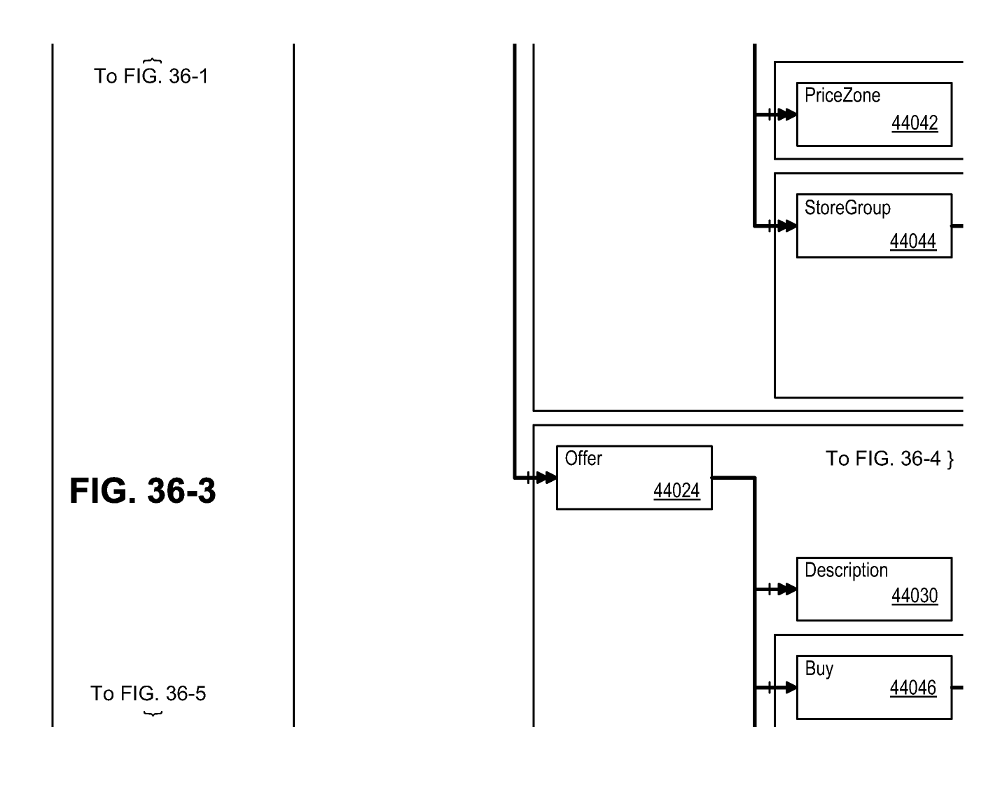

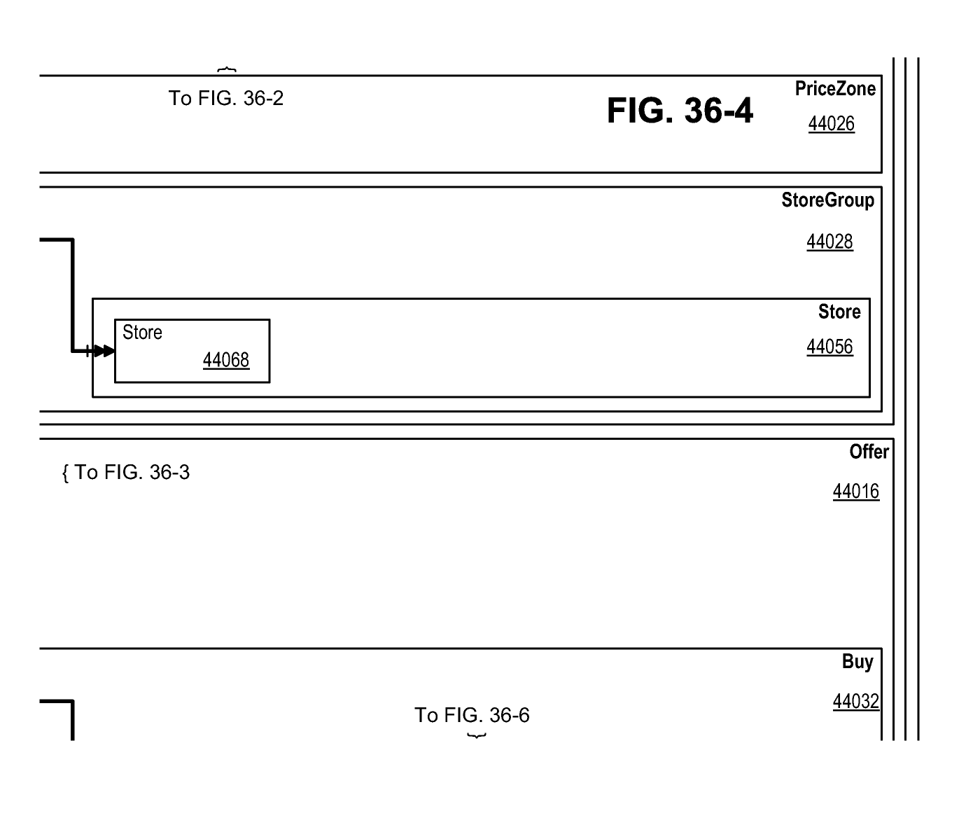

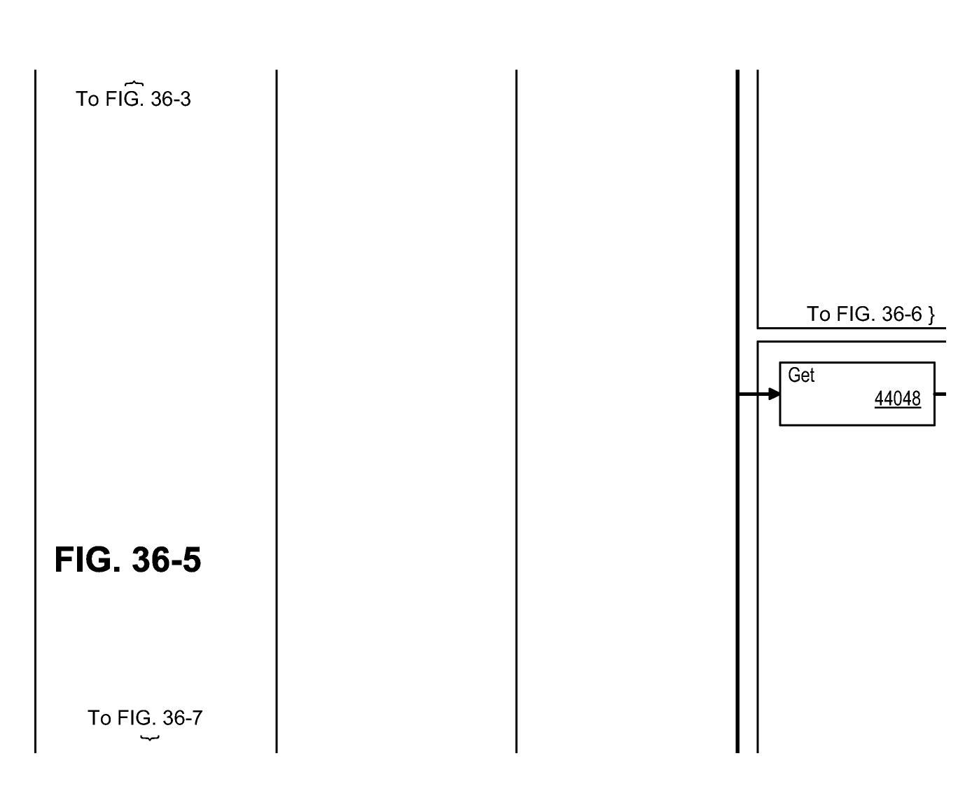

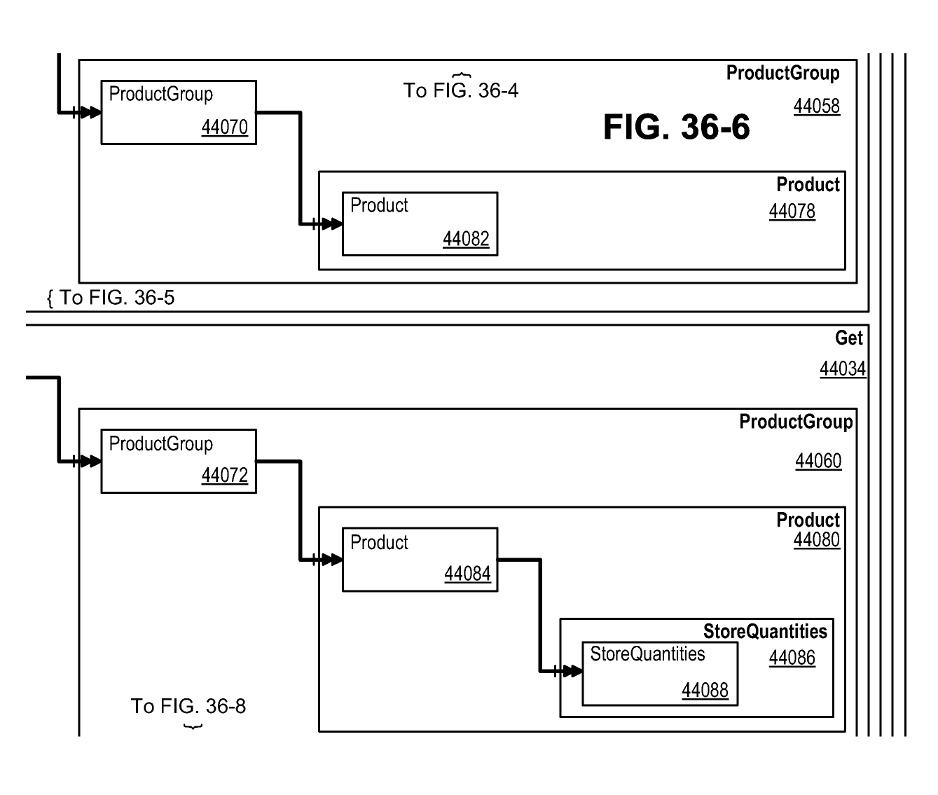

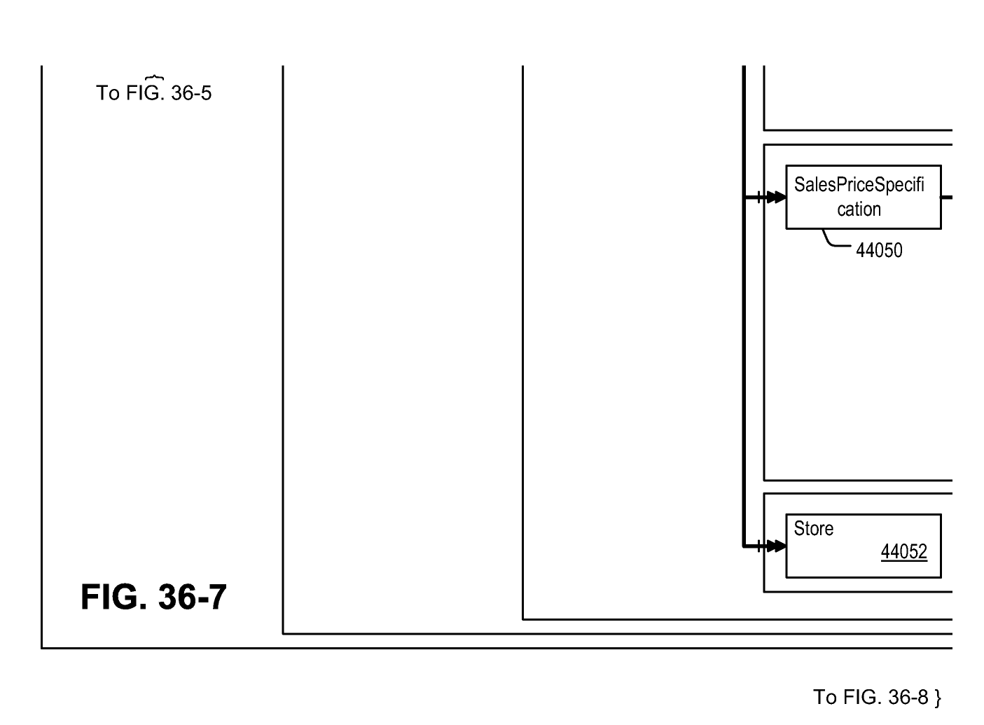

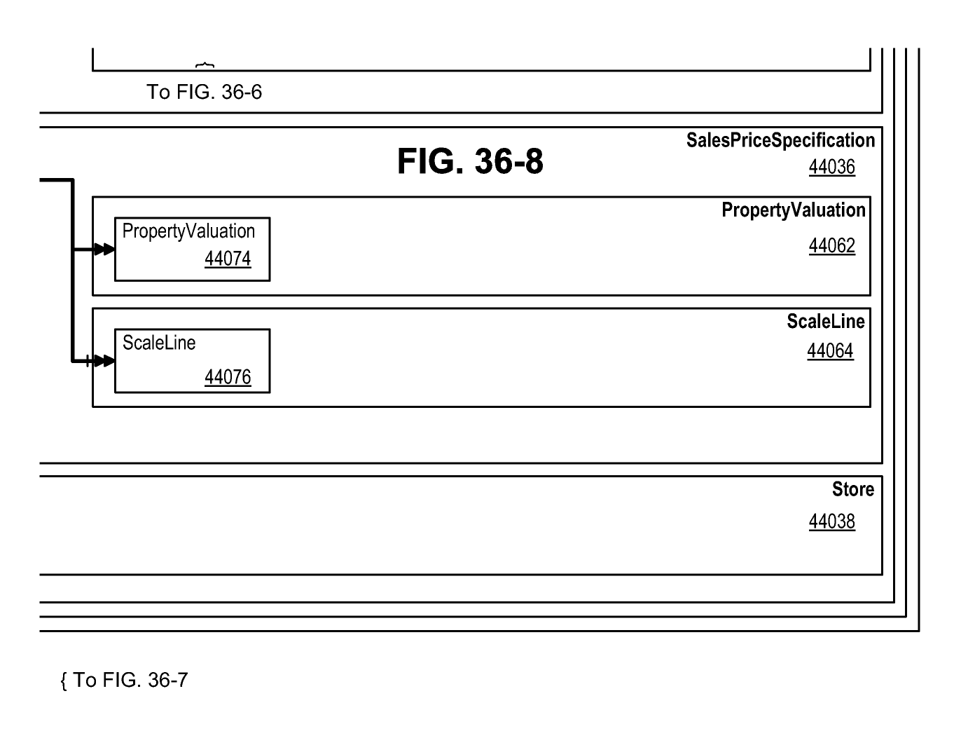

Additionally, FIGS. 36-1 to 36-8 illustrate one example logical configuration of RetailEventERPStoreReplicationRequestMessage message 44000. Specifically, this figure depicts the arrangement and hierarchy of various components such as one or more levels of packages, entities, and datatypes, shown here as 44002 through 44088. As described above, packages may be used to represent hierarchy levels. Entities are discrete business elements that are used during a business transaction. Data types are used to type object entities and interfaces with a structure. For example, RetailEventERPStoreReplicationRequestMessage message 44000 includes, among other things, RetailEvent 44006. Accordingly, heterogeneous applications may communicate using this consistent message configured as such.

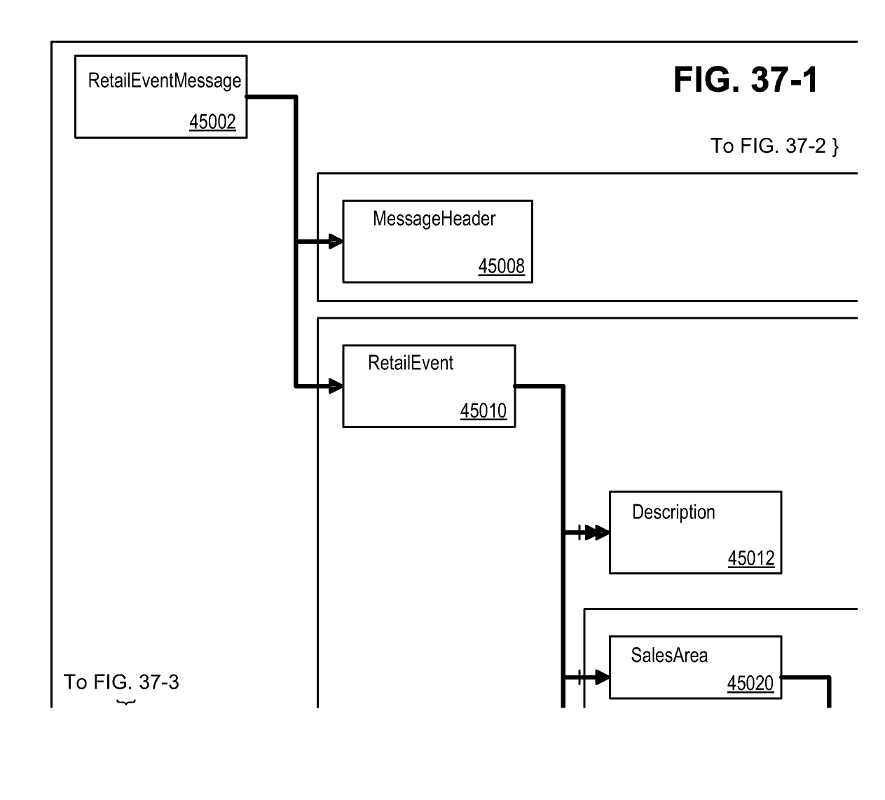

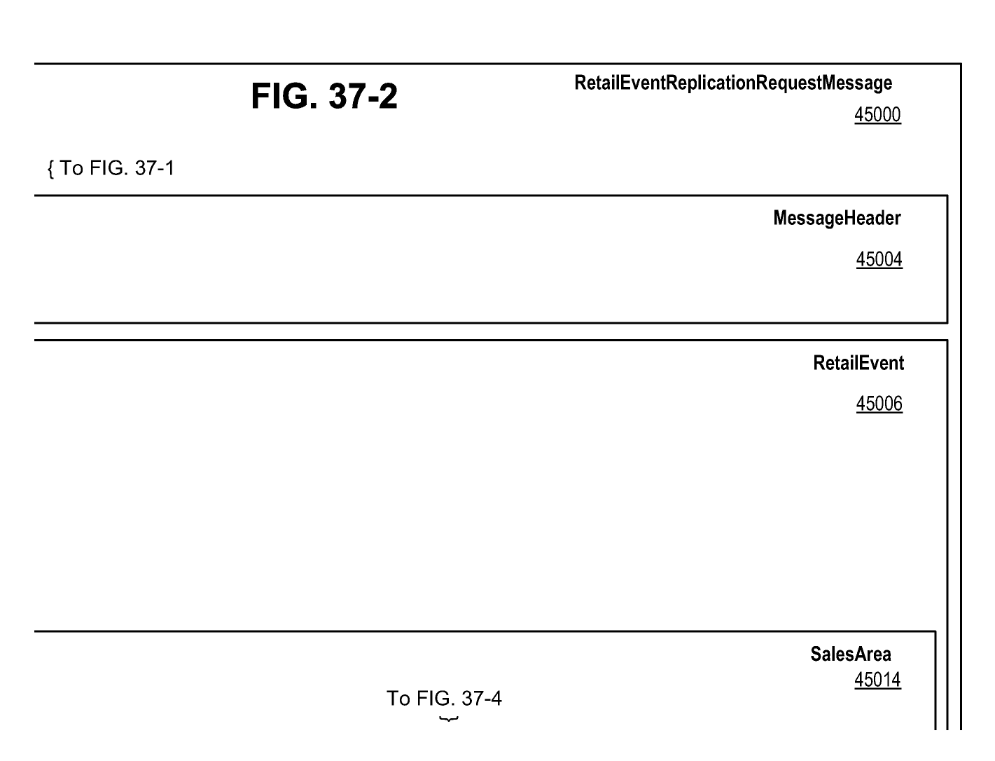

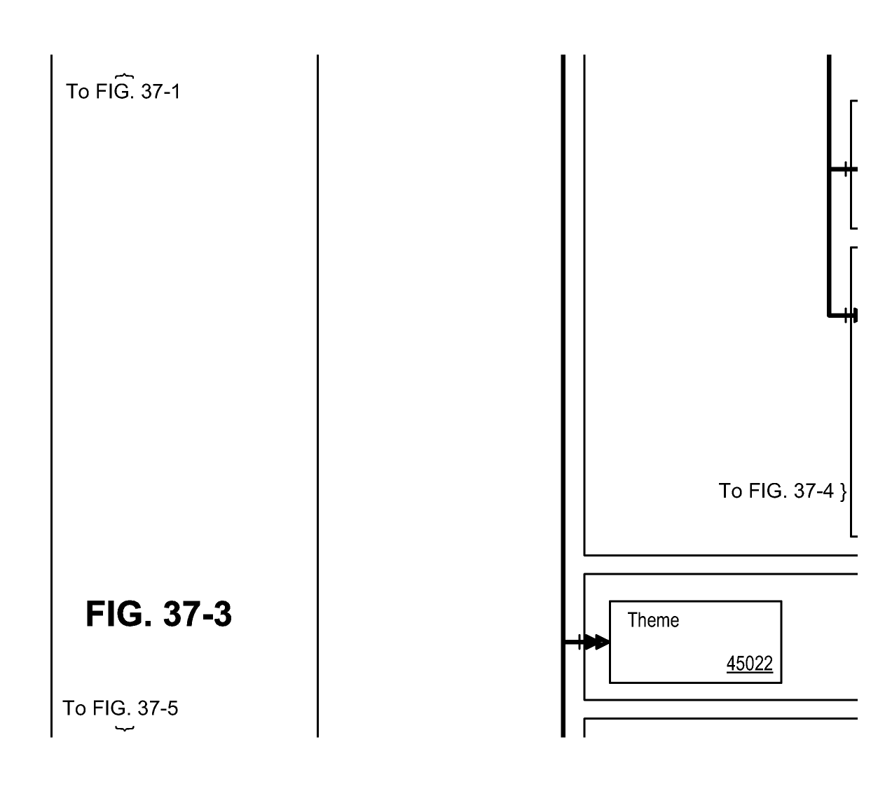

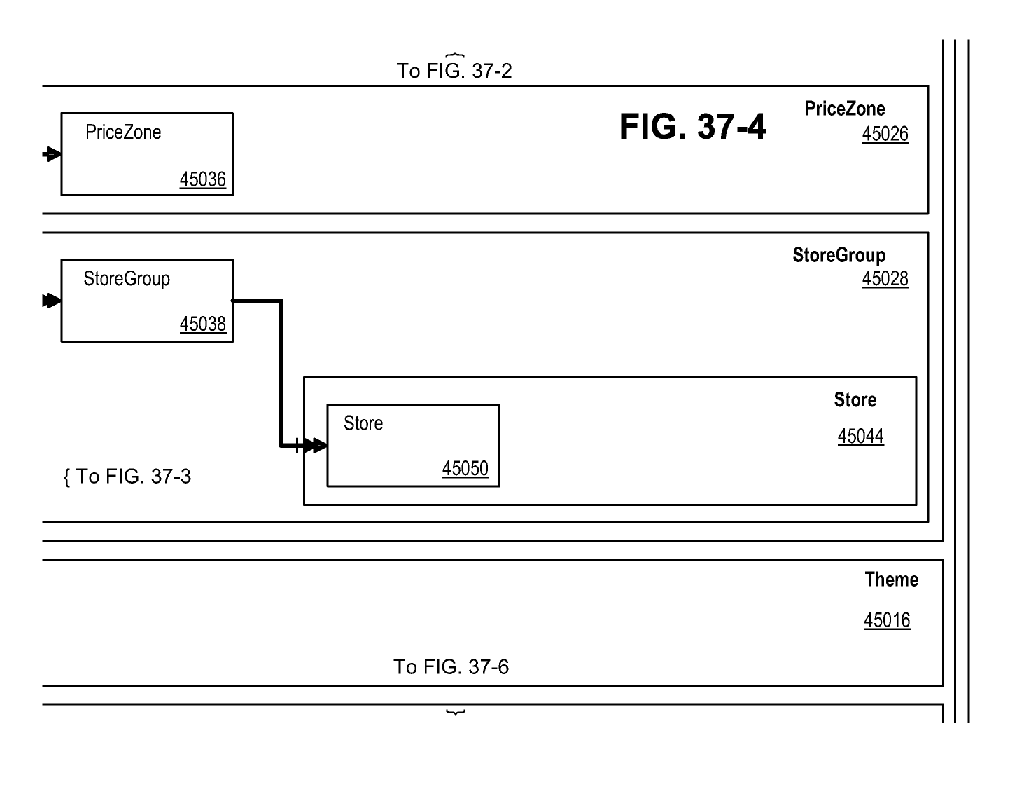

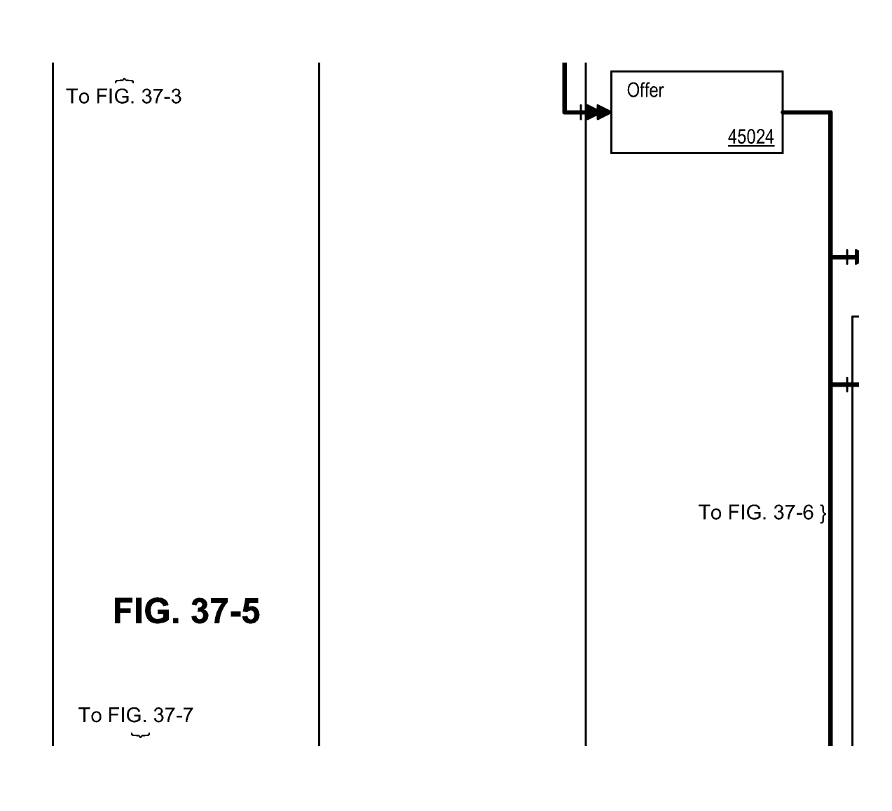

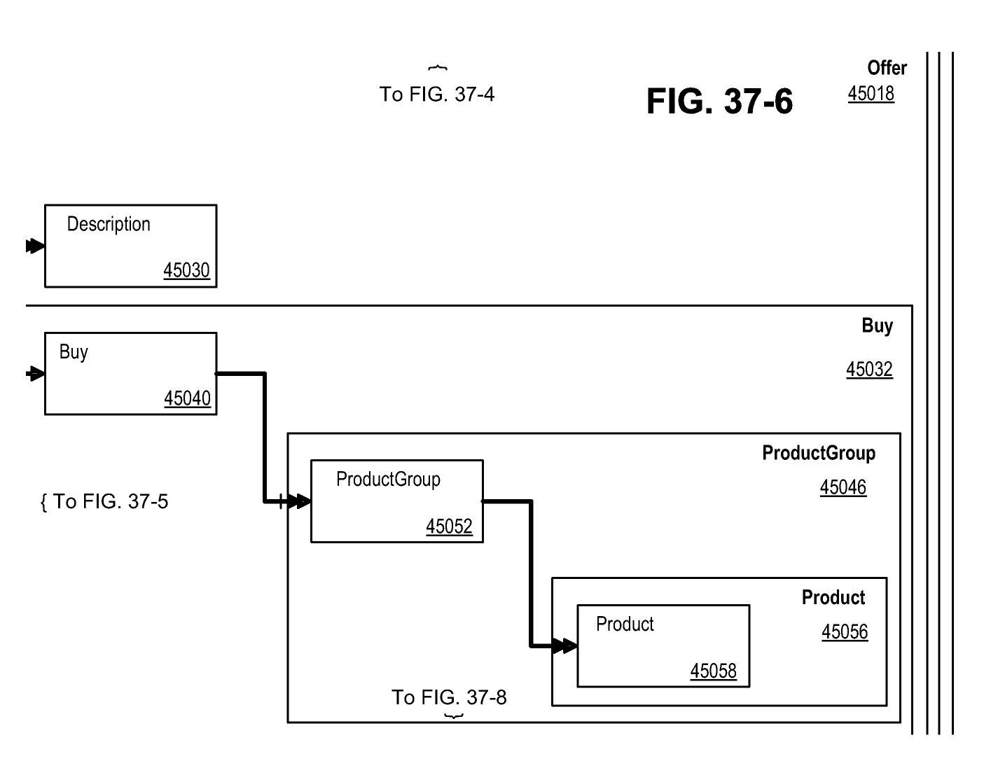

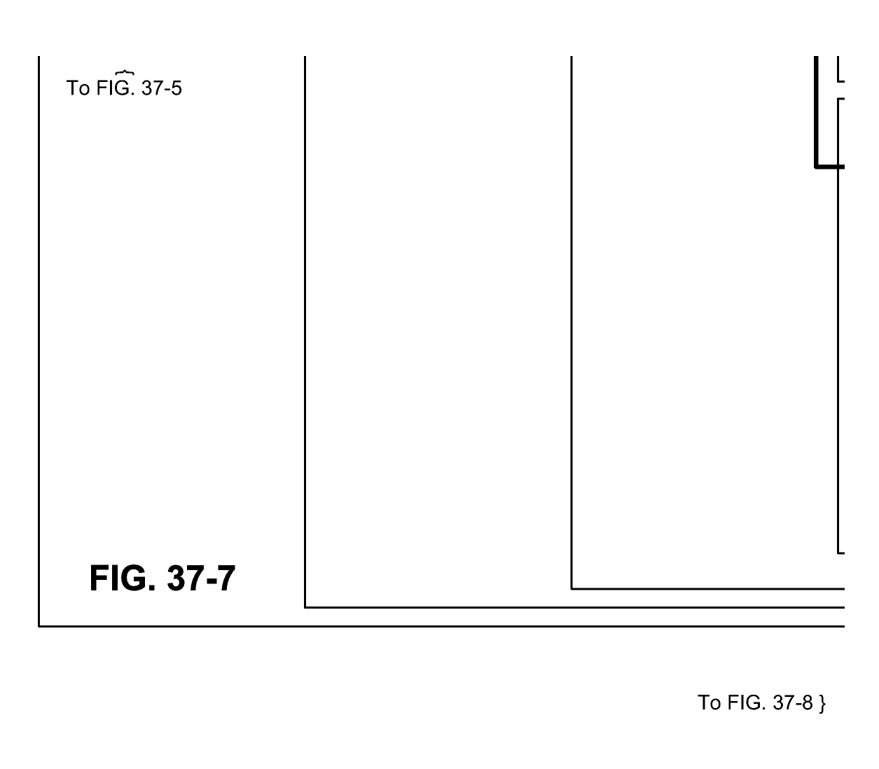

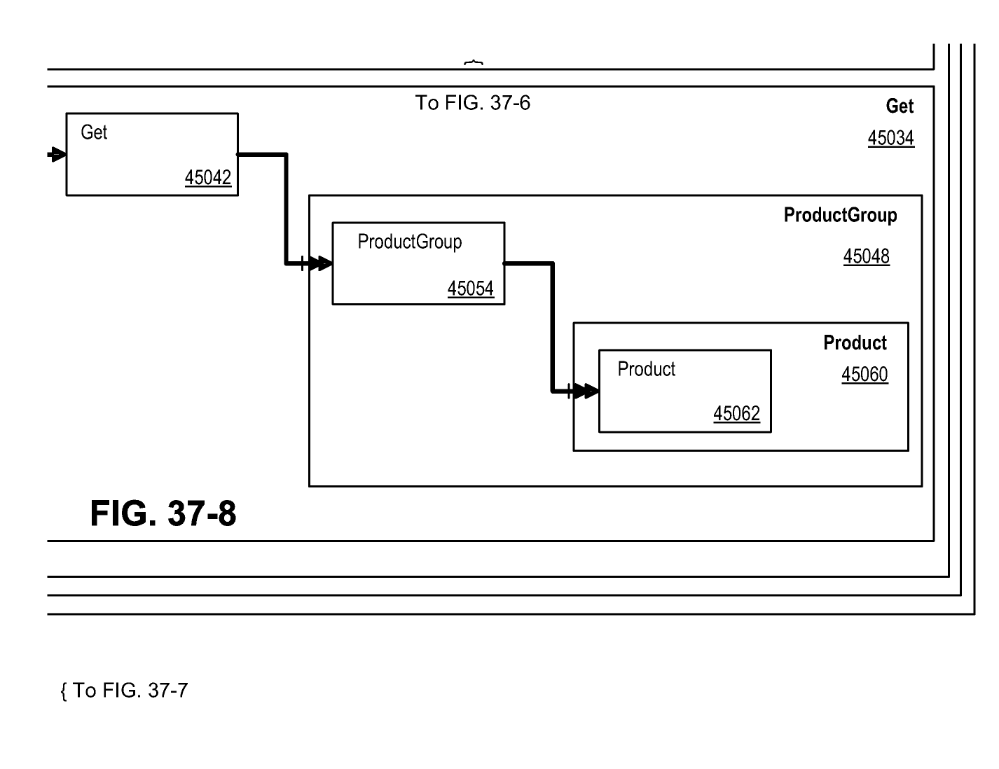

Additionally, FIGS. 37-1 to 37-8 illustrate one example logical configuration of RetailEventReplicationRequestMessage message 45000. Specifically, this figure depicts the arrangement and hierarchy of various components such as one or more levels of packages, entities, and datatypes, shown here as 45002 through 45062. As described above, packages may be used to represent hierarchy levels. Entities are discrete business elements that are used during a business transaction. Data types are used to type object entities and interfaces with a structure. For example, RetailEventReplicationRequestMessage message 45000 includes, among other things, RetailEvent 45006. Accordingly, heterogeneous applications may communicate using this consistent message configured as such.

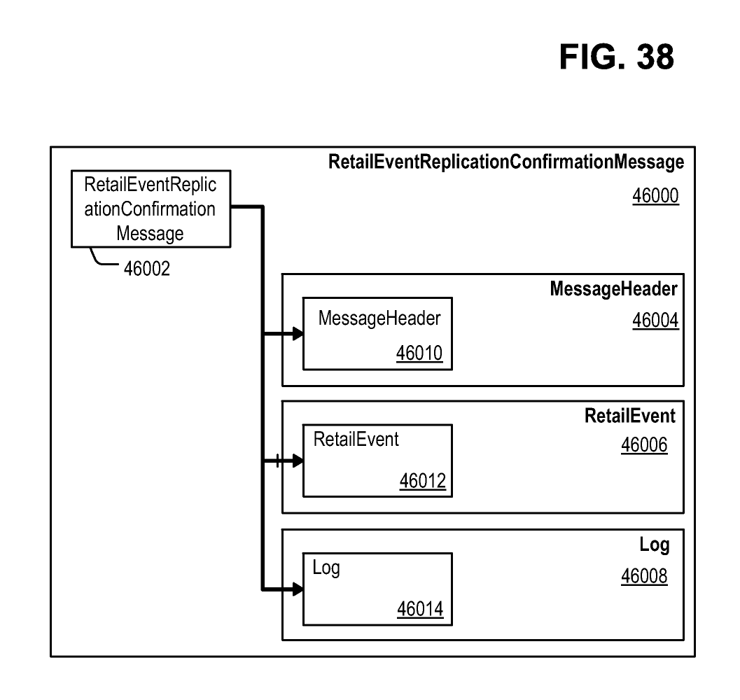

Additionally, FIG. 38 illustrates one example logical configuration of RetailEventReplicationConfirmationMessage message 46000. Specifically, this figure depicts the arrangement and hierarchy of various components such as one or more levels of packages, entities, and datatypes, shown here as 46002 through 46014. As described above, packages may be used to represent hierarchy levels. Entities are discrete business elements that are used during a business transaction. Data types are used to type object entities and interfaces with a structure. For example, RetailEventReplicationConfirmationMessage message 46000 includes, among other things, RetailEvent 46006. Accordingly, heterogeneous applications may communicate using this consistent message configured as such.

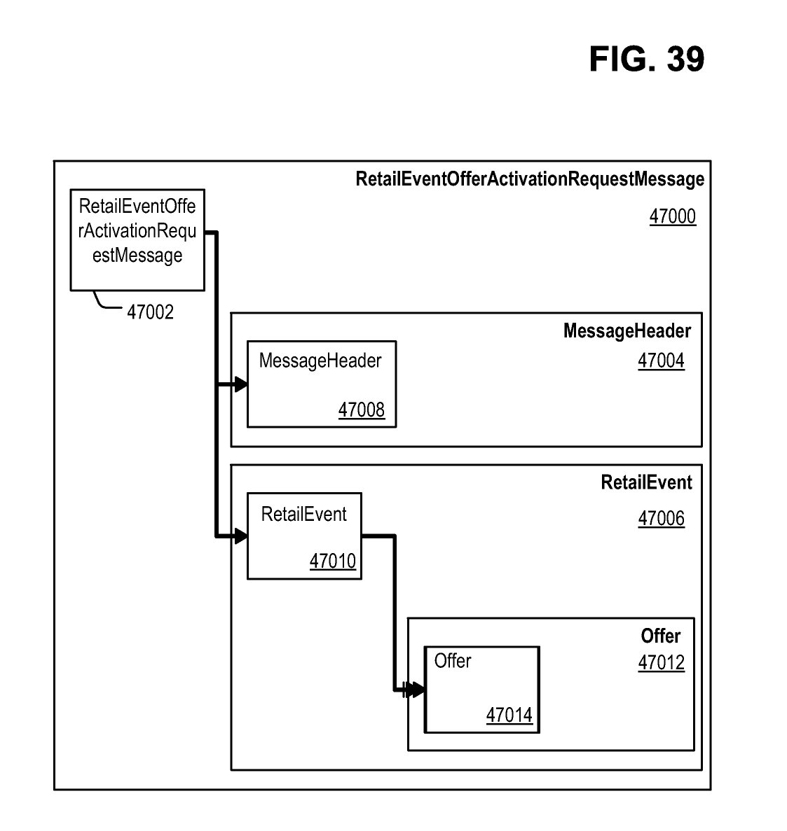

Additionally, FIG. 39 illustrates one example logical configuration of RetailEventOfferActivationRequestMessage message 47000. Specifically, this figure depicts the arrangement and hierarchy of various components such as one or more levels of packages, entities, and datatypes, shown here as 47002 through 47014. As described above, packages may be used to represent hierarchy levels. Entities are discrete business elements that are used during a business transaction. Data types are used to type object entities and interfaces with a structure. For example, RetailEventOfferActivationRequestMessage message 47000 includes, among other things, RetailEvent 47006. Accordingly, heterogeneous applications may communicate using this consistent message configured as such.

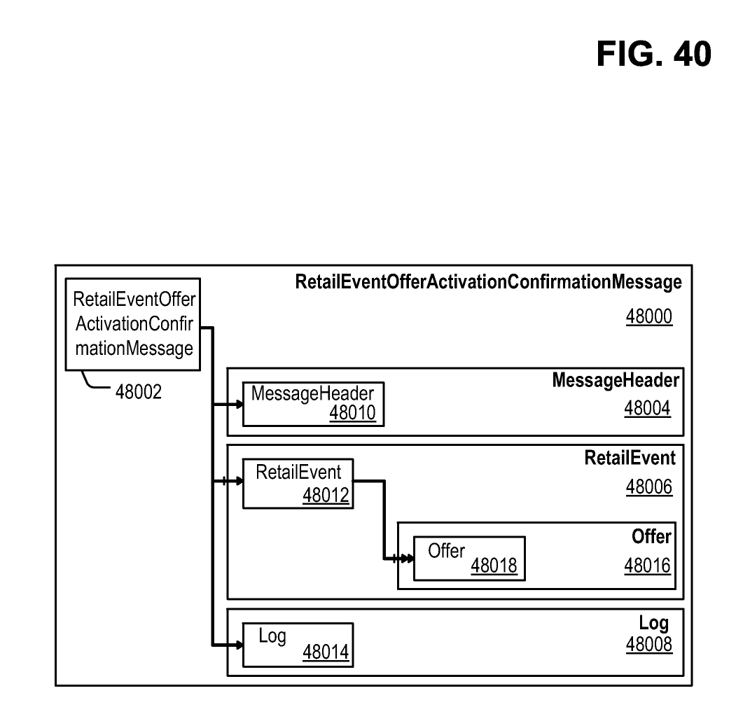

Additionally, FIG. 40 illustrates one example logical configuration of RetailEventOfferActivationConfirmationMessage message 48000. Specifically, this figure depicts the arrangement and hierarchy of various components such as one or more levels of packages, entities, and datatypes, shown here as 48002 through 48018. As described above, packages may be used to represent hierarchy levels. Entities are discrete business elements that are used during a business transaction. Data types are used to type object entities and interfaces with a structure. For example, RetailEventOfferActivationConfirmationMessage message 48000 includes, among other things, RetailEvent 48006. Accordingly, heterogeneous applications may communicate using this consistent message configured as such.

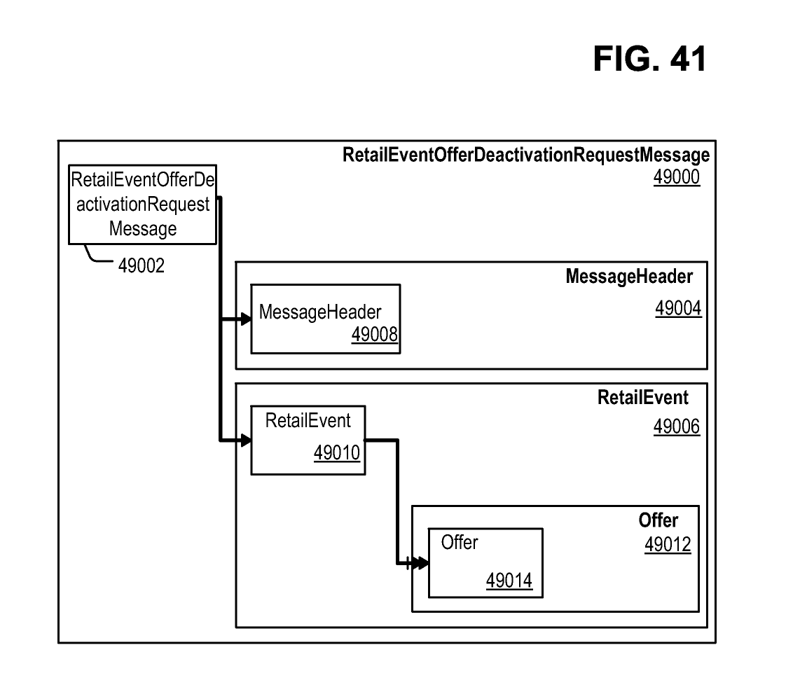

Additionally, FIG. 41 illustrates one example logical configuration of RetailEventOfferDeactivationRequestMessage message 49000. Specifically, this figure depicts the arrangement and hierarchy of various components such as one or more levels of packages, entities, and datatypes, shown here as 49002 through 49014. As described above, packages may be used to represent hierarchy levels. Entities are discrete business elements that are used during a business transaction. Data types are used to type object entities and interfaces with a structure. For example, RetailEventOfferDeactivationRequestMessage message 49000 includes, among other things, RetailEvent 49006. Accordingly, heterogeneous applications may communicate using this consistent message configured as such.

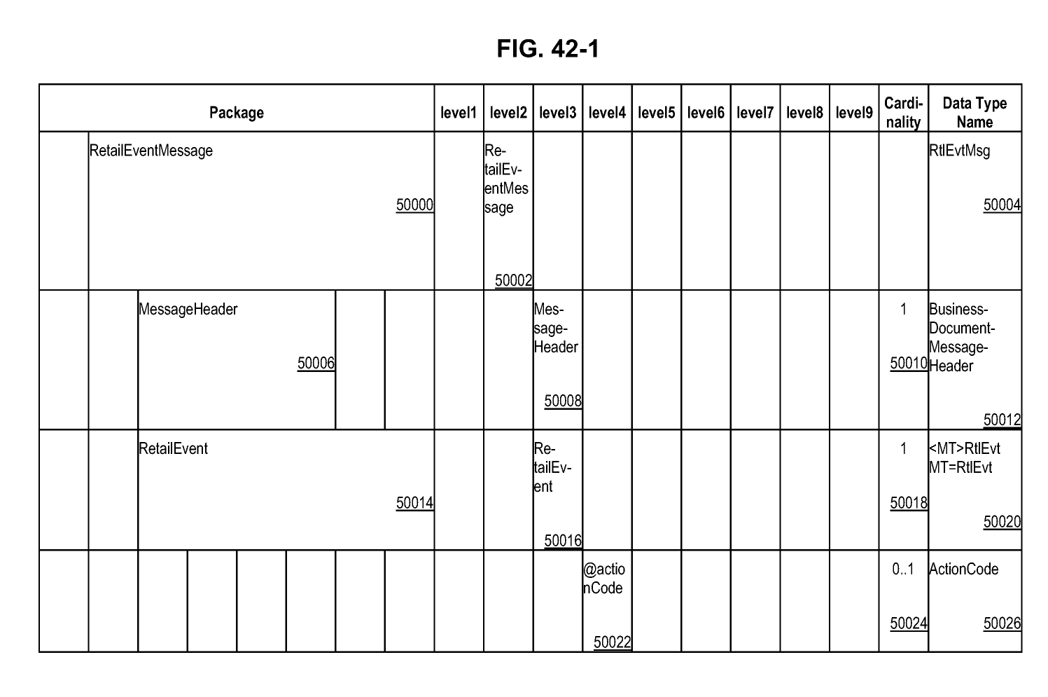

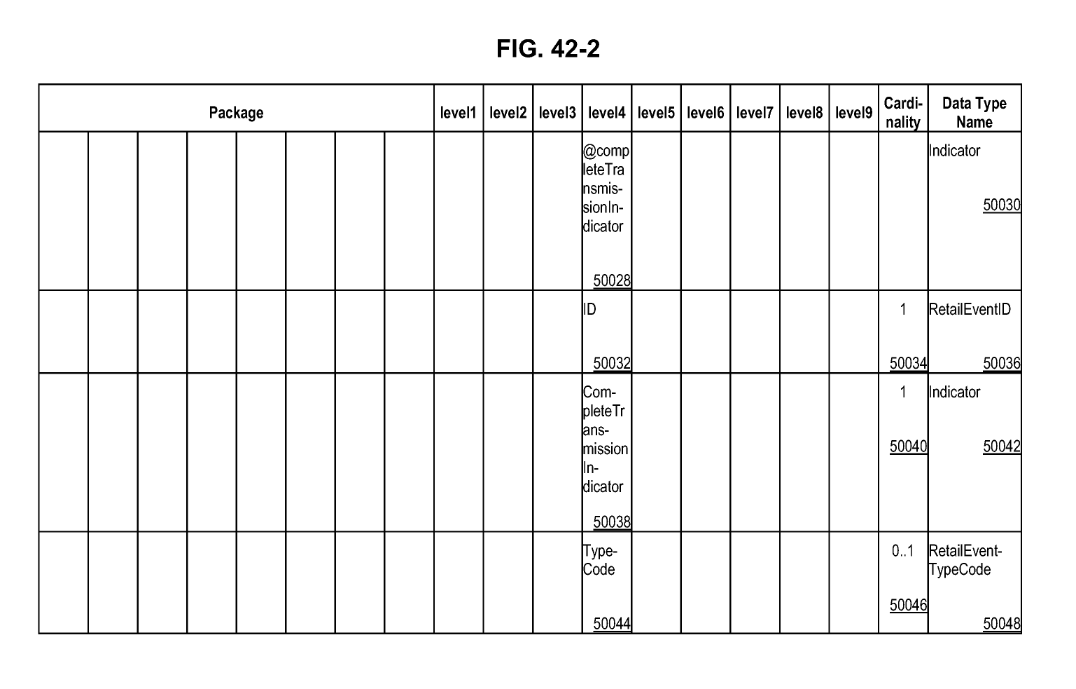

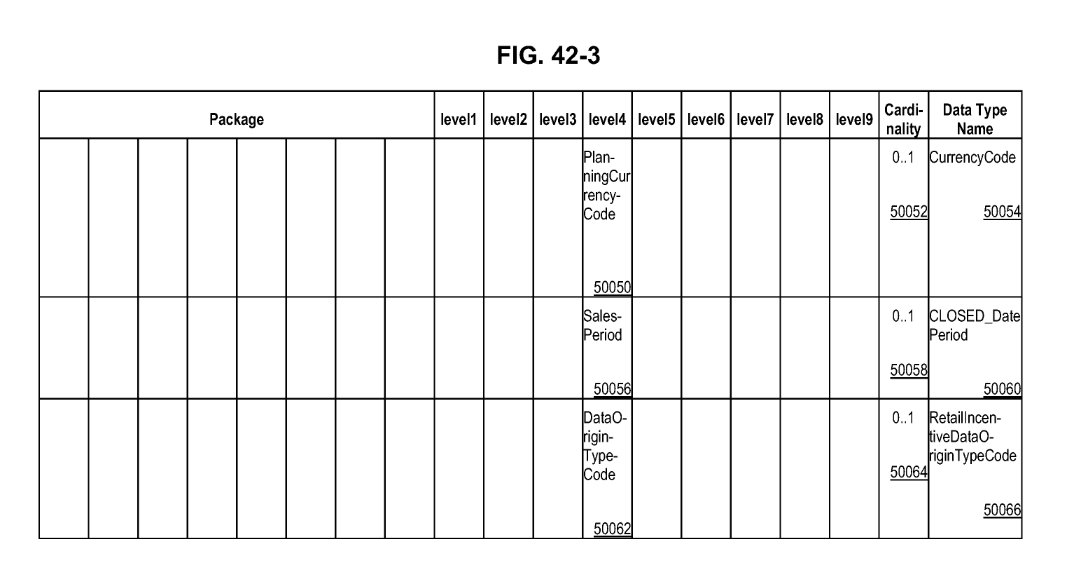

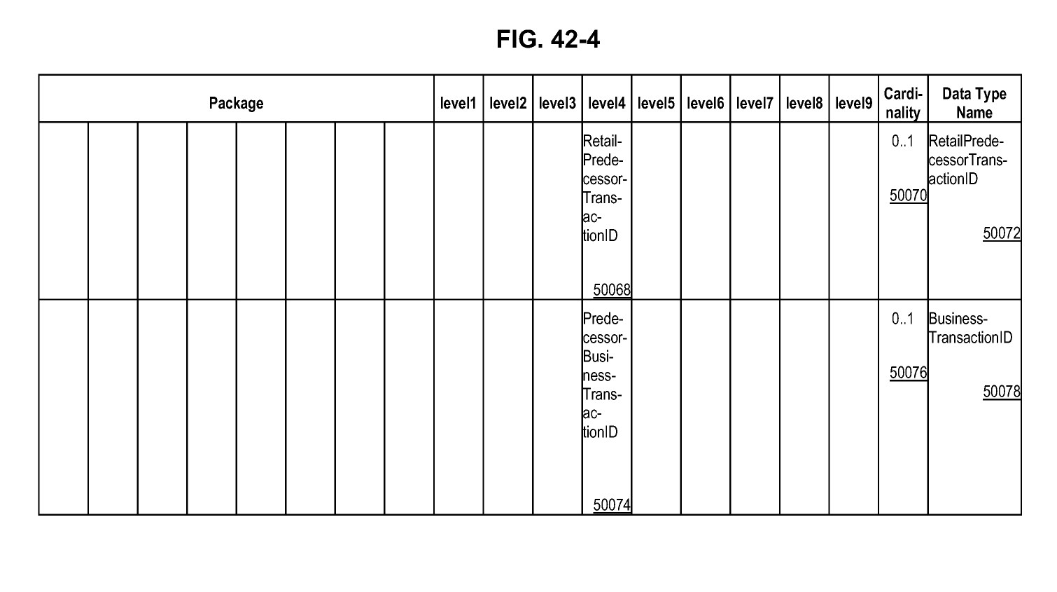

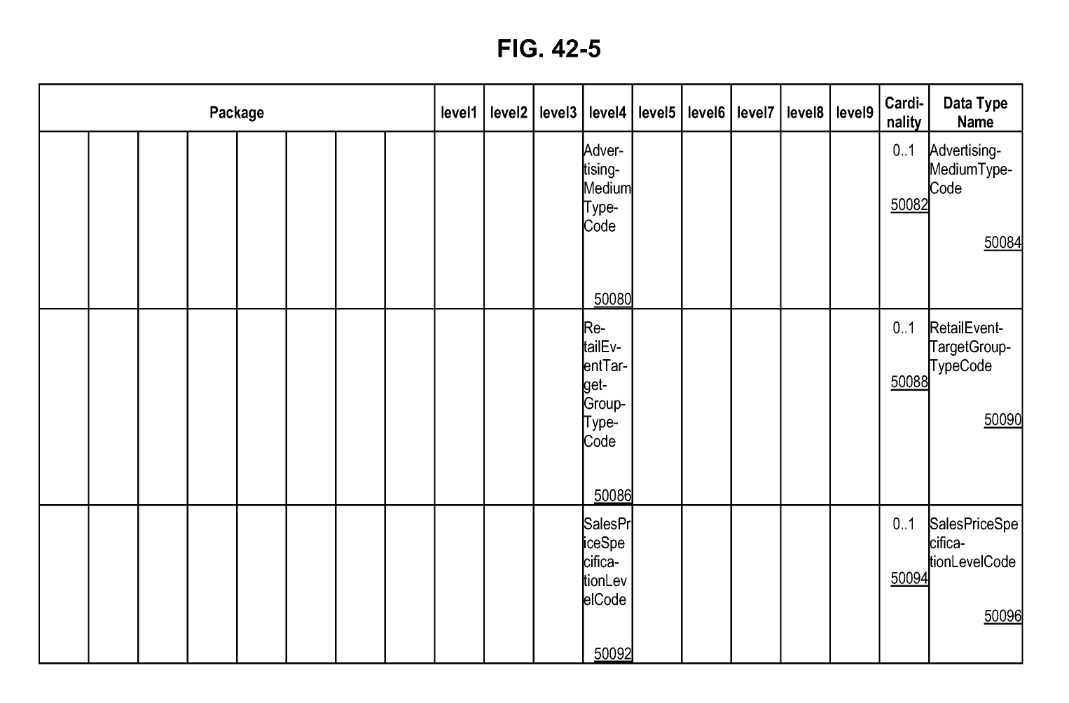

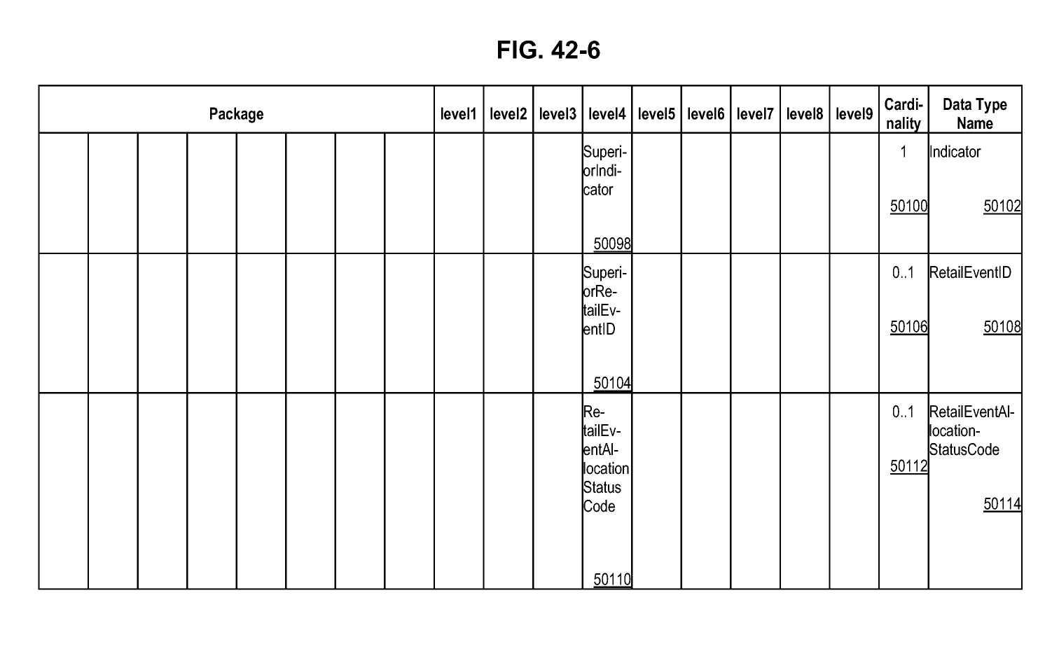

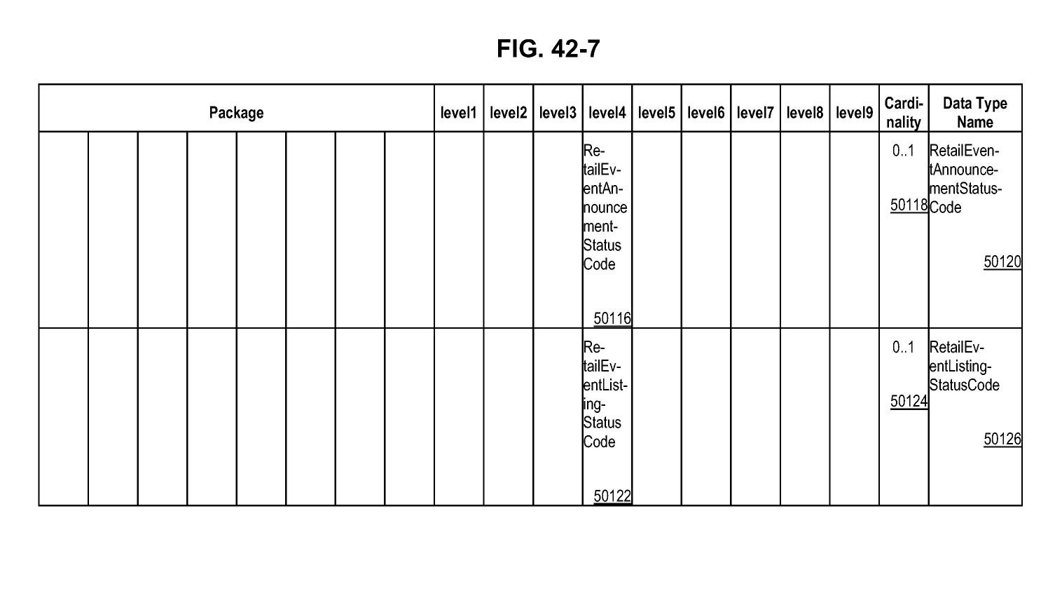

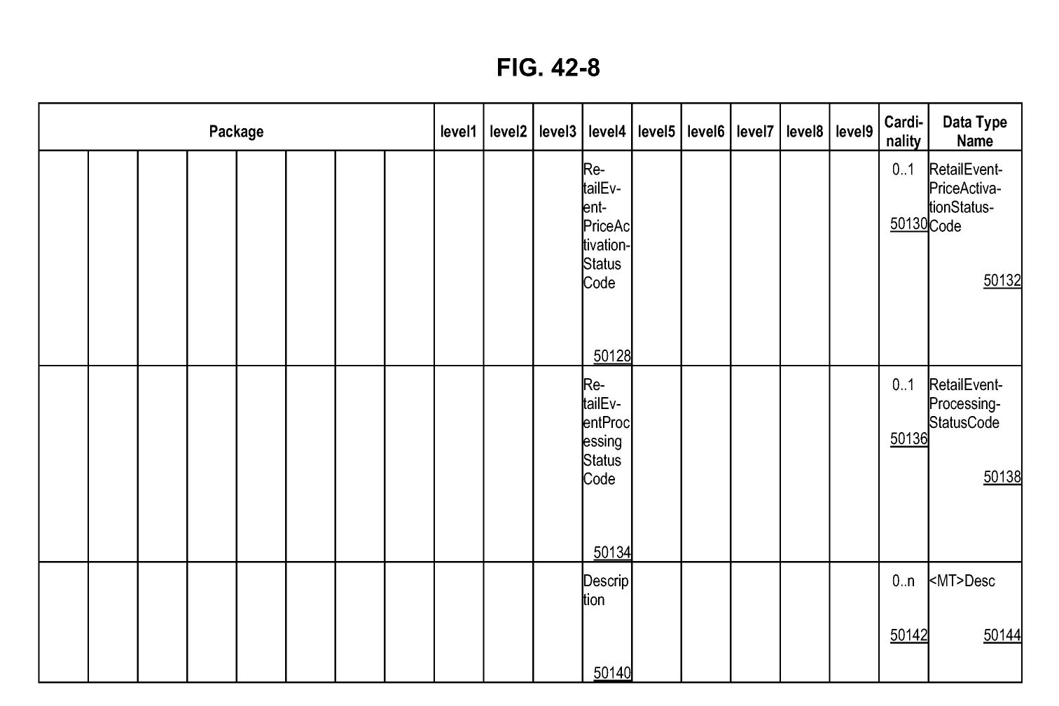

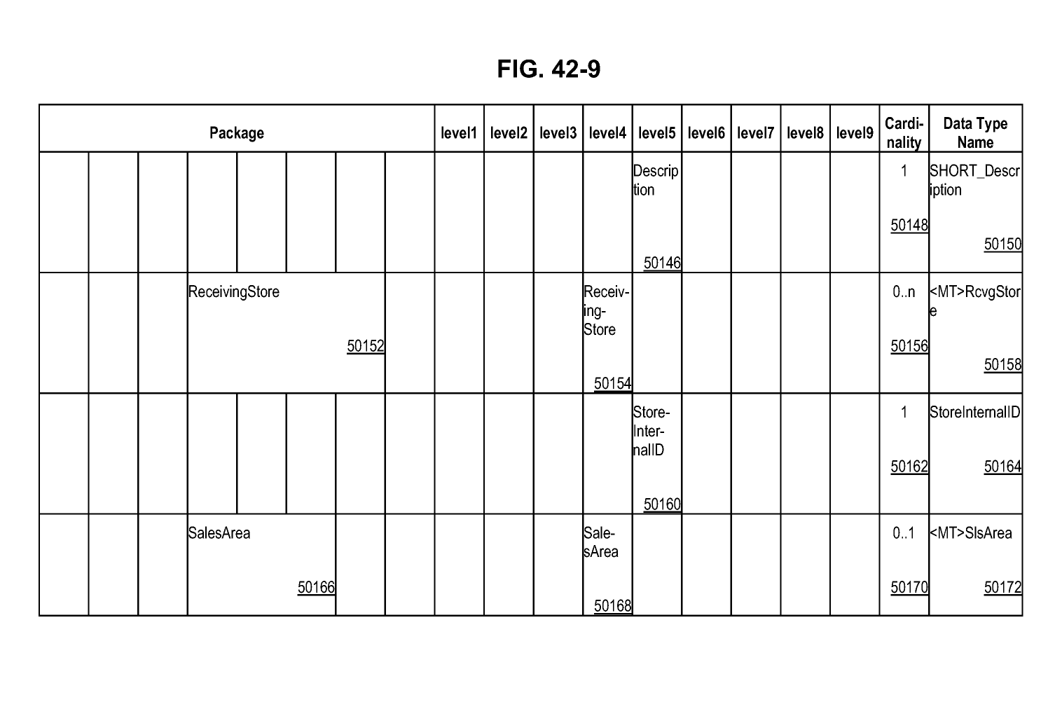

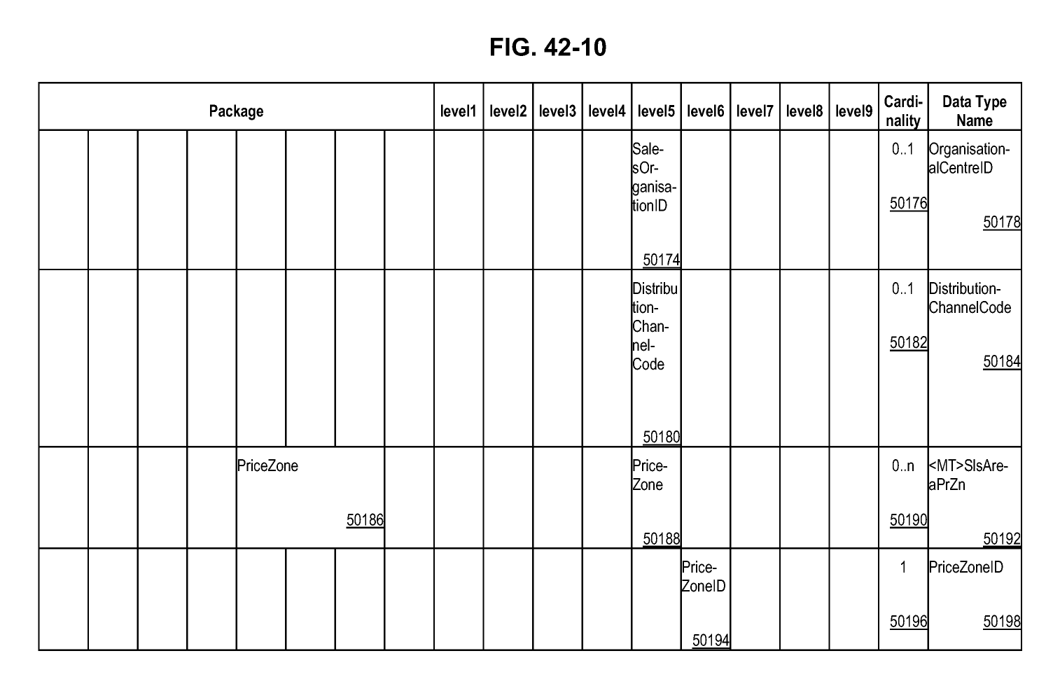

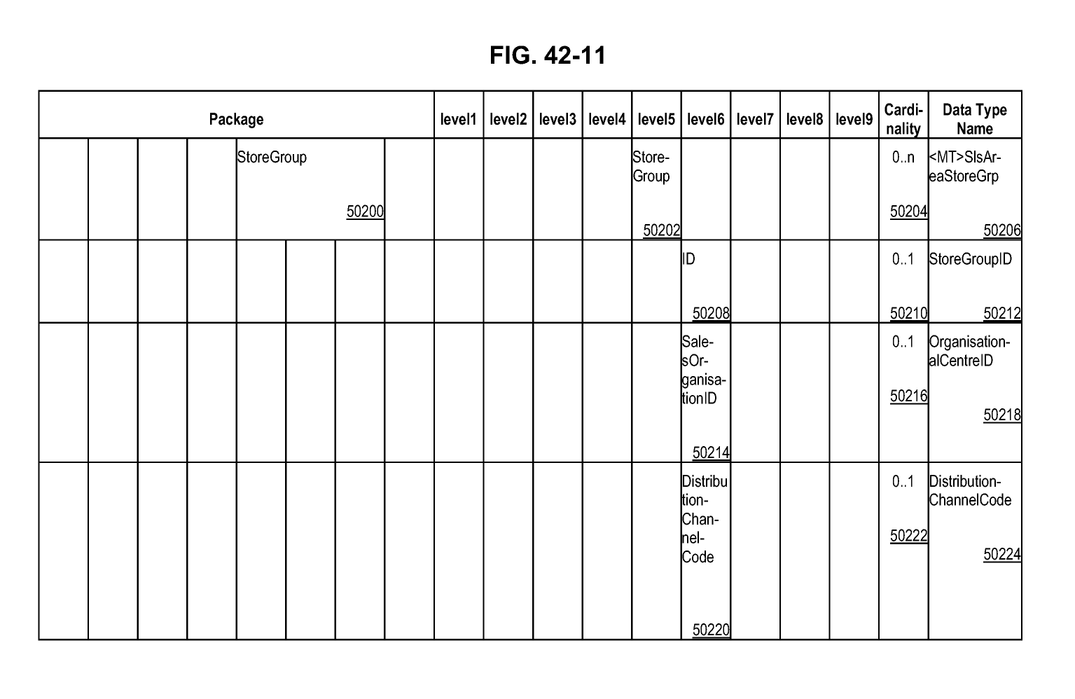

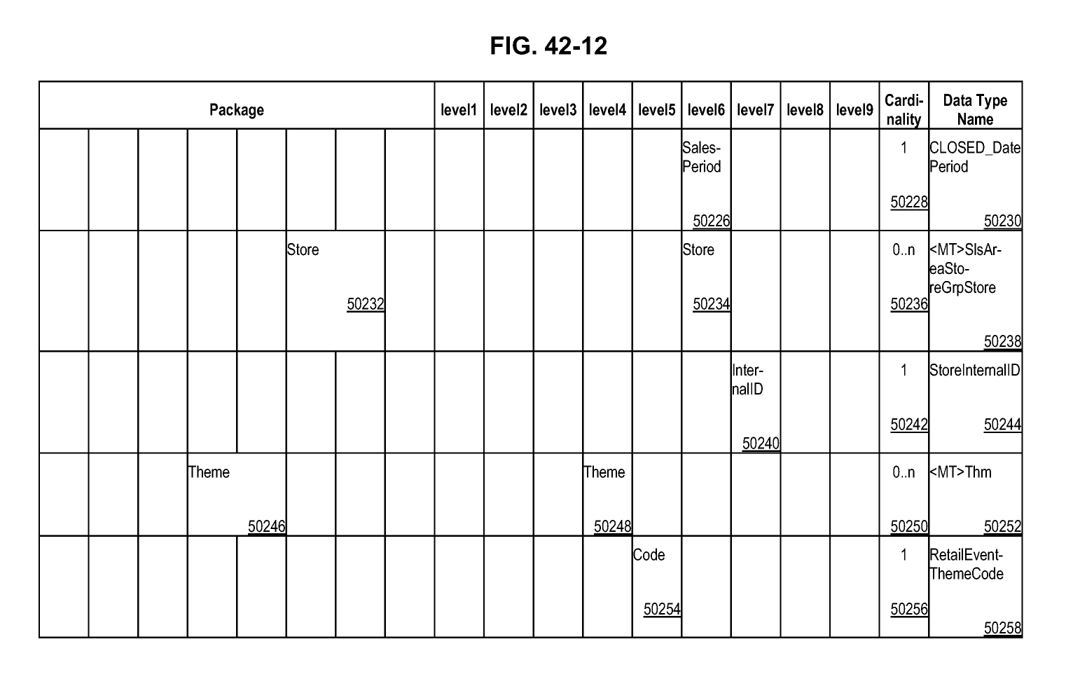

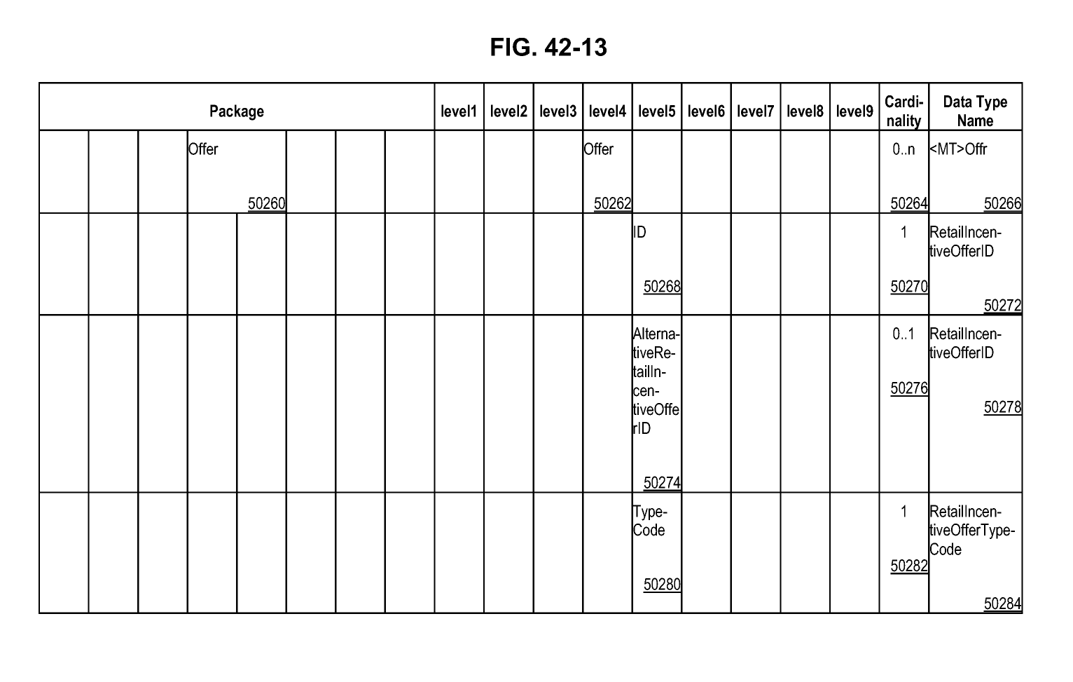

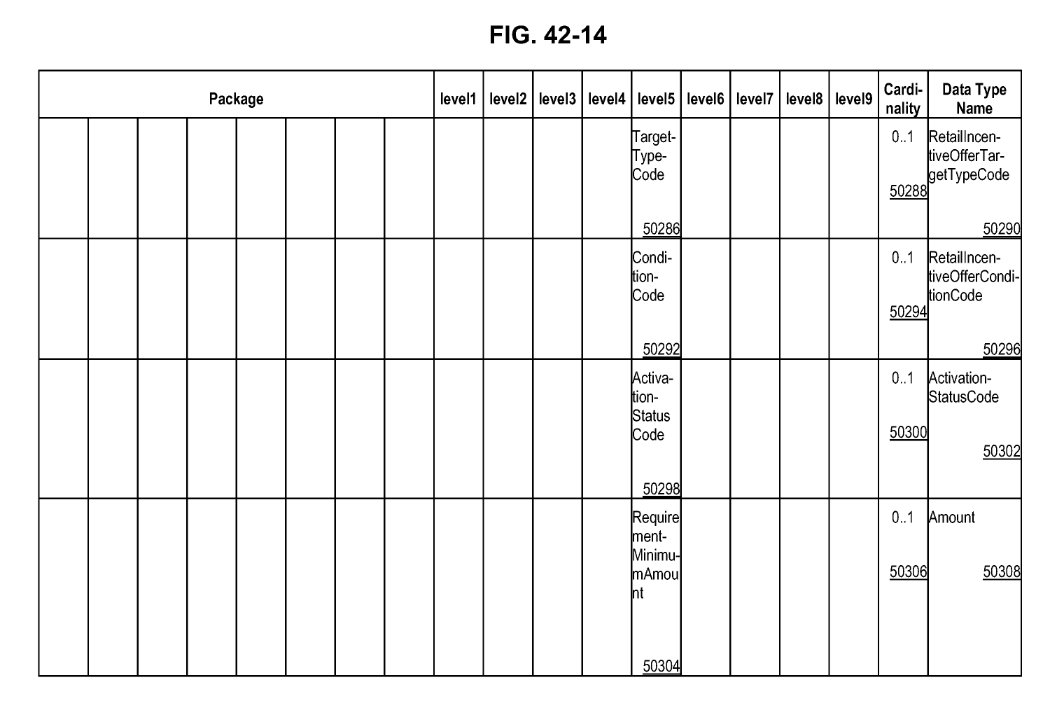

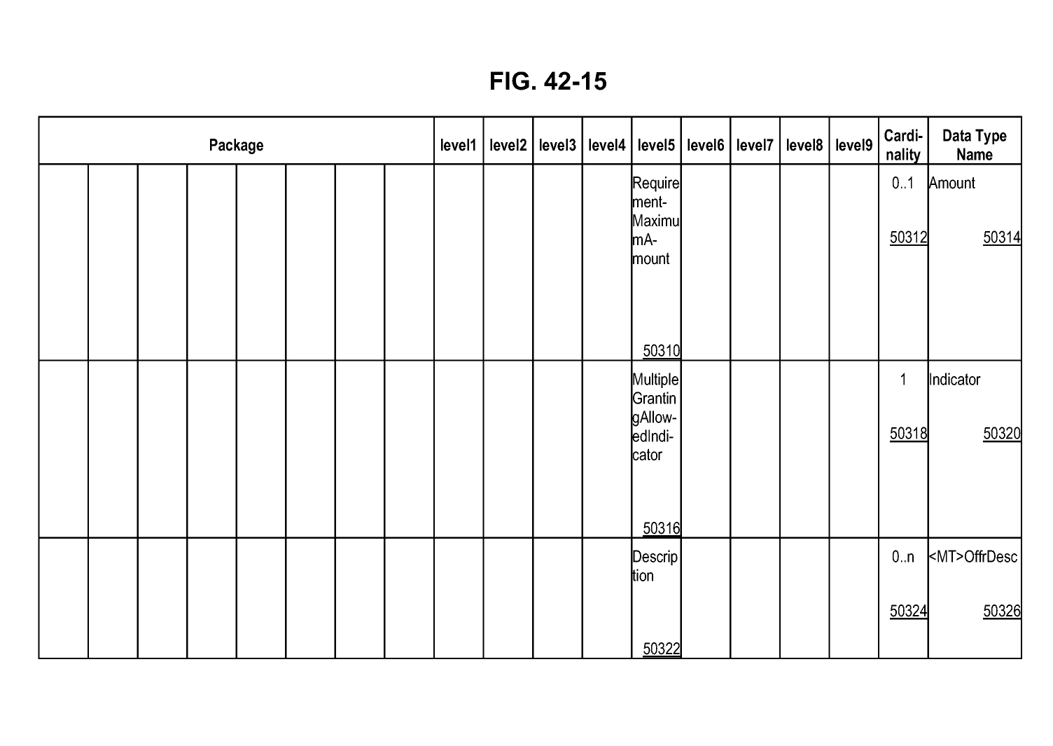

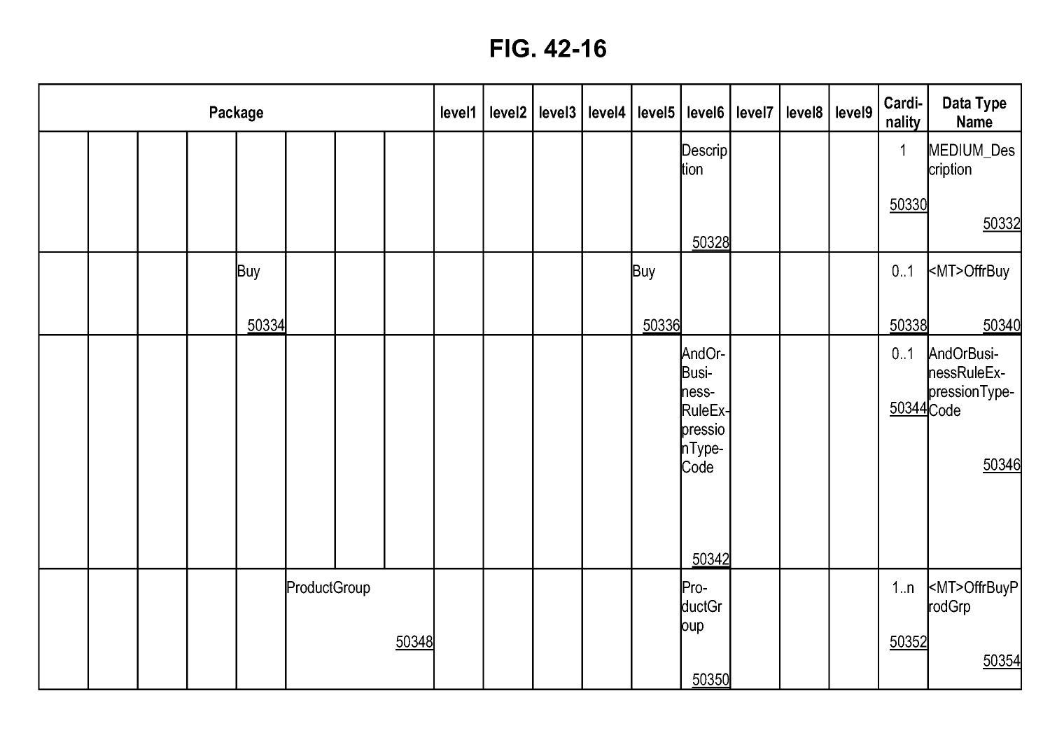

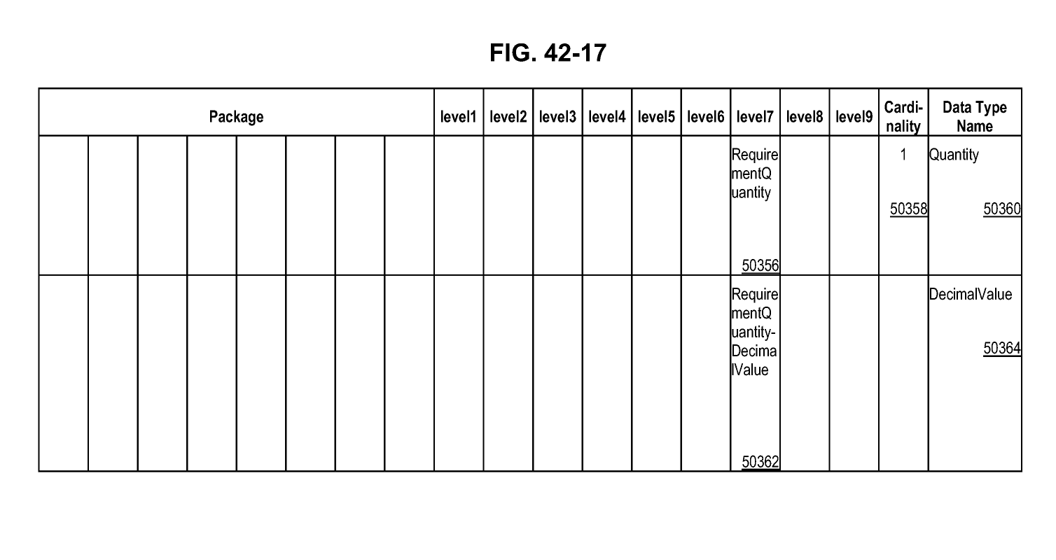

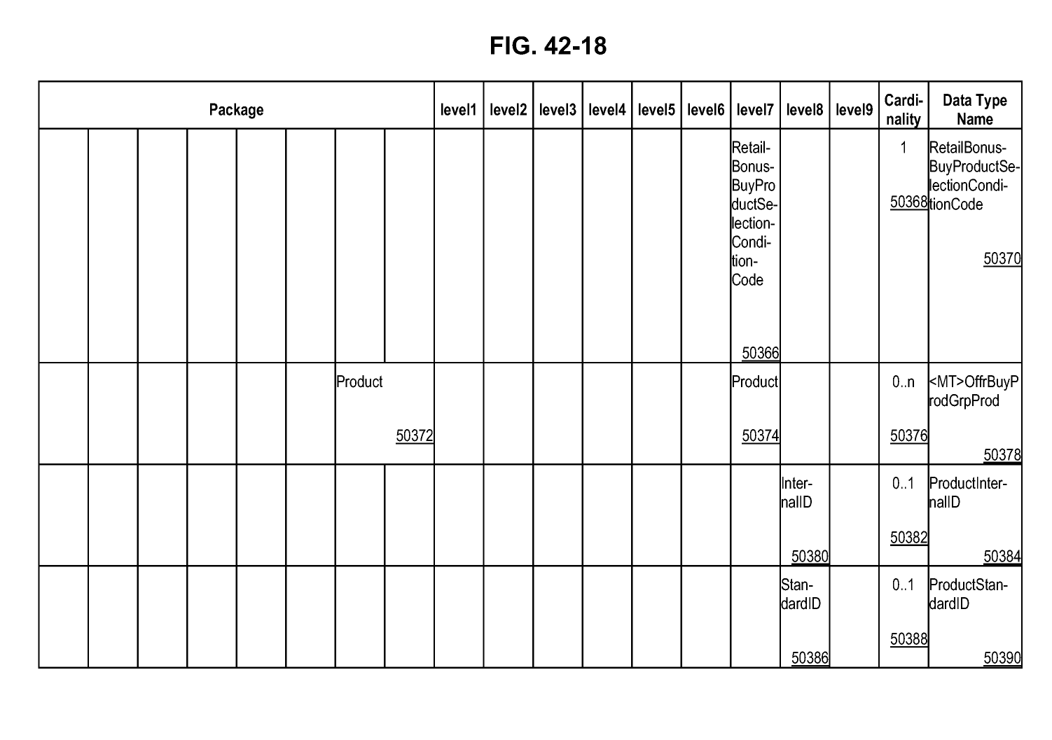

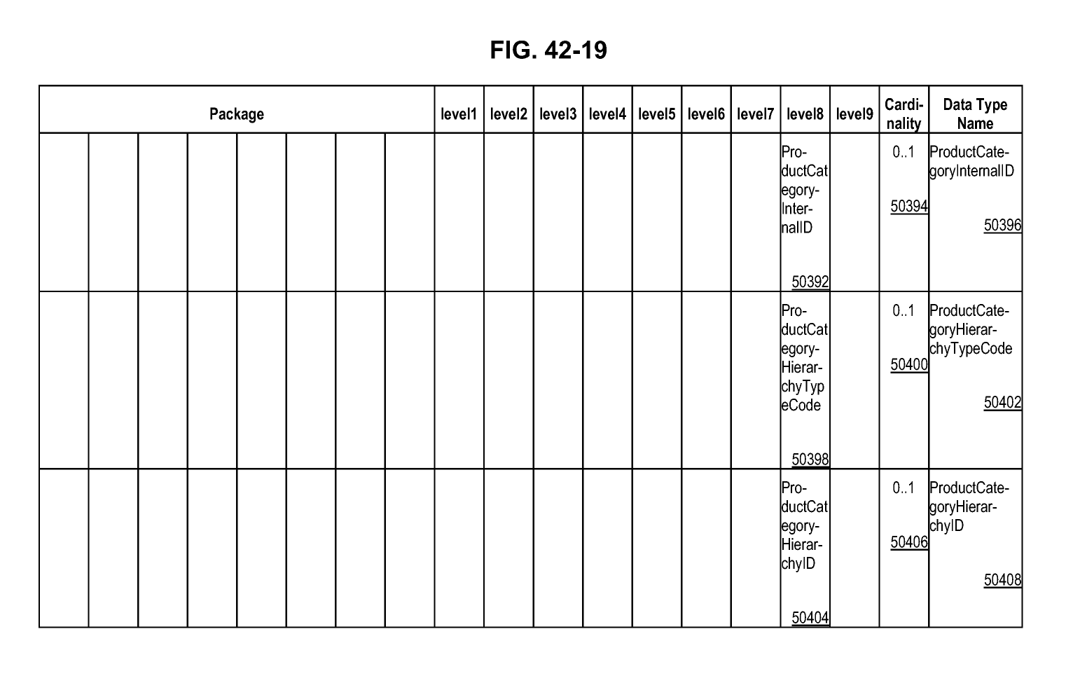

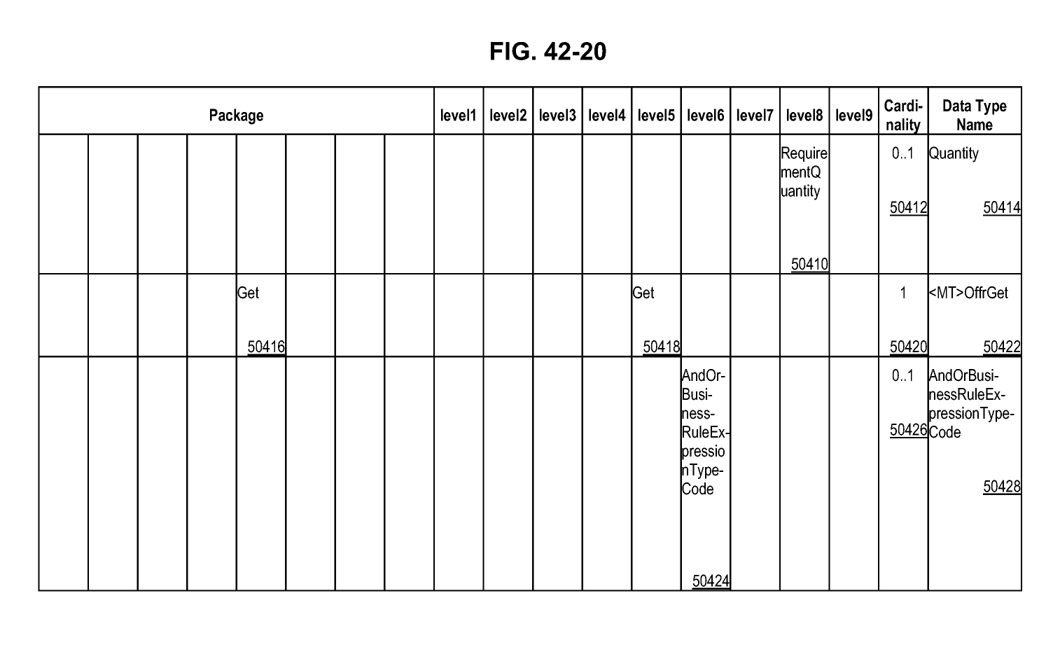

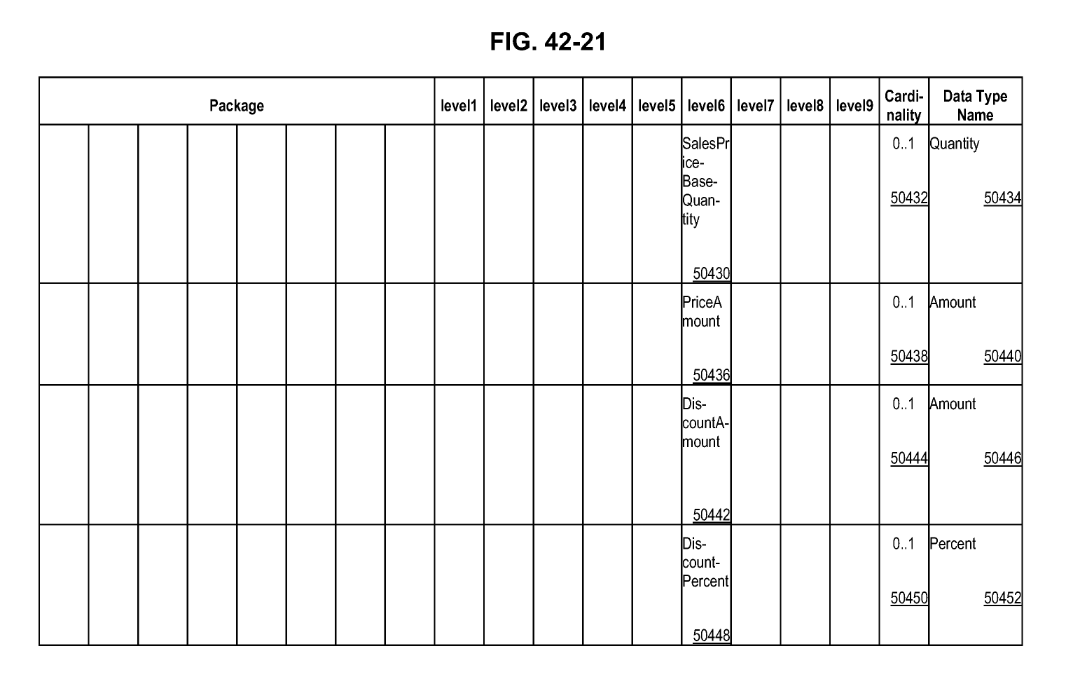

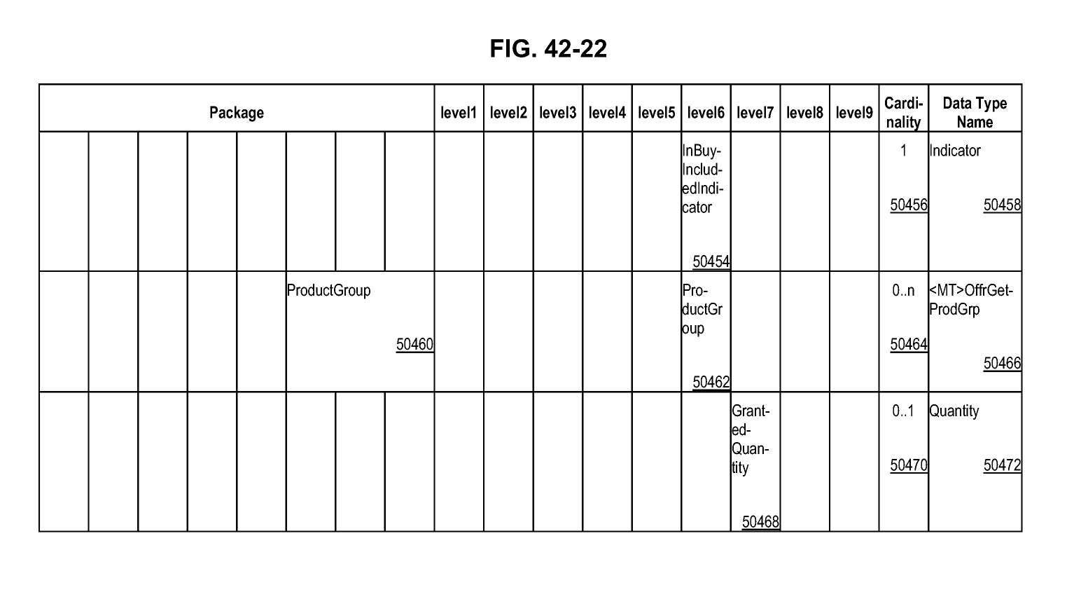

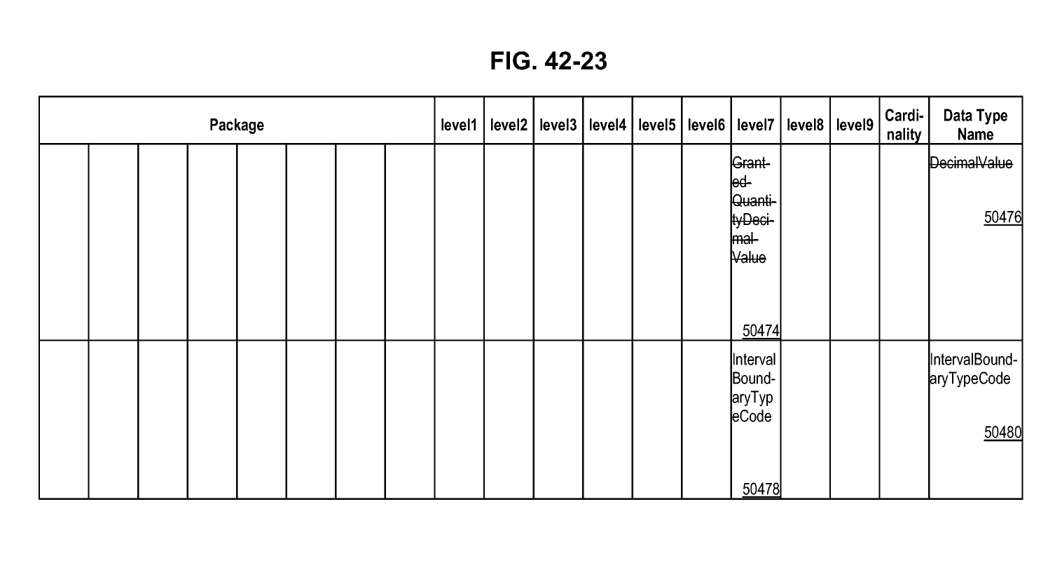

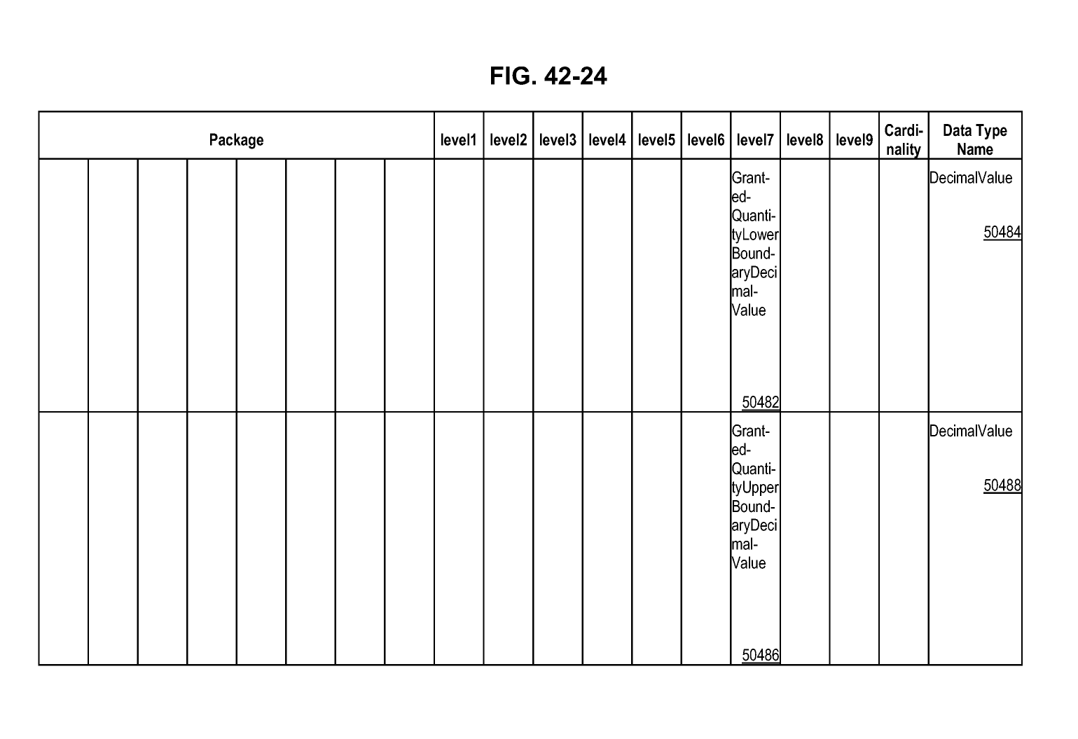

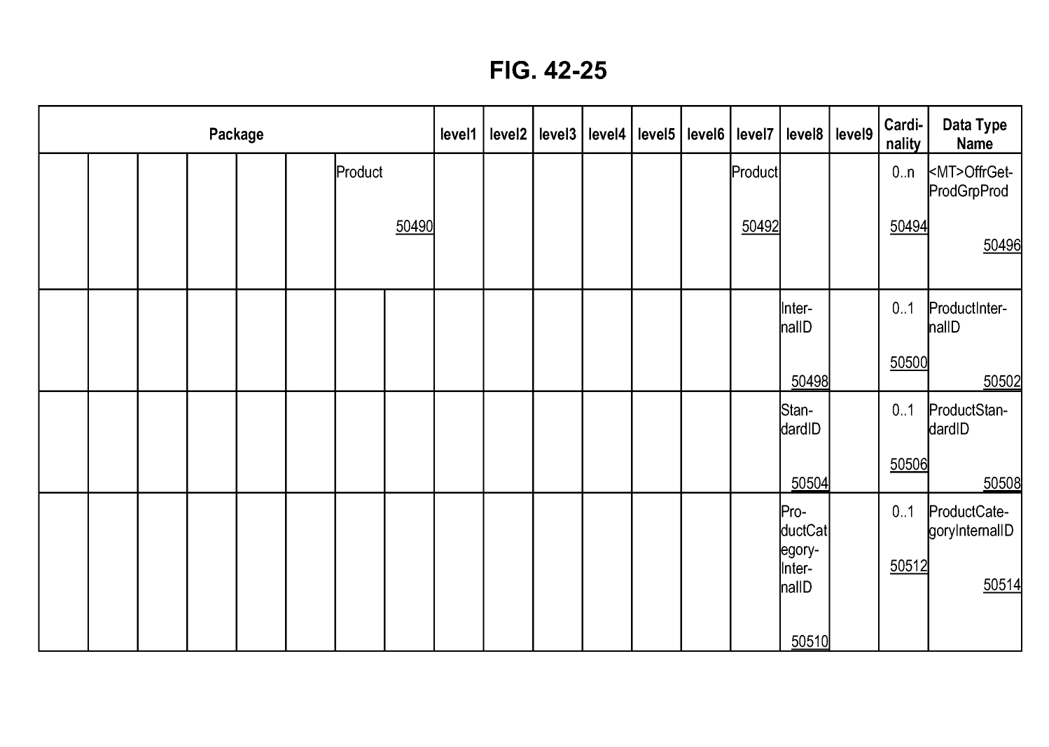

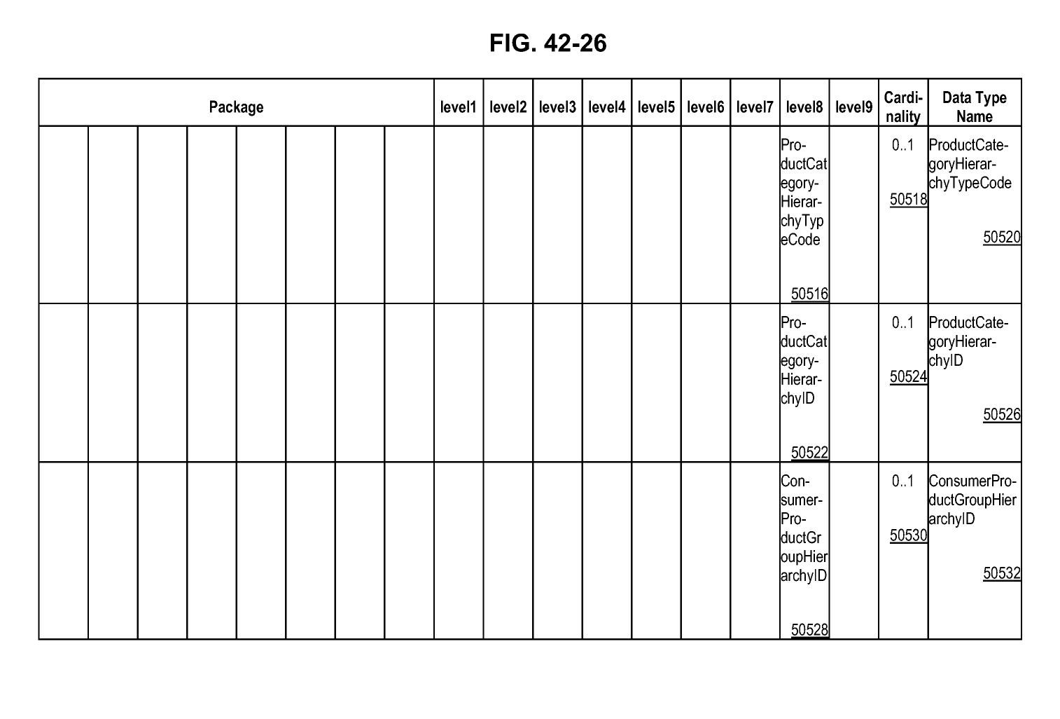

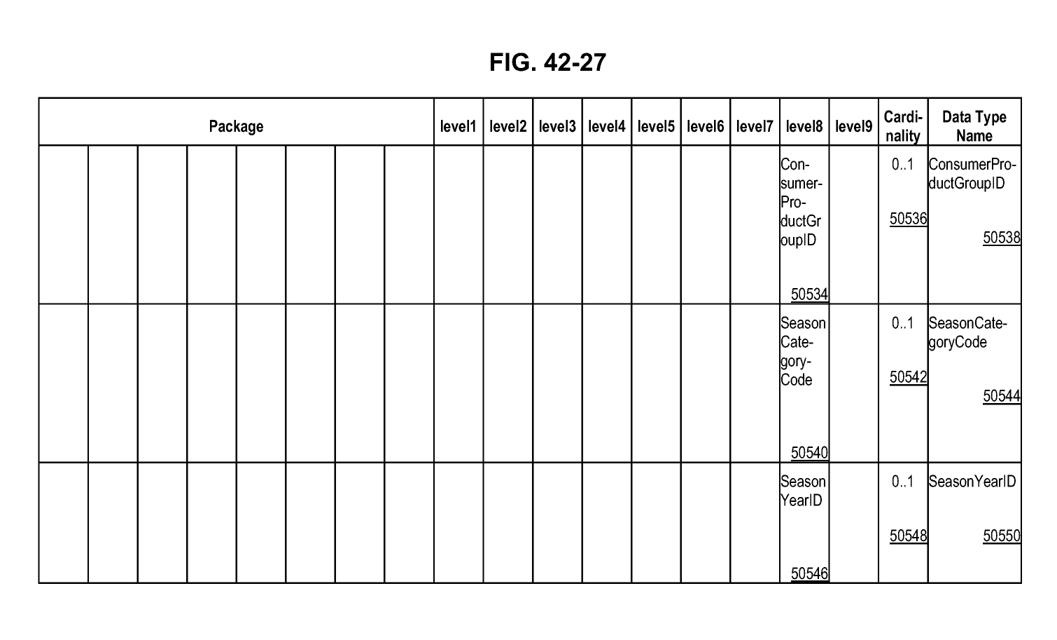

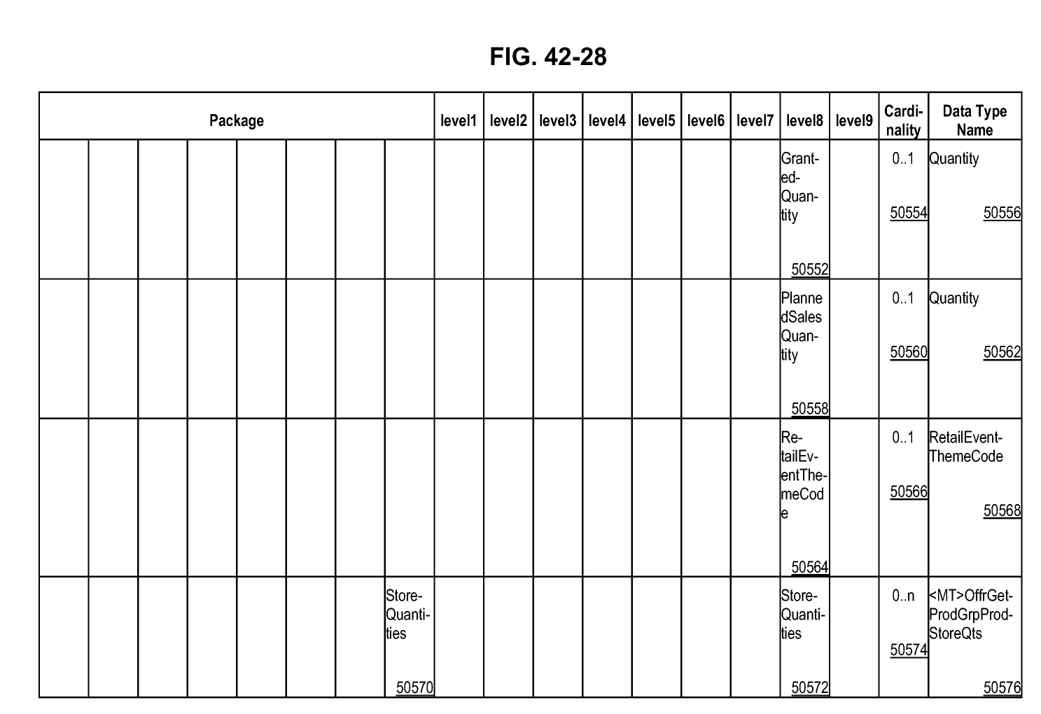

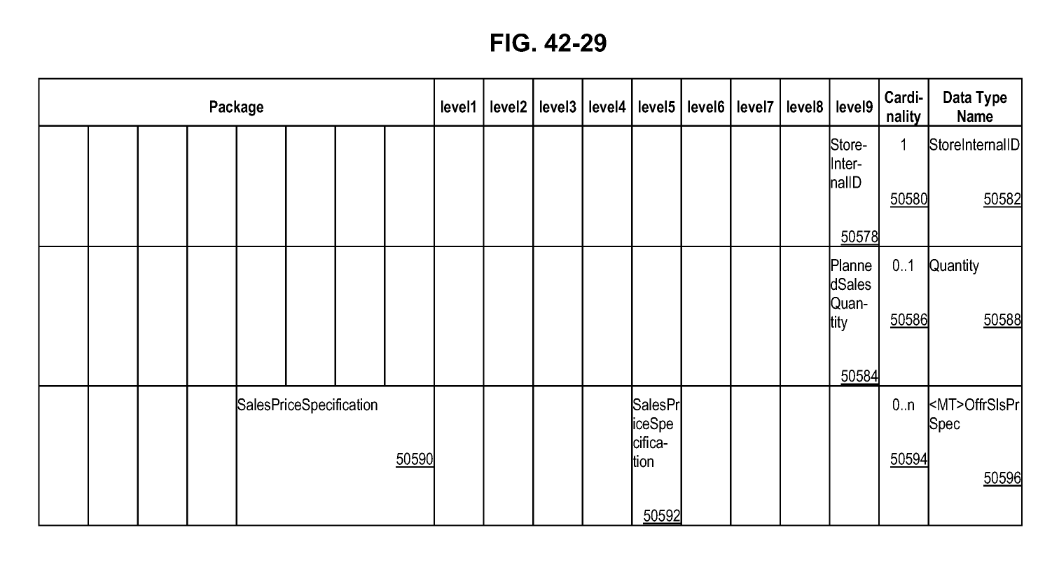

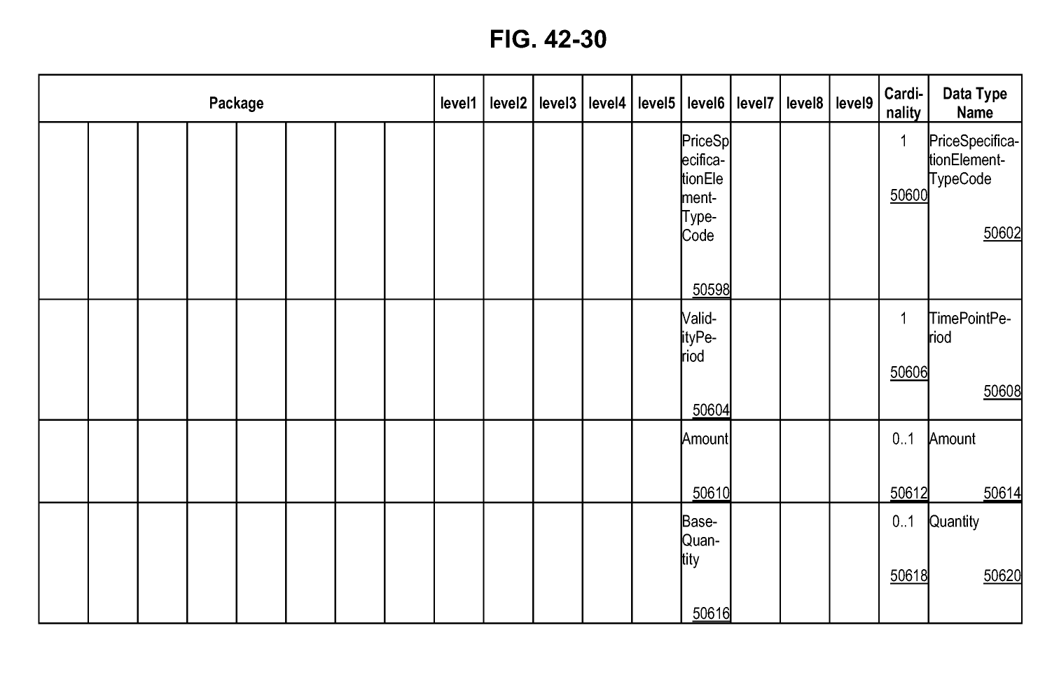

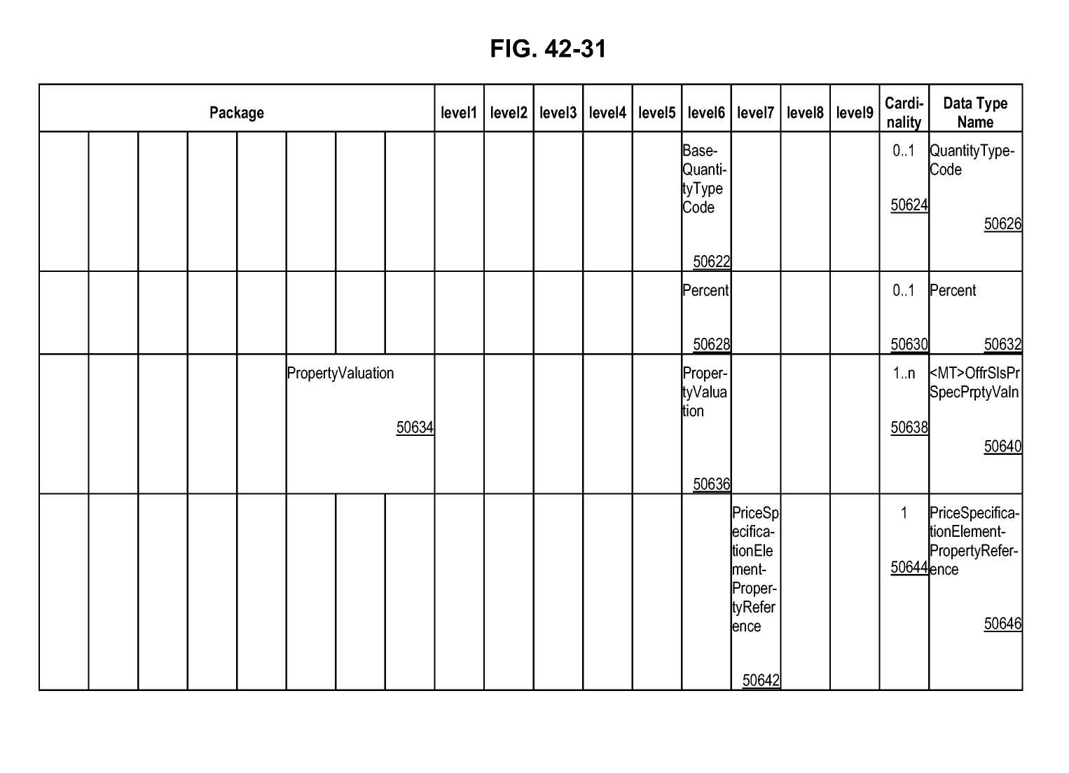

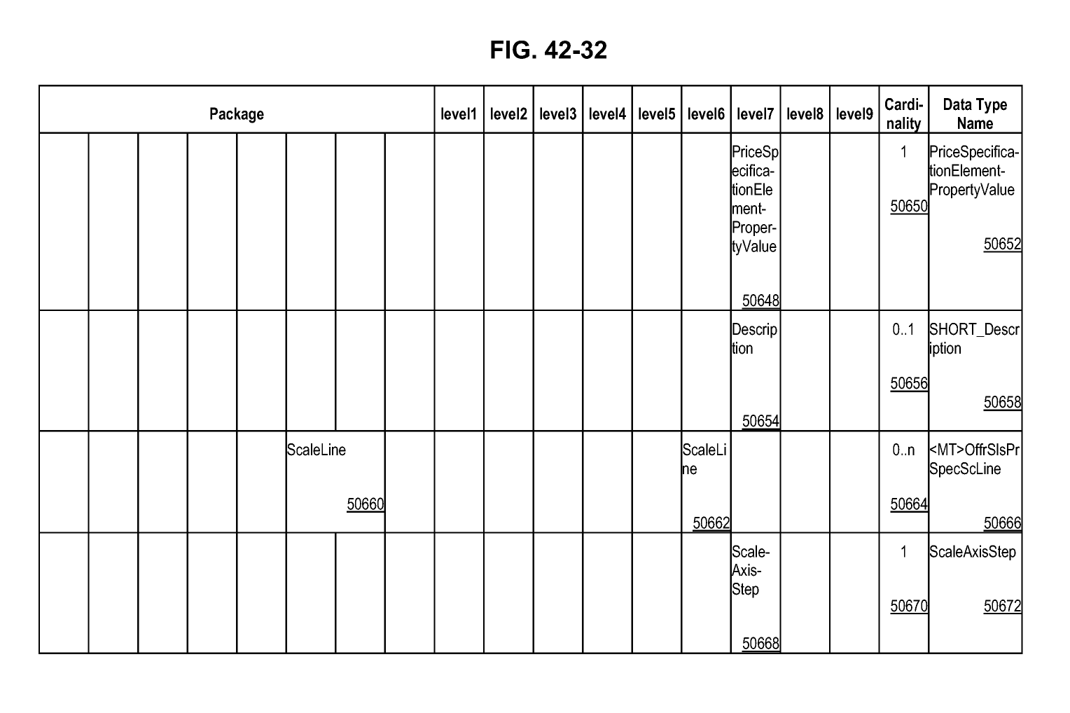

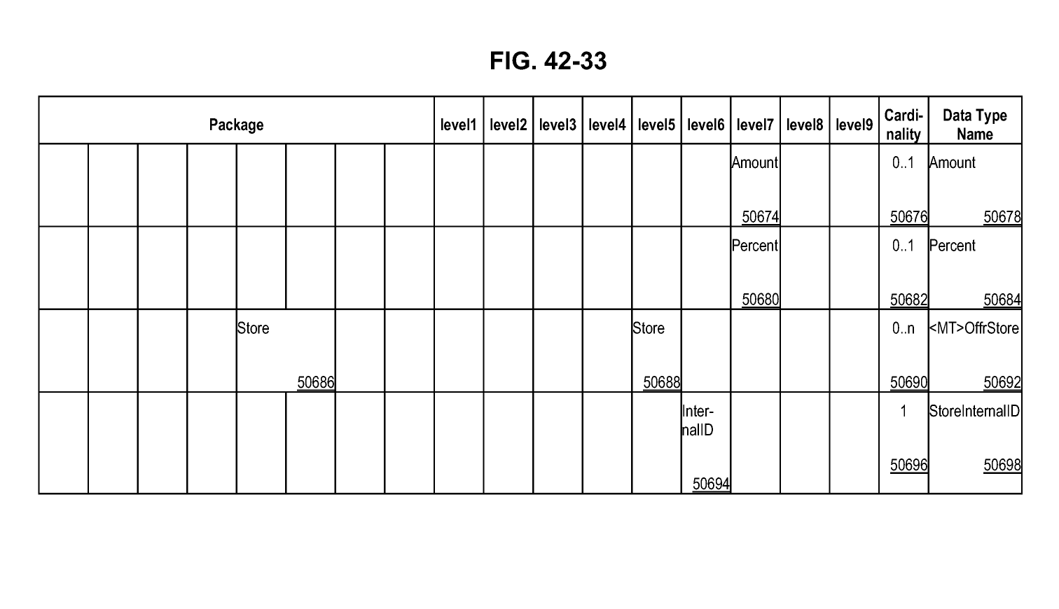

Additionally, FIGS. 42-1 through 42-33 show an example configuration of an Element Structure that includes a RetailEventMessage 50000 package. The RetailEventMessage 50000 package is a RtlEvtMsg 50004 data type. The RetailEventMessage 50000 package includes a RetailEventMessage 50002 entity. The RetailEventMessage 50000 package includes various packages, namely a MessageHeader 50006 and a RetailEvent 50014.

The MessageHeader 50006 package is a BusinessDocumentMessageHeader 50012 data type. The MessageHeader 50006 package includes a MessageHeader 50008 entity.

The MessageHeader 50008 entity has a cardinality of 1 50010 meaning that for each instance of the MessageHeader 50006 package there is one MessageHeader 50008 entity. A MessageHeader includes business information from the perspective of a sender application for identifying processing of a business document (e.g., instance) within a technical message (if applicable, with a reference to a previous instance of business document within a previous technical message), information about the sender, and information about the receiver.

The RetailEvent 50014 package is an <MT>RtlEvtMT=RtlEvt 50020 data type. The RetailEvent 50014 package includes a RetailEvent 50016 entity. The RetailEvent 50014 package includes various packages, namely a ReceivingStore 50152, a SalesArea 50166, a Theme 50246 and an Offer 50260. The RetailEvent 50016 entity has a cardinality of 1 50018 meaning that for each instance of the RetailEvent 50014 package there is one RetailEvent 50016 entity. The RetailEvent 50016 entity includes various attributes, namely an @actionCode 50022, an @completeTransmissionIndicator 50028, an ID 50032, a CompleteTransmissionIndicator 50038, a TypeCode 50044, a PlanningCurrencyCode 50050, a SalesPeriod 50056, a DataOriginTypeCode 50062, a RetailPredecessorTransactionID 50068, a PredecessorBusinessTransactionID 50074, an AdvertisingMediumTypeCode 50080, a RetailEventTargetGroupTypeCode 50086, a SalesPriceSpecificationLevelCode 50092, a SuperiorIndicator 50098, a SuperiorRetailEventID 50104, a RetailEventAllocationStatusCode 50110, a RetailEventAnnouncementStatusCode 50116, a RetailEventListingStatusCode 50122, a RetailEventPriceActivationStatusCode 50128 and a RetailEventProcessingStatusCode 50134. The RetailEvent 50016 entity includes a Description 50140 subordinate entity. The @actionCode 50022 attribute is an ActionCode 50026 data type. The @actionCode 50022 attribute has a cardinality of 0 . . . 1 50024 meaning that for each instance of the RetailEvent 50016 entity there may be one @actionCode 50022 attribute. An @actionCode is a coded representation of an instruction to the recipient of a message describing how to process a transmitted element. The @completeTransmissionIndicator 50028 attribute is an Indicator 50030 data type. An @completeTransmissionIndicator specifies whether an element transferred in a message or a transmitted list of similar elements is transmitted in its entirety. The ID 50032 attribute is a RetailEventID 50036 data type. The ID 50032 attribute has a cardinality of 1 50034 meaning that for each instance of the RetailEvent 50016 entity there is one ID 50032 attribute. An ID is an identifier for a retail event. The CompleteTransmissionIndicator 50038 attribute is an Indicator 50042 data type. The CompleteTransmissionIndicator 50038 attribute has a cardinality of 1 50040 meaning that for each instance of the RetailEvent 50016 entity there is one CompleteTransmissionIndicator 50038 attribute. A CompleteTransmissionIndicator specifies whether an element transferred in a message or a transmitted list of similar elements is transmitted in its entirety. The TypeCode 50044 attribute is a RetailEventTypeCode 50048 data type. The TypeCode 50044 attribute has a cardinality of 0 . . . 1 50046 meaning that for each instance of the RetailEvent 50016 entity there may be one TypeCode 50044 attribute. A TypeCode is a coded representation of the type of a retail event from a business viewpoint. The PlanningCurrencyCode 50050 attribute is a CurrencyCode 50054 data type. The PlanningCurrencyCode 50050 attribute has a cardinality of 0 . . . 1 50052 meaning that for each instance of the RetailEvent 50016 entity there may be one PlanningCurrencyCode 50050 attribute. A PlanningCurrencyCode represents a currency that is used for planning purposes. The SalesPeriod 50056 attribute is a CLOSED_DatePeriod 50060 data type. The SalesPeriod 50056 attribute has a cardinality of 0 . . . 1 50058 meaning that for each instance of the RetailEvent 50016 entity there may be one SalesPeriod 50056 attribute. A SalesPeriod is a period during which something is sold. The DataOriginTypeCode 50062 attribute is a RetailIncentiveDataOriginTypeCode 50066 data type. The DataOriginTypeCode 50062 attribute has a cardinality of 0 . . . 1 50064 meaning that for each instance of the RetailEvent 50016 entity there may be one DataOriginTypeCode 50062 attribute. A DataOriginTypeCode is a coded representation of the type of location a retail incentive data originates. The RetailPredecessorTransactionID 50068 attribute is a RetailPredecessorTransactionID 50072 data type. The RetailPredecessorTransactionID 50068 attribute has a cardinality of 0 . . . 1 50070 meaning that for each instance of the RetailEvent 50016 entity there may be one RetailPredecessorTransactionID 50068 attribute. A RetailPredecessorTransactionID is an identifier of a preceding transaction which leads to the creation of a specific retail business process. The PredecessorBusinessTransactionID 50074 attribute is a BusinessTransactionID 50078 data type. The PredecessorBusinessTransactionID 50074 attribute has a cardinality of 0 . . . 1 50076 meaning that for each instance of the RetailEvent 50016 entity there may be one PredecessorBusinessTransactionID 50074 attribute. A PredecessorBusinessTransactionID is an identifier for a preceeding business transaction. The AdvertisingMediumTypeCode 50080 attribute is an AdvertisingMediumTypeCode 50084 data type. The AdvertisingMediumTypeCode 50080 attribute has a cardinality of 0 . . . 1 50082 meaning that for each instance of the RetailEvent 50016 entity there may be one AdvertisingMediumTypeCode 50080 attribute. An AdvertisingMediumTypeCode is a coded representation of a type of medium that is used for advertising. The RetailEventTargetGroupTypeCode 50086 attribute is a RetailEventTargetGroupTypeCode 50090 data type. The RetailEventTargetGroupTypeCode 50086 attribute has a cardinality of 0 . . . 1 50088 meaning that for each instance of the RetailEvent 50016 entity there may be one RetailEventTargetGroupTypeCode 50086 attribute. A RetailEventTargetGroupTypeCode is a coded representation of the type of a target group for whom a retail event is intended for. The SalesPriceSpecificationLevelCode 50092 attribute is a SalesPriceSpecificationLevelCode 50096 data type. The SalesPriceSpecificationLevelCode 50092 attribute has a cardinality of 0 . . . 1 50094 meaning that for each instance of the RetailEvent 50016 entity there may be one SalesPriceSpecificationLevelCode 50092 attribute. A SalesPriceSpecificationLevelCode is a coded representation of a specification level of a sales price. The SuperiorIndicator 50098 attribute is an Indicator 50102 data type. The SuperiorIndicator 50098 attribute has a cardinality of 1 50100 meaning that for each instance of the RetailEvent 50016 entity there is one SuperiorIndicator 50098 attribute. A SuperiorIndicator indicates that a Retail Event is a superior Retail Event that can be assigned to other Retail Events as a superior Retail Event. The SuperiorRetailEventID 50104 attribute is a RetailEventID 50108 data type. The SuperiorRetailEventID 50104 attribute has a cardinality of 0 . . . 1 50106 meaning that for each instance of the RetailEvent 50016 entity there may be one SuperiorRetailEventID 50104 attribute. A SuperiorRetailEventID specifies an assigned superior retail event and may only be available if the SuperIndicator is equal to false. The RetailEventAllocationStatusCode 50110 attribute is a RetailEventAllocationStatusCode 50114 data type. The RetailEventAllocationStatusCode 50110 attribute has a cardinality of 0 . . . 1 50112 meaning that for each instance of the RetailEvent 50016 entity there may be one RetailEventAllocationStatusCode 50110 attribute. The RetailEventAnnouncementStatusCode 50116 attribute is a RetailEventAnnouncementStatusCode 50120 data type. The RetailEventAnnouncementStatusCode 50116 attribute has a cardinality of 0 . . . 1 50118 meaning that for each instance of the RetailEvent 50016 entity there may be one RetailEventAnnouncementStatusCode 50116 attribute. The RetailEventListingStatusCode 50122 attribute is a RetailEventListingStatusCode 50126 data type. The RetailEventListingStatusCode 50122 attribute has a cardinality of 0 . . . 1 50124 meaning that for each instance of the RetailEvent 50016 entity there may be one RetailEventListingStatusCode 50122 attribute. The RetailEventPriceActivationStatusCode 50128 attribute is a RetailEventPriceActivationStatusCode 50132 data type. The RetailEventPriceActivationStatusCode 50128 attribute has a cardinality of 0 . . . 1 50130 meaning that for each instance of the RetailEvent 50016 entity there may be one RetailEventPriceActivationStatusCode 50128 attribute. The RetailEventProcessingStatusCode 50134 attribute is a RetailEventProcessingStatusCode 50138 data type. The RetailEventProcessingStatusCode 50134 attribute has a cardinality of 0 . . . 1 50136 meaning that for each instance of the RetailEvent 50016 entity there may be one RetailEventProcessingStatusCode 50134 attribute. The Description 50140 entity has a cardinality of 0 . . . n 50142 meaning that for each instance of the RetailEvent 50016 entity there may be one or more Description 50140 entities. The Description 50140 entity includes a Description 50146 attribute. The Description 50146 attribute is a SHORT_Description 50150 data type. The Description 50146 attribute has a cardinality of 1 50148 meaning that for each instance of the Description 50140 entity there is one Description 50146 attribute. A Description represents a description of a Retail Event.

The ReceivingStore 50152 package is an <MT>RcvgStore 50158 data type. The ReceivingStore 50152 package includes a ReceivingStore 50154 entity. The ReceivingStore 50154 entity has a cardinality of 0 . . . n 50156 meaning that for each instance of the ReceivingStore 50152 package there may be one or more ReceivingStore 50154 entities. The ReceivingStore 50154 entity includes a StoreInternalID 50160 attribute. The StoreInternalID 50160 attribute is a StoreInternalID 50164 data type. The StoreInternalID 50160 attribute has a cardinality of 1 50162 meaning that for each instance of the ReceivingStore 50154 entity there is one StoreInternalID 50160 attribute. A StoreInternalID is a proprietary identifier for a store.

The SalesArea 50166 package is an <MT>SlsArea 50172 data type. The SalesArea 50166 package includes a SalesArea 50168 entity. The SalesArea 50166 package includes various packages, namely a PriceZone 50186 and a StoreGroup 50200. The SalesArea 50168 entity has a cardinality of 0 . . . 1 50170 meaning that for each instance of the SalesArea 50166 package there may be one SalesArea 50168 entity. The SalesArea 50168 entity may represent, for example, a distribution chain (e.g., SalesOrganisationID and DistributionChannelCode), or a distribution chain and price zone, or a store group (together w/distribution chain). The SalesArea 50168 entity includes various attributes, namely a SalesOrganisationID 50174 and a DistributionChannelCode 50180. The SalesOrganisationID 50174 attribute is an OrganisationalCentreID 50178 data type. The SalesOrganisationID 50174 attribute has a cardinality of 0 . . . 1 50176 meaning that for each instance of the SalesArea 50168 entity there may be one SalesOrganisationID 50174 attribute. A SalesOrganisationID is a unique identifier of an organizational unit. The DistributionChannelCode 50180 attribute is a DistributionChannelCode 50184 data type. The DistributionChannelCode 50180 attribute has a cardinality of 0 . . . 1 50182 meaning that for each instance of the SalesArea 50168 entity there may be one DistributionChannelCode 50180 attribute. A DistributionChannelCode is a coded representation of a distribution channel.

The PriceZone 50186 package is an <MT>SlsAreaPrZn 50192 data type. The PriceZone 50186 package includes a PriceZone 50188 entity. The PriceZone 50188 entity has a cardinality of 0 . . . n 50190 meaning that for each instance of the PriceZone 50186 package there may be one or more PriceZone 50188 entities. The PriceZone 50188 entity includes a PriceZoneID 50194 attribute. The PriceZoneID 50194 attribute is a PriceZoneID 50198 data type. The PriceZoneID 50194 attribute has a cardinality of 1 50196 meaning that for each instance of the PriceZone 50188 entity there is one PriceZoneID 50194 attribute. A PriceZoneID is a unique identifier for a price zone.

The StoreGroup 50200 package is an <MT>SlsAreaStoreGrp 50206 data type. The StoreGroup 50200 package includes a StoreGroup 50202 entity. The StoreGroup 50200 package includes a Store 50232 package. The StoreGroup 50202 entity has a cardinality of 0 . . . n 50204 meaning that for each instance of the StoreGroup 50200 package there may be one or more StoreGroup 50202 entities. The StoreGroup 50202 entity includes various attributes, namely an ID 50208, a SalesOrganisationID 50214, a DistributionChannelCode 50220 and a SalesPeriod 50226. The ID 50208 attribute is a StoreGroupID 50212 data type. The ID 50208 attribute has a cardinality of 0 . . . 1 50210 meaning that for each instance of the StoreGroup 50202 entity there may be one ID 50208 attribute. An ID is an identifier for a store group. The SalesOrganisationID 50214 attribute is an OrganisationalCentreID 50218 data type. The SalesOrganisationID 50214 attribute has a cardinality of 0 . . . 1 50216 meaning that for each instance of the StoreGroup 50202 entity there may be one SalesOrganisationID 50214 attribute. A SalesOrganisationID is a unique identifier of an organizational unit. The DistributionChannelCode 50220 attribute is a DistributionChannelCode 50224 data type. The DistributionChannelCode 50220 attribute has a cardinality of 0 . . . 1 50222 meaning that for each instance of the StoreGroup 50202 entity there may be one DistributionChannelCode 50220 attribute. A DistributionChannelCode is a coded representation of a distribution channel. The SalesPeriod 50226 attribute is a CLOSED_DatePeriod 50230 data type. The SalesPeriod 50226 attribute has a cardinality of 1 50228 meaning that for each instance of the StoreGroup 50202 entity there is one SalesPeriod 50226 attribute. A SalesPeriod is a period during something is sold.

The Store 50232 package is an <MT>SlsAreaStoreGrpStore 50238 data type. The Store 50232 package includes a Store 50234 entity. The Store 50234 entity has a cardinality of 0 . . . n 50236 meaning that for each instance of the Store 50232 package there may be one or more Store 50234 entities. The Store 50234 entity includes an InternalID 50240 attribute. The InternalID 50240 attribute is a StoreInternalID 50244 data type. The InternalID 50240 attribute has a cardinality of 1 50242 meaning that for each instance of the Store 50234 entity there is one InternalID 50240 attribute. An InternalID is a proprietary identifier for a store.

The Theme 50246 package is an <MT>Thm 50252 data type. The Theme 50246 package includes a Theme 50248 entity. The Theme 50248 entity has a cardinality of 0 . . . n 50250 meaning that for each instance of the Theme 50246 package there may be one or more Theme 50248 entities. The Theme 50248 entity includes a Code 50254 attribute. The Code 50254 attribute is a RetailEventThemeCode 50258 data type. The Code 50254 attribute has a cardinality of 1 50256 meaning that for each instance of the Theme 50248 entity there is one Code 50254 attribute. A Code is a coded representation of a retail event theme.

The Offer 50260 package is an <MT>Offr 50266 data type. The Offer 50260 package includes an Offer 50262 entity. The Offer 50260 package includes various packages, namely a Buy 50334, a Get 50416, a SalesPriceSpecification 50590 and a Store 50686. The Offer 50262 entity has a cardinality of 0 . . . n 50264 meaning that for each instance of the Offer 50260 package there may be one or more Offer 50262 entities. The Offer 50262 entity includes various attributes, namely an ID 50268, an AlternativeRetailIncentiveOfferID 50274, a TypeCode 50280, a TargetTypeCode 50286, a ConditionCode 50292, an ActivationStatusCode 50298, a RequirementMinimumAmount 50304, a RequirementMaximumAmount 50310 and a MultipleGrantingAllowedIndicator 50316. The Offer 50262 entity includes a Description 50322 subordinate entity. The ID 50268 attribute is a RetailIncentiveOfferID 50272 data type. The ID 50268 attribute has a cardinality of 1 50270 meaning that for each instance of the Offer 50262 entity there is one ID 50268 attribute. An ID is an identifier for an offer within a retail incentive. The AlternativeRetailIncentiveOfferID 50274 attribute is a RetailIncentiveOfferID 50278 data type. The AlternativeRetailIncentiveOfferID 50274 attribute has a cardinality of 0 . . . 1 50276 meaning that for each instance of the Offer 50262 entity there may be one AlternativeRetailIncentiveOfferID 50274 attribute. An AlternativeRetailIncentiveOfferID is an alternative RetailIncentiveOfferID. The TypeCode 50280 attribute is a RetailIncentiveOfferTypeCode 50284 data type. The TypeCode 50280 attribute has a cardinality of 1 50282 meaning that for each instance of the Offer 50262 entity there is one TypeCode 50280 attribute. A TypeCode is a coded representation of the type of an offer within a retail incentive. The TargetTypeCode 50286 attribute is a RetailIncentiveOfferTargetTypeCode 50290 data type. The TargetTypeCode 50286 attribute has a cardinality of 0 . . . 1 50288 meaning that for each instance of the Offer 50262 entity there may be one TargetTypeCode 50286 attribute. A TargetTypeCode is a coded representation of the type of the target of an offer of a retail incentive. The ConditionCode 50292 attribute is a RetailIncentiveOfferConditionCode 50296 data type. The ConditionCode 50292 attribute has a cardinality of 0 . . . 1 50294 meaning that for each instance of the Offer 50262 entity there may be one ConditionCode 50292 attribute. A ConditionCode is a coded representation of a condition for an offer within a retail incentive. The ActivationStatusCode 50298 attribute is an ActivationStatusCode 50302 data type. The ActivationStatusCode 50298 attribute has a cardinality of 0 . . . 1 50300 meaning that for each instance of the Offer 50262 entity there may be one ActivationStatusCode 50298 attribute. An ActivationStatusCode is a coded representation of the activation status of an offer. The RequirementMinimumAmount 50304 attribute is an Amount 50308 data type. The RequirementMinimumAmount 50304 attribute has a cardinality of 0 . . . 1 50306 meaning that for each instance of the Offer 50262 entity there may be one RequirementMinimumAmount 50304 attribute. A RequirementMinimumAmount represents a minimum amount. The RequirementMaximumAmount 50310 attribute is an Amount 50314 data type. The RequirementMaximumAmount 50310 attribute has a cardinality of 0 . . . 1 50312 meaning that for each instance of the Offer 50262 entity there may be one RequirementMaximumAmount 50310 attribute. A RequirementMaximumAmount represents a maximum amount. The MultipleGrantingAllowedIndicator 50316 attribute is an Indicator 50320 data type. The MultipleGrantingAllowedIndicator 50316 attribute has a cardinality of 1 50318 meaning that for each instance of the Offer 50262 entity there is one MultipleGrantingAllowedIndicator 50316 attribute. A MultipleGrantingAllowedIndicator indicates whether something is allowed. The Description 50322 entity has a cardinality of 0 . . . n 50324 meaning that for each instance of the Offer 50262 entity there may be one or more Description 50322 entities. The Description 50322 entity includes a Description 50328 attribute. The Description 50328 attribute is a MEDIUM_Description 50332 data type. The Description 50328 attribute has a cardinality of 1 50330 meaning that for each instance of the Description 50322 entity there is one Description 50328 attribute. A Description represents a description of a retail incentive offer.

The Buy 50334 package is an <MT>OffrBuy 50340 data type. The Buy 50334 package includes a Buy 50336 entity. The Buy 50334 package includes a ProductGroup 50348 package. The Buy 50336 entity has a cardinality of 0 . . . 1 50338 meaning that for each instance of the Buy 50334 package there may be one Buy 50336 entity. The Buy 50336 entity includes an AndOrBusinessRuleExpressionTypeCode 50342 attribute. The AndOrBusinessRuleExpressionTypeCode 50342 attribute is an AndOrBusinessRuleExpressionTypeCode 50346 data type. The AndOrBusinessRuleExpressionTypeCode 50342 attribute has a cardinality of 0 . . . 1 50344 meaning that for each instance of the Buy 50336 entity there may be one AndOrBusinessRuleExpressionTypeCode 50342 attribute. An AndOrBusinessRuleExpressionTypeCode is a coded representation of the type of a Business Rule Expression of type AndOr.

The ProductGroup 50348 package is an <MT>OffrBuyProdGrp 50354 data type. The ProductGroup 50348 package includes a ProductGroup 50350 entity. The ProductGroup 50348 package includes a Product 50372 package. The ProductGroup 50350 entity has a cardinality of 1 . . . n 50352 meaning that for each instance of the ProductGroup 50348 package there are one or more ProductGroup 50350 entities. The ProductGroup 50350 entity includes various attributes, namely a RequirementQuantity 50356, a RequirementQuantityDecimalValue 50362 and a RetailBonusBuyProductSelectionConditionCode 50366. The RequirementQuantity 50356 attribute is a Quantity 50360 data type. The RequirementQuantity 50356 attribute has a cardinality of 1 50358 meaning that for each instance of the ProductGroup 50350 entity there is one RequirementQuantity 50356 attribute. A RequirementQuantity represents a quantity of a material that is requested by a requirement. The RequirementQuantityDecimalValue 50362 attribute is a DecimalValue 50364 data type. A RequirementQuantityDecimalValue represents a multiplier for product requirement quantities. The RetailBonusBuyProductSelectionConditionCode 50366 attribute is a RetailBonusBuyProductSelectionConditionCode 50370 data type. The RetailBonusBuyProductSelectionConditionCode 50366 attribute has a cardinality of 1 50368 meaning that for each instance of the ProductGroup 50350 entity there is one RetailBonusBuyProductSelectionConditionCode 50366 attribute. A RetailBonusBuyProductSelectionConditionCode is a coded representation of a condition for product selection within a retail bonus buy.

The Product 50372 package is an <MT>OffrBuyProdGrpProd 50378 data type. The Product 50372 package includes a Product 50374 entity. The Product 50374 entity has a cardinality of 0 . . . n 50376 meaning that for each instance of the Product 50372 package there may be one or more Product 50374 entities. The Product 50374 entity includes various attributes, namely an InternalID 50380, a StandardID 50386, a ProductCategoryInternalID 50392, a ProductCategoryHierarchyTypeCode 50398, a ProductCategoryHierarchyID 50404 and a RequirementQuantity 50410. The Product 50374 entity may represent a single product (via ProductInternalID or ProductStandardID) or a ProductCategoryInternalID or an article hierarchy node (e.g., consumer product group hierarchy ID and consumer product group ID). For RetailIncentiveOfferTypeCode in [5, 8], inbound services do not support product groups, but only single products. The InternalID 50380 attribute is a ProductInternalID 50384 data type. The InternalID 50380 attribute has a cardinality of 0 . . . 1 50382 meaning that for each instance of the Product 50374 entity there may be one InternalID 50380 attribute. An InternalID is a proprietary identifier for a product. The StandardID 50386 attribute is a ProductStandardID 50390 data type. The StandardID 50386 attribute has a cardinality of 0 . . . 1 50388 meaning that for each instance of the Product 50374 entity there may be one StandardID 50386 attribute. A StandardID is a standardized identifier for a product. In some implementations, the AgencySchemeID is fixed by Provider and Consumer (e.g., typically, nine characters (International Article Number, or EAN) and does not need to be specified). The ProductCategoryInternalID 50392 attribute is a ProductCategoryInternalID 50396 data type. The ProductCategoryInternalID 50392 attribute has a cardinality of 0 . . . 1 50394 meaning that for each instance of the Product 50374 entity there may be one ProductCategoryInternalID 50392 attribute. A ProductCategoryInternalID is a proprietary identifier for a product category. The ProductCategoryHierarchyTypeCode 50398 attribute is a ProductCategoryHierarchyTypeCode 50402 data type. The ProductCategoryHierarchyTypeCode 50398 attribute has a cardinality of 0 . . . 1 50400 meaning that for each instance of the Product 50374 entity there may be one ProductCategoryHierarchyTypeCode 50398 attribute. A ProductCategoryHierarchyTypeCode is a coded representation of the type of a product category hierarchy. The ProductCategoryHierarchyID 50404 attribute is a ProductCategoryHierarchyID 50408 data type. The ProductCategoryHierarchyID 50404 attribute has a cardinality of 0 . . . 1 50406 meaning that for each instance of the Product 50374 entity there may be one ProductCategoryHierarchyID 50404 attribute. A ProductCategoryHierarchyID is a unique identifier for a product category hierarchy. The RequirementQuantity 50410 attribute is a Quantity 50414 data type. The RequirementQuantity 50410 attribute has a cardinality of 0 . . . 1 50412 meaning that for each instance of the Product 50374 entity there may be one RequirementQuantity 50410 attribute. A RequirementQuantity represents a non-monetary numerical specification of an amount in a unit of measurement.

The Get 50416 package is an <MT>OffrGet 50422 data type. The Get 50416 package includes a Get 50418 entity. The Get 50416 package includes a ProductGroup 50460 package. The Get 50418 entity has a cardinality of 1 50420 meaning that for each instance of the Get 50416 package there is one Get 50418 entity. The Get 50418 entity includes various attributes, namely an AndOrBusinessRuleExpressionTypeCode 50424, a SalesPriceBaseQuantity 50430, a PriceAmount 50436, a DiscountAmount 50442, a DiscountPercent 50448 and an InBuyIncludedIndicator 50454. The AndOrBusinessRuleExpressionTypeCode 50424 attribute is an AndOrBusinessRuleExpressionTypeCode 50428 data type. The AndOrBusinessRuleExpressionTypeCode 50424 attribute has a cardinality of 0 . . . 1 50426 meaning that for each instance of the Get 50418 entity there may be one AndOrBusinessRuleExpressionTypeCode 50424 attribute. An AndOrBusinessRuleExpressionTypeCode is a coded representation of the type of a Business Rule Expression of type AndOr. The SalesPriceBaseQuantity 50430 attribute is a Quantity 50434 data type. The SalesPriceBaseQuantity 50430 attribute has a cardinality of 0 . . . 1 50432 meaning that for each instance of the Get 50418 entity there may be one SalesPriceBaseQuantity 50430 attribute. A SalesPriceBaseQuantity represents a quantity that is defined as a base of another quantity or amount. The PriceAmount 50436 attribute is an Amount 50440 data type. The PriceAmount 50436 attribute has a cardinality of 0 . . . 1 50438 meaning that for each instance of the Get 50418 entity there may be one PriceAmount 50436 attribute. A PriceAmount represents the amount of a price. The DiscountAmount 50442 attribute is an Amount 50446 data type. The DiscountAmount 50442 attribute has a cardinality of 0 . . . 1 50444 meaning that for each instance of the Get 50418 entity there may be one DiscountAmount 50442 attribute. A DiscountAmount represents the amount of a discount. The DiscountPercent 50448 attribute is a Percent 50452 data type. The DiscountPercent 50448 attribute has a cardinality of 0 . . . 1 50450 meaning that for each instance of the Get 50418 entity there may be one DiscountPercent 50448 attribute. A DiscountPercent represents a discount expressed as a percent. The InBuyIncludedIndicator 50454 attribute is an Indicator 50458 data type. The InBuyIncludedIndicator 50454 attribute has a cardinality of 1 50456 meaning that for each instance of the Get 50418 entity there is one InBuyIncludedIndicator 50454 attribute. An InBuyIncludedIndicator indicates whether something is included.

The ProductGroup 50460 package is an <MT>OffrGetProdGrp 50466 data type. The ProductGroup 50460 package includes a ProductGroup 50462 entity. The ProductGroup 50460 package includes a Product 50490 package. The ProductGroup 50462 entity has a cardinality of 0 . . . n 50464 meaning that for each instance of the ProductGroup 50460 package there may be one or more ProductGroup 50462 entities. The ProductGroup 50462 entity includes various attributes, namely a GrantedQuantity 50468, a GrantedQuantityDecimalValue 50474, an IntervalBoundaryTypeCode 50478, a GrantedQuantityLowerBoundaryDecimalValue 50482 and a GrantedQuantityUpperBoundaryDecimalValue 50486. The GrantedQuantity 50468 attribute is a Quantity 50472 data type. The GrantedQuantity 50468 attribute has a cardinality of 0 . . . 1 50470 meaning that for each instance of the ProductGroup 50462 entity there may be one GrantedQuantity 50468 attribute. A GrantedQuantity represents a quantity that has been granted by someone. The GrantedQuantityDecimalValue 50474 attribute is a DecimalValue 50476 data type. A GrantedQuantityDecimalValue is a multiplier for product granted quantities. A QuantityDecimalValue is a non-monetary numerical specification of an amount without a unit of measurement. The IntervalBoundaryTypeCode 50478 attribute is an IntervalBoundaryTypeCode 50480 data type. An IntervalBoundaryTypeCode is a coded representation of an interval boundary type. The GrantedQuantityLowerBoundaryDecimalValue 50482 attribute is a DecimalValue 50484 data type. A GrantedQuantityLowerBoundaryDecimalValue represents a multiplier for product granted quantities. The GrantedQuantityUpperBoundaryDecimalValue 50486 attribute is a DecimalValue 50488 data type. A GrantedQuantityUpperBoundaryDecimalValue represents a multiplier for product granted quantities.

The Product 50490 package is an <MT>OffrGetProdGrpProd 50496 data type. The Product 50490 package includes a Product 50492 entity. The Product 50490 package includes a StoreQuantities 50570 package. The Product 50492 entity has a cardinality of 0 . . . n 50494 meaning that for each instance of the Product 50490 package there may be one or more Product 50492 entities. The Product 50492 entity includes various attributes, namely an InternalID 50498, a StandardID 50504, a ProductCategoryInternalID 50510, a ProductCategoryHierarchyTypeCode 50516, a ProductCategoryHierarchyID 50522, a ConsumerProductGroupHierarchyID 50528, a ConsumerProductGroupID 50534, a SeasonCategoryCode 50540, a SeasonYearID 50546, a GrantedQuantity 50552, a PlannedSalesQuantity 50558 and a RetailEventThemeCode 50564. The InternalID 50498 attribute is a ProductInternalID 50502 data type. The InternalID 50498 attribute has a cardinality of 0 . . . 1 50500 meaning that for each instance of the Product 50492 entity there may be one InternalID 50498 attribute. An InternalID is a proprietary identifier for a product. The StandardID 50504 attribute is a ProductStandardID 50508 data type. The StandardID 50504 attribute has a cardinality of 0 . . . 1 50506 meaning that for each instance of the Product 50492 entity there may be one StandardID 50504 attribute. A StandardID is a standardized identifier for a product. In some implementations, the AgencySchemeID is fixed by Provider and Consumer (e.g., typically, nine characters (International Article Number, or EAN) and does not need to be specified). The ProductCategoryInternalID 50510 attribute is a ProductCategoryInternalID 50514 data type. The ProductCategoryInternalID 50510 attribute has a cardinality of 0 . . . 1 50512 meaning that for each instance of the Product 50492 entity there may be one ProductCategoryInternalID 50510 attribute. A ProductCategoryInternalID is a proprietary identifier for a product category. The ProductCategoryHierarchyTypeCode 50516 attribute is a ProductCategoryHierarchyTypeCode 50520 data type. The ProductCategoryHierarchyTypeCode 50516 attribute has a cardinality of 0 . . . 1 50518 meaning that for each instance of the Product 50492 entity there may be one ProductCategoryHierarchyTypeCode 50516 attribute. A ProductCategoryHierarchyTypeCode is a coded representation of the type of a product category hierarchy. The ProductCategoryHierarchyID 50522 attribute is a ProductCategoryHierarchyID 50526 data type. The ProductCategoryHierarchyID 50522 attribute has a cardinality of 0 . . . 1 50524 meaning that for each instance of the Product 50492 entity there may be one ProductCategoryHierarchyID 50522 attribute. A ProductCategoryHierarchyID is a unique identifier for a product category hierarchy. The ConsumerProductGroupHierarchyID 50528 attribute is a ConsumerProductGroupHierarchyID 50532 data type. The ConsumerProductGroupHierarchyID 50528 attribute has a cardinality of 0 . . . 1 50530 meaning that for each instance of the Product 50492 entity there may be one ConsumerProductGroupHierarchyID 50528 attribute. A ConsumerProductGroupHierarchyID is an identifier for a consumer product group hierachy. The ConsumerProductGroupID 50534 attribute is a ConsumerProductGroupID 50538 data type. The ConsumerProductGroupID 50534 attribute has a cardinality of 0 . . . 1 50536 meaning that for each instance of the Product 50492 entity there may be one ConsumerProductGroupID 50534 attribute. A ConsumerProductGroupID is an identifier for a consumer product group. The SeasonCategoryCode 50540 attribute is a SeasonCategoryCode 50544 data type. The SeasonCategoryCode 50540 attribute has a cardinality of 0 . . . 1 50542 meaning that for each instance of the Product 50492 entity there may be one SeasonCategoryCode 50540 attribute. A SeasonCategoryCode is a coded representation of a season category. The SeasonYearID 50546 attribute is a SeasonYearID 50550 data type. The SeasonYearID 50546 attribute has a cardinality of 0 . . . 1 50548 meaning that for each instance of the Product 50492 entity there may be one SeasonYearID 50546 attribute. A SeasonYearID is an identifier for a season year. The GrantedQuantity 50552 attribute is a Quantity 50556 data type. The GrantedQuantity 50552 attribute has a cardinality of 0 . . . 1 50554 meaning that for each instance of the Product 50492 entity there may be one GrantedQuantity 50552 attribute. A GrantedQuantity represents a quantity that has been granted by someone. The PlannedSalesQuantity 50558 attribute is a Quantity 50562 data type. The PlannedSalesQuantity 50558 attribute has a cardinality of 0 . . . 1 50560 meaning that for each instance of the Product 50492 entity there may be one PlannedSalesQuantity 50558 attribute. A PlannedSalesQuantity denotes a quantity of products that is planned to be sold. The RetailEventThemeCode 50564 attribute is a RetailEventThemeCode 50568 data type. The RetailEventThemeCode 50564 attribute has a cardinality of 0 . . . 1 50566 meaning that for each instance of the Product 50492 entity there may be one RetailEventThemeCode 50564 attribute. A RetailEventThemeCode represents an assigned retail event theme.

The StoreQuantities 50570 package is an <MT>OffrGetProdGrpProdStoreQts 50576 data type. The StoreQuantities 50570 package includes a StoreQuantities 50572 entity. The StoreQuantities 50572 entity has a cardinality of 0 . . . n 50574 meaning that for each instance of the StoreQuantities 50570 package there may be one or more StoreQuantities 50572 entities. The StoreQuantities 50572 entity includes various attributes, namely a StoreInternalID 50578 and a PlannedSalesQuantity 50584. The StoreInternalID 50578 attribute is a StoreInternalID 50582 data type. The StoreInternalID 50578 attribute has a cardinality of 1 50580 meaning that for each instance of the StoreQuantities 50572 entity there is one StoreInternalID 50578 attribute. A StoreInternalID is a proprietary identifier for a store. The PlannedSalesQuantity 50584 attribute is a Quantity 50588 data type. The PlannedSalesQuantity 50584 attribute has a cardinality of 0 . . . 1 50586 meaning that for each instance of the StoreQuantities 50572 entity there may be one PlannedSalesQuantity 50584 attribute. A PlannedSalesQuantity denotes a quantity of products that is planned to be sold.

The SalesPriceSpecification 50590 package is an <MT>OffrSlsPrSpec 50596 data type. The SalesPriceSpecification 50590 package includes a SalesPriceSpecification 50592 entity. The SalesPriceSpecification 50590 package includes various packages, namely a PropertyValuation 50634 and a ScaleLine 50660. The SalesPriceSpecification 50592 entity has a cardinality of 0 . . . n 50594 meaning that for each instance of the SalesPriceSpecification 50590 package there may be one or more SalesPriceSpecification 50592 entities. The SalesPriceSpecification 50592 entity includes various attributes, namely a PriceSpecificationElementTypeCode 50598, a ValidityPeriod 50604, an Amount 50610, a BaseQuantity 50616, a BaseQuantityTypeCode 50622 and a Percent 50628. The PriceSpecificationElementTypeCode 50598 attribute is a PriceSpecificationElementTypeCode 50602 data type. The PriceSpecificationElementTypeCode 50598 attribute has a cardinality of 1 50600 meaning that for each instance of the SalesPriceSpecification 50592 entity there is one PriceSpecificationElementTypeCode 50598 attribute. A PriceSpecificationElementTypeCode is a coded representation of the type of a PriceSpecificationElement. The ValidityPeriod 50604 attribute is a TimePointPeriod 50608 data type. The ValidityPeriod 50604 attribute has a cardinality of 1 50606 meaning that for each instance of the SalesPriceSpecification 50592 entity there is one ValidityPeriod 50604 attribute. A ValidityPeriod represents a period in which something is valid. The Amount 50610 attribute is an Amount 50614 data type. The Amount 50610 attribute has a cardinality of 0 . . . 1 50612 meaning that for each instance of the SalesPriceSpecification 50592 entity there may be one Amount 50610 attribute. An Amount represents an amount with a corresponding currency unit. The BaseQuantity 50616 attribute is a Quantity 50620 data type. The BaseQuantity 50616 attribute has a cardinality of 0 . . . 1 50618 meaning that for each instance of the SalesPriceSpecification 50592 entity there may be one BaseQuantity 50616 attribute. A BaseQuantity represents a quantity that is defined as a base of another quantity or amount. The BaseQuantityTypeCode 50622 attribute is a QuantityTypeCode 50626 data type. The BaseQuantityTypeCode 50622 attribute has a cardinality of 0 . . . 1 50624 meaning that for each instance of the SalesPriceSpecification 50592 entity there may be one BaseQuantityTypeCode 50622 attribute. A BaseQuantityTypeCode is a coded representation of a type of quantity that is based on a measurable characteristic of an object or physical phenomenon. The Percent 50628 attribute is a Percent 50632 data type. The Percent 50628 attribute has a cardinality of 0 . . . 1 50630 meaning that for each instance of the SalesPriceSpecification 50592 entity there may be one Percent 50628 attribute. A Percent represents a number that relates to the comparison figure one hundred.

The PropertyValuation 50634 package is an <MT>OffrSlsPrSpecPrptyValn 50640 data type. The PropertyValuation 50634 package includes a PropertyValuation 50636 entity. The PropertyValuation 50636 entity has a cardinality of 1 . . . n 50638 meaning that for each instance of the PropertyValuation 50634 package there are one or more PropertyValuation 50636 entities. The PropertyValuation 50636 entity includes various attributes, namely a PriceSpecificationElementPropertyReference 50642, a PriceSpecificationElementPropertyValue 50648 and a Description 50654. The PriceSpecificationElementPropertyReference 50642 attribute is a PriceSpecificationElementPropertyReference 50646 data type. The PriceSpecificationElementPropertyReference 50642 attribute has a cardinality of 1 50644 meaning that for each instance of the PropertyValuation 50636 entity there is one PriceSpecificationElementPropertyReference 50642 attribute. A PriceSpecificationElementPropertyReference is a unique reference of a property for the specification of a price, discount or surcharge within a property definition class. The PriceSpecificationElementPropertyValue 50648 attribute is a PriceSpecificationElementPropertyValue 50652 data type. The PriceSpecificationElementPropertyValue 50648 attribute has a cardinality of 1 50650 meaning that for each instance of the PropertyValuation 50636 entity there is one PriceSpecificationElementPropertyValue 50648 attribute. A PriceSpecificationElementPropertyValue is a value that is assigned to a property within a property valuation of a PriceSpecificationElement. The Description 50654 attribute is a SHORT_Description 50658 data type. The Description 50654 attribute has a cardinality of 0 . . . 1 50656 meaning that for each instance of the PropertyValuation 50636 entity there may be one Description 50654 attribute. A Description is a representation of the properties of an object in natural language.

The ScaleLine 50660 package is an <MT>OffrSlsPrSpecScLine 50666 data type. The ScaleLine 50660 package includes a ScaleLine 50662 entity. The ScaleLine 50662 entity has a cardinality of 0 . . . n 50664 meaning that for each instance of the ScaleLine 50660 package there may be one or more ScaleLine 50662 entities. The ScaleLine 50662 entity includes various attributes, namely a ScaleAxisStep 50668, an Amount 50674 and a Percent 50680. The ScaleAxisStep 50668 attribute is a ScaleAxisStep 50672 data type. The ScaleAxisStep 50668 attribute has a cardinality of 1 50670 meaning that for each instance of the ScaleLine 50662 entity there is one ScaleAxisStep 50668 attribute. A ScaleAxisStep represents a step (e.g., scale dimension value) of a scale axis. The Amount 50674 attribute is an Amount 50678 data type. The Amount 50674 attribute has a cardinality of 0 . . . 1 50676 meaning that for each instance of the ScaleLine 50662 entity there may be one Amount 50674 attribute. An Amount represents an amount with a corresponding currency unit. The Percent 50680 attribute is a Percent 50684 data type. The Percent 50680 attribute has a cardinality of 0 . . . 1 50682 meaning that for each instance of the ScaleLine 50662 entity there may be one Percent 50680 attribute. A Percent represents a number that relates to the comparison figure one hundred.

The Store 50686 package is an <MT>OffrStore 50692 data type. The Store 50686 package includes a Store 50688 entity. The Store 50688 entity has a cardinality of 0 . . . n 50690 meaning that for each instance of the Store 50686 package there may be one or more Store 50688 entities. The Store 50688 entity includes an InternalID 50694 attribute. The InternalID 50694 attribute is a StoreInternalID 50698 data type. The InternalID 50694 attribute has a cardinality of 1 50696 meaning that for each instance of the Store 50688 entity there is one InternalID 50694 attribute. An InternalID is a proprietary identifier for a store.

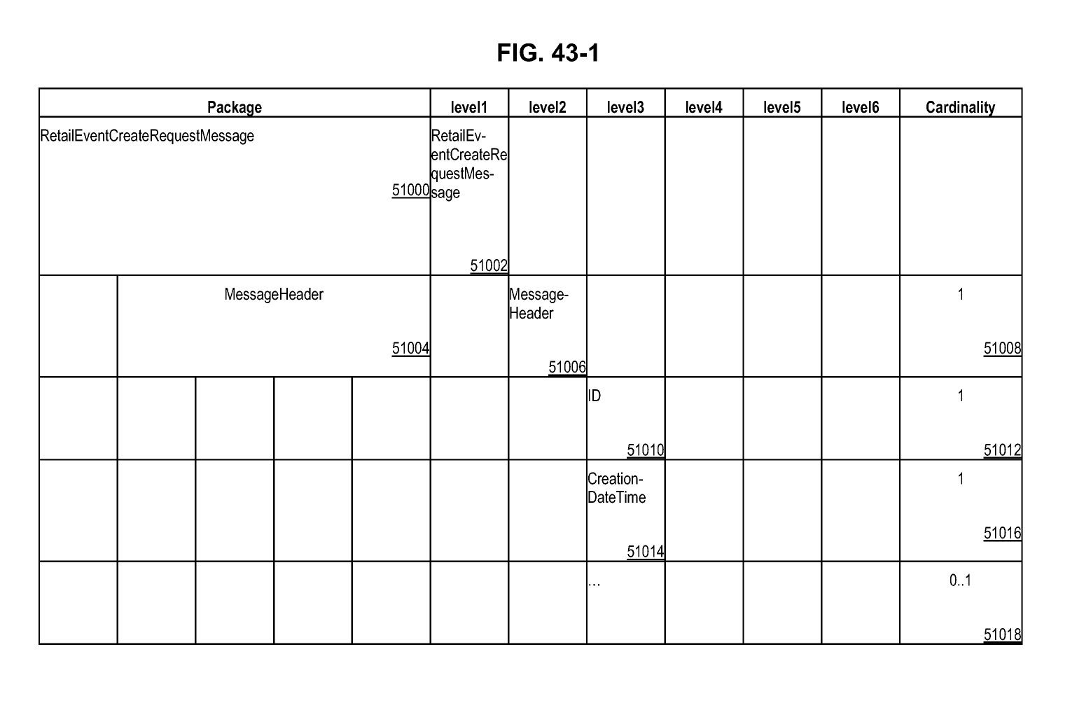

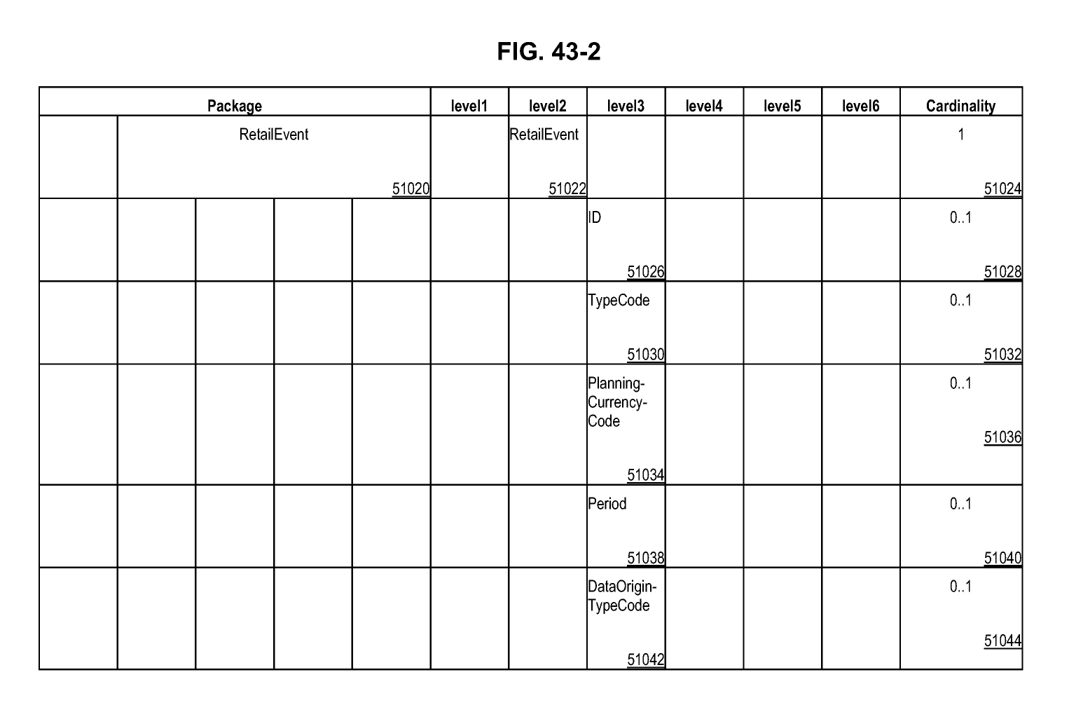

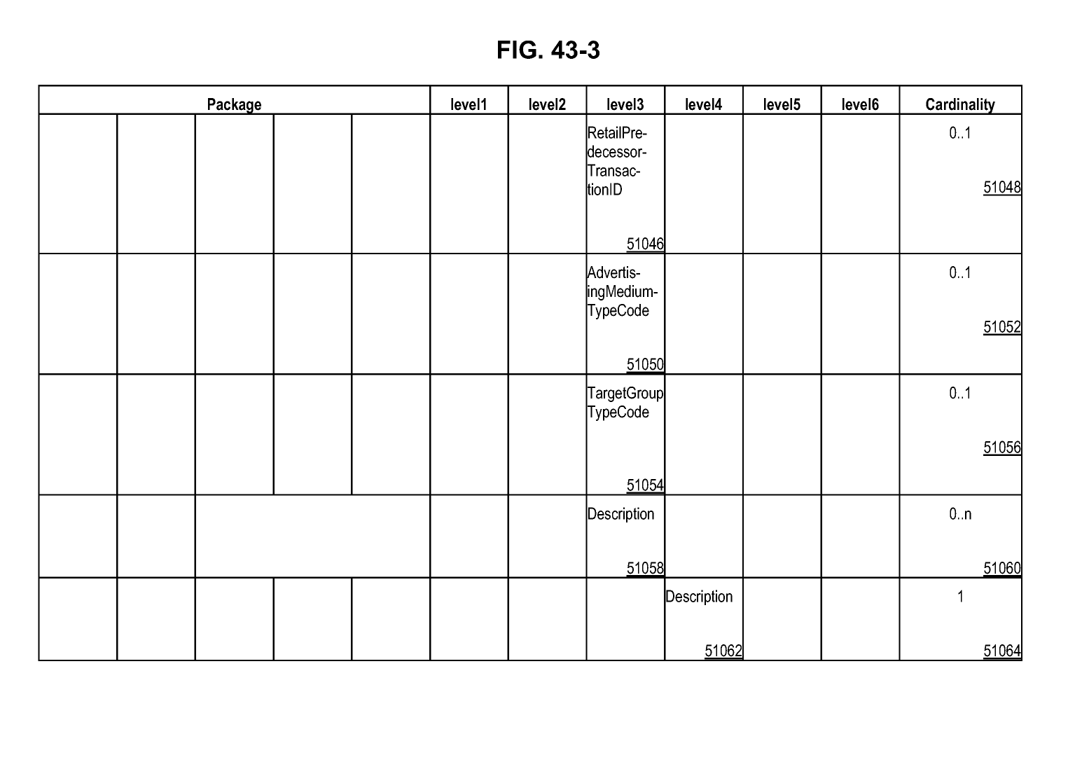

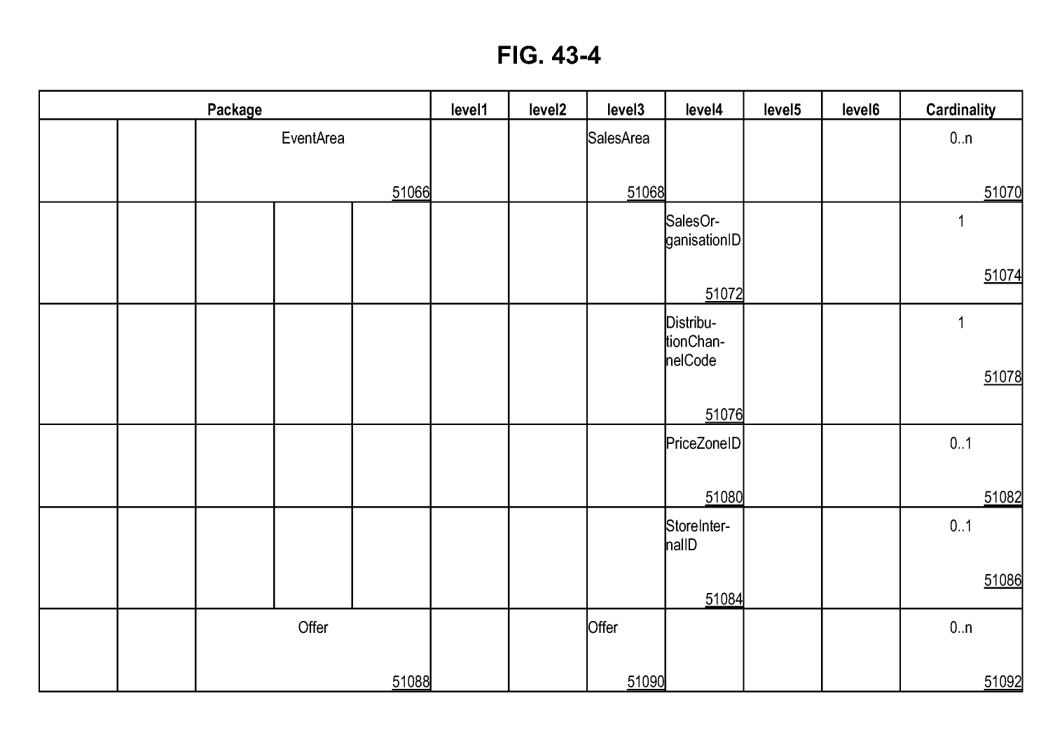

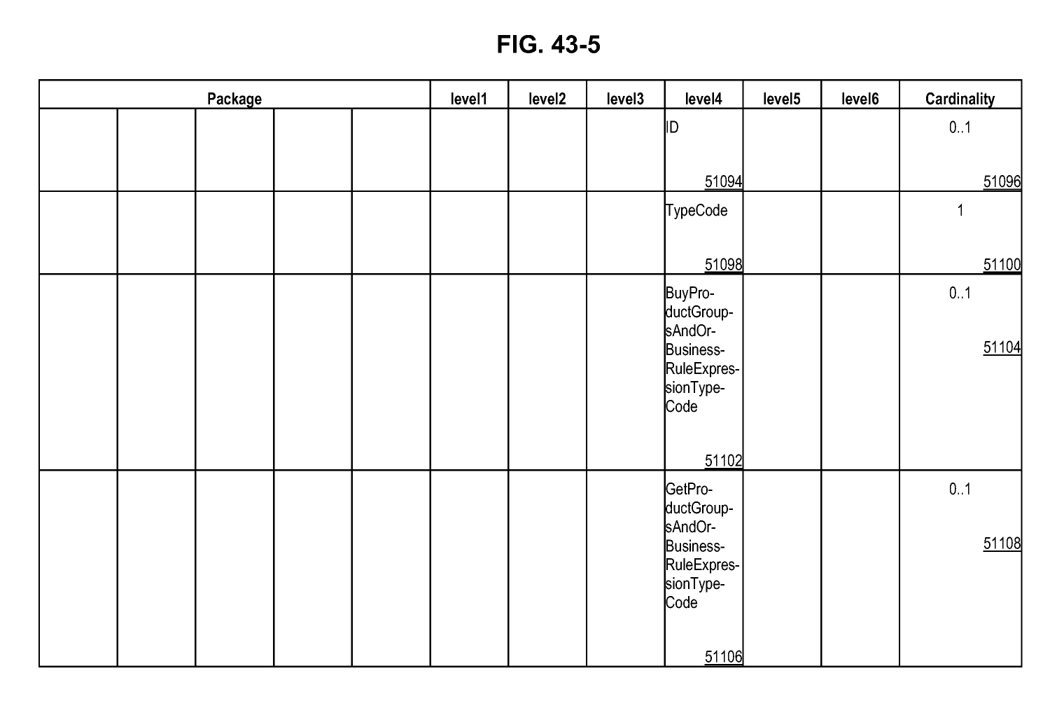

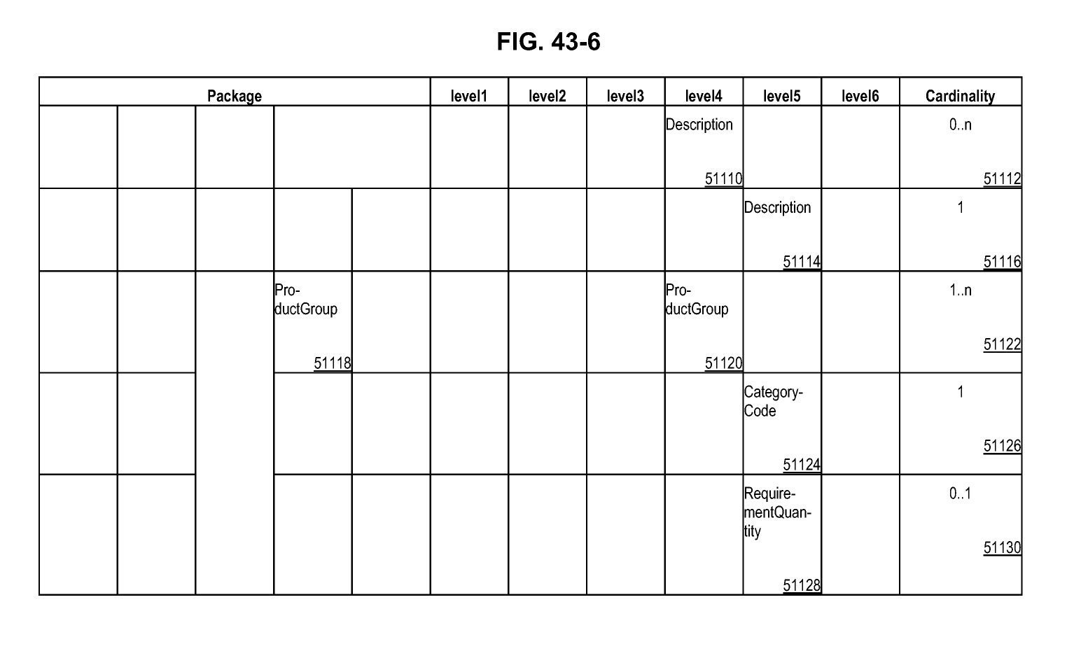

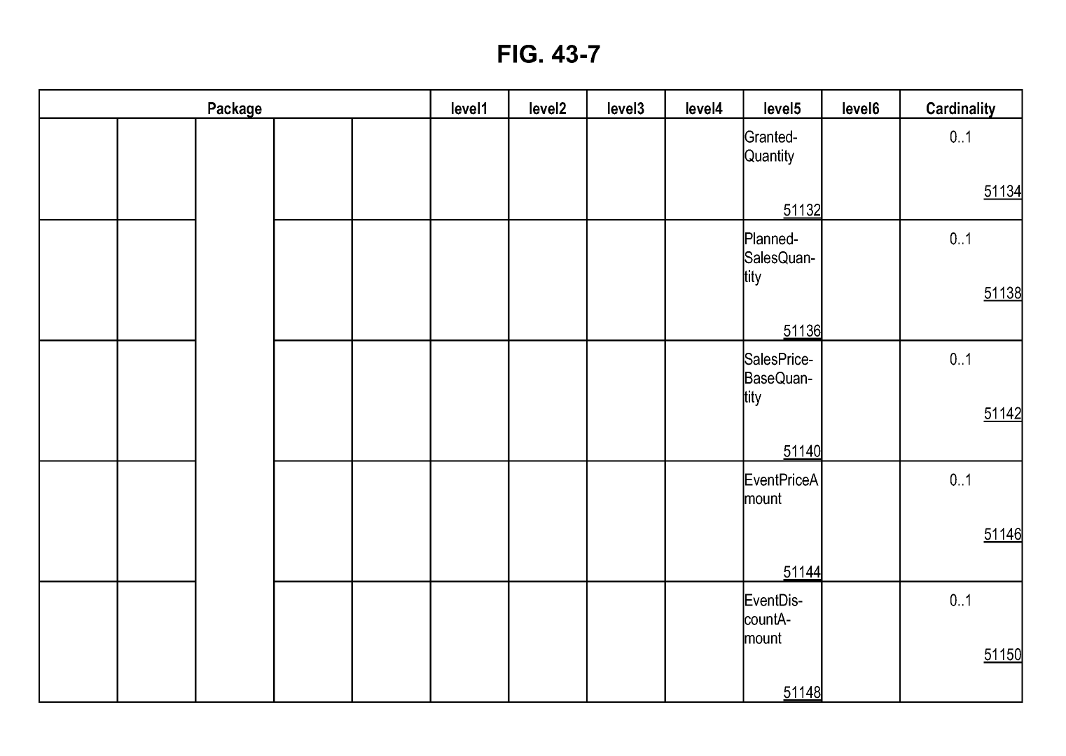

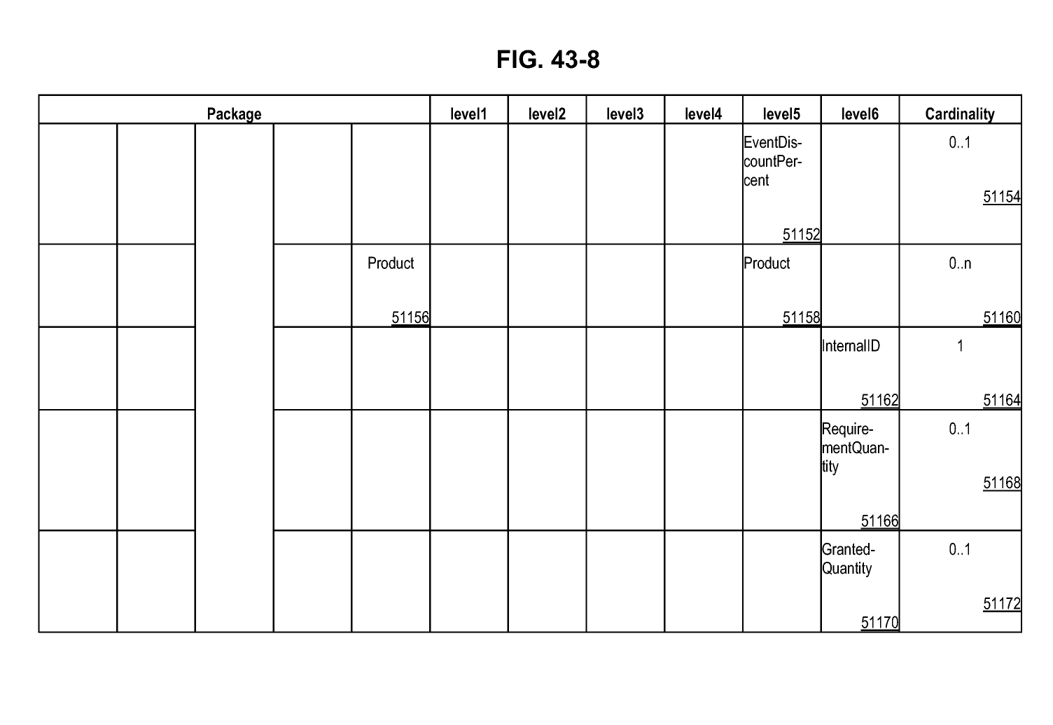

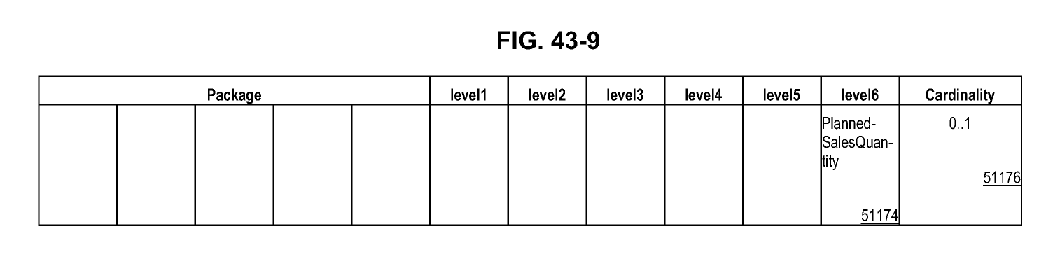

Additionally, FIGS. 43-1 through 43-9 show an example configuration of an Element Structure that includes a RetailEventCreateRequestMessage 51000 package. The RetailEventCreateRequestMessage 51000 package includes a RetailEventCreateRequestMessage 51002 entity. The RetailEventCreateRequestMessage 51000 package includes various packages, namely a MessageHeader 51004 and a RetailEvent 51020.

The MessageHeader 51004 package includes a MessageHeader 51006 entity. The MessageHeader 51006 entity has a cardinality of 1 51008 meaning that for each instance of the MessageHeader 51004 package there is one MessageHeader 51006 entity. The MessageHeader 51006 entity includes various attributes, namely an ID 51010, and a CreationDateTime 51014. The ID 51010 attribute has a cardinality of 1 51012 meaning that for each instance of the MessageHeader 51006 entity there is one ID 51010 attribute. The CreationDateTime 51014 attribute has a cardinality of 1 51016 meaning that for each instance of the MessageHeader 51006 entity there is one CreationDateTime 51014 attribute.

The RetailEvent 51020 package includes a RetailEvent 51022 entity. The RetailEvent 51020 package includes various packages, namely an EventArea 51066 and an Offer 51088. The RetailEvent 51022 entity has a cardinality of 1 51024 meaning that for each instance of the RetailEvent 51020 package there is one RetailEvent 51022 entity. The RetailEvent 51022 entity includes various attributes, namely an ID 51026, a TypeCode 51030, a PlanningCurrencyCode 51034, a Period 51038, a DataOriginTypeCode 51042, a RetailPredecessorTransactionID 51046, an AdvertisingMediumTypeCode 51050 and a TargetGroupTypeCode 51054. The RetailEvent 51022 entity includes a Description 51058 subordinate entity. The ID 51026 attribute has a cardinality of 0 . . . 1 51028 meaning that for each instance of the RetailEvent 51022 entity there may be one ID 51026 attribute. The TypeCode 51030 attribute has a cardinality of 0 . . . 1 51032 meaning that for each instance of the RetailEvent 51022 entity there may be one TypeCode 51030 attribute. The PlanningCurrencyCode 51034 attribute has a cardinality of 0 . . . 1 51036 meaning that for each instance of the RetailEvent 51022 entity there may be one PlanningCurrencyCode 51034 attribute. The Period 51038 attribute has a cardinality of 0 . . . 1 51040 meaning that for each instance of the RetailEvent 51022 entity there may be one Period 51038 attribute. The DataOriginTypeCode 51042 attribute has a cardinality of 0 . . . 1 51044 meaning that for each instance of the RetailEvent 51022 entity there may be one DataOriginTypeCode 51042 attribute. The RetailPredecessorTransactionID 51046 attribute has a cardinality of 0 . . . 1 51048 meaning that for each instance of the RetailEvent 51022 entity there may be one RetailPredecessorTransactionID 51046 attribute. The AdvertisingMediumTypeCode 51050 attribute has a cardinality of 0 . . . 1 51052 meaning that for each instance of the RetailEvent 51022 entity there may be one AdvertisingMediumTypeCode 51050 attribute. The TargetGroupTypeCode 51054 attribute has a cardinality of 0 . . . 1 51056 meaning that for each instance of the RetailEvent 51022 entity there may be one TargetGroupTypeCode 51054 attribute. The Description 51058 entity has a cardinality of 0 . . . n 51060 meaning that for each instance of the RetailEvent 51022 entity there may be one or more Description 51058 entities. The Description 51058 entity includes a Description 51062 attribute. The Description 51062 attribute has a cardinality of 1 51064 meaning that for each instance of the Description 51058 entity there is one Description 51062 attribute.

The EventArea 51066 package includes a SalesArea 51068 entity. The SalesArea 51068 entity has a cardinality of 0 . . . n 51070 meaning that for each instance of the EventArea 51066 package there may be one or more SalesArea 51068 entities. The SalesArea 51068 entity includes various attributes, namely a SalesOrganisationID 51072, a DistributionChannelCode 51076, a PriceZoneID 51080 and a StoreInternalID 51084. The SalesOrganisationID 51072 attribute has a cardinality of 1 51074 meaning that for each instance of the SalesArea 51068 entity there is one SalesOrganisationID 51072 attribute. The DistributionChannelCode 51076 attribute has a cardinality of 1 51078 meaning that for each instance of the SalesArea 51068 entity there is one DistributionChannelCode 51076 attribute. The PriceZoneID 51080 attribute has a cardinality of 0 . . . 1 51082 meaning that for each instance of the SalesArea 51068 entity there may be one PriceZoneID 51080 attribute. The StoreInternalID 51084 attribute has a cardinality of 0 . . . 1 51086 meaning that for each instance of the SalesArea 51068 entity there may be one StoreInternalID 51084 attribute.

The Offer 51088 package includes an Offer 51090 entity. The Offer 51088 package includes a ProductGroup 51118 package. The Offer 51090 entity has a cardinality of 0 . . . n 51092 meaning that for each instance of the Offer 51088 package there may be one or more Offer 51090 entities. The Offer 51090 entity includes various attributes, namely an ID 51094, a TypeCode 51098, a BuyProductGroupsAndOrBusinessRuleExpressionTypeCode 51102 and a GetProductGroupsAndOrBusinessRuleExpressionTypeCode 51106. The Offer 51090 entity includes a Description 51110 subordinate entity. The ID 51094 attribute has a cardinality of 0 . . . 1 51096 meaning that for each instance of the Offer 51090 entity there may be one ID 51094 attribute. The TypeCode 51098 attribute has a cardinality of 1 51100 meaning that for each instance of the Offer 51090 entity there is one TypeCode 51098 attribute. The BuyProductGroupsAndOrBusinessRuleExpressionTypeCode 51102 attribute has a cardinality of 0 . . . 1 51104 meaning that for each instance of the Offer 51090 entity there may be one BuyProductGroupsAndOrBusinessRuleExpressionTypeCode 51102 attribute. The GetProductGroupsAndOrBusinessRuleExpressionTypeCode 51106 attribute has a cardinality of 0 . . . 1 51108 meaning that for each instance of the Offer 51090 entity there may be one GetProductGroupsAndOrBusinessRuleExpressionTypeCode 51106 attribute. The Description 51110 entity has a cardinality of 0 . . . n 51112 meaning that for each instance of the Offer 51090 entity there may be one or more Description 51110 entities. The Description 51110 entity includes a Description 51114 attribute. The Description 51114 attribute has a cardinality of 1 51116 meaning that for each instance of the Description 51110 entity there is one Description 51114 attribute.

The ProductGroup 51118 package includes a ProductGroup 51120 entity. The ProductGroup 51118 package includes a Product 51156 package. The ProductGroup 51120 entity has a cardinality of 1 . . . n 51122 meaning that for each instance of the ProductGroup 51118 package there are one or more ProductGroup 51120 entities. The ProductGroup 51120 entity includes various attributes, namely a CategoryCode 51124, a RequirementQuantity 51128, a GrantedQuantity 51132, a PlannedSalesQuantity 51136, a SalesPriceBaseQuantity 51140, an EventPriceAmount 51144, an EventDiscountAmount 51148 and an EventDiscountPercent 51152. The CategoryCode 51124 attribute has a cardinality of 1 51126 meaning that for each instance of the ProductGroup 51120 entity there is one CategoryCode 51124 attribute. The RequirementQuantity 51128 attribute has a cardinality of 0 . . . 1 51130 meaning that for each instance of the ProductGroup 51120 entity there may be one RequirementQuantity 51128 attribute. The GrantedQuantity 51132 attribute has a cardinality of 0 . . . 1 51134 meaning that for each instance of the ProductGroup 51120 entity there may be one GrantedQuantity 51132 attribute. The PlannedSalesQuantity 51136 attribute has a cardinality of 0 . . . 1 51138 meaning that for each instance of the ProductGroup 51120 entity there may be one PlannedSalesQuantity 51136 attribute. The SalesPriceBaseQuantity 51140 attribute has a cardinality of 0 . . . 1 51142 meaning that for each instance of the ProductGroup 51120 entity there may be one SalesPriceBaseQuantity 51140 attribute. The EventPriceAmount 51144 attribute has a cardinality of 0 . . . 1 51146 meaning that for each instance of the ProductGroup 51120 entity there may be one EventPriceAmount 51144 attribute. The EventDiscountAmount 51148 attribute has a cardinality of 0 . . . 1 51150 meaning that for each instance of the ProductGroup 51120 entity there may be one EventDiscountAmount 51148 attribute. The EventDiscountPercent 51152 attribute has a cardinality of 0 . . . 1 51154 meaning that for each instance of the ProductGroup 51120 entity there may be one EventDiscountPercent 51152 attribute.

The Product 51156 package includes a Product 51158 entity. The Product 51158 entity has a cardinality of 0 . . . n 51160 meaning that for each instance of the Product 51156 package there may be one or more Product 51158 entities. The Product 51158 entity includes various attributes, namely an InternalID 51162, a RequirementQuantity 51166, a GrantedQuantity 51170 and a PlannedSalesQuantity 51174. The InternalID 51162 attribute has a cardinality of 1 51164 meaning that for each instance of the Product 51158 entity there is one InternalID 51162 attribute. The RequirementQuantity 51166 attribute has a cardinality of 0 . . . 1 51168 meaning that for each instance of the Product 51158 entity there may be one RequirementQuantity 51166 attribute. The GrantedQuantity 51170 attribute has a cardinality of 0 . . . 1 51172 meaning that for each instance of the Product 51158 entity there may be one GrantedQuantity 51170 attribute. The PlannedSalesQuantity 51174 attribute has a cardinality of 0 . . . 1 51176 meaning that for each instance of the Product 51158 entity there may be one PlannedSalesQuantity 51174 attribute.

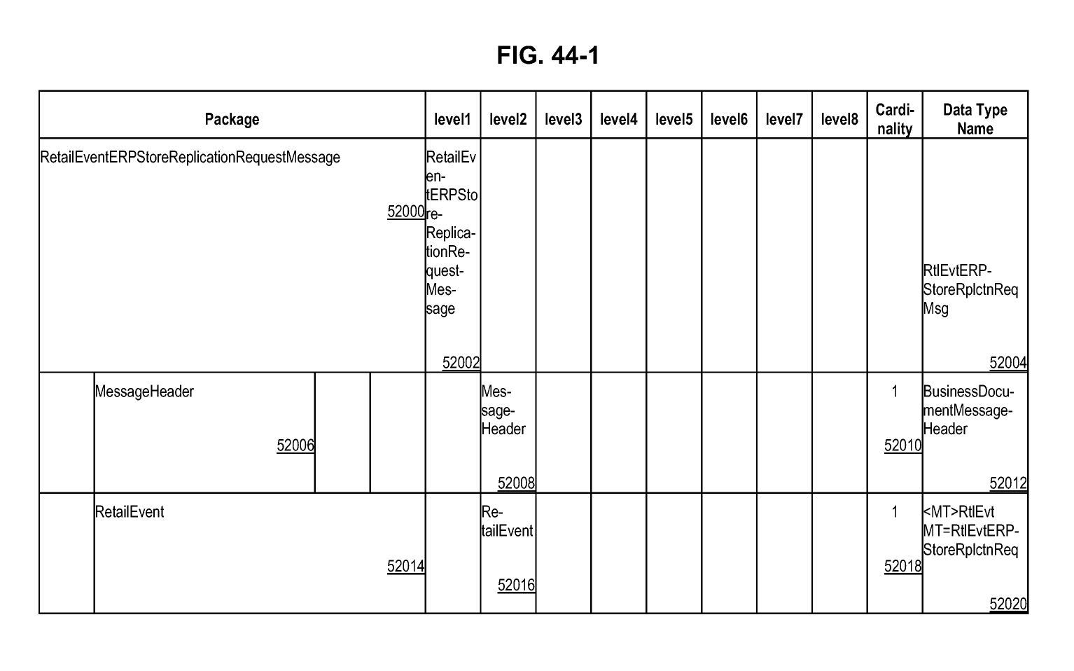

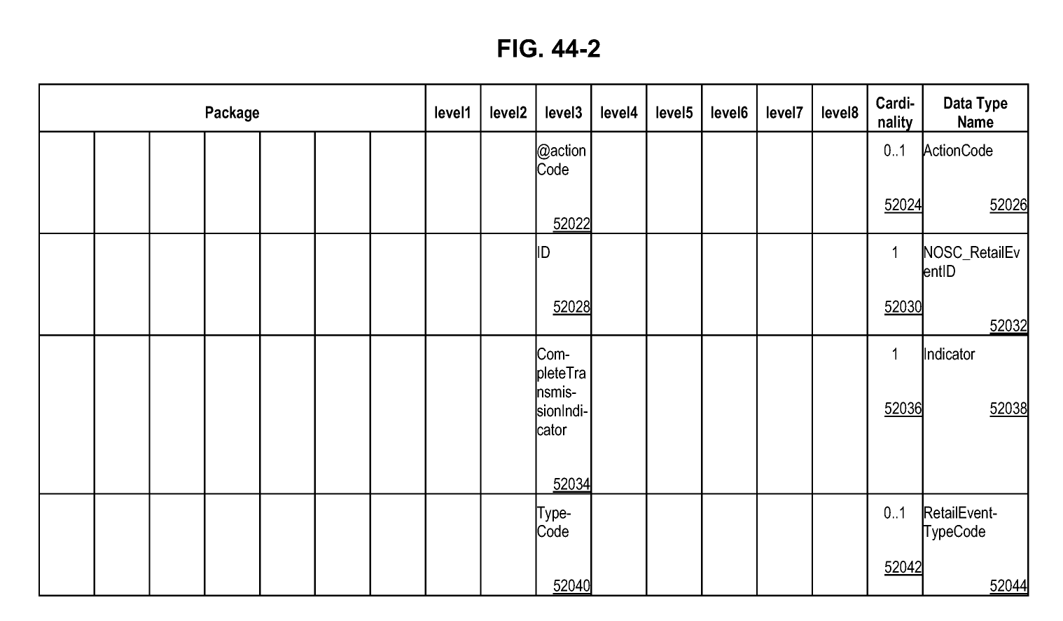

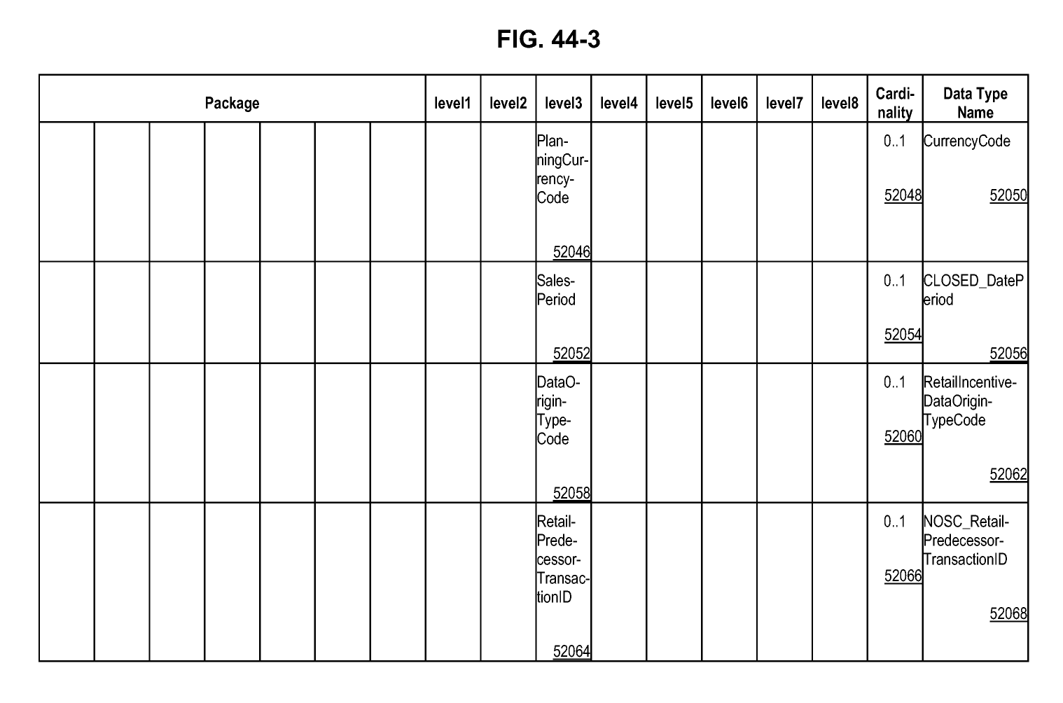

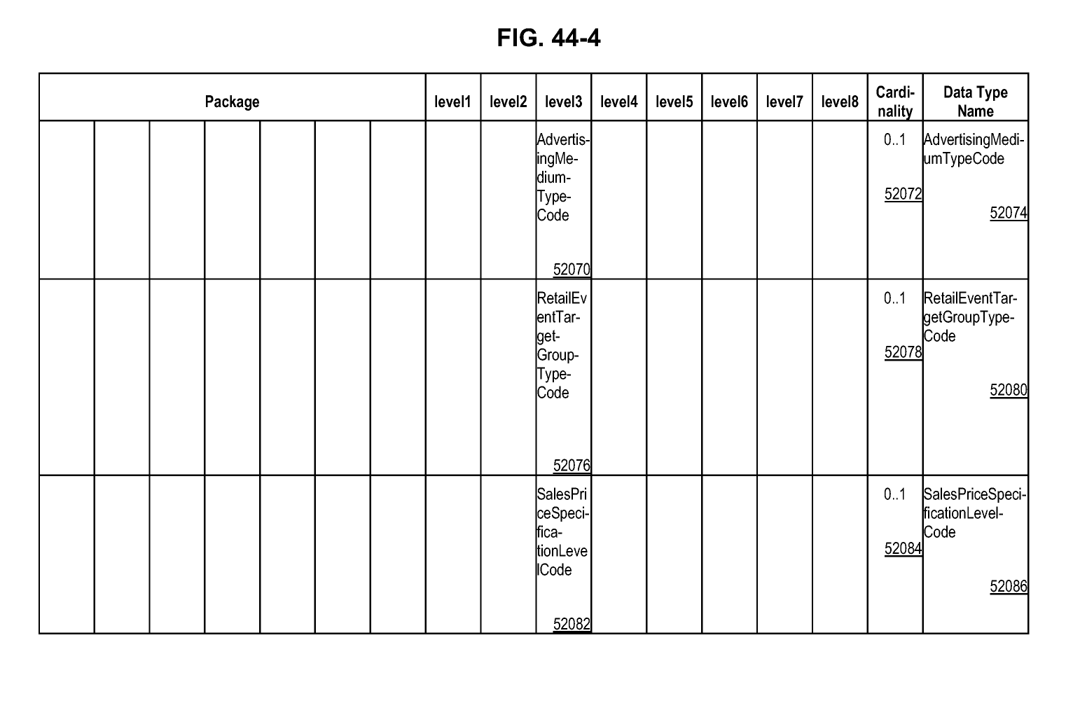

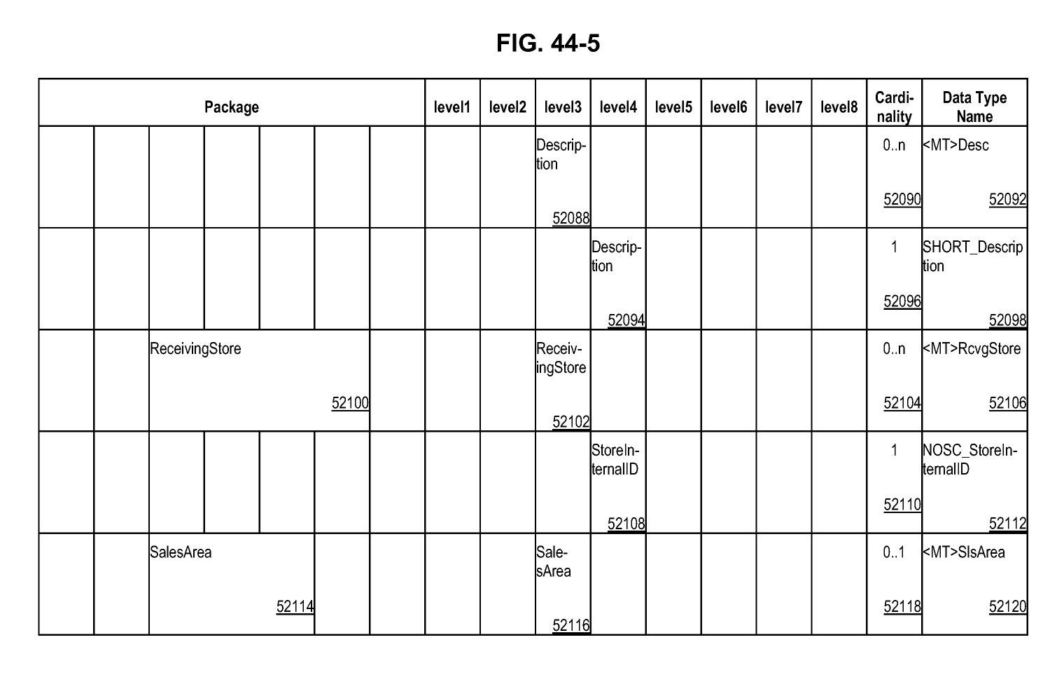

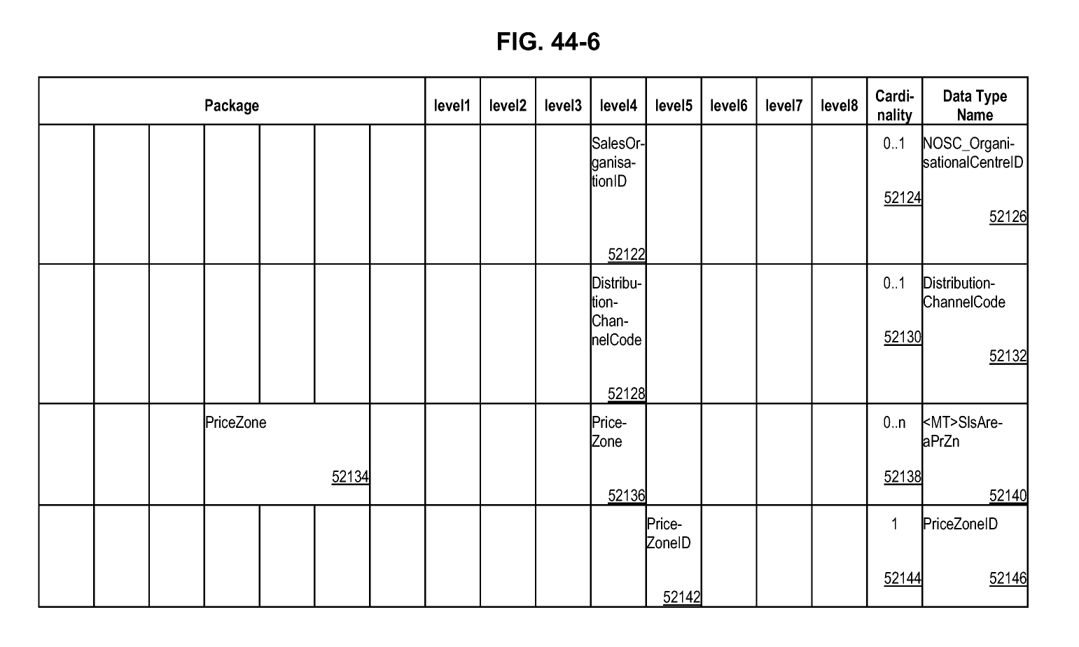

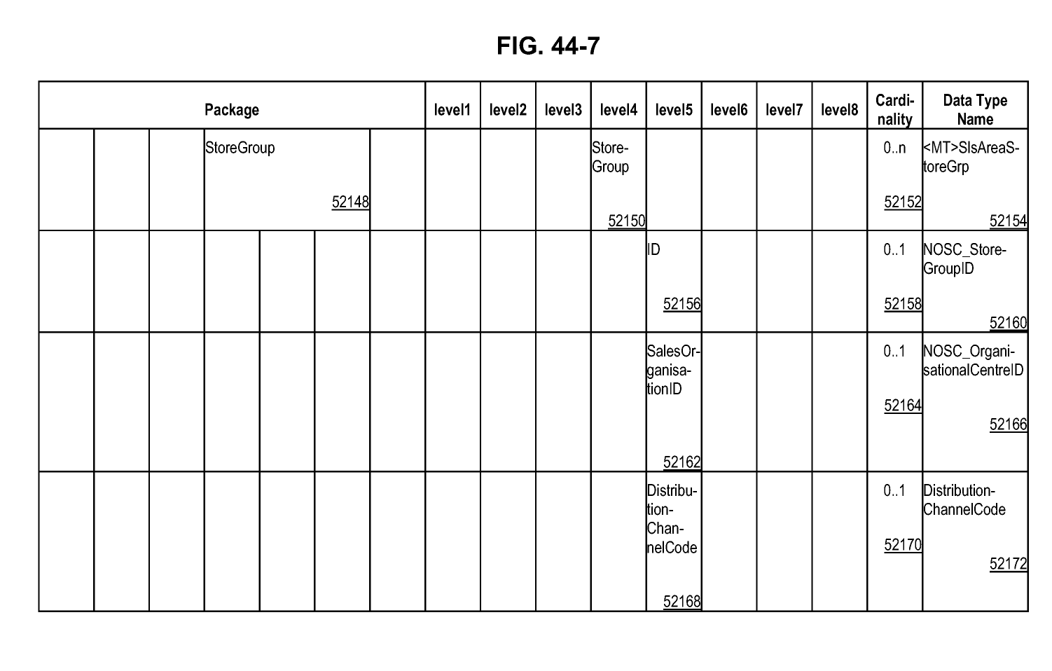

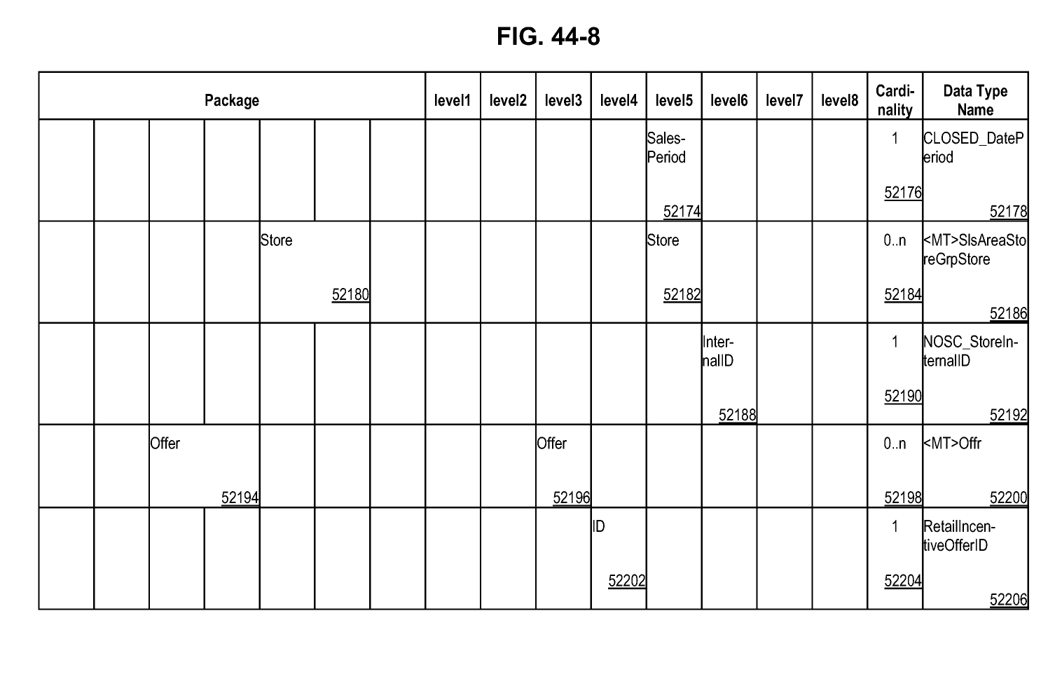

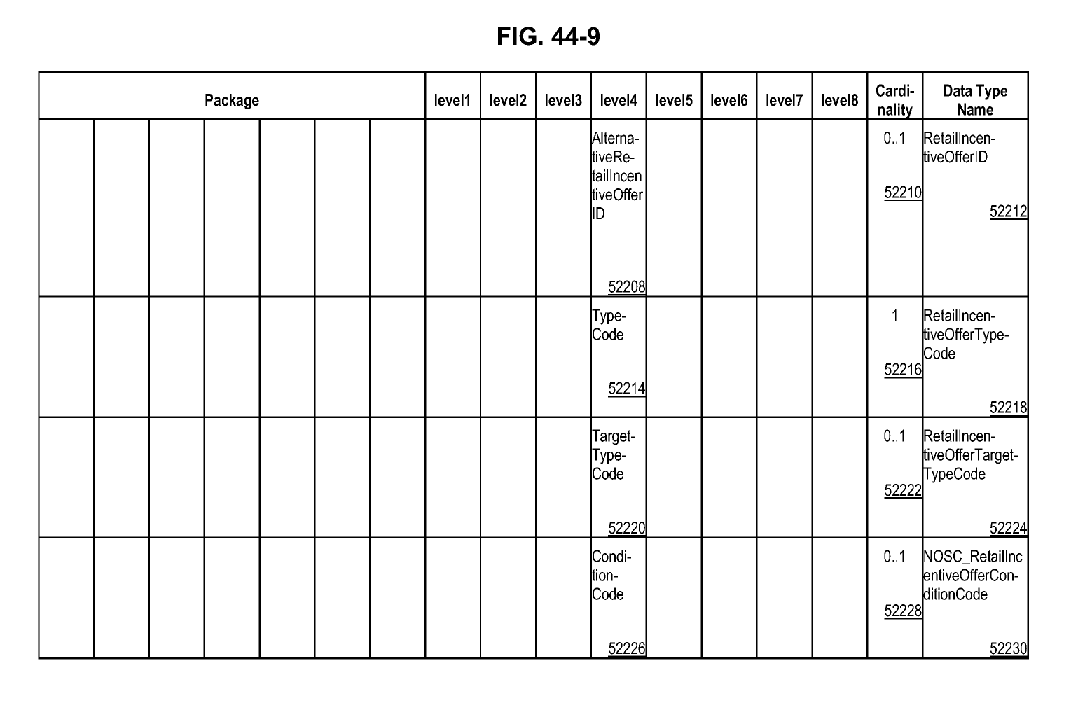

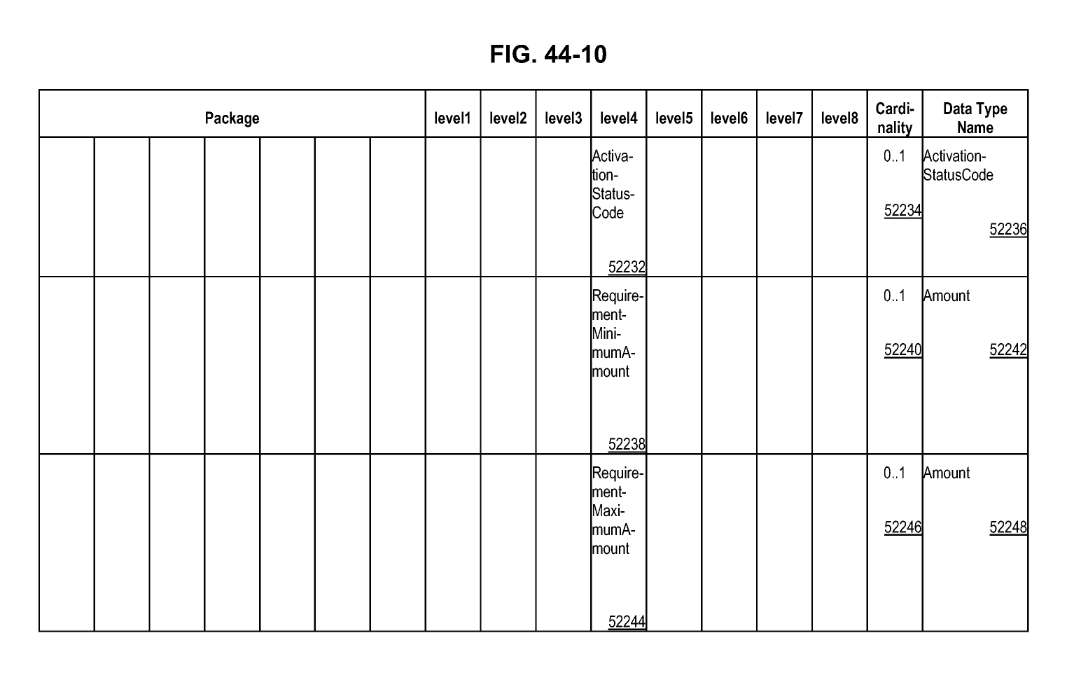

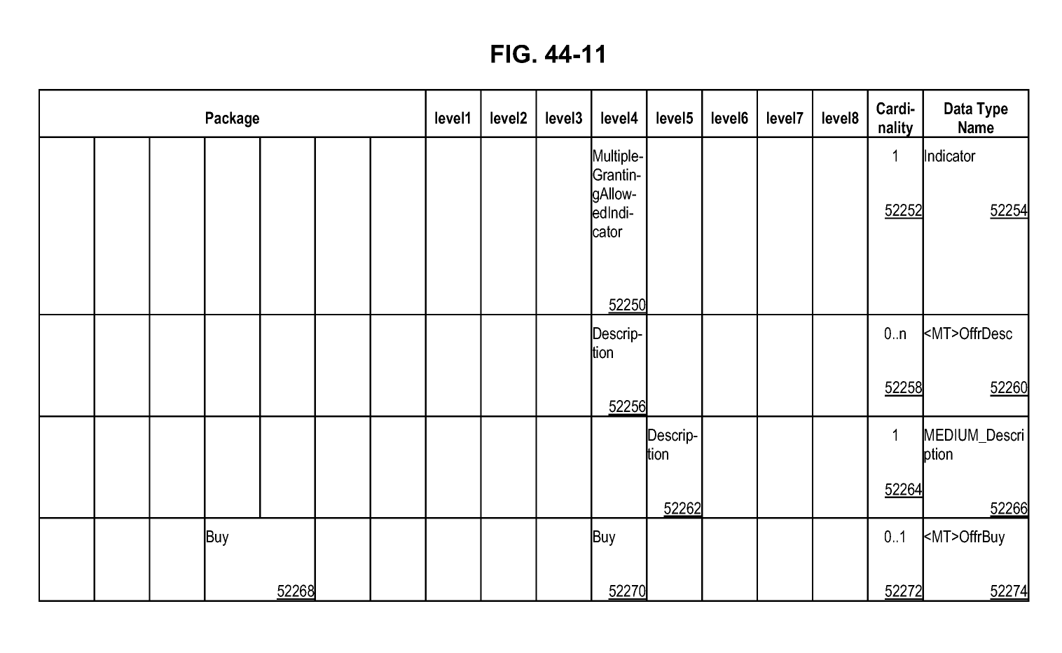

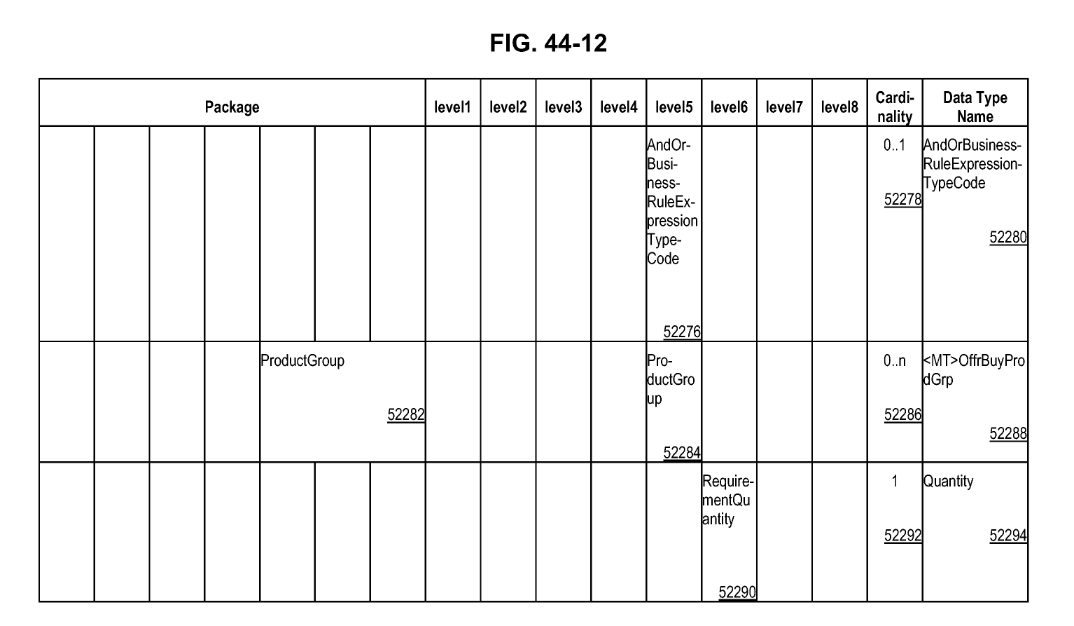

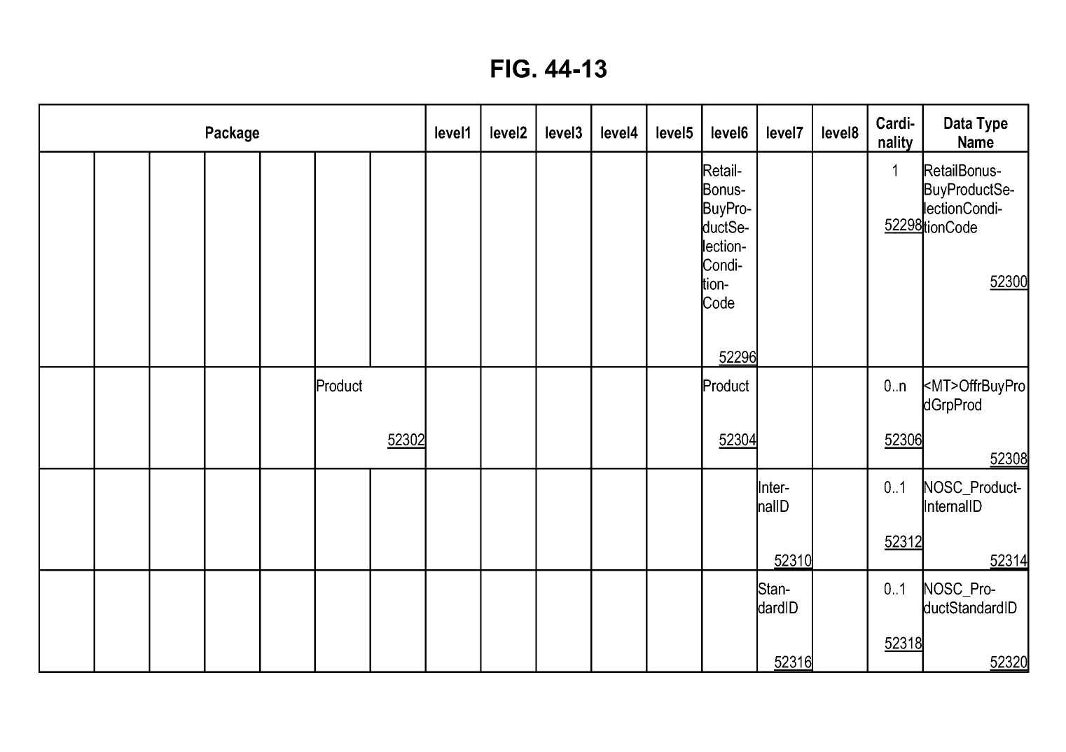

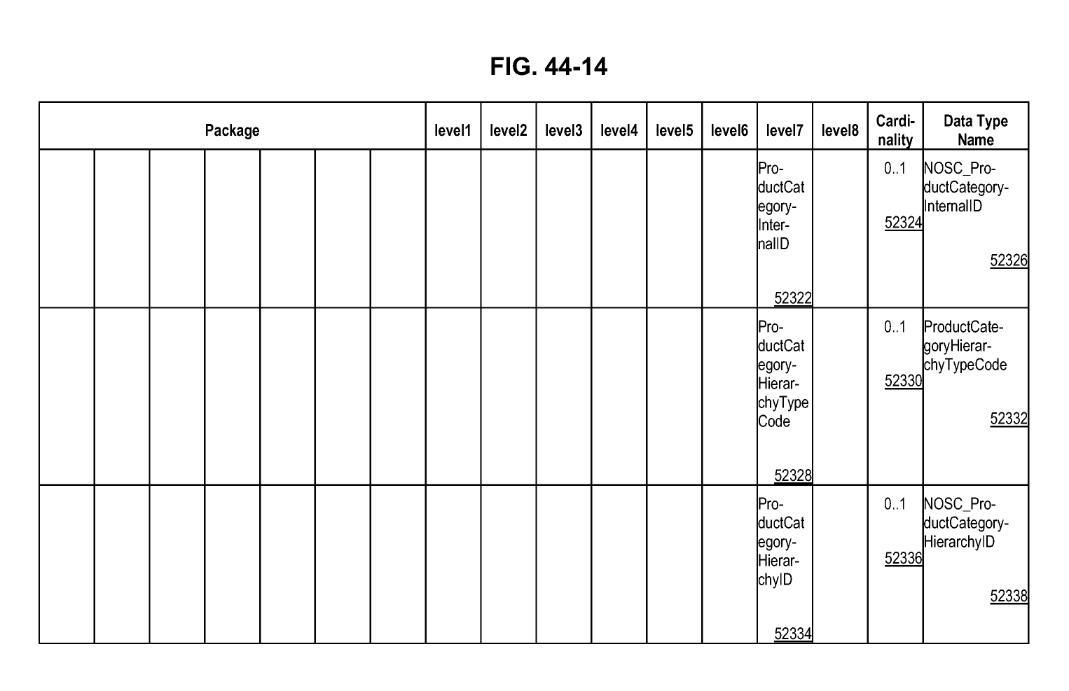

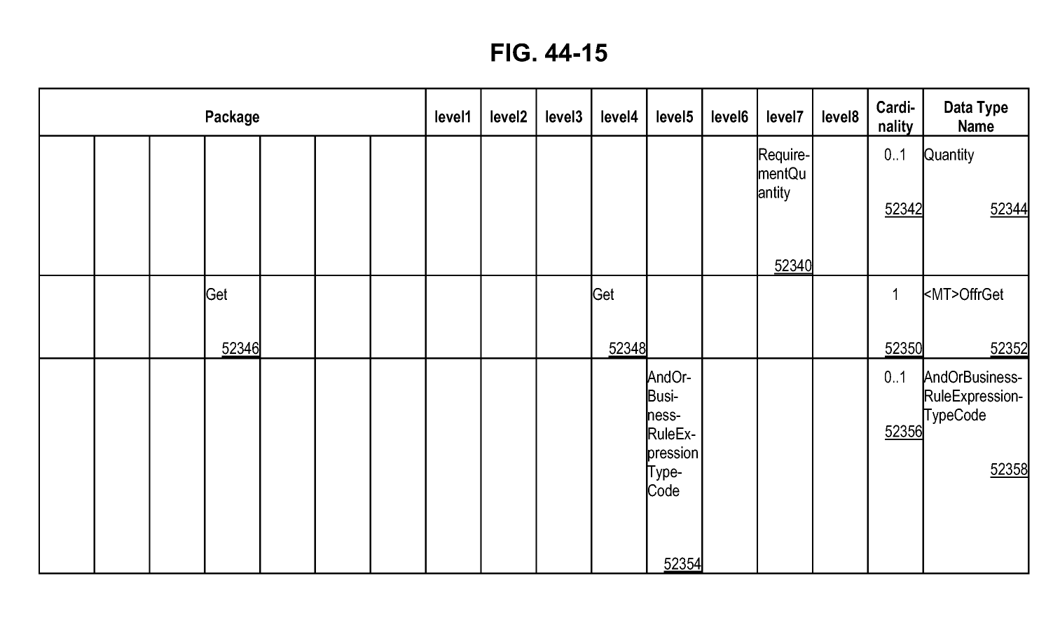

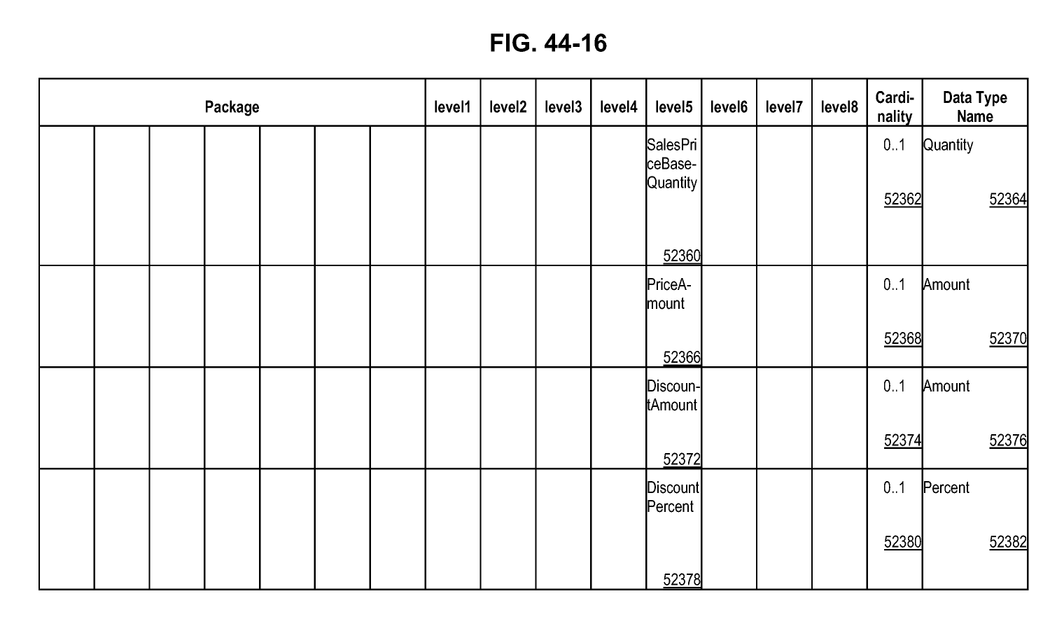

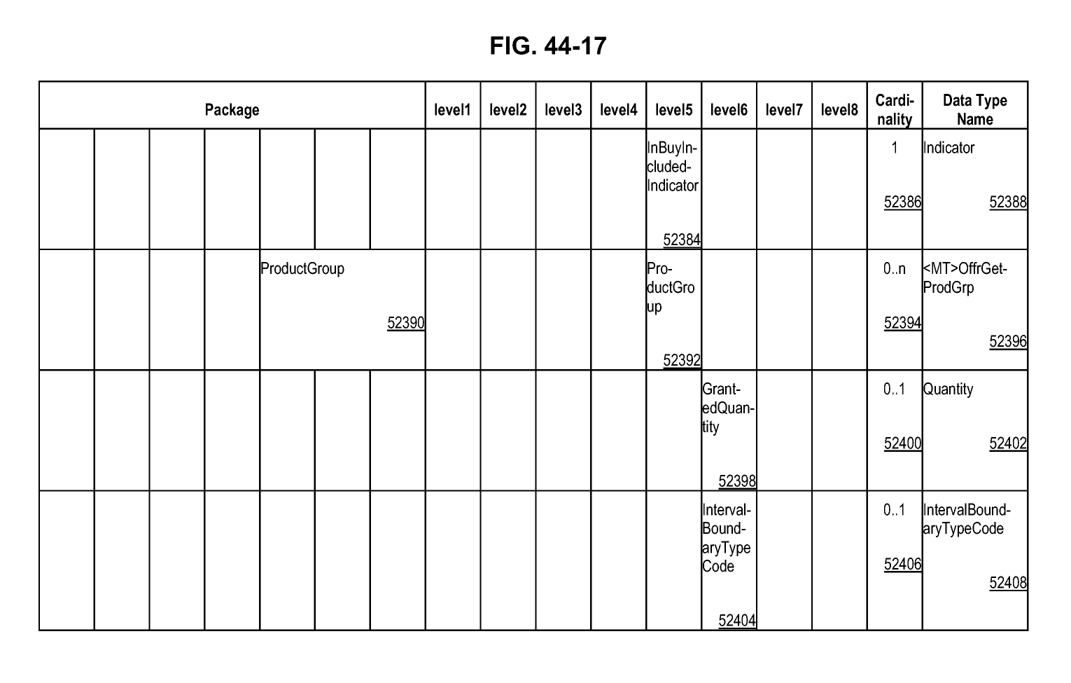

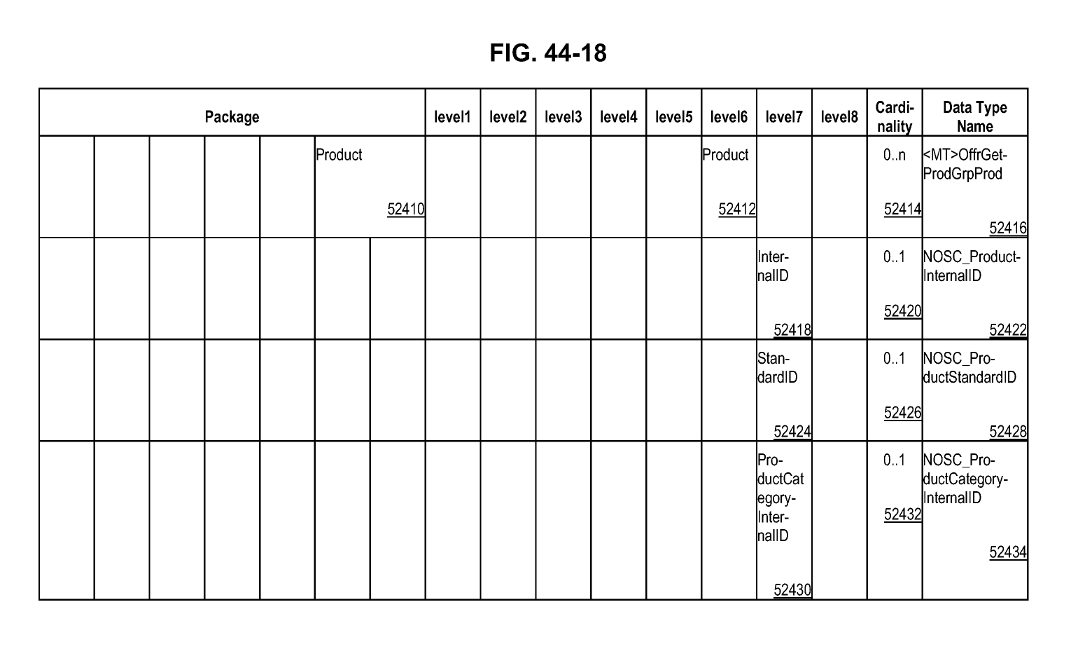

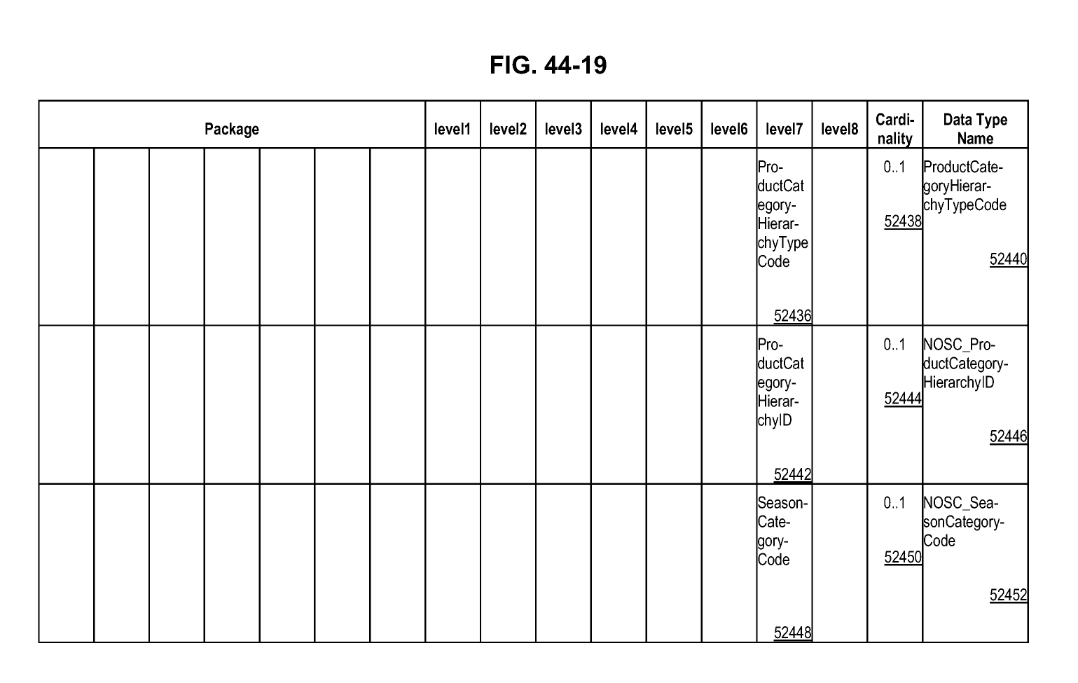

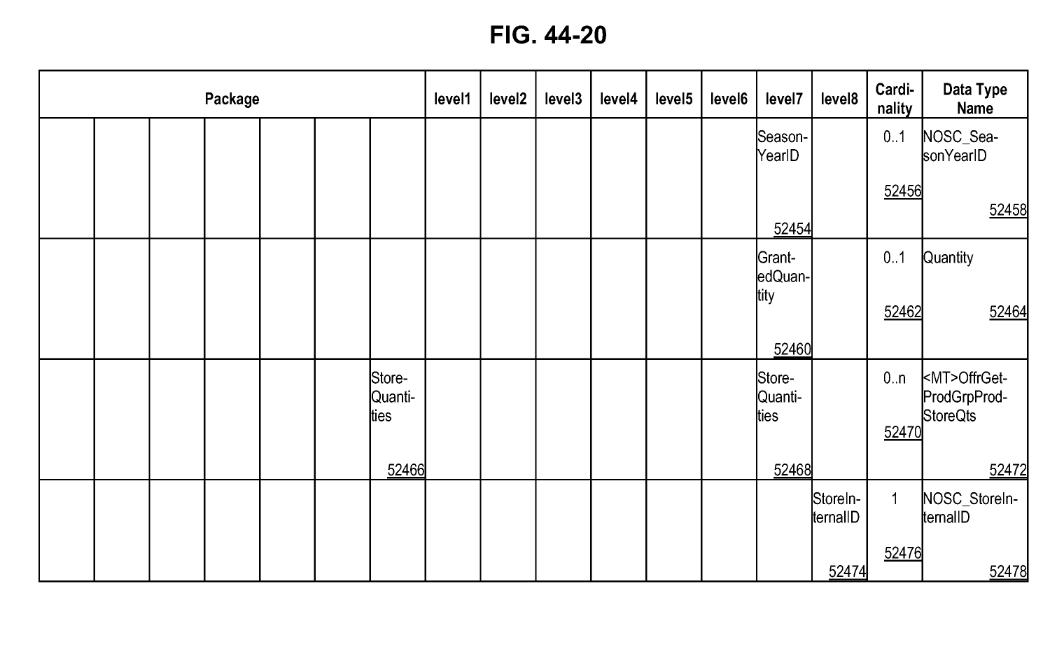

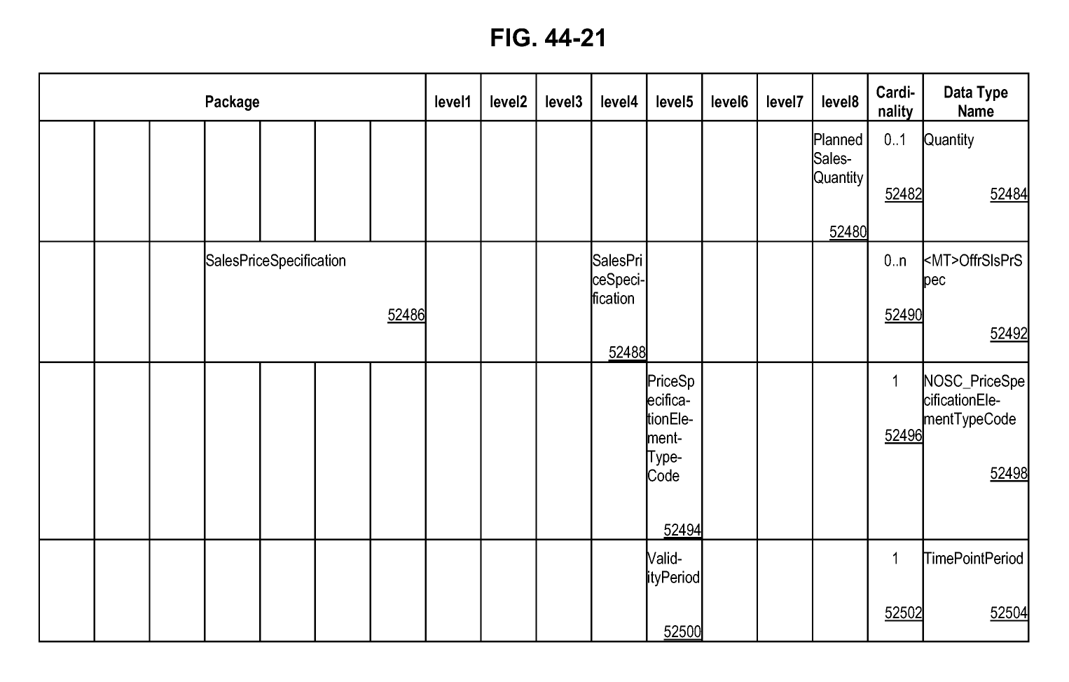

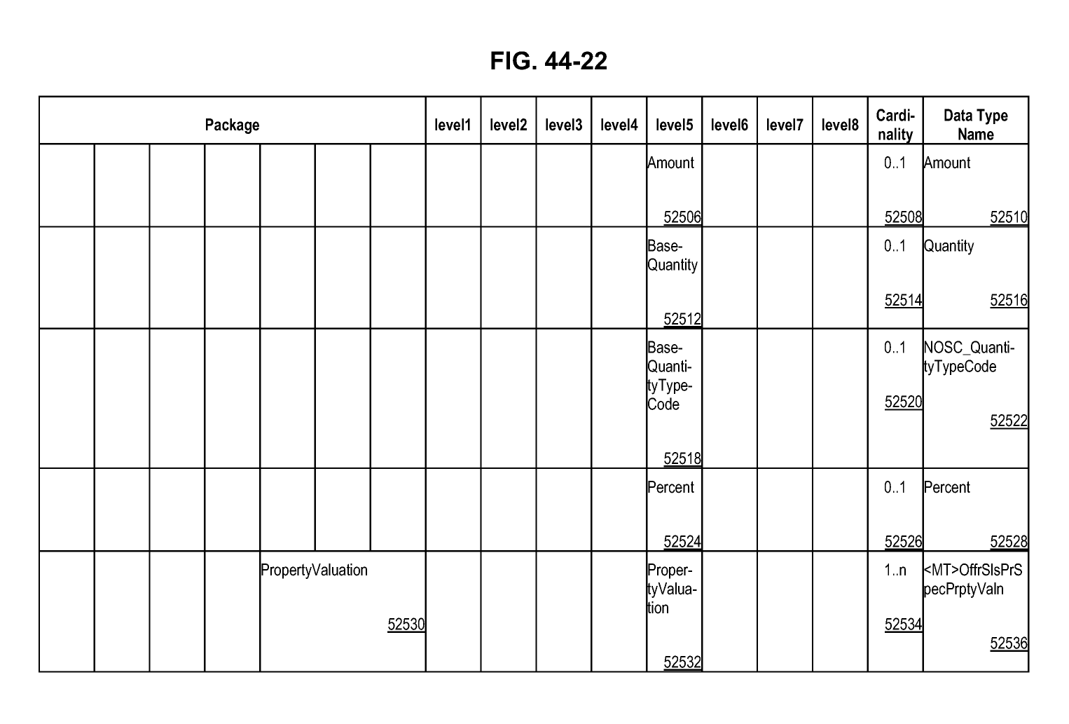

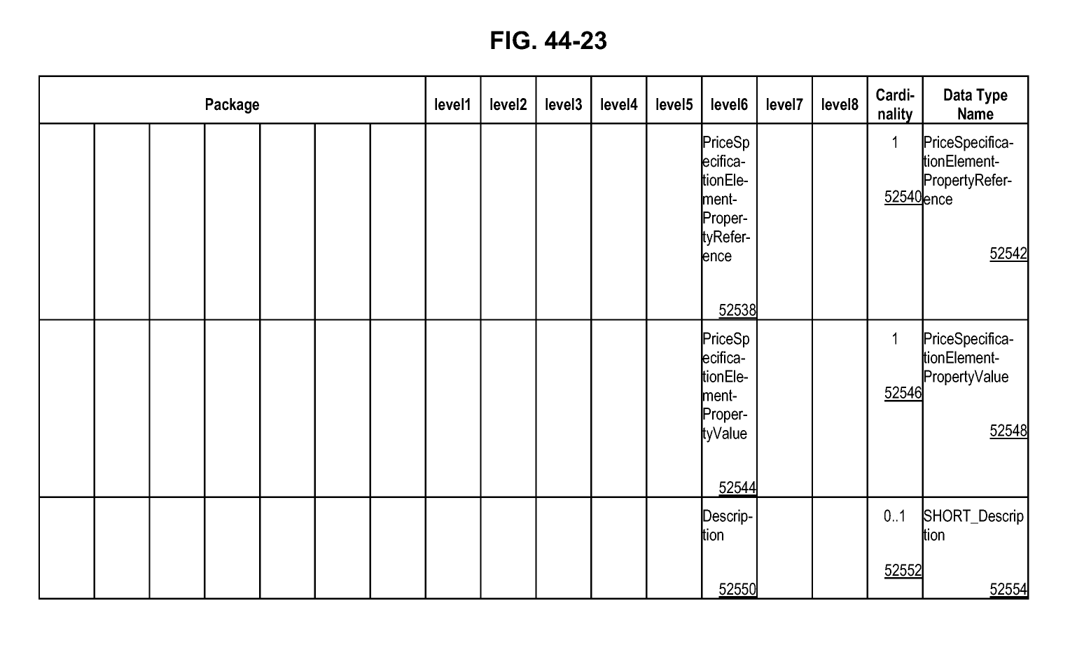

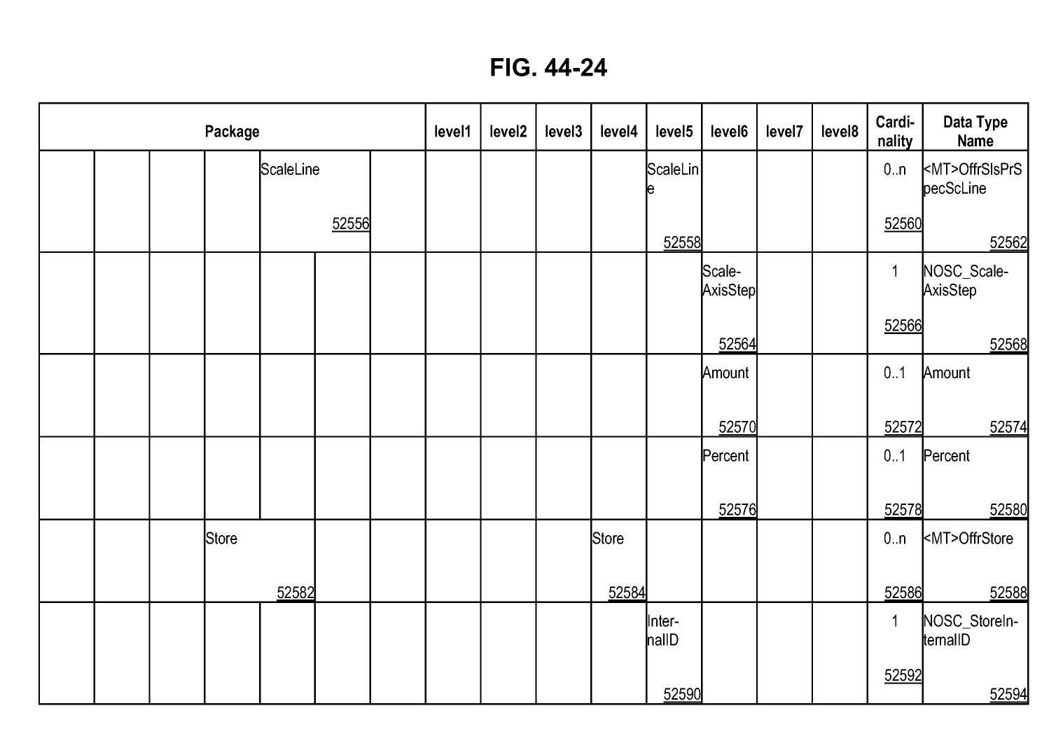

Additionally, FIGS. 44-1 through 44-24 show an example configuration of an Element Structure that includes a RetailEventERPStoreReplicationRequestMessage 52000 package. The RetailEventERPStoreReplicationRequestMessage 52000 package is a RtlEvtERPStoreRplctnReqMsg 52004 data type. The RetailEventERPStoreReplicationRequestMessage 52000 package includes a RetailEventERPStoreReplicationRequestMessage 52002 entity. The RetailEventERPStoreReplicationRequestMessage 52000 package includes various packages, namely a MessageHeader 52006 and a RetailEvent 52014.

The MessageHeader 52006 package is a BusinessDocumentMessageHeader 52012 data type. The MessageHeader 52006 package includes a MessageHeader 52008 entity. The MessageHeader 52008 entity has a cardinality of 1 52010 meaning that for each instance of the MessageHeader 52006 package there is one MessageHeader 52008 entity.

The RetailEvent 52014 package is an <MT>RtlEvtMT=RtlEvtERPStoreRplanReq 52020 data type. The RetailEvent 52014 package includes a RetailEvent 52016 entity. The RetailEvent 52014 package includes various packages, namely a ReceivingStore 52100, a SalesArea 52114 and an Offer 52194. The RetailEvent 52016 entity has a cardinality of 1 52018 meaning that for each instance of the RetailEvent 52014 package there is one RetailEvent 52016 entity. The RetailEvent 52016 entity includes various attributes, namely a @actionCode 52022, an ID 52028, a CompleteTransmissionIndicator 52034, a TypeCode 52040, a PlanningCurrencyCode 52046, a SalesPeriod 52052, a DataOriginTypeCode 52058, a RetailPredecessorTransactionID 52064, an AdvertisingMediumTypeCode 52070, a RetailEventTargetGroupTypeCode 52076 and a SalesPriceSpecificationLevelCode 52082. The RetailEvent 52016 entity includes a Description 52088 subordinate entity. The @actionCode 52022 attribute is an ActionCode 52026 data type. The @actionCode 52022 attribute has a cardinality of 0 . . . 1 52024 meaning that for each instance of the RetailEvent 52016 entity there may be one @actionCode 52022 attribute.

The ID 52028 attribute is a NOSC_RetailEventID 52032 data type. The ID 52028 attribute has a cardinality of 1 52030 meaning that for each instance of the RetailEvent 52016 entity there is one ID 52028 attribute. The CompleteTransmissionIndicator 52034 attribute is an Indicator 52038 data type. The CompleteTransmissionIndicator 52034 attribute has a cardinality of 1 52036 meaning that for each instance of the RetailEvent 52016 entity there is one CompleteTransmissionIndicator 52034 attribute. The TypeCode 52040 attribute is a RetailEventTypeCode 52044 data type. The TypeCode 52040 attribute has a cardinality of 0 . . . 1 52042 meaning that for each instance of the RetailEvent 52016 entity there may be one TypeCode 52040 attribute. The PlanningCurrencyCode 52046 attribute is a CurrencyCode 52050 data type. The PlanningCurrencyCode 52046 attribute has a cardinality of 0 . . . 1 52048 meaning that for each instance of the RetailEvent 52016 entity there may be one PlanningCurrencyCode 52046 attribute. The SalesPeriod 52052 attribute is a CLOSED_DatePeriod 52056 data type. The SalesPeriod 52052 attribute has a cardinality of 0 . . . 1 52054 meaning that for each instance of the RetailEvent 52016 entity there may be one SalesPeriod 52052 attribute. The DataOriginTypeCode 52058 attribute is a RetailIncentiveDataOriginTypeCode 52062 data type. The DataOriginTypeCode 52058 attribute has a cardinality of 0 . . . 1 52060 meaning that for each instance of the RetailEvent 52016 entity there may be one DataOriginTypeCode 52058 attribute. The RetailPredecessorTransactionID 52064 attribute is a NOSCRetailPredecessorTransactionID 52068 data type. The RetailPredecessorTransactionID 52064 attribute has a cardinality of 0 . . . 1 52066 meaning that for each instance of the RetailEvent 52016 entity there may be one RetailPredecessorTransactionID 52064 attribute. The AdvertisingMediumTypeCode 52070 attribute is an AdvertisingMediumTypeCode 52074 data type. The AdvertisingMediumTypeCode 52070 attribute has a cardinality of 0 . . . 1 52072 meaning that for each instance of the RetailEvent 52016 entity there may be one AdvertisingMediumTypeCode 52070 attribute. The RetailEventTargetGroupTypeCode 52076 attribute is a RetailEventTargetGroupTypeCode 52080 data type. The RetailEventTargetGroupTypeCode 52076 attribute has a cardinality of 0 . . . 1 52078 meaning that for each instance of the RetailEvent 52016 entity there may be one RetailEventTargetGroupTypeCode 52076 attribute. The SalesPriceSpecificationLevelCode 52082 attribute is a SalesPriceSpecificationLevelCode 52086 data type. The SalesPriceSpecificationLevelCode 52082 attribute has a cardinality of 0 . . . 1 52084 meaning that for each instance of the RetailEvent 52016 entity there may be one SalesPriceSpecificationLevelCode 52082 attribute. The Description 52088 entity has a cardinality of 0 . . . n 52090 meaning that for each instance of the RetailEvent 52016 entity there may be one or more Description 52088 entities. The Description 52088 entity includes a Description 52094 attribute. The Description 52094 attribute is a SHORT_Description 52098 data type. The Description 52094 attribute has a cardinality of 1 52096 meaning that for each instance of the Description 52088 entity there is one Description 52094 attribute.

The ReceivingStore 52100 package is an <MT>RcvgStore 52106 data type. The ReceivingStore 52100 package includes a ReceivingStore 52102 entity. The ReceivingStore 52102 entity has a cardinality of 0 . . . n 52104 meaning that for each instance of the ReceivingStore 52100 package there may be one or more ReceivingStore 52102 entities. The ReceivingStore 52102 entity includes a StoreInternalID 52108 attribute. The StoreInternalID 52108 attribute is a NOSC_StoreInternalID 52112 data type. The StoreInternalID 52108 attribute has a cardinality of 1 52110 meaning that for each instance of the ReceivingStore 52102 entity there is one StoreInternalID 52108 attribute. The SalesArea 52114 package is an <MT>SlsArea 52120 data type. The SalesArea 52114 package includes a SalesArea 52116 entity. The SalesArea 52114 package includes various packages, namely a PriceZone 52134 and a StoreGroup 52148. The SalesArea 52116 entity has a cardinality of 0 . . . 1 52118 meaning that for each instance of the SalesArea 52114 package there may be one SalesArea 52116 entity. The SalesArea 52116 entity includes various attributes, namely a SalesOrganisationID 52122 and a DistributionChannelCode 52128. The SalesOrganisationID 52122 attribute is a NOSC_OrganisationalCentreID 52126 data type. The SalesOrganisationID 52122 attribute has a cardinality of 0 . . . 1 52124 meaning that for each instance of the SalesArea 52116 entity there may be one SalesOrganisationID 52122 attribute. The DistributionChannelCode 52128 attribute is a DistributionChannelCode 52132 data type. The DistributionChannelCode 52128 attribute has a cardinality of 0 . . . 1 52130 meaning that for each instance of the SalesArea 52116 entity there may be one DistributionChannelCode 52128 attribute.

The PriceZone 52134 package is an <MT>SlsAreaPrZn 52140 data type. The PriceZone 52134 package includes a PriceZone 52136 entity. The PriceZone 52136 entity has a cardinality of 0 . . . n 52138 meaning that for each instance of the PriceZone 52134 package there may be one or more PriceZone 52136 entities. The PriceZone 52136 entity includes a PriceZoneID 52142 attribute. The PriceZoneID 52142 attribute is a PriceZoneID 52146 data type. The PriceZoneID 52142 attribute has a cardinality of 1 52144 meaning that for each instance of the PriceZone 52136 entity there is one PriceZoneID 52142 attribute.

The StoreGroup 52148 package is an <MT>SlsAreaStoreGrp 52154 data type. The StoreGroup 52148 package includes a StoreGroup 52150 entity. The StoreGroup 52148 package includes a Store 52180 package. The StoreGroup 52150 entity has a cardinality of 0 . . . n 52152 meaning that for each instance of the StoreGroup 52148 package there may be one or more StoreGroup 52150 entities. The StoreGroup 52150 entity includes various attributes, namely an ID 52156, a SalesOrganisationID 52162, a DistributionChannelCode 52168 and a SalesPeriod 52174. The ID 52156 attribute is a NOSC_StoreGroupID 52160 data type. The ID 52156 attribute has a cardinality of 0 . . . 1 52158 meaning that for each instance of the StoreGroup 52150 entity there may be one ID 52156 attribute. The SalesOrganisationID 52162 attribute is a NOSC_OrganisationalCentreID 52166 data type. The SalesOrganisationID 52162 attribute has a cardinality of 0 . . . 1 52164 meaning that for each instance of the StoreGroup 52150 entity there may be one SalesOrganisationID 52162 attribute. The DistributionChannelCode 52168 attribute is a DistributionChannelCode 52172 data type. The DistributionChannelCode 52168 attribute has a cardinality of 0 . . . 1 52170 meaning that for each instance of the StoreGroup 52150 entity there may be one DistributionChannelCode 52168 attribute. The SalesPeriod 52174 attribute is a CLOSED_DatePeriod 52178 data type. The SalesPeriod 52174 attribute has a cardinality of 1 52176 meaning that for each instance of the StoreGroup 52150 entity there is one SalesPeriod 52174 attribute.

The Store 52180 package is an <MT>SlsAreaStoreGrpStore 52186 data type. The Store 52180 package includes a Store 52182 entity. The Store 52182 entity has a cardinality of 0 . . . n 52184 meaning that for each instance of the Store 52180 package there may be one or more Store 52182 entities. The Store 52182 entity includes an InternalID 52188 attribute. The InternalID 52188 attribute is a NOSC_StoreInternalID 52192 data type. The InternalID 52188 attribute has a cardinality of 1 52190 meaning that for each instance of the Store 52182 entity there is one InternalID 52188 attribute.

The Offer 52194 package is an <MT>Offr 52200 data type. The Offer 52194 package includes an Offer 52196 entity. The Offer 52194 package includes various packages, namely a Buy 52268, a Get 52346, a SalesPriceSpecification 52486 and a Store 52582. The Offer 52196 entity has a cardinality of 0 . . . n 52198 meaning that for each instance of the Offer 52194 package there may be one or more Offer 52196 entities. The Offer 52196 entity includes various attributes, namely an ID 52202, an AlternativeRetailIncentiveOfferID 52208, a TypeCode 52214, a TargetTypeCode 52220, a ConditionCode 52226, an ActivationStatusCode 52232, a RequirementMinimumAmount 52238, a RequirementMaximumAmount 52244 and a MultipleGrantingAllowedIndicator 52250. The Offer 52196 entity includes a Description 52256 subordinate entity. The ID 52202 attribute is a RetailIncentiveOfferID 52206 data type. The ID 52202 attribute has a cardinality of 1 52204 meaning that for each instance of the Offer 52196 entity there is one ID 52202 attribute. The AlternativeRetailIncentiveOfferID 52208 attribute is a RetailIncentiveOfferID 52212 data type. The AlternativeRetailIncentiveOfferID 52208 attribute has a cardinality of 0 . . . 1 52210 meaning that for each instance of the Offer 52196 entity there may be one AlternativeRetailIncentiveOfferID 52208 attribute. The TypeCode 52214 attribute is a RetailIncentiveOfferTypeCode 52218 data type. The TypeCode 52214 attribute has a cardinality of 1 52216 meaning that for each instance of the Offer 52196 entity there is one TypeCode 52214 attribute. The TargetTypeCode 52220 attribute is a RetailIncentiveOfferTargetTypeCode 52224 data type. The TargetTypeCode 52220 attribute has a cardinality of 0 . . . 1 52222 meaning that for each instance of the Offer 52196 entity there may be one TargetTypeCode 52220 attribute. The ConditionCode 52226 attribute is a NOSC_RetailIncentiveOfferConditionCode 52230 data type. The ConditionCode 52226 attribute has a cardinality of 0 . . . 1 52228 meaning that for each instance of the Offer 52196 entity there may be one ConditionCode 52226 attribute. The ActivationStatusCode 52232 attribute is an ActivationStatusCode 52236 data type. The ActivationStatusCode 52232 attribute has a cardinality of 0 . . . 1 52234 meaning that for each instance of the Offer 52196 entity there may be one ActivationStatusCode 52232 attribute. The RequirementMinimumAmount 52238 attribute is an Amount 52242 data type. The RequirementMinimumAmount 52238 attribute has a cardinality of 0 . . . 1 52240 meaning that for each instance of the Offer 52196 entity there may be one RequirementMinimumAmount 52238 attribute. The RequirementMaximumAmount 52244 attribute is an Amount 52248 data type. The RequirementMaximumAmount 52244 attribute has a cardinality of 0 . . . 1 52246 meaning that for each instance of the Offer 52196 entity there may be one RequirementMaximumAmount 52244 attribute. The MultipleGrantingAllowedIndicator 52250 attribute is an Indicator 52254 data type. The MultipleGrantingAllowedIndicator 52250 attribute has a cardinality of 1 52252 meaning that for each instance of the Offer 52196 entity there is one MultipleGrantingAllowedIndicator 52250 attribute. The Description 52256 entity has a cardinality of 0 . . . n 52258 meaning that for each instance of the Offer 52196 entity there may be one or more Description 52256 entities. The Description 52256 entity includes a Description 52262 attribute. The Description 52262 attribute is a MEDIUM_Description 52266 data type. The Description 52262 attribute has a cardinality of 1 52264 meaning that for each instance of the Description 52256 entity there is one Description 52262 attribute.

The Buy 52268 package is an <MT>OffrBuy 52274 data type. The Buy 52268 package includes a Buy 52270 entity. The Buy 52268 package includes a ProductGroup 52282 package.

The Buy 52270 entity has a cardinality of 0 . . . 1 52272 meaning that for each instance of the Buy 52268 package there may be one Buy 52270 entity. The Buy 52270 entity includes an AndOrBusinessRuleExpressionTypeCode 52276 attribute. The AndOrBusinessRuleExpressionTypeCode 52276 attribute is an AndOrBusinessRuleExpressionTypeCode 52280 data type. The AndOrBusinessRuleExpressionTypeCode 52276 attribute has a cardinality of 0 . . . 1 52278 meaning that for each instance of the Buy 52270 entity there may be one AndOrBusinessRuleExpressionTypeCode 52276 attribute.

The ProductGroup 52282 package is an <MT>OffrBuyProdGrp 52288 data type. The ProductGroup 52282 package includes a ProductGroup 52284 entity. The ProductGroup 52282 package includes a Product 52302 package. The ProductGroup 52284 entity has a cardinality of 0 . . . n 52286 meaning that for each instance of the ProductGroup 52282 package there may be one or more ProductGroup 52284 entities. The ProductGroup 52284 entity includes various attributes, namely a RequirementQuantity 52290 and a RetailBonusBuyProductSelectionConditionCode 52296. The RequirementQuantity 52290 attribute is a Quantity 52294 data type. The RequirementQuantity 52290 attribute has a cardinality of 1 52292 meaning that for each instance of the ProductGroup 52284 entity there is one RequirementQuantity 52290 attribute. The RetailBonusBuyProductSelectionConditionCode 52296 attribute is a RetailBonusBuyProductSelectionConditionCode 52300 data type. The RetailBonusBuyProductSelectionConditionCode 52296 attribute has a cardinality of 1 52298 meaning that for each instance of the ProductGroup 52284 entity there is one RetailBonusBuyProductSelectionConditionCode 52296 attribute.

The Product 52302 package is an <MT>OffrBuyProdGrpProd 52308 data type. The Product 52302 package includes a Product 52304 entity. The Product 52304 entity has a cardinality of 0 . . . n 52306 meaning that for each instance of the Product 52302 package there may be one or more Product 52304 entities. The Product 52304 entity includes various attributes, namely an InternalID 52310, a StandardID 52316, a ProductCategoryInternalID 52322, a ProductCategoryHierarchyTypeCode 52328, a ProductCategoryHierarchyID 52334 and a RequirementQuantity 52340. The InternalID 52310 attribute is a NOSC_ProductInternalID 52314 data type. The InternalID 52310 attribute has a cardinality of 0 . . . 1 52312 meaning that for each instance of the Product 52304 entity there may be one InternalID 52310 attribute. The StandardID 52316 attribute is a NOSC_ProductStandardID 52320 data type. The StandardID 52316 attribute has a cardinality of 0 . . . 1 52318 meaning that for each instance of the Product 52304 entity there may be one StandardID 52316 attribute. The ProductCategoryInternalID 52322 attribute is a NOSC_ProductCategoryInternalID 52326 data type. The ProductCategoryInternalID 52322 attribute has a cardinality of 0 . . . 1 52324 meaning that for each instance of the Product 52304 entity there may be one ProductCategoryInternalID 52322 attribute. The ProductCategoryHierarchyTypeCode 52328 attribute is a ProductCategoryHierarchyTypeCode 52332 data type. The ProductCategoryHierarchyTypeCode 52328 attribute has a cardinality of 0 . . . 1 52330 meaning that for each instance of the Product 52304 entity there may be one ProductCategoryHierarchyTypeCode 52328 attribute. The ProductCategoryHierarchyID 52334 attribute is a NOSC_ProductCategoryHierarchyID 52338 data type. The ProductCategoryHierarchyID 52334 attribute has a cardinality of 0 . . . 1 52336 meaning that for each instance of the Product 52304 entity there may be one ProductCategoryHierarchyID 52334 attribute. The RequirementQuantity 52340 attribute is a Quantity 52344 data type. The RequirementQuantity 52340 attribute has a cardinality of 0 . . . 1 52342 meaning that for each instance of the Product 52304 entity there may be one RequirementQuantity 52340 attribute.

The Get 52346 package is an <MT>OffrGet 52352 data type. The Get 52346 package includes a Get 52348 entity. The Get 52346 package includes a ProductGroup 52390 package. The Get 52348 entity has a cardinality of 1 52350 meaning that for each instance of the Get 52346 package there is one Get 52348 entity. The Get 52348 entity includes various attributes, namely an AndOrBusinessRuleExpressionTypeCode 52354, a SalesPriceBaseQuantity 52360, a PriceAmount 52366, a DiscountAmount 52372, a DiscountPercent 52378 and an InBuyIncludedIndicator 52384. The AndOrBusinessRuleExpressionTypeCode 52354 attribute is an AndOrBusinessRuleExpressionTypeCode 52358 data type. The AndOrBusinessRuleExpressionTypeCode 52354 attribute has a cardinality of 0 . . . 1 52356 meaning that for each instance of the Get 52348 entity there may be one AndOrBusinessRuleExpressionTypeCode 52354 attribute. The SalesPriceBaseQuantity 52360 attribute is a Quantity 52364 data type. The SalesPriceBaseQuantity 52360 attribute has a cardinality of 0 . . . 1 52362 meaning that for each instance of the Get 52348 entity there may be one SalesPriceBaseQuantity 52360 attribute. The PriceAmount 52366 attribute is an Amount 52370 data type. The PriceAmount 52366 attribute has a cardinality of 0 . . . 1 52368 meaning that for each instance of the Get 52348 entity there may be one PriceAmount 52366 attribute. The DiscountAmount 52372 attribute is an Amount 52376 data type. The DiscountAmount 52372 attribute has a cardinality of 0 . . . 1 52374 meaning that for each instance of the Get 52348 entity there may be one DiscountAmount 52372 attribute. The DiscountPercent 52378 attribute is a Percent 52382 data type. The DiscountPercent 52378 attribute has a cardinality of 0 . . . 1 52380 meaning that for each instance of the Get 52348 entity there may be one DiscountPercent 52378 attribute. The InBuyIncludedIndicator 52384 attribute is an Indicator 52388 data type. The InBuyIncludedIndicator 52384 attribute has a cardinality of 1 52386 meaning that for each instance of the Get 52348 entity there is one InBuyIncludedIndicator 52384 attribute.

The ProductGroup 52390 package is an <MT>OffrGetProdGrp 52396 data type. The ProductGroup 52390 package includes a ProductGroup 52392 entity. The ProductGroup 52390 package includes a Product 52410 package. The ProductGroup 52392 entity has a cardinality of 0 . . . n 52394 meaning that for each instance of the ProductGroup 52390 package there may be one or more ProductGroup 52392 entities. The ProductGroup 52392 entity includes various attributes, namely a GrantedQuantity 52398 and an IntervalBoundaryTypeCode 52404. The GrantedQuantity 52398 attribute is a Quantity 52402 data type. The GrantedQuantity 52398 attribute has a cardinality of 0 . . . 1 52400 meaning that for each instance of the ProductGroup 52392 entity there may be one GrantedQuantity 52398 attribute. The IntervalBoundaryTypeCode 52404 attribute is an IntervalBoundaryTypeCode 52408 data type. The IntervalBoundaryTypeCode 52404 attribute has a cardinality of 0 . . . 1 52406 meaning that for each instance of the ProductGroup 52392 entity there may be one IntervalBoundaryTypeCode 52404 attribute.

The Product 52410 package is an <MT>OffrGetProdGrpProd 52416 data type. The Product 52410 package includes a Product 52412 entity. The Product 52410 package includes a StoreQuantities 52466 package. The Product 52412 entity has a cardinality of 0 . . . n 52414 meaning that for each instance of the Product 52410 package there may be one or more Product 52412 entities. The Product 52412 entity includes various attributes, namely an InternalID 52418, a StandardID 52424, a ProductCategoryInternalID 52430, a ProductCategoryHierarchyTypeCode 52436, a ProductCategoryHierarchyID 52442, a SeasonCategoryCode 52448, a SeasonYearID 52454 and a GrantedQuantity 52460. The InternalID 52418 attribute is a NOSC_ProductInternalID 52422 data type. The InternalID 52418 attribute has a cardinality of 0 . . . 1 52420 meaning that for each instance of the Product 52412 entity there may be one InternalID 52418 attribute. The StandardID 52424 attribute is a NOSC_ProductStandardID 52428 data type. The StandardID 52424 attribute has a cardinality of 0 . . . 1 52426 meaning that for each instance of the Product 52412 entity there may be one StandardID 52424 attribute. The ProductCategoryInternalID 52430 attribute is a NOSC_ProductCategoryInternalID 52434 data type. The ProductCategoryInternalID 52430 attribute has a cardinality of 0 . . . 1 52432 meaning that for each instance of the Product 52412 entity there may be one ProductCategoryInternalID 52430 attribute. The ProductCategoryHierarchyTypeCode 52436 attribute is a ProductCategoryHierarchyTypeCode 52440 data type. The ProductCategoryHierarchyTypeCode 52436 attribute has a cardinality of 0 . . . 1 52438 meaning that for each instance of the Product 52412 entity there may be one ProductCategoryHierarchyTypeCode 52436 attribute. The ProductCategoryHierarchyID 52442 attribute is a NOSC_ProductCategoryHierarchyID 52446 data type. The ProductCategoryHierarchyID 52442 attribute has a cardinality of 0 . . . 1 52444 meaning that for each instance of the Product 52412 entity there may be one ProductCategoryHierarchyID 52442 attribute. The SeasonCategoryCode 52448 attribute is a NOSC_SeasonCategoryCode 52452 data type. The SeasonCategoryCode 52448 attribute has a cardinality of 0 . . . 1 52450 meaning that for each instance of the Product 52412 entity there may be one SeasonCategoryCode 52448 attribute. The SeasonYearID 52454 attribute is a NOSC_SeasonYearID 52458 data type. The SeasonYearID 52454 attribute has a cardinality of 0 . . . 1 52456 meaning that for each instance of the Product 52412 entity there may be one SeasonYearID 52454 attribute. The GrantedQuantity 52460 attribute is a Quantity 52464 data type. The GrantedQuantity 52460 attribute has a cardinality of 0 . . . 1 52462 meaning that for each instance of the Product 52412 entity there may be one GrantedQuantity 52460 attribute.

The StoreQuantities 52466 package is an <MT>OffrGetProdGrpProdStoreQts 52472 data type. The StoreQuantities 52466 package includes a StoreQuantities 52468 entity. The StoreQuantities 52468 entity has a cardinality of 0 . . . n 52470 meaning that for each instance of the StoreQuantities 52466 package there may be one or more StoreQuantities 52468 entities. The StoreQuantities 52468 entity includes various attributes, namely a StoreInternalID 52474 and a PlannedSalesQuantity 52480. The StoreInternalID 52474 attribute is a NOSC_StoreInternalID 52478 data type. The StoreInternalID 52474 attribute has a cardinality of 1 52476 meaning that for each instance of the StoreQuantities 52468 entity there is one StoreInternalID 52474 attribute. The PlannedSalesQuantity 52480 attribute is a Quantity 52484 data type. The PlannedSalesQuantity 52480 attribute has a cardinality of 0 . . . 1 52482 meaning that for each instance of the StoreQuantities 52468 entity there may be one PlannedSalesQuantity 52480 attribute.

The SalesPriceSpecification 52486 package is an <MT>OffrSlsPrSpec 52492 data type. The SalesPriceSpecification 52486 package includes a SalesPriceSpecification 52488 entity. The SalesPriceSpecification 52486 package includes various packages, namely a PropertyValuation 52530 and a ScaleLine 52556. The SalesPriceSpecification 52488 entity has a cardinality of 0 . . . n 52490 meaning that for each instance of the SalesPriceSpecification 52486 package there may be one or more SalesPriceSpecification 52488 entities. The SalesPriceSpecification 52488 entity includes various attributes, namely a PriceSpecificationElementTypeCode 52494, a ValidityPeriod 52500, an Amount 52506, a BaseQuantity 52512, a BaseQuantityTypeCode 52518 and a Percent 52524. The PriceSpecificationElementTypeCode 52494 attribute is a NOSC_PriceSpecificationElementTypeCode 52498 data type. The PriceSpecificationElementTypeCode 52494 attribute has a cardinality of 1 52496 meaning that for each instance of the SalesPriceSpecification 52488 entity there is one PriceSpecificationElementTypeCode 52494 attribute. The ValidityPeriod 52500 attribute is a TimePointPeriod 52504 data type. The ValidityPeriod 52500 attribute has a cardinality of 1 52502 meaning that for each instance of the SalesPriceSpecification 52488 entity there is one ValidityPeriod 52500 attribute. The Amount 52506 attribute is an Amount 52510 data type. The Amount 52506 attribute has a cardinality of 0 . . . 1 52508 meaning that for each instance of the SalesPriceSpecification 52488 entity there may be one Amount 52506 attribute. The BaseQuantity 52512 attribute is a Quantity 52516 data type. The BaseQuantity 52512 attribute has a cardinality of 0 . . . 1 52514 meaning that for each instance of the SalesPriceSpecification 52488 entity there may be one BaseQuantity 52512 attribute. The BaseQuantityTypeCode 52518 attribute is a NOSC_QuantityTypeCode 52522 data type. The BaseQuantityTypeCode 52518 attribute has a cardinality of 0 . . . 1 52520 meaning that for each instance of the SalesPriceSpecification 52488 entity there may be one BaseQuantityTypeCode 52518 attribute. The Percent 52524 attribute is a Percent 52528 data type. The Percent 52524 attribute has a cardinality of 0 . . . 1 52526 meaning that for each instance of the SalesPriceSpecification 52488 entity there may be one Percent 52524 attribute.

The PropertyValuation 52530 package is an <MT>OffrSlsPrSpecPrptyValn 52536 data type. The PropertyValuation 52530 package includes a PropertyValuation 52532 entity. The PropertyValuation 52532 entity has a cardinality of 1 . . . n 52534 meaning that for each instance of the PropertyValuation 52530 package there are one or more PropertyValuation 52532 entities. The PropertyValuation 52532 entity includes various attributes, namely a PriceSpecificationElementPropertyReference 52538, a PriceSpecificationElementPropertyValue 52544 and a Description 52550. The PriceSpecificationElementPropertyReference 52538 attribute is a PriceSpecificationElementPropertyReference 52542 data type. The PriceSpecificationElementPropertyReference 52538 attribute has a cardinality of 1 52540 meaning that for each instance of the PropertyValuation 52532 entity there is one PriceSpecificationElementPropertyReference 52538 attribute. The PriceSpecificationElementPropertyValue 52544 attribute is a PriceSpecificationElementPropertyValue 52548 data type. The PriceSpecificationElementPropertyValue 52544 attribute has a cardinality of 1 52546 meaning that for each instance of the PropertyValuation 52532 entity there is one PriceSpecificationElementPropertyValue 52544 attribute. The Description 52550 attribute is a SHORT_Description 52554 data type. The Description 52550 attribute has a cardinality of 0 . . . 1 52552 meaning that for each instance of the PropertyValuation 52532 entity there may be one Description 52550 attribute.

The ScaleLine 52556 package is an <MT>OffrSlsPrSpecScLine 52562 data type. The ScaleLine 52556 package includes a ScaleLine 52558 entity. The ScaleLine 52558 entity has a cardinality of 0 . . . n 52560 meaning that for each instance of the ScaleLine 52556 package there may be one or more ScaleLine 52558 entities. The ScaleLine 52558 entity includes various attributes, namely a ScaleAxisStep 52564, an Amount 52570 and a Percent 52576. The ScaleAxisStep 52564 attribute is a NOSC_ScaleAxisStep 52568 data type. The ScaleAxisStep 52564 attribute has a cardinality of 1 52566 meaning that for each instance of the ScaleLine 52558 entity there is one ScaleAxisStep 52564 attribute. The Amount 52570 attribute is an Amount 52574 data type. The Amount 52570 attribute has a cardinality of 0 . . . 1 52572 meaning that for each instance of the ScaleLine 52558 entity there may be one Amount 52570 attribute. The Percent 52576 attribute is a Percent 52580 data type. The Percent 52576 attribute has a cardinality of 0 . . . 1 52578 meaning that for each instance of the ScaleLine 52558 entity there may be one Percent 52576 attribute.

The Store 52582 package is an <MT>OffrStore 52588 data type. The Store 52582 package includes a Store 52584 entity. The Store 52584 entity has a cardinality of 0 . . . n 52586 meaning that for each instance of the Store 52582 package there may be one or more Store 52584 entities. The Store 52584 entity includes an InternalID 52590 attribute. The InternalID 52590 attribute is a NOSC_StoreInternalID 52594 data type. The InternalID 52590 attribute has a cardinality of 1 52592 meaning that for each instance of the Store 52584 entity there is one InternalID 52590 attribute.

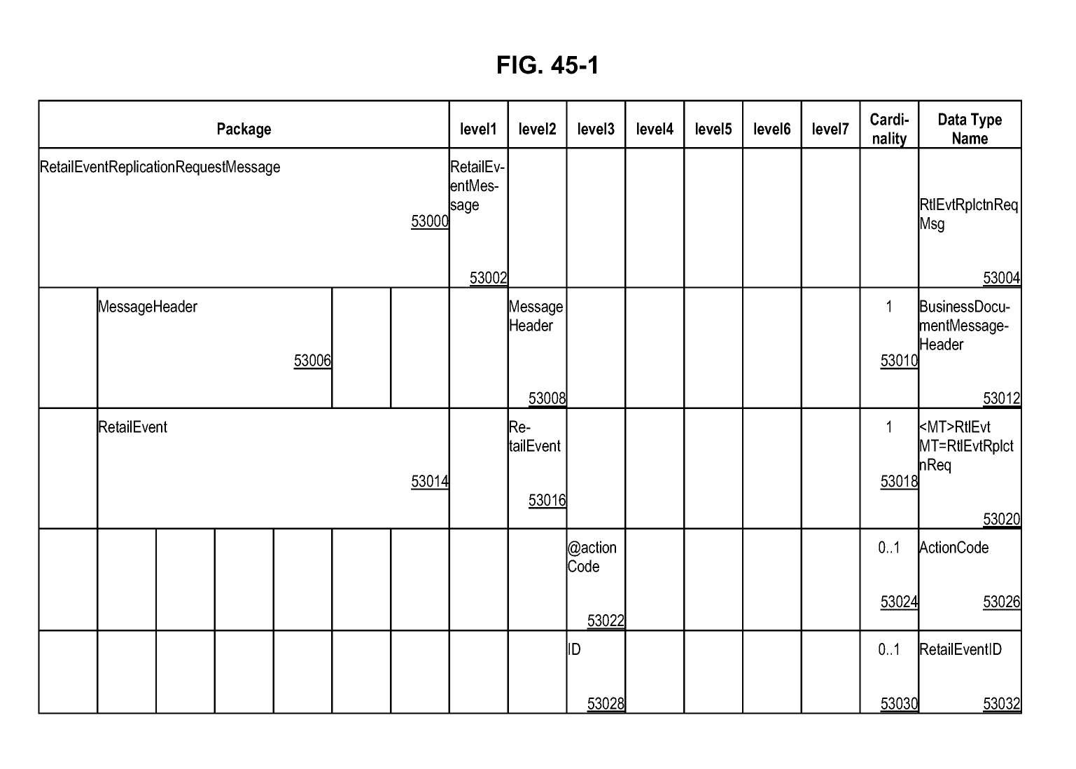

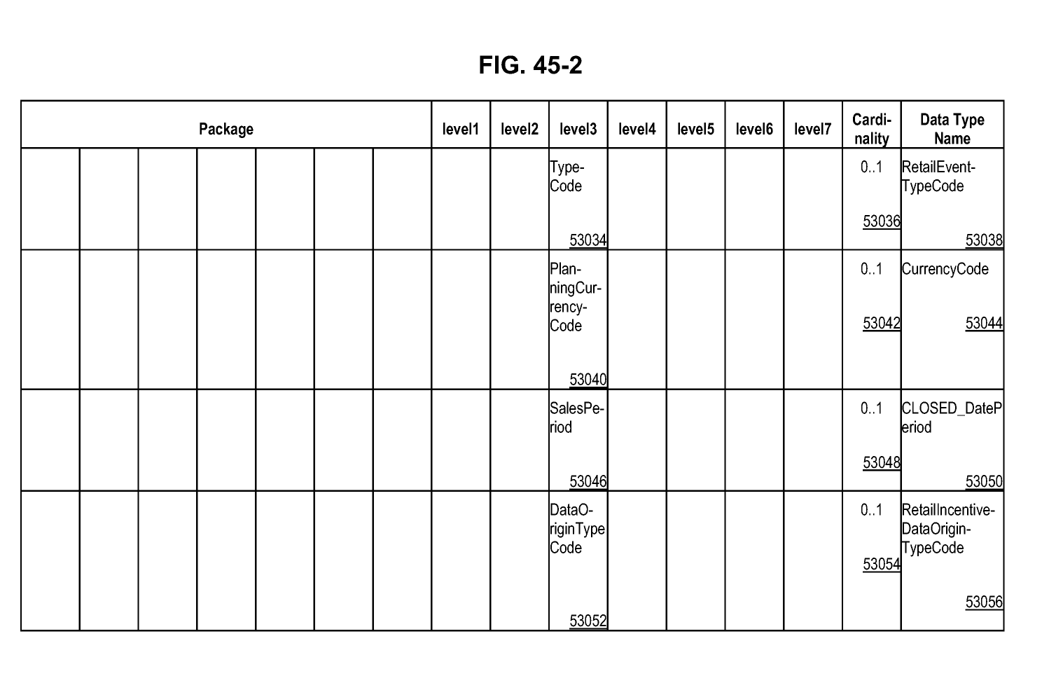

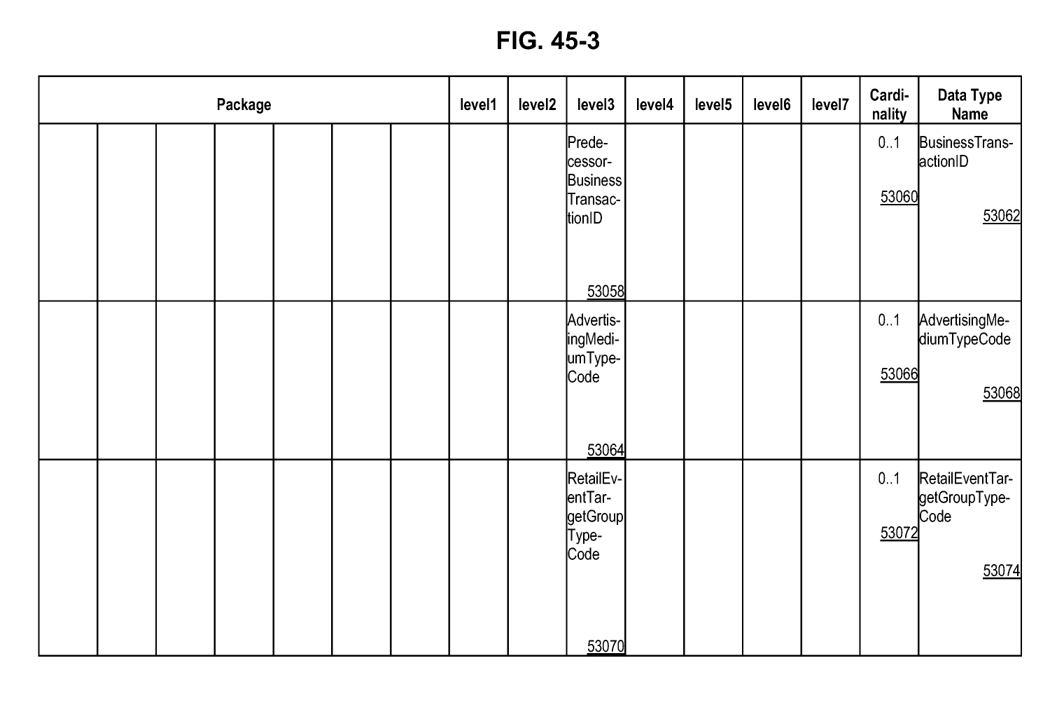

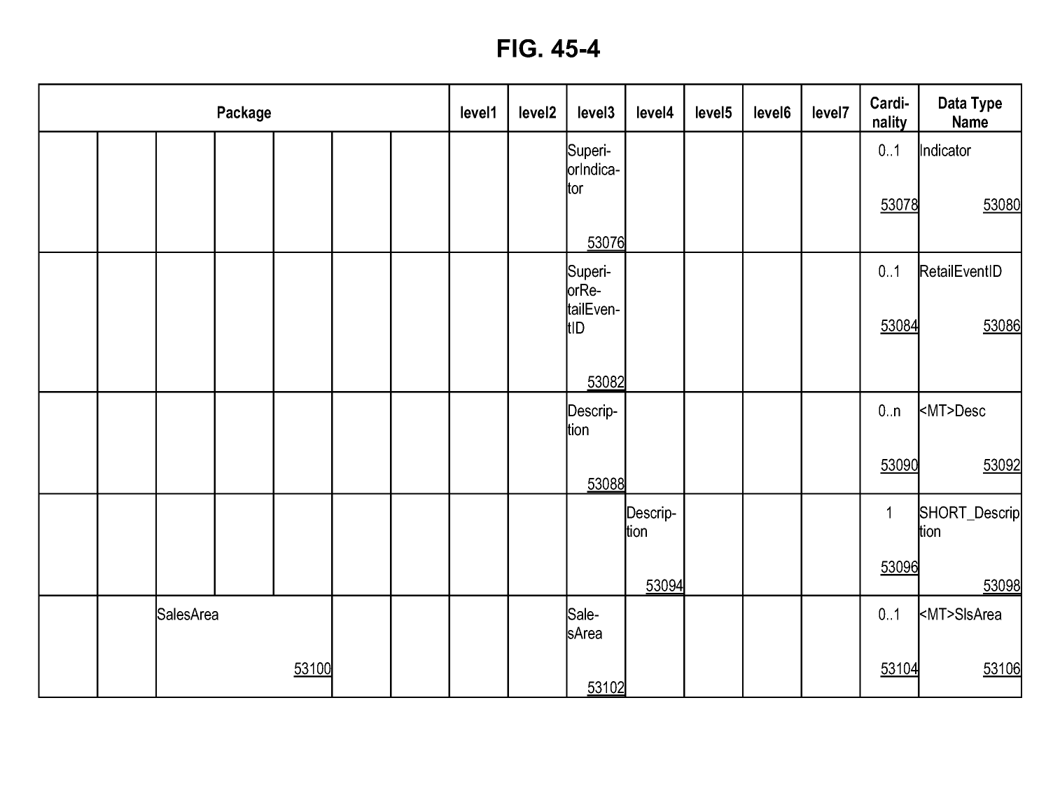

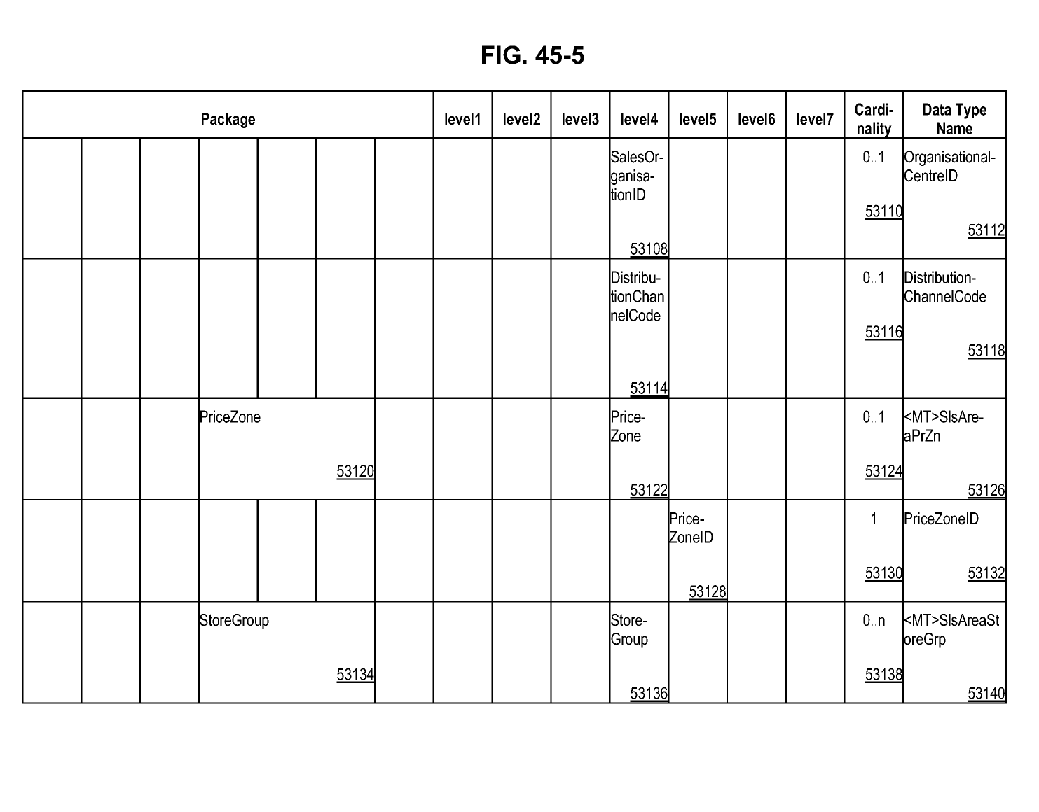

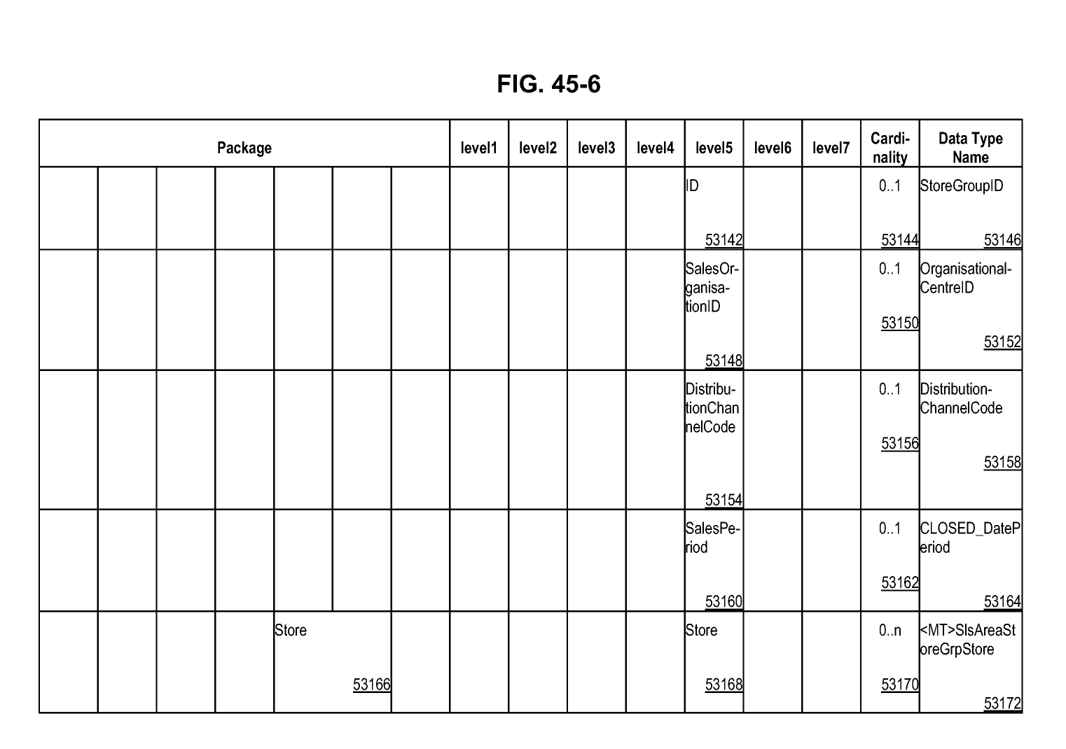

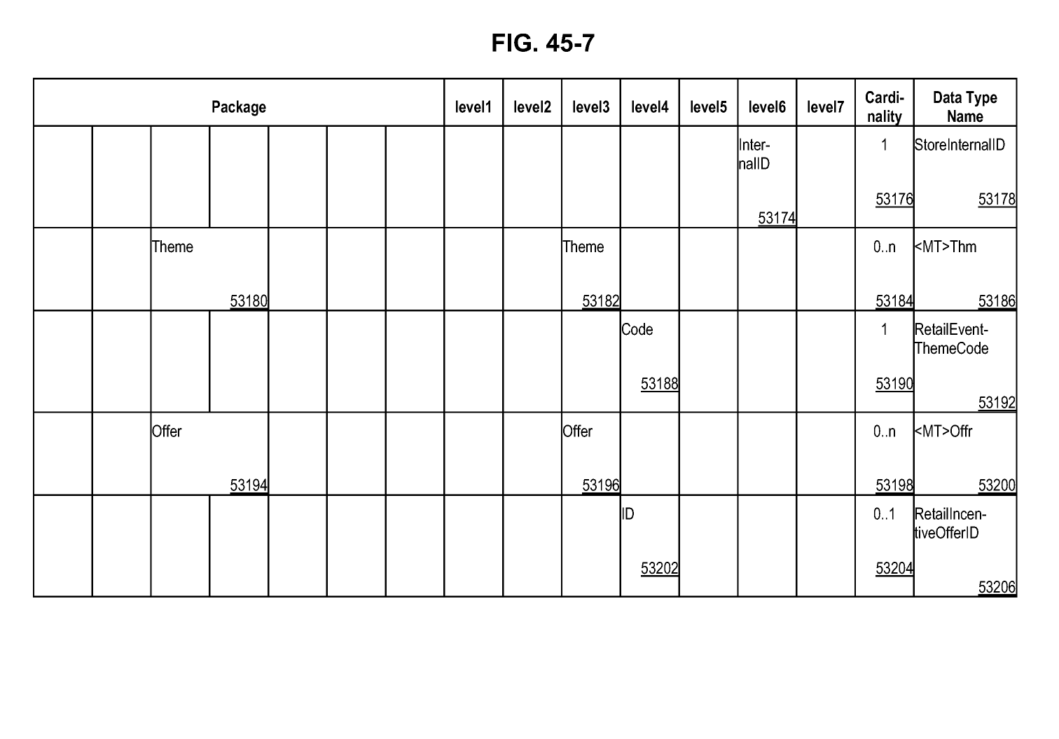

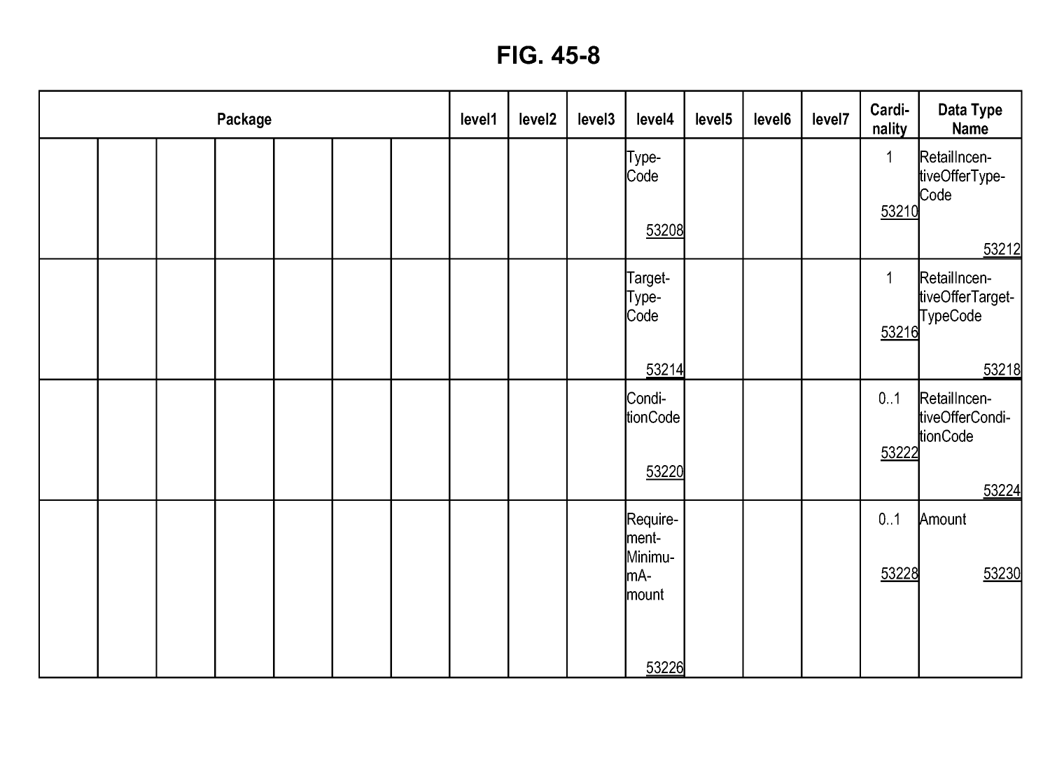

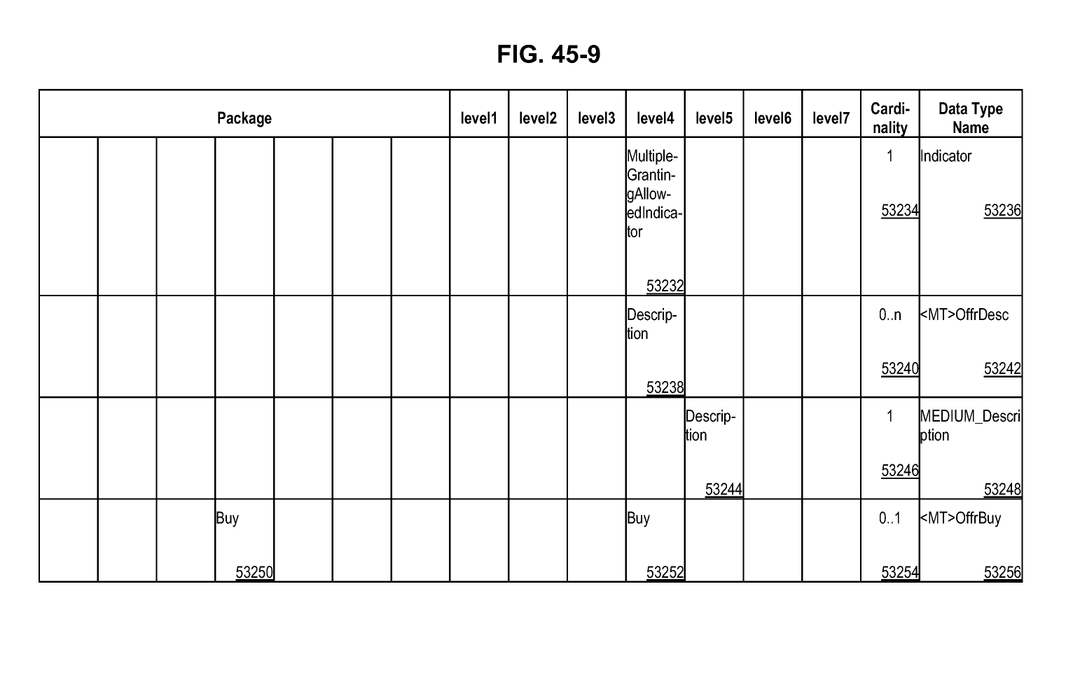

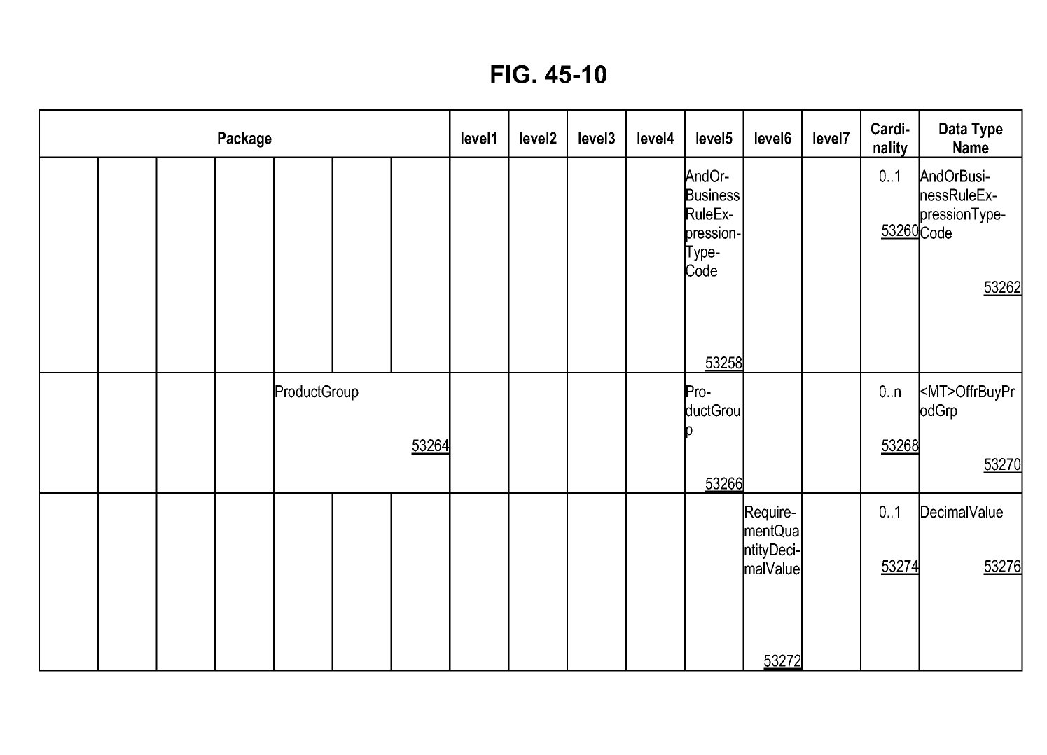

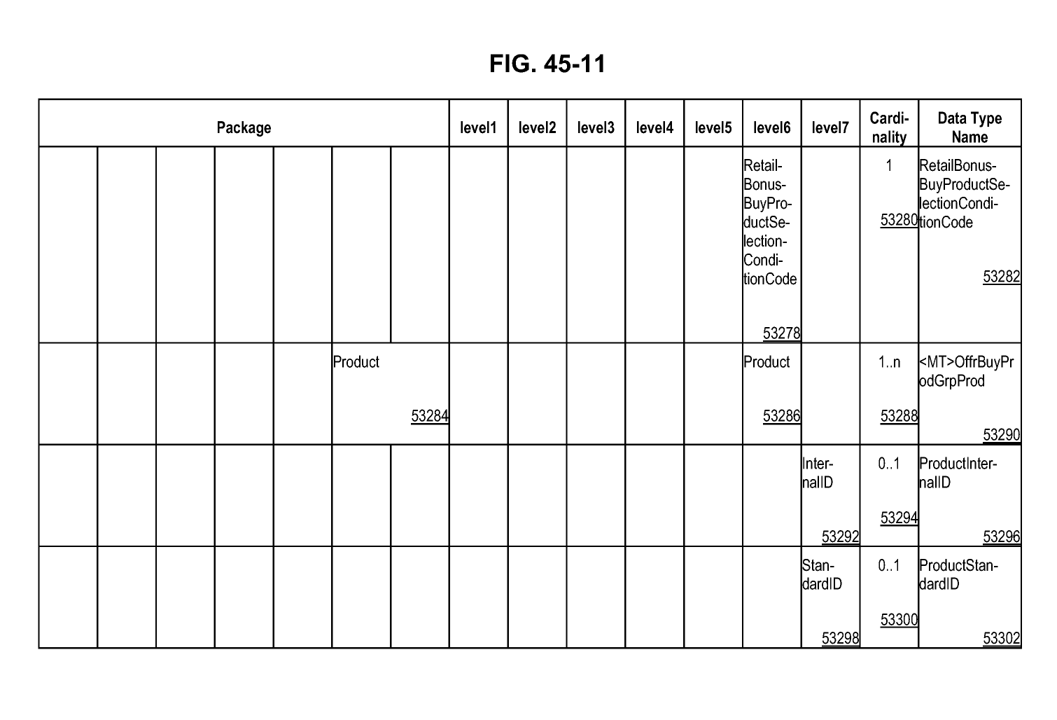

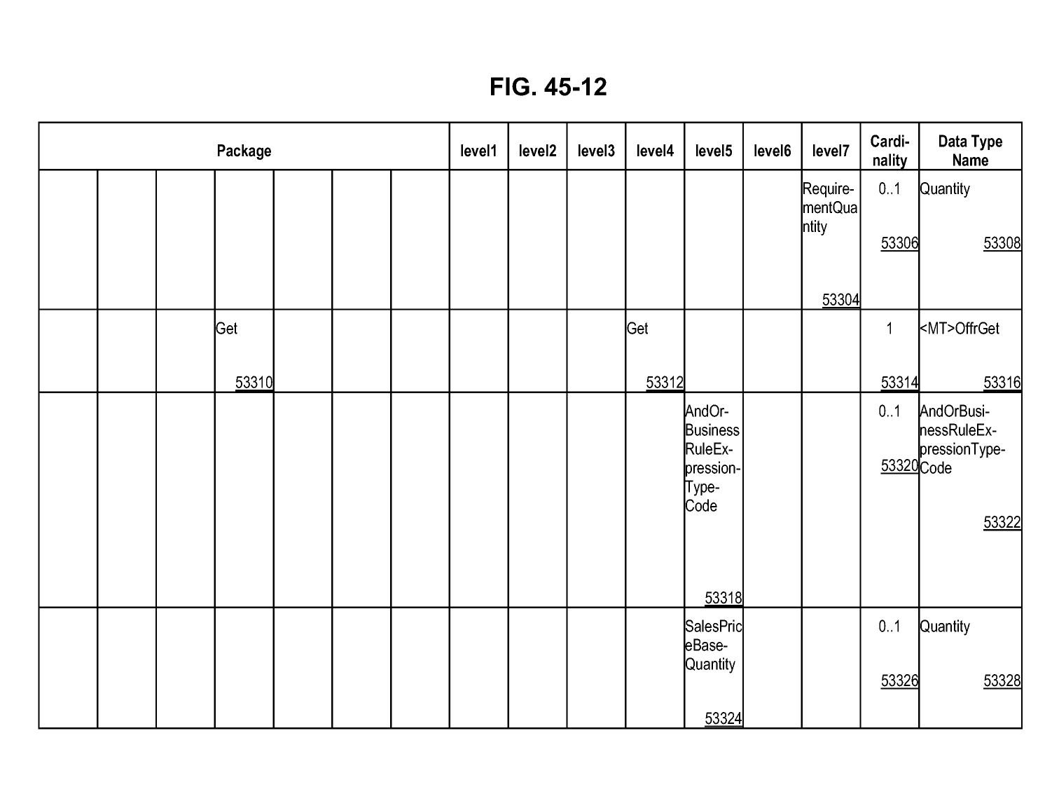

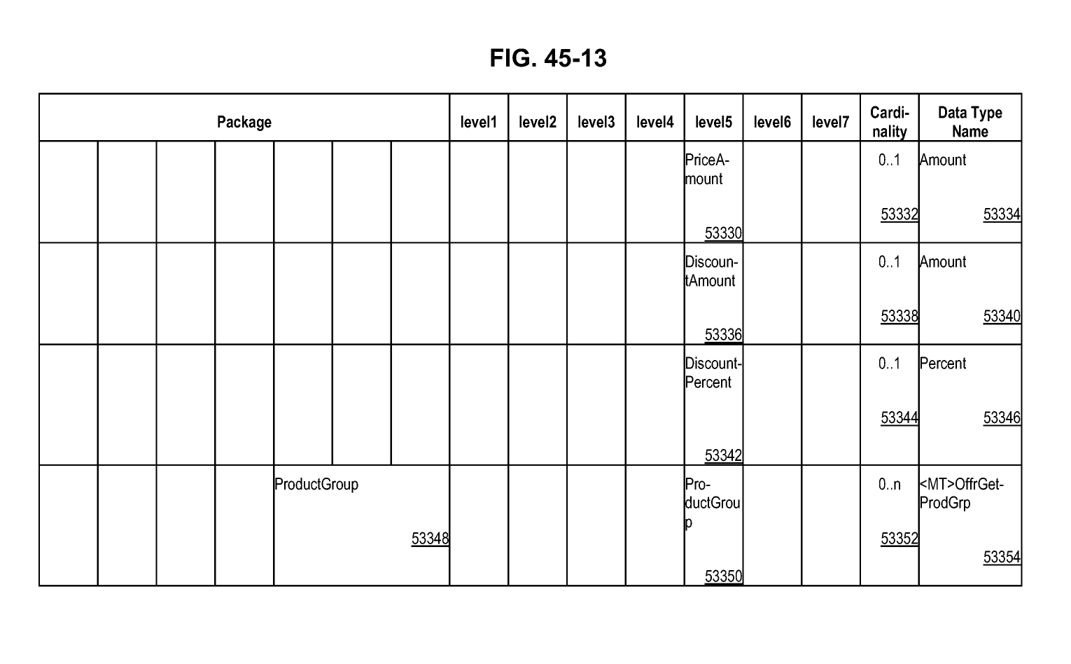

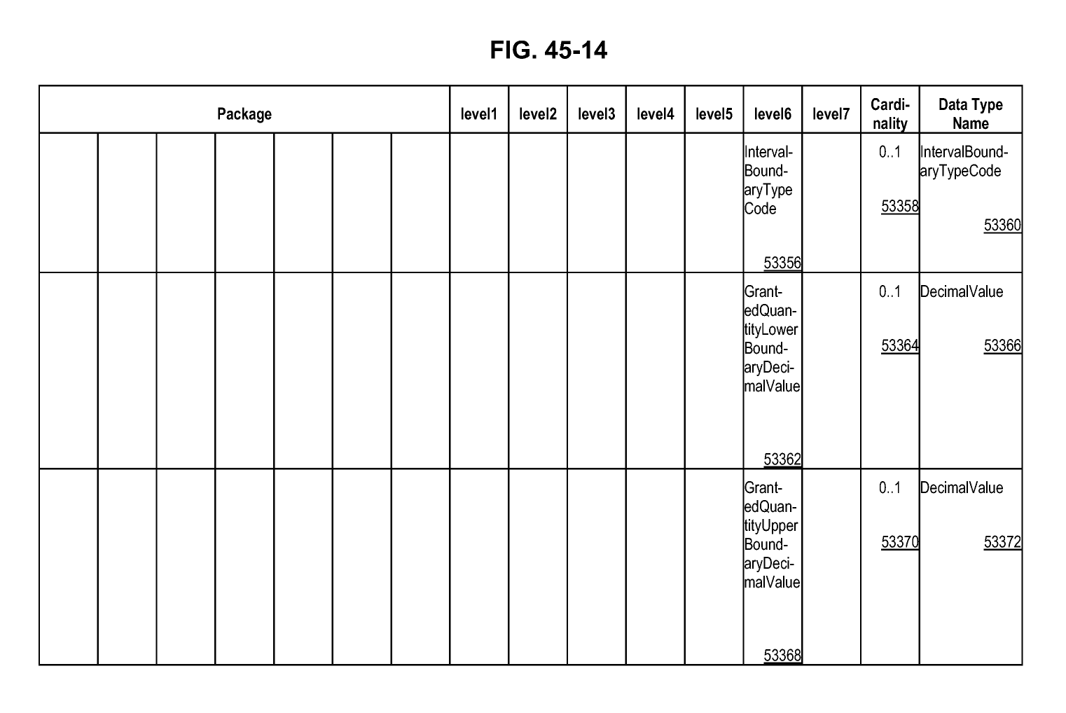

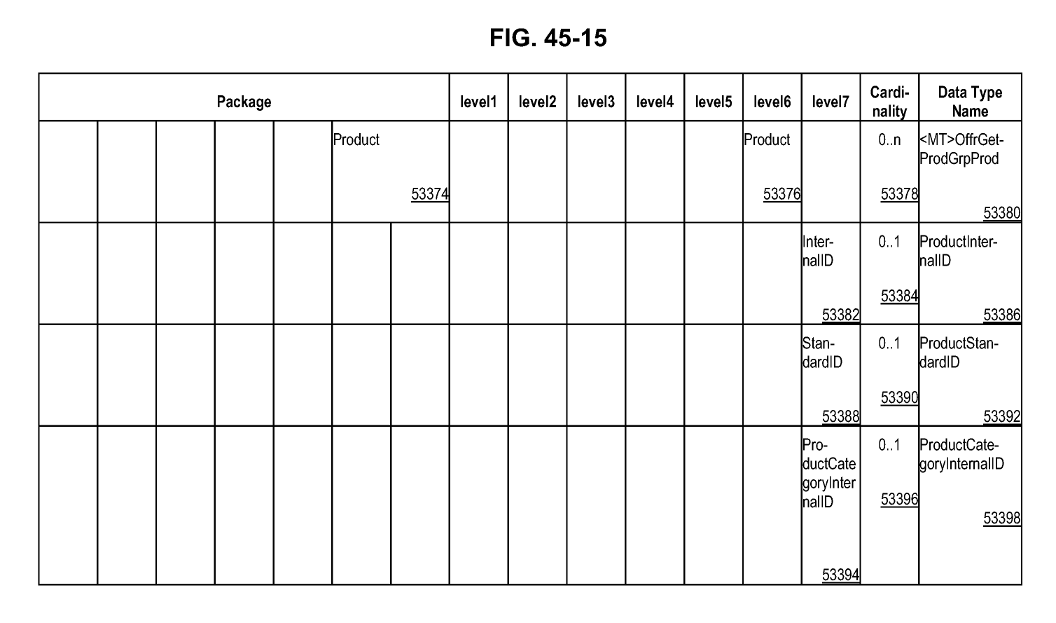

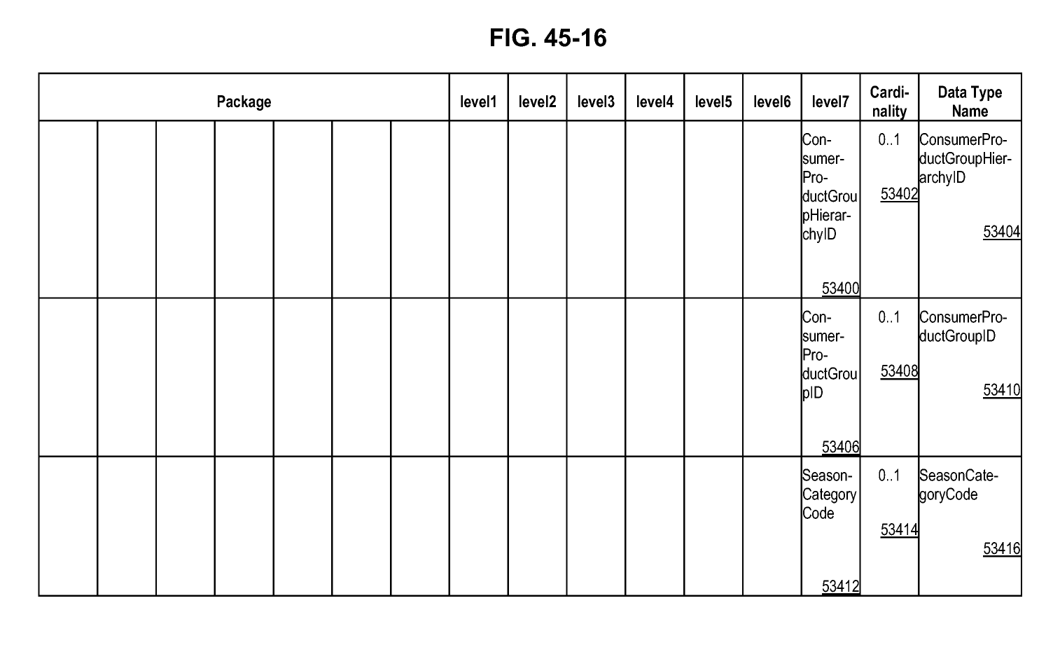

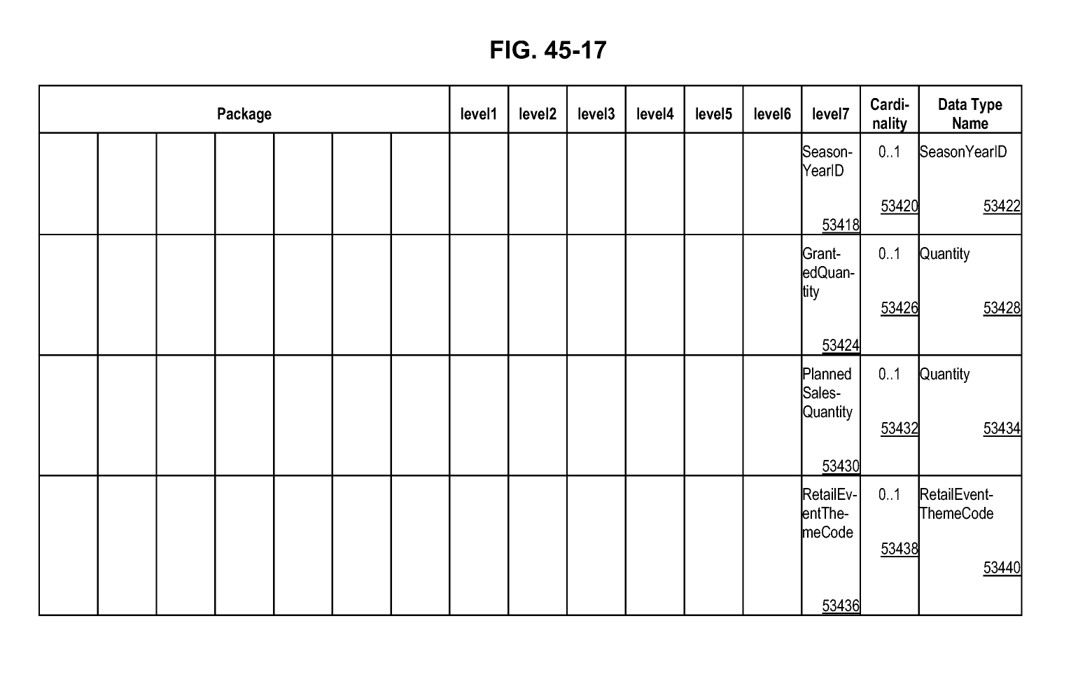

Additionally, FIGS. 45-1 through 45-17 show an example configuration of an Element Structure that includes a RetailEventReplicationRequestMessage 53000 package. The RetailEventReplicationRequestMessage 53000 package is a RtlEvtRplctnReqMsg 53004 data type. The RetailEventReplicationRequestMessage 53000 package includes a RetailEventMessage 53002 entity. The RetailEventReplicationRequestMessage 53000 package includes various packages, namely a MessageHeader 53006 and a RetailEvent 53014.

The MessageHeader 53006 package is a BusinessDocumentMessageHeader 53012 data type. The MessageHeader 53006 package includes a MessageHeader 53008 entity. The MessageHeader 53008 entity has a cardinality of 1 53010 meaning that for each instance of the MessageHeader 53006 package there is one MessageHeader 53008 entity.

The RetailEvent 53014 package is an <MT>RtlEvtMT=RtlEvtRplctnReq 53020 data type. The RetailEvent 53014 package includes a RetailEvent 53016 entity. The RetailEvent 53014 package includes various packages, namely a SalesArea 53100, a Theme 53180 and an Offer 53194. The RetailEvent 53016 entity has a cardinality of 1 53018 meaning that for each instance of the RetailEvent 53014 package there is one RetailEvent 53016 entity. The RetailEvent 53016 entity includes various attributes, namely a @actionCode 53022, an ID 53028, a TypeCode 53034, a PlanningCurrencyCode 53040, a SalesPeriod 53046, a DataOriginTypeCode 53052, a PredecessorBusinessTransactionID 53058, an AdvertisingMediumTypeCode 53064, a RetailEventTargetGroupTypeCode 53070, a SuperiorIndicator 53076 and a SuperiorRetailEventID 53082. The RetailEvent 53016 entity includes a Description 53088 subordinate entity. The @actionCode 53022 attribute is an ActionCode 53026 data type. The @actionCode 53022 attribute has a cardinality of 0 . . . 1 53024 meaning that for each instance of the RetailEvent 53016 entity there may be one @actionCode 53022 attribute. The ID 53028 attribute is a RetailEventID 53032 data type. The ID 53028 attribute has a cardinality of 0 . . . 1 53030 meaning that for each instance of the RetailEvent 53016 entity there may be one ID 53028 attribute. The TypeCode 53034 attribute is a RetailEventTypeCode 53038 data type. The TypeCode 53034 attribute has a cardinality of 0 . . . 1 53036 meaning that for each instance of the RetailEvent 53016 entity there may be one TypeCode 53034 attribute. The PlanningCurrencyCode 53040 attribute is a CurrencyCode 53044 data type. The PlanningCurrencyCode 53040 attribute has a cardinality of 0 . . . 1 53042 meaning that for each instance of the RetailEvent 53016 entity there may be one PlanningCurrencyCode 53040 attribute. The SalesPeriod 53046 attribute is a CLOSED_DatePeriod 53050 data type. The SalesPeriod 53046 attribute has a cardinality of 0 . . . 1 53048 meaning that for each instance of the RetailEvent 53016 entity there may be one SalesPeriod 53046 attribute. The DataOriginTypeCode 53052 attribute is a RetailIncentiveDataOriginTypeCode 53056 data type. The DataOriginTypeCode 53052 attribute has a cardinality of 0 . . . 1 53054 meaning that for each instance of the RetailEvent 53016 entity there may be one DataOriginTypeCode 53052 attribute. The PredecessorBusinessTransactionID 53058 attribute is a BusinessTransactionID 53062 data type. The PredecessorBusinessTransactionID 53058 attribute has a cardinality of 0 . . . 1 53060 meaning that for each instance of the RetailEvent 53016 entity there may be one PredecessorBusinessTransactionID 53058 attribute. The AdvertisingMediumTypeCode 53064 attribute is an AdvertisingMediumTypeCode 53068 data type. The AdvertisingMediumTypeCode 53064 attribute has a cardinality of 0 . . . 1 53066 meaning that for each instance of the RetailEvent 53016 entity there may be one AdvertisingMediumTypeCode 53064 attribute. The RetailEventTargetGroupTypeCode 53070 attribute is a RetailEventTargetGroupTypeCode 53074 data type. The RetailEventTargetGroupTypeCode 53070 attribute has a cardinality of 0 . . . 1 53072 meaning that for each instance of the RetailEvent 53016 entity there may be one RetailEventTargetGroupTypeCode 53070 attribute. The SuperiorIndicator 53076 attribute is an Indicator 53080 data type. The SuperiorIndicator 53076 attribute has a cardinality of 0 . . . 1 53078 meaning that for each instance of the RetailEvent 53016 entity there may be one SuperiorIndicator 53076 attribute. The SuperiorRetailEventID 53082 attribute is a RetailEventID 53086 data type. The SuperiorRetailEventID 53082 attribute has a cardinality of 0 . . . 1 53084 meaning that for each instance of the RetailEvent 53016 entity there may be one SuperiorRetailEventID 53082 attribute. The Description 53088 entity has a cardinality of 0 . . . n 53090 meaning that for each instance of the RetailEvent 53016 entity there may be one or more Description 53088 entities. The Description 53088 entity includes a Description 53094 attribute. The Description 53094 attribute is a SHORT_Description 53098 data type. The Description 53094 attribute has a cardinality of 1 53096 meaning that for each instance of the Description 53088 entity there is one Description 53094 attribute.

The SalesArea 53100 package is an <MT>SlsArea 53106 data type. The SalesArea 53100 package includes a SalesArea 53102 entity. The SalesArea 53100 package includes various packages, namely a PriceZone 53120 and a StoreGroup 53134. The SalesArea 53102 entity has a cardinality of 0 . . . 1 53104 meaning that for each instance of the SalesArea 53100 package there may be one SalesArea 53102 entity. The SalesArea 53102 entity includes various attributes, namely a SalesOrganisationID 53108 and a DistributionChannelCode 53114. The SalesOrganisationID 53108 attribute is an OrganisationalCentreID 53112 data type. The SalesOrganisationID 53108 attribute has a cardinality of 0 . . . 1 53110 meaning that for each instance of the SalesArea 53102 entity there may be one SalesOrganisationID 53108 attribute. The DistributionChannelCode 53114 attribute is a DistributionChannelCode 53118 data type. The DistributionChannelCode 53114 attribute has a cardinality of 0 . . . 1 53116 meaning that for each instance of the SalesArea 53102 entity there may be one DistributionChannelCode 53114 attribute.

The PriceZone 53120 package is an <MT>SlsAreaPrZn 53126 data type. The PriceZone 53120 package includes a PriceZone 53122 entity. The PriceZone 53122 entity has a cardinality of 0 . . . 1 53124 meaning that for each instance of the PriceZone 53120 package there may be one PriceZone 53122 entity. The PriceZone 53122 entity includes a PriceZoneID 53128 attribute. The PriceZoneID 53128 attribute is a PriceZoneID 53132 data type. The PriceZoneID 53128 attribute has a cardinality of 1 53130 meaning that for each instance of the PriceZone 53122 entity there is one PriceZoneID 53128 attribute.

The StoreGroup 53134 package is an <MT>SlsAreaStoreGrp 53140 data type. The StoreGroup 53134 package includes a StoreGroup 53136 entity. The StoreGroup 53134 package includes a Store 53166 package. The StoreGroup 53136 entity has a cardinality of 0 . . . n 53138 meaning that for each instance of the StoreGroup 53134 package there may be one or more StoreGroup 53136 entities. The StoreGroup 53136 entity includes various attributes, namely an ID 53142, a SalesOrganisationID 53148, a DistributionChannelCode 53154 and a SalesPeriod 53160. The ID 53142 attribute is a StoreGroupID 53146 data type. The ID 53142 attribute has a cardinality of 0 . . . 1 53144 meaning that for each instance of the StoreGroup 53136 entity there may be one ID 53142 attribute. The SalesOrganisationID 53148 attribute is an OrganisationalCentreID 53152 data type. The SalesOrganisationID 53148 attribute has a cardinality of 0 . . . 1 53150 meaning that for each instance of the StoreGroup 53136 entity there may be one SalesOrganisationID 53148 attribute. The DistributionChannelCode 53154 attribute is a DistributionChannelCode 53158 data type. The DistributionChannelCode 53154 attribute has a cardinality of 0 . . . 1 53156 meaning that for each instance of the StoreGroup 53136 entity there may be one DistributionChannelCode 53154 attribute. The SalesPeriod 53160 attribute is a CLOSED_DatePeriod 53164 data type. The SalesPeriod 53160 attribute has a cardinality of 0 . . . 1 53162 meaning that for each instance of the StoreGroup 53136 entity there may be one SalesPeriod 53160 attribute.

The Store 53166 package is an <MT>SlsAreaStoreGrpStore 53172 data type. The Store 53166 package includes a Store 53168 entity. The Store 53168 entity has a cardinality of 0 . . . n 53170 meaning that for each instance of the Store 53166 package there may be one or more Store 53168 entities. The Store 53168 entity includes an InternalID 53174 attribute. The InternalID 53174 attribute is a StoreInternalID 53178 data type. The InternalID 53174 attribute has a cardinality of 1 53176 meaning that for each instance of the Store 53168 entity there is one InternalID 53174 attribute.

The Theme 53180 package is an <MT>Thm 53186 data type. The Theme 53180 package includes a Theme 53182 entity. The Theme 53182 entity has a cardinality of 0 . . . n 53184 meaning that for each instance of the Theme 53180 package there may be one or more Theme 53182 entities. The Theme 53182 entity includes a Code 53188 attribute. The Code 53188 attribute is a RetailEventThemeCode 53192 data type. The Code 53188 attribute has a cardinality of 1 53190 meaning that for each instance of the Theme 53182 entity there is one Code 53188 attribute.

The Offer 53194 package is an <MT>Offr 53200 data type. The Offer 53194 package includes an Offer 53196 entity. The Offer 53194 package includes various packages, namely a Buy 53250 and a Get 53310. The Offer 53196 entity has a cardinality of 0 . . . n 53198 meaning that for each instance of the Offer 53194 package there may be one or more Offer 53196 entities. The Offer 53196 entity includes various attributes, namely an ID 53202, a TypeCode 53208, a TargetTypeCode 53214, a ConditionCode 53220, a RequirementMinimumAmount 53226 and a MultipleGrantingAllowedIndicator 53232. The Offer 53196 entity includes a Description 53238 subordinate entity. The ID 53202 attribute is a RetailIncentiveOfferID 53206 data type. The ID 53202 attribute has a cardinality of 0 . . . 1 53204 meaning that for each instance of the Offer 53196 entity there may be one ID 53202 attribute. The TypeCode 53208 attribute is a RetailIncentiveOfferTypeCode 53212 data type. The TypeCode 53208 attribute has a cardinality of 1 53210 meaning that for each instance of the Offer 53196 entity there is one TypeCode 53208 attribute. The TargetTypeCode 53214 attribute is a RetailIncentiveOfferTargetTypeCode 53218 data type. The TargetTypeCode 53214 attribute has a cardinality of 1 53216 meaning that for each instance of the Offer 53196 entity there is one TargetTypeCode 53214 attribute. The ConditionCode 53220 attribute is a RetailIncentiveOfferConditionCode 53224 data type. The ConditionCode 53220 attribute has a cardinality of 0 . . . 1 53222 meaning that for each instance of the Offer 53196 entity there may be one ConditionCode 53220 attribute. The RequirementMinimumAmount 53226 attribute is an Amount 53230 data type. The RequirementMinimumAmount 53226 attribute has a cardinality of 0 . . . 1 53228 meaning that for each instance of the Offer 53196 entity there may be one RequirementMinimumAmount 53226 attribute. The MultipleGrantingAllowedIndicator 53232 attribute is an Indicator 53236 data type. The MultipleGrantingAllowedIndicator 53232 attribute has a cardinality of 1 53234 meaning that for each instance of the Offer 53196 entity there is one MultipleGrantingAllowedIndicator 53232 attribute. The Description 53238 entity has a cardinality of 0 . . . n 53240 meaning that for each instance of the Offer 53196 entity there may be one or more Description 53238 entities. The Description 53238 entity includes a Description 53244 attribute. The Description 53244 attribute is a MEDIUM_Description 53248 data type. The Description 53244 attribute has a cardinality of 1 53246 meaning that for each instance of the Description 53238 entity there is one Description 53244 attribute.

The Buy 53250 package is an <MT>OffrBuy 53256 data type. The Buy 53250 package includes a Buy 53252 entity. The Buy 53250 package includes a ProductGroup 53264 package. The Buy 53252 entity has a cardinality of 0 . . . 1 53254 meaning that for each instance of the Buy 53250 package there may be one Buy 53252 entity. The Buy 53252 entity includes an AndOrBusinessRuleExpressionTypeCode 53258 attribute. The AndOrBusinessRuleExpressionTypeCode 53258 attribute is an AndOrBusinessRuleExpressionTypeCode 53262 data type. The AndOrBusinessRuleExpressionTypeCode 53258 attribute has a cardinality of 0 . . . 1 53260 meaning that for each instance of the Buy 53252 entity there may be one AndOrBusinessRuleExpressionTypeCode 53258 attribute.

The ProductGroup 53264 package is an <MT>OffrBuyProdGrp 53270 data type. The ProductGroup 53264 package includes a ProductGroup 53266 entity. The ProductGroup 53264 package includes a Product 53284 package. The ProductGroup 53266 entity has a cardinality of 0 . . . n 53268 meaning that for each instance of the ProductGroup 53264 package there may be one or more ProductGroup 53266 entities. The ProductGroup 53266 entity includes various attributes, namely a RequirementQuantityDecimalValue 53272 and a RetailBonusBuyProductSelectionConditionCode 53278. The RequirementQuantityDecimalValue 53272 attribute is a DecimalValue 53276 data type. The RequirementQuantityDecimalValue 53272 attribute has a cardinality of 0 . . . 1 53274 meaning that for each instance of the ProductGroup 53266 entity there may be one RequirementQuantityDecimalValue 53272 attribute. The RetailBonusBuyProductSelectionConditionCode 53278 attribute is a RetailBonusBuyProductSelectionConditionCode 53282 data type. The RetailBonusBuyProductSelectionConditionCode 53278 attribute has a cardinality of 1 53280 meaning that for each instance of the ProductGroup 53266 entity there is one RetailBonusBuyProductSelectionConditionCode 53278 attribute.

The Product 53284 package is an <MT>OffrBuyProdGrpProd 53290 data type. The Product 53284 package includes a Product 53286 entity. The Product 53286 entity has a cardinality of 1 . . . n 53288 meaning that for each instance of the Product 53284 package there are one or more Product 53286 entities. The Product 53286 entity includes various attributes, namely an InternalID 53292, a StandardID 53298 and a RequirementQuantity 53304. The InternalID 53292 attribute is a ProductInternalID 53296 data type. The InternalID 53292 attribute has a cardinality of 0 . . . 1 53294 meaning that for each instance of the Product 53286 entity there may be one InternalID 53292 attribute. The StandardID 53298 attribute is a ProductStandardID 53302 data type. The StandardID 53298 attribute has a cardinality of 0 . . . 1 53300 meaning that for each instance of the Product 53286 entity there may be one StandardID 53298 attribute. The RequirementQuantity 53304 attribute is a Quantity 53308 data type. The RequirementQuantity 53304 attribute has a cardinality of 0 . . . 1 53306 meaning that for each instance of the Product 53286 entity there may be one RequirementQuantity 53304 attribute.

The Get 53310 package is an <MT>OffrGet 53316 data type. The Get 53310 package includes a Get 53312 entity. The Get 53310 package includes a ProductGroup 53348 package. The Get 53312 entity has a cardinality of 1 53314 meaning that for each instance of the Get 53310 package there is one Get 53312 entity. The Get 53312 entity includes various attributes, namely an AndOrBusinessRuleExpressionTypeCode 53318, a SalesPriceBaseQuantity 53324, a PriceAmount 53330, a DiscountAmount 53336 and a DiscountPercent 53342. The AndOrBusinessRuleExpressionTypeCode 53318 attribute is an AndOrBusinessRuleExpressionTypeCode 53322 data type. The AndOrBusinessRuleExpressionTypeCode 53318 attribute has a cardinality of 0 . . . 1 53320 meaning that for each instance of the Get 53312 entity there may be one AndOrBusinessRuleExpressionTypeCode 53318 attribute. The SalesPriceBaseQuantity 53324 attribute is a Quantity 53328 data type. The SalesPriceBaseQuantity 53324 attribute has a cardinality of 0 . . . 1 53326 meaning that for each instance of the Get 53312 entity there may be one SalesPriceBaseQuantity 53324 attribute. The PriceAmount 53330 attribute is an Amount 53334 data type. The PriceAmount 53330 attribute has a cardinality of 0 . . . 1 53332 meaning that for each instance of the Get 53312 entity there may be one PriceAmount 53330 attribute. The DiscountAmount 53336 attribute is an Amount 53340 data type. The DiscountAmount 53336 attribute has a cardinality of 0 . . . 1 53338 meaning that for each instance of the Get 53312 entity there may be one DiscountAmount 53336 attribute. The DiscountPercent 53342 attribute is a Percent 53346 data type. The DiscountPercent 53342 attribute has a cardinality of 0 . . . 1 53344 meaning that for each instance of the Get 53312 entity there may be one DiscountPercent 53342 attribute.

The ProductGroup 53348 package is an <MT>OffrGetProdGrp 53354 data type. The ProductGroup 53348 package includes a ProductGroup 53350 entity. The ProductGroup 53348 package includes a Product 53374 package. The ProductGroup 53350 entity has a cardinality of 0 . . . n 53352 meaning that for each instance of the ProductGroup 53348 package there may be one or more ProductGroup 53350 entities. The ProductGroup 53350 entity includes various attributes, namely an IntervalBoundaryTypeCode 53356, a GrantedQuantityLowerBoundaryDecimalValue 53362 and a GrantedQuantityUpperBoundaryDecimalValue 53368. The IntervalBoundaryTypeCode 53356 attribute is an IntervalBoundaryTypeCode 53360 data type. The IntervalBoundaryTypeCode 53356 attribute has a cardinality of 0 . . . 1 53358 meaning that for each instance of the ProductGroup 53350 entity there may be one IntervalBoundaryTypeCode 53356 attribute. The GrantedQuantityLowerBoundaryDecimalValue 53362 attribute is a DecimalValue 53366 data type. The GrantedQuantityLowerBoundaryDecimalValue 53362 attribute has a cardinality of 0 . . . 1 53364 meaning that for each instance of the ProductGroup 53350 entity there may be one GrantedQuantityLowerBoundaryDecimalValue 53362 attribute. The GrantedQuantityUpperBoundaryDecimalValue 53368 attribute is a DecimalValue 53372 data type. The GrantedQuantityUpperBoundaryDecimalValue 53368 attribute has a cardinality of 0 . . . 1 53370 meaning that for each instance of the ProductGroup 53350 entity there may be one GrantedQuantityUpperBoundaryDecimalValue 53368 attribute.

The Product 53374 package is an <MT>OffrGetProdGrpProd 53380 data type. The Product 53374 package includes a Product 53376 entity. The Product 53376 entity has a cardinality of 0 . . . n 53378 meaning that for each instance of the Product 53374 package there may be one or more Product 53376 entities. The Product 53376 entity includes various attributes, namely an InternalID 53382, a StandardID 53388, a ProductCategoryInternalID 53394, a ConsumerProductGroupHierarchyID 53400, a ConsumerProductGroupID 53406, a SeasonCategoryCode 53412, a SeasonYearID 53418, a GrantedQuantity 53424, a PlannedSalesQuantity 53430 and a RetailEventThemeCode 53436. The InternalID 53382 attribute is a ProductInternalID 53386 data type. The InternalID 53382 attribute has a cardinality of 0 . . . 1 53384 meaning that for each instance of the Product 53376 entity there may be one InternalID 53382 attribute. The StandardID 53388 attribute is a ProductStandardID 53392 data type. The StandardID 53388 attribute has a cardinality of 0 . . . 1 53390 meaning that for each instance of the Product 53376 entity there may be one StandardID 53388 attribute. The ProductCategoryInternalID 53394 attribute is a ProductCategoryInternalID 53398 data type. The ProductCategoryInternalID 53394 attribute has a cardinality of 0 . . . 1 53396 meaning that for each instance of the Product 53376 entity there may be one ProductCategoryInternalID 53394 attribute. The ConsumerProductGroupHierarchyID 53400 attribute is a ConsumerProductGroupHierarchyID 53404 data type. The ConsumerProductGroupHierarchyID 53400 attribute has a cardinality of 0 . . . 1 53402 meaning that for each instance of the Product 53376 entity there may be one ConsumerProductGroupHierarchyID 53400 attribute. The ConsumerProductGroupID 53406 attribute is a ConsumerProductGroupID 53410 data type. The ConsumerProductGroupID 53406 attribute has a cardinality of 0 . . . 1 53408 meaning that for each instance of the Product 53376 entity there may be one ConsumerProductGroupID 53406 attribute. The SeasonCategoryCode 53412 attribute is a SeasonCategoryCode 53416 data type. The SeasonCategoryCode 53412 attribute has a cardinality of 0 . . . 1 53414 meaning that for each instance of the Product 53376 entity there may be one SeasonCategoryCode 53412 attribute. The SeasonYearID 53418 attribute is a SeasonYearID 53422 data type. The SeasonYearID 53418 attribute has a cardinality of 0 . . . 1 53420 meaning that for each instance of the Product 53376 entity there may be one SeasonYearID 53418 attribute. The GrantedQuantity 53424 attribute is a Quantity 53428 data type. The GrantedQuantity 53424 attribute has a cardinality of 0 . . . 1 53426 meaning that for each instance of the Product 53376 entity there may be one GrantedQuantity 53424 attribute. The PlannedSalesQuantity 53430 attribute is a Quantity 53434 data type. The PlannedSalesQuantity 53430 attribute has a cardinality of 0 . . . 1 53432 meaning that for each instance of the Product 53376 entity there may be one PlannedSalesQuantity 53430 attribute. The RetailEventThemeCode 53436 attribute is a RetailEventThemeCode 53440 data type. The RetailEventThemeCode 53436 attribute has a cardinality of 0 . . . 1 53438 meaning that for each instance of the Product 53376 entity there may be one RetailEventThemeCode 53436 attribute.

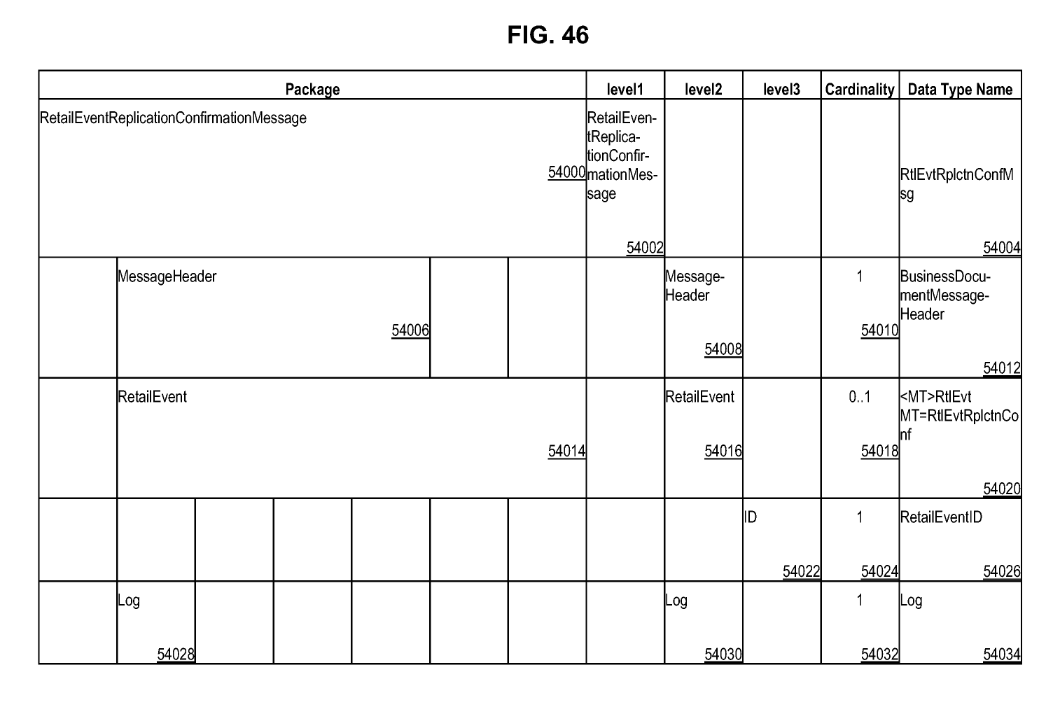

Additionally, FIG. 46 shows an example configuration of an Element Structure that includes a RetailEventReplicationConfirmationMessage 54000 package. The RetailEventReplicationConfirmationMessage 54000 package is a RtlEvtRplctnConfMsg 54004 data type. The RetailEventReplicationConfirmationMessage 54000 package includes a RetailEventReplicationConfirmationMessage 54002 entity. The RetailEventReplicationConfirmationMessage 54000 package includes various packages, namely a MessageHeader 54006, a RetailEvent 54014 and a Log 54028.

The MessageHeader 54006 package is a BusinessDocumentMessageHeader 54012 data type. The MessageHeader 54006 package includes a MessageHeader 54008 entity. The MessageHeader 54008 entity has a cardinality of 1 54010 meaning that for each instance of the MessageHeader 54006 package there is one MessageHeader 54008 entity.

The RetailEvent 54014 package is an <MT>RtlEvtMT=RtlEvtRplctnConf 54020 data type. The RetailEvent 54014 package includes a RetailEvent 54016 entity. The RetailEvent 54016 entity has a cardinality of 0 . . . 1 54018 meaning that for each instance of the RetailEvent 54014 package there may be one RetailEvent 54016 entity. The RetailEvent 54016 entity includes an ID 54022 attribute. The ID 54022 attribute is a RetailEventID 54026 data type. The ID 54022 attribute has a cardinality of 1 54024 meaning that for each instance of the RetailEvent 54016 entity there is one ID 54022 attribute.

The Log 54028 package is a Log 54034 data type. The Log 54028 package includes a Log 54030 entity. The Log 54030 entity has a cardinality of 1 54032 meaning that for each instance of the Log 54028 package there is one Log 54030 entity.

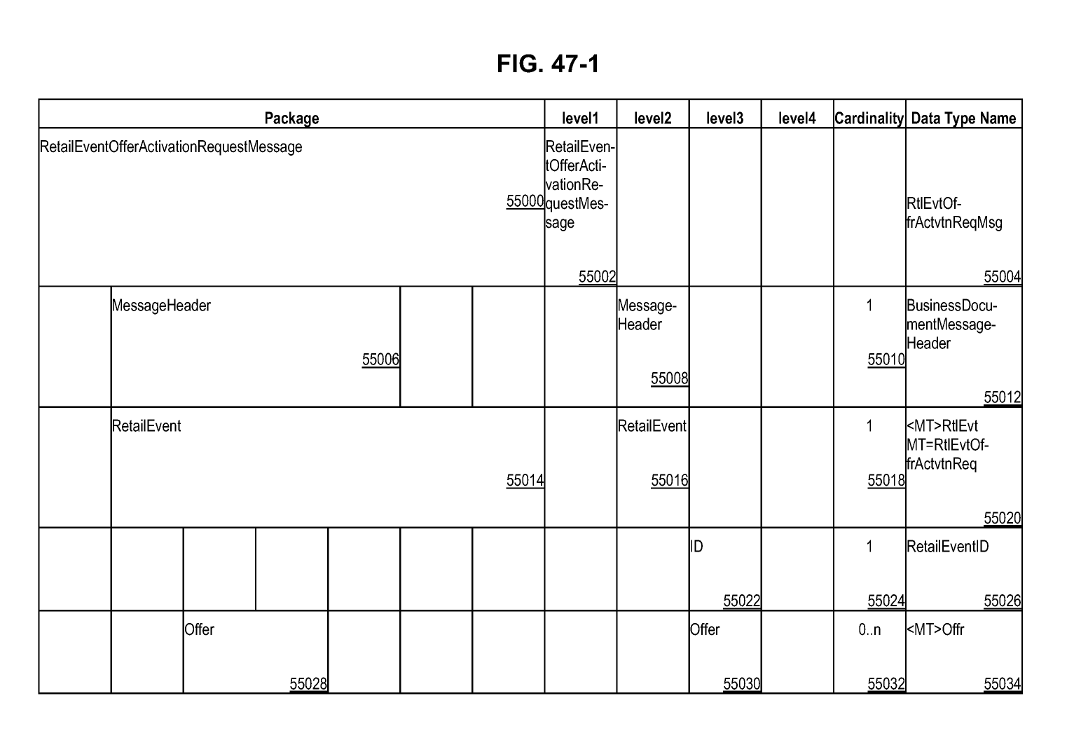

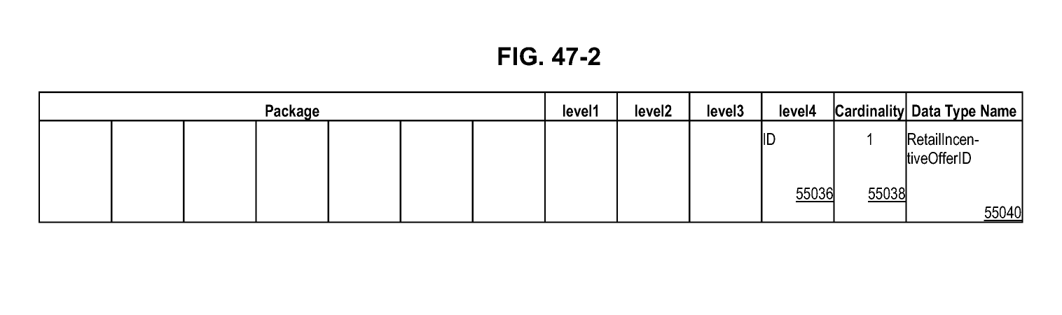

Additionally, FIGS. 47-1 through 47-2 show an example configuration of an Element Structure that includes a RetailEventOfferActivationRequestMessage 55000 package. The RetailEventOfferActivationRequestMessage 55000 package is a RtlEvtOffrActvtnReqMsg 55004 data type. The RetailEventOfferActivationRequestMessage 55000 package includes a RetailEventOfferActivationRequestMessage 55002 entity. The RetailEventOfferActivationRequestMessage 55000 package includes various packages, namely a MessageHeader 55006 and a RetailEvent 55014.

The MessageHeader 55006 package is a BusinessDocumentMessageHeader 55012 data type. The MessageHeader 55006 package includes a MessageHeader 55008 entity. The MessageHeader 55008 entity has a cardinality of 1 55010 meaning that for each instance of the MessageHeader 55006 package there is one MessageHeader 55008 entity.

The RetailEvent 55014 package is an <MT>RtlEvtMT=RtlEvtOffrActvtnReq 55020 data type. The RetailEvent 55014 package includes a RetailEvent 55016 entity. The RetailEvent 55014 package includes an Offer 55028 package. The RetailEvent 55016 entity has a cardinality of 1 55018 meaning that for each instance of the RetailEvent 55014 package there is one RetailEvent 55016 entity. The RetailEvent 55016 entity includes an ID 55022 attribute. The ID 55022 attribute is a RetailEventID 55026 data type. The ID 55022 attribute has a cardinality of 1 55024 meaning that for each instance of the RetailEvent 55016 entity there is one ID 55022 attribute.

The Offer 55028 package is an <MT>Offr 55034 data type. The Offer 55028 package includes an Offer 55030 entity. The Offer 55030 entity has a cardinality of 0 . . . n 55032 meaning that for each instance of the Offer 55028 package there may be one or more Offer 55030 entities. The Offer 55030 entity includes an ID 55036 attribute. The ID 55036 attribute is a RetailIncentiveOfferID 55040 data type. The ID 55036 attribute has a cardinality of 1 55038 meaning that for each instance of the Offer 55030 entity there is one ID 55036 attribute.

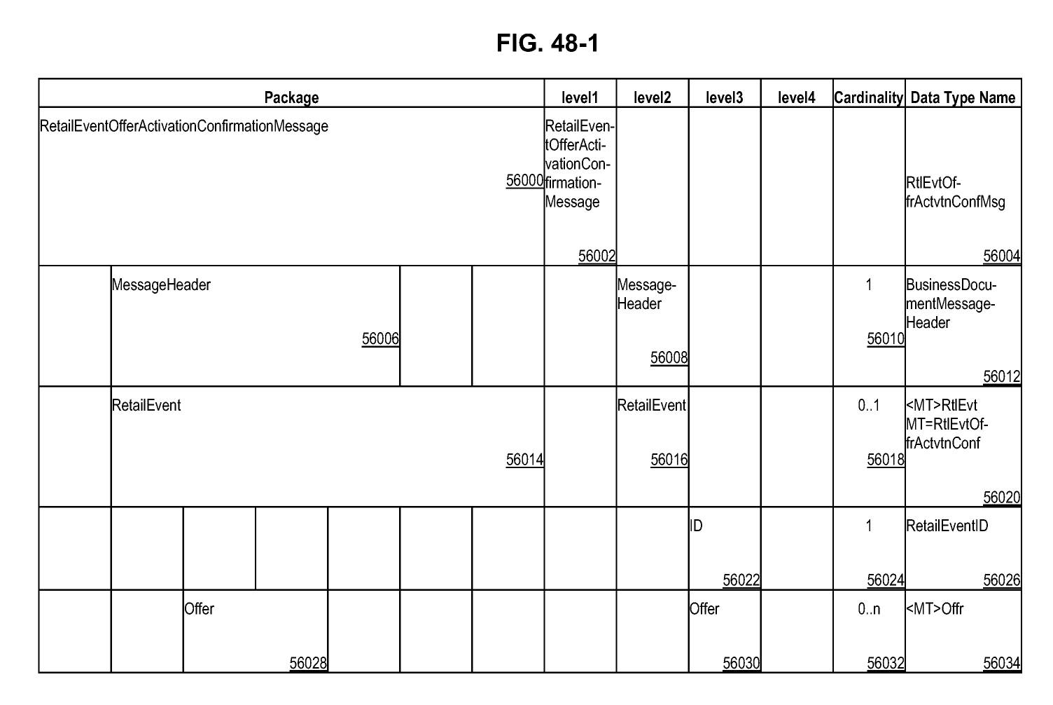

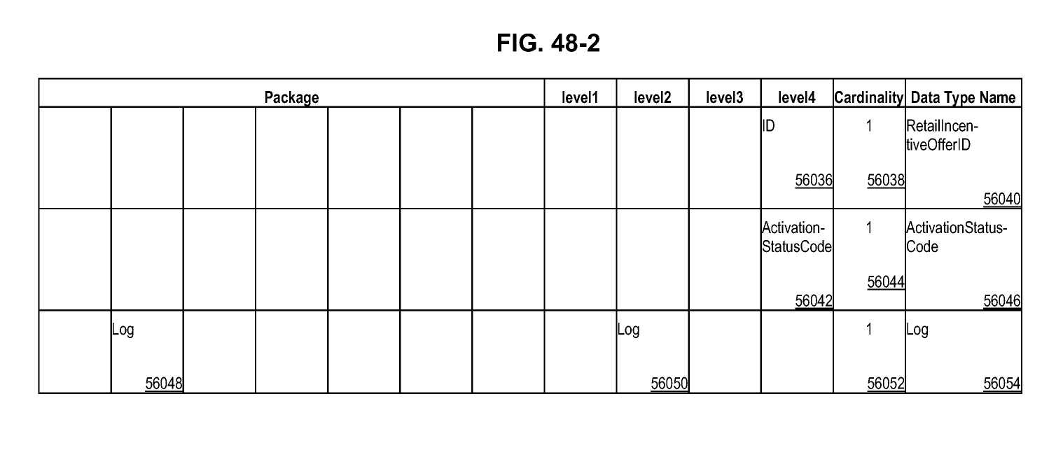

Additionally, FIGS. 48-1 through 48-2 show an example configuration of an Element Structure that includes a RetailEventOfferActivationConfirmationMessage 56000 package. The RetailEventOfferActivationConfirmationMessage 56000 package is a RtlEvtOffrActvtnConfMsg 56004 data type. The RetailEventOfferActivationConfirmationMessage 56000 package includes a RetailEventOfferActivationConfirmationMessage 56002 entity. The RetailEventOfferActivationConfirmationMessage 56000 package includes various packages, namely a MessageHeader 56006, a RetailEvent 56014 and a Log 56048.

The MessageHeader 56006 package is a BusinessDocumentMessageHeader 56012 data type. The MessageHeader 56006 package includes a MessageHeader 56008 entity. The MessageHeader 56008 entity has a cardinality of 1 56010 meaning that for each instance of the MessageHeader 56006 package there is one MessageHeader 56008 entity.

The RetailEvent 56014 package is an <MT>RtlEvtMT=RtlEvtOffrActvtnConf 56020 data type. The RetailEvent 56014 package includes a RetailEvent 56016 entity. The RetailEvent 56014 package includes an Offer 56028 package. The RetailEvent 56016 entity has a cardinality of 0 . . . 1 56018 meaning that for each instance of the RetailEvent 56014 package there may be one RetailEvent 56016 entity. The RetailEvent 56016 entity includes an ID 56022 attribute. The ID 56022 attribute is a RetailEventID 56026 data type. The ID 56022 attribute has a cardinality of 1 56024 meaning that for each instance of the RetailEvent 56016 entity there is one ID 56022 attribute.

The Offer 56028 package is an <MT>Offr 56034 data type. The Offer 56028 package includes an Offer 56030 entity. The Offer 56030 entity has a cardinality of 0 . . . n 56032 meaning that for each instance of the Offer 56028 package there may be one or more Offer 56030 entities. The Offer 56030 entity includes various attributes, namely an ID 56036 and an ActivationStatusCode 56042. The ID 56036 attribute is a RetailIncentiveOfferID 56040 data type. The ID 56036 attribute has a cardinality of 1 56038 meaning that for each instance of the Offer 56030 entity there is one ID 56036 attribute. The ActivationStatusCode 56042 attribute is an ActivationStatusCode 56046 data type. The ActivationStatusCode 56042 attribute has a cardinality of 1 56044 meaning that for each instance of the Offer 56030 entity there is one ActivationStatusCode 56042 attribute.

The Log 56048 package is a Log 56054 data type. The Log 56048 package includes a Log 56050 entity. The Log 56050 entity has a cardinality of 1 56052 meaning that for each instance of the Log 56048 package there is one Log 56050 entity.

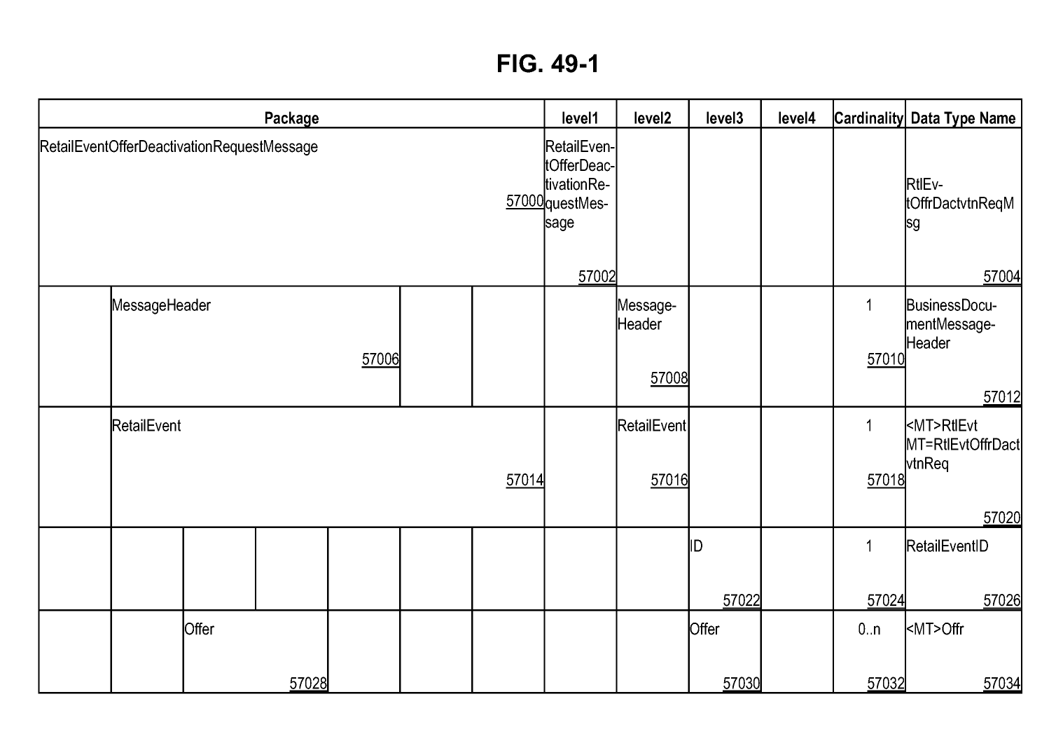

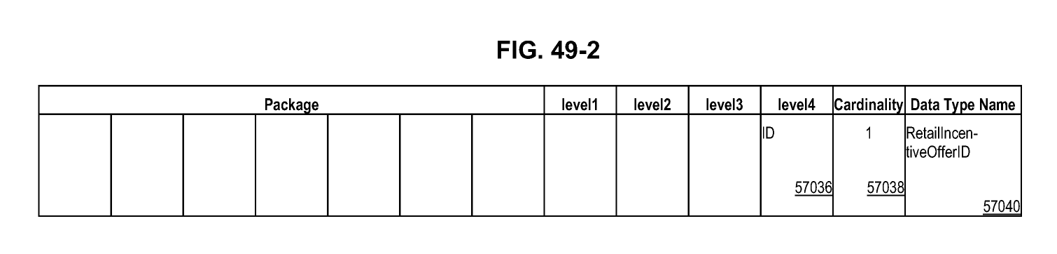

Additionally, FIGS. 49-1 through 49-2 show an example configuration of an Element Structure that includes a RetailEventOfferDeactivationRequestMessage 57000 package. The RetailEventOfferDeactivationRequestMessage 57000 package is a RtlEvtOffrDactvtnReqMsg 57004 data type. The RetailEventOfferDeactivationRequestMessage 57000 package includes a RetailEventOfferDeactivationRequestMessage 57002 entity. The RetailEventOfferDeactivationRequestMessage 57000 package includes various packages, namely a MessageHeader 57006 and a RetailEvent 57014.

The MessageHeader 57006 package is a BusinessDocumentMessageHeader 57012 data type. The MessageHeader 57006 package includes a MessageHeader 57008 entity. The MessageHeader 57008 entity has a cardinality of 1 57010 meaning that for each instance of the MessageHeader 57006 package there is one MessageHeader 57008 entity.

The RetailEvent 57014 package is an <MT>RtlEvtMT=RtlEvtOffrDactvtnReq 57020 data type. The RetailEvent 57014 package includes a RetailEvent 57016 entity. The RetailEvent 57014 package includes an Offer 57028 package. The RetailEvent 57016 entity has a cardinality of 1 57018 meaning that for each instance of the RetailEvent 57014 package there is one RetailEvent 57016 entity. The RetailEvent 57016 entity includes an ID 57022 attribute. The ID 57022 attribute is a RetailEventID 57026 data type. The ID 57022 attribute has a cardinality of 1 57024 meaning that for each instance of the RetailEvent 57016 entity there is one ID 57022 attribute.

The Offer 57028 package is an <MT>Offr 57034 data type. The Offer 57028 package includes an Offer 57030 entity. The Offer 57030 entity has a cardinality of 0 . . . n 57032 meaning that for each instance of the Offer 57028 package there may be one or more Offer 57030 entities. The Offer 57030 entity includes an ID 57036 attribute. The ID 57036 attribute is a RetailIncentiveOfferID 57040 data type. The ID 57036 attribute has a cardinality of 1 57038 meaning that for each instance of the Offer 57030 entity there is one ID 57036 attribute.

### RetailIncentive Interfaces

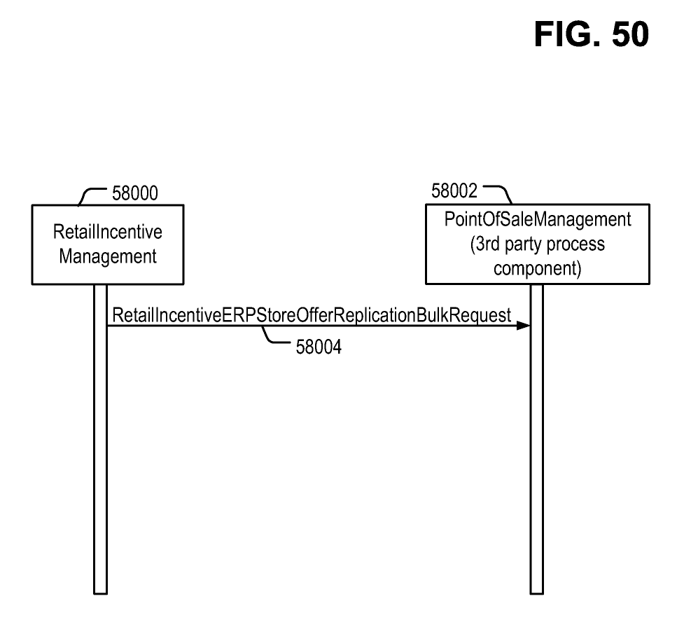

The message choreography of FIG. 50 describes a possible logical sequence of messages that can be used to realize a Retail Incentive business scenario.

A “RetailIncentive Management” system 58000 can send a request to align sales incentives or offers to a “PointOfSaleManagement (3^{rd}-party process component)” system 58002, using a RetailIncentiveERPStoreOfferReplicationBulkRequest message 58004 as shown, for example, in FIG. 50. The RetailIncentiveERPStoreOfferReplicationBulkRequest message 58004 can be sent by a RetailIncentiveERPStoreOfferReplicationBulkRequest_Out operation that is included in a RetailIncentive_Out interface. The RetailIncentiveERPStoreOfferReplicationBulkRequest_Out operation can be used in trading industries to provide a POS system in a Store with exceptional sales offering master data.

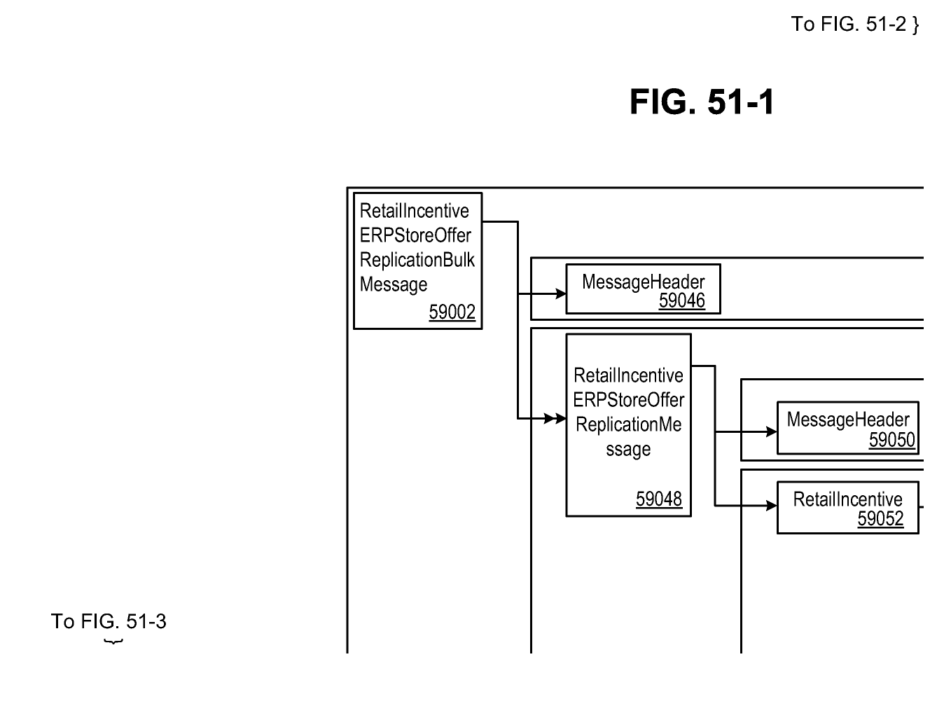

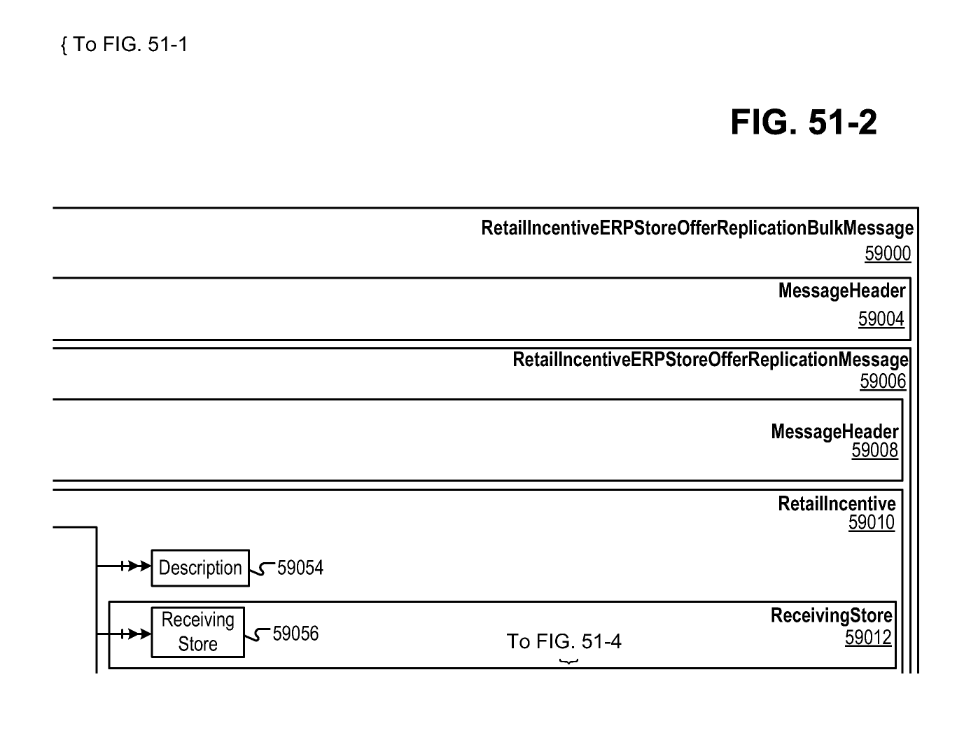

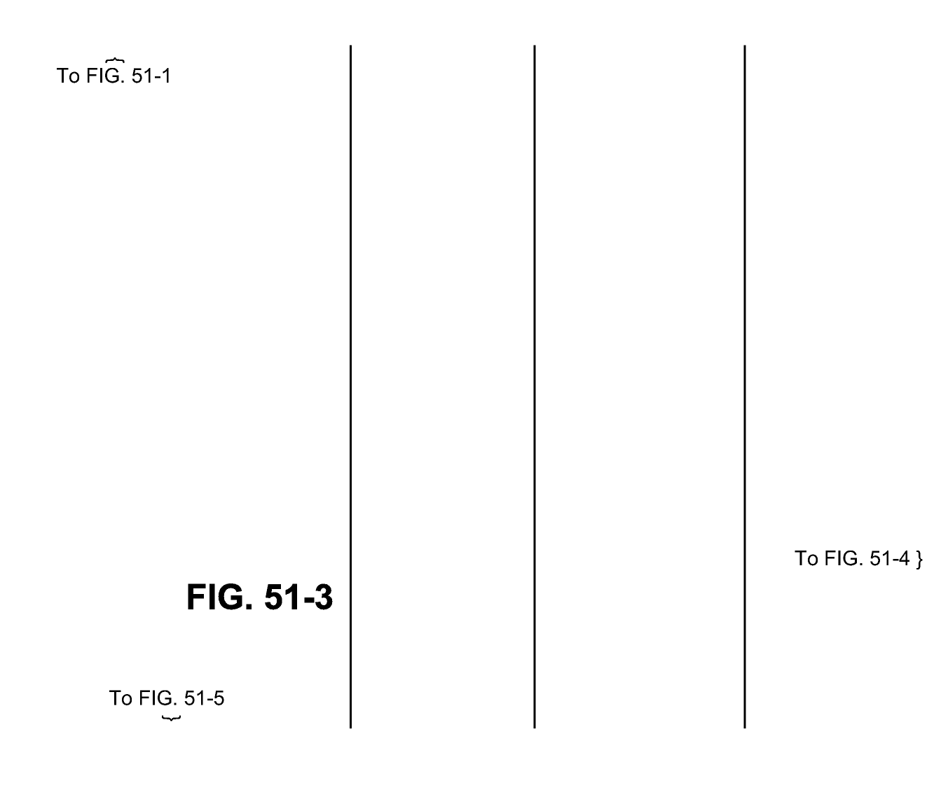

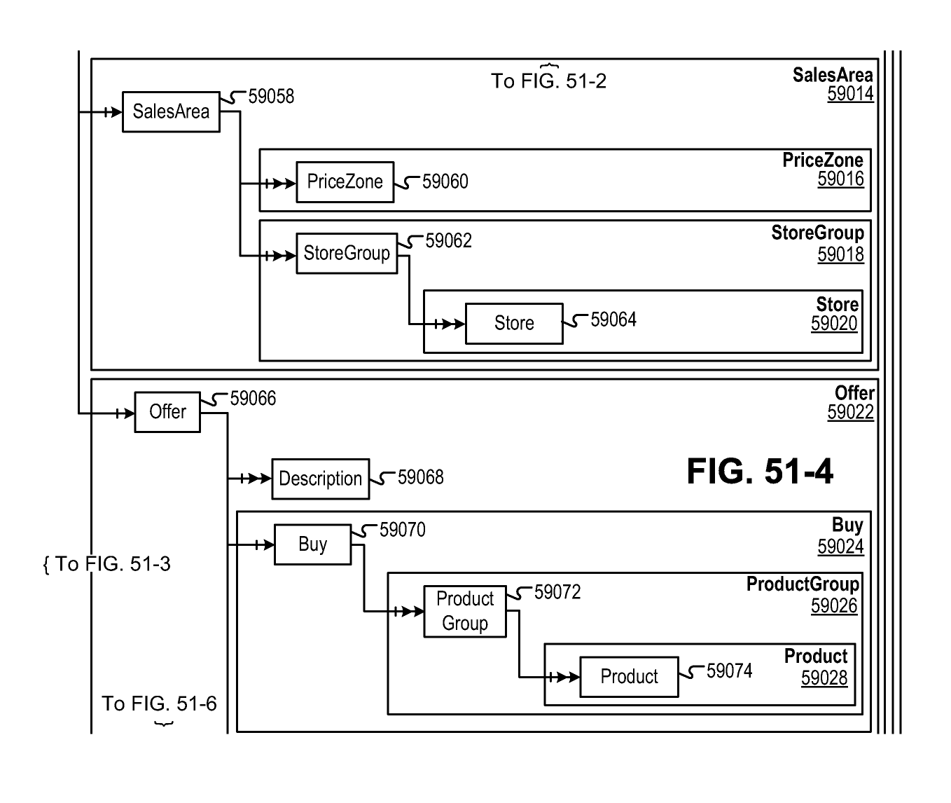

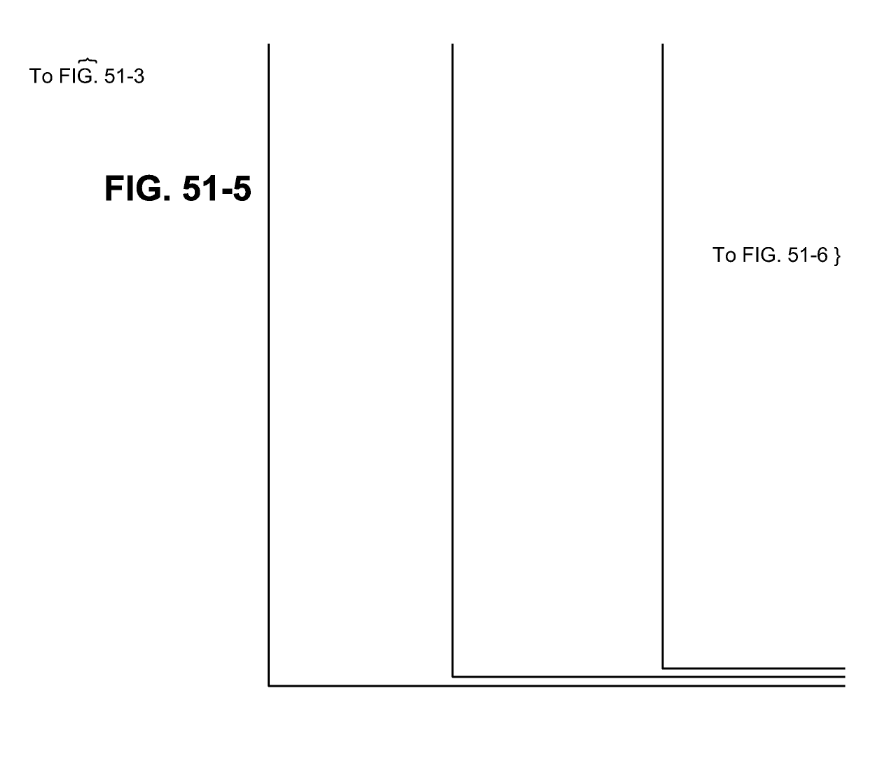

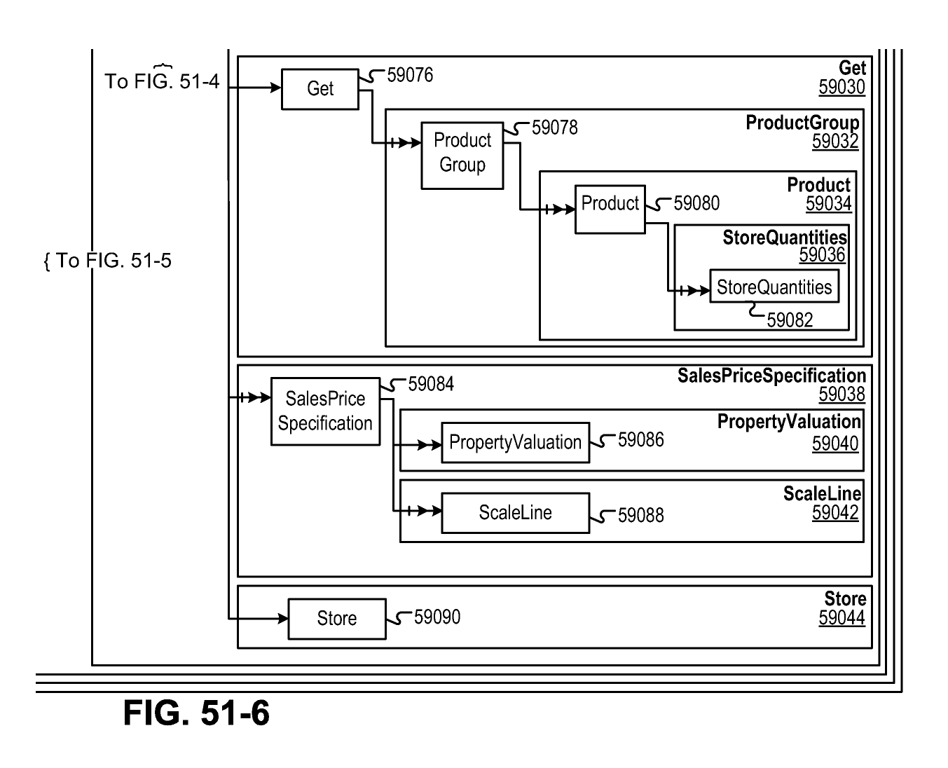

FIGS. 51-1 to 51-6 illustrate one example logical configuration of RetailIncentiveERPStoreOfferReplicationBulkRequestMessage message 59000. Specifically, this figure depicts the arrangement and hierarchy of various components such as one or more levels of packages, entities, and datatypes, shown here as 59002 through 59090. As described above, packages may be used to represent hierarchy levels. Entities are discrete business elements that are used during a business transaction. Data types are used to type object entities and interfaces with a structure. For example, RetailIncentiveERPStoreOfferReplicationBulkRequestMessage message 59000 includes, among other things, RetailIncentiveERPStoreOfferReplicationMessage 59006. Accordingly, heterogeneous applications may communicate using this consistent message configured as such.

Additionally, FIGS. 52-1 through 52-28 show an example configuration of an Element Structure that includes a RetailIncentiveMessage 60000 package. The RetailIncentiveMessage 60000 package is a RtlIncntvMsg 60004 data type. The RetailIncentiveMessage 60000 package includes a RetailIncentiveMessage 60002 entity. The RetailIncentiveMessage 60000 package includes various packages, namely a MessageHeader 60006 and a RetailIncentive 60012.

The MessageHeader 60006 package is a BusinessDocumentMessageHeader 60010 data type. The MessageHeader 60006 package includes a MessageHeader 60008 entity. A MessageHeader includes business information from the perspective of the sender application for identifying processing of a business document (e.g., an instance) within a message (e.g., a technical message). If applicable, it includes a reference to a previous instance of a business document within a previous message (e.g., a technical message), information about the sender, and information about the receiver.

The RetailIncentive 60012 package is an <MT>RtlIncntvMT=RtlIncntv 60016 data type. The RetailIncentive 60012 package includes a RetailIncentive 60014 entity. The RetailIncentive 60012 package includes various packages, namely a ReceivingStore 60094, a SalesArea 60104, a Theme 60160 and an Offer 60170. The RetailIncentive 60014 entity includes various attributes, namely an @actionCode 60018, an @completeTransmissionIndicator 60022, a RetailEventID 60026, a RetailBonusBuyID 60030, a TypeCode 60034, a CompleteTransmissionIndicator 60038, a RetailEventTypeCode 60042, a PlanningCurrencyCode 60046, a SalesPeriod 60050, a DataOriginTypeCode 60054, a RetailPredecessorTransactionID 60058, a RetailPredecessorTransactionID 60062, an AdvertisingMediumTypeCode 60066, a RetailEventTargetGroupTypeCode 60070, a SalesPriceSpecificationLevelCode 60074, a SuperiorIndicator 60078 and a SuperiorRetailEventID 60082. The RetailIncentive 60014 entity includes a Description 60086 subordinate entity. The @actionCode 60018 attribute is an ActionCode 60020 data type. An @actionCode is a coded representation of an instruction to the recipient of a message describing how to process a transmitted element. The @completeTransmissionIndicator 60022 attribute is an Indicator 60024 data type. An @completeTransmissionIndicator specifies whether an element transferred in a message or in a transmitted list of similar elements is transmitted in its entirety. The RetailEventID 60026 attribute is an NOSC_RetailEventID 60028 data type. A RetailEventID is an identifier for a retail event. The RetailBonusBuyID 60030 attribute is an NOSC_RetailBonusBuyID 60032 data type. A RetailBonusBuyID is an identifier for a retail bonus buy. The TypeCode 60034 attribute is a RetailIncentiveTypeCode 60036 data type. A TypeCode is a coded representation of the type of a retail incentive (e.g., RetailEvent or RetailBonusBuy). The CompleteTransmissionIndicator 60038 attribute is an Indicator 60040 data type. A CompleteTransmissionIndicator specifies whether an element transferred in a message or in a transmitted list of similar elements is transmitted in its entirety. The RetailEventTypeCode 60042 attribute is a RetailEventTypeCode 60044 data type. A RetailEventTypeCode is a coded representation of the type of a retail event from a business viewpoint. The PlanningCurrencyCode 60046 attribute is a CurrencyCode 60048 data type. A PlanningCurrencyCode represents a currency that is used for planning purposes. The SalesPeriod 60050 attribute is a CLOSED_DatePeriod 60052 data type. A SalesPeriod represents a period during which something is sold. The DataOriginTypeCode 60054 attribute is a RetailIncentiveDataOriginTypeCode 60056 data type. A DataOriginTypeCode is a coded representation of the type of retail incentive data origination. The RetailPredecessorTransactionID 60058 attribute is an NOSC_RetailPredecessorTransactionID 60060 data type. A RetailPredecessorTransactionID is an identifier of a preceding transaction which leads to the creation of a specific retail business process. The RetailPredecessorTransactionID 60062 attribute is a RetailPredecessorTransactionID 60064 data type. A RetailPredecessorTransactionID is an identifier of a preceding transaction which leads to the creation of a specific retail business process. The AdvertisingMediumTypeCode 60066 attribute is an AdvertisingMediumTypeCode 60068 data type. An AdvertisingMediumTypeCode is a coded representation of a type of medium that is used for advertising. The RetailEventTargetGroupTypeCode 60070 attribute is a RetailEventTargetGroupTypeCode 60072 data type. A RetailEventTargetGroupTypeCode is a coded representation of the type of a target group for whom a retail event is intended for. The SalesPriceSpecificationLevelCode 60074 attribute is a SalesPriceSpecificationLevelCode 60076 data type. A SalesPriceSpecificationLevelCode is a coded representation of a specification level of a sales price. The SuperiorIndicator 60078 attribute is an Indicator 60080 data type. A SuperiorIndicator indicates that the Retail Event is a superior Retail Event that can be assigned to other Retail Events as a superior Retail Event. The SuperiorRetailEventID 60082 attribute is a RetailEventID 60084 data type. A SuperiorRetailEventID specifies an assigned superior retail event and in some implementations is only available if the SuperIndicator is equal to false. The Description 60086 entity includes a Description 60090 attribute. The Description 60090 attribute is a SHORT_Description 60092 data type. A Description represents a description of a retail event.

The ReceivingStore 60094 package is an <MT>RcvgStore 60098 data type. The ReceivingStore 60094 package includes a ReceivingStore 60096 entity. The ReceivingStore 60096 entity includes a StoreInternalID 60100 attribute. The StoreInternalID 60100 attribute is an NOSC_StoreInternalID 60102 data type. A StoreInternalID is a proprietary identifier for a store.

The SalesArea 60104 package is an <MT>SlsArea 60108 data type. The SalesArea 60104 package includes a SalesArea 60106 entity. The SalesArea 60104 package includes various packages, namely a PriceZone 60118 and a StoreGroup 60128. The SalesArea 60106 entity includes various attributes, namely a SalesOrganisationID 60110 and a DistributionChannelCode 60114. The SalesArea 60106 entity can represent a distribution chain (e.g., SalesOrganisationID and DistributionChannelCode), or a distribution chain and price zone, or a store group (together w/distribution chain). The SalesOrganisationID 60110 attribute is an NOSC_OrganisationalCentreID 60112 data type. A SalesOrganisationID is a unique identifier of an organizational unit. The DistributionChannelCode 60114 attribute is a DistributionChannelCode 60116 data type. A DistributionChannelCode is a coded representation of a distribution channel.

The PriceZone 60118 package is an <MT>SlsAreaPrZn 60122 data type. The PriceZone 60118 package includes a PriceZone 60120 entity. The PriceZone 60120 entity includes a PriceZoneID 60124 attribute. The PriceZoneID 60124 attribute is a PriceZoneID 60126 data type. A PriceZoneID is a unique identifier for a price zone.

The StoreGroup 60128 package is an <MT>SlsAreaStoreGrp 60132 data type. The StoreGroup 60128 package includes a StoreGroup 60130 entity. The StoreGroup 60128 package includes a Store 60150 package. The StoreGroup 60130 entity includes various attributes, namely an ID 60134, a SalesOrganisationID 60138, a DistributionChannelCode 60142 and a SalesPeriod 60146. The ID 60134 attribute is an NOSC_StoreGroupID 60136 data type. An ID is an identifier for a store group. The SalesOrganisationID 60138 attribute is an NOSC_OrganisationalCentreID 60140 data type. A SalesOrganisationID is a unique identifier of an organizational unit. The DistributionChannelCode 60142 attribute is a DistributionChannelCode 60144 data type. A DistributionChannelCode is a coded representation of a distribution channel. The SalesPeriod 60146 attribute is a CLOSED_DatePeriod 60148 data type. A SalesPeriod is a period during which something is sold.

The Store 60150 package is an <MT>SlsAreaStoreGrpStore 60154 data type. The Store 60150 package includes a Store 60152 entity. The Store 60152 entity includes an InternalID 60156 attribute. The InternalID 60156 attribute is an NOSC_StoreInternalID 60158 data type. An InternalID is a proprietary identifier for a store.

The Theme 60160 package is an <MT>Thm 60164 data type. The Theme 60160 package includes a Theme 60162 entity. The Theme 60162 entity includes a Code 60166 attribute. The Code 60166 attribute is a RetailEventThemeCode 60168 data type. A Code is a coded representation of a retail event theme.

The Offer 60170 package is a <MT>Offr 60174 data type. The Offer 60170 package includes an Offer 60172 entity. The Offer 60170 package includes various packages, namely a Buy 60220, a Get 60278, a SalesPriceSpecification 60398 and a Store 60464. The Offer 60172 entity includes various attributes, namely an ID 60176, an AlternativeRetailIncentiveOfferID 60180, a TypeCode 60184, a TargetTypeCode 60188, a ConditionCode 60192, an ActivationStatusCode 60196, a RequirementMinimumAmount 60200, a RequirementMaximumAmount 60204 and a MultipleGrantingAllowedIndicator 60208. The Offer 60172 entity includes a Description 60212 subordinate entity. The ID 60176 attribute is a RetailIncentiveOfferID 60178 data type. An ID is an identifier of an offer within a retail incentive. The AlternativeRetailIncentiveOfferID 60180 attribute is a RetailIncentiveOfferID 60182 data type. An AlternativeRetailIncentiveOfferID represents an alternative RetailIncentiveOfferID. The TypeCode 60184 attribute is a RetailIncentiveOfferTypeCode 60186 data type. A TypeCode is a coded representation of the type of an offer within a retail incentive. The TargetTypeCode 60188 attribute is a RetailIncentiveOfferTargetTypeCode 60190 data type. A TargetTypeCode is a coded representation of the type of a target of an offer of a retail incentive. The ConditionCode 60192 attribute is an NOSC_RetailIncentiveOfferConditionCode 60194 data type. A ConditionCode is a coded representation of a condition for an offer within a retail incentive. The ActivationStatusCode 60196 attribute is an ActivationStatusCode 60198 data type. An ActivationStatusCode represents the activation status of an offer. The RequirementMinimumAmount 60200 attribute is an Amount 60202 data type. A RequirementMinimumAmount represents a minimum amount. The RequirementMaximumAmount 60204 attribute is an Amount 60206 data type. A RequirementMaximumAmount represents a maximum amount. The MultipleGrantingAllowedIndicator 60208 attribute is an Indicator 60210 data type. A MultipleGrantingAllowedIndicator indicates whether something is allowed. The Description 60212 entity includes a Description 60216 attribute. The Description 60216 attribute is a MEDIUM_Description 60218 data type.

The Buy 60220 package is an <MT>OffrBuy 60224 data type. The Buy 60220 package includes a Buy 60222 entity. The Buy 60220 package includes a ProductGroup 60230 package. The Buy 60222 entity includes an AndOrBusinessRuleExpressionTypeCode 60226 attribute. The AndOrBusinessRuleExpressionTypeCode 60226 attribute is an AndOrBusinessRuleExpressionTypeCode 60228 data type. An AndOrBusinessRuleExpressionTypeCode is a coded representation of the type of a Business Rule Expression of type AndOr.

The ProductGroup 60230 package is an <MT>OffrBuyProdGrp 60234 data type. The ProductGroup 60230 package includes a ProductGroup 60232 entity. The ProductGroup 60230 package includes a Product 60248 package. The ProductGroup 60232 entity includes various attributes, namely a RequirementQuantity 60236, a RequirementQuantityDecimalValue 60240 and a RetailBonusBuyProductSelectionConditionCode 60244. The RequirementQuantity 60236 attribute is a Quantity 60238 data type. A RequirementQuantity represents a quantity of a material that is requested by a requirement. The RequirementQuantityDecimalValue 60240 attribute is a DecimalValue 60242 data type. A RequirementQuantityDecimalValue represents the multiplier for product requirement quantities. The RetailBonusBuyProductSelectionConditionCode 60244 attribute is a RetailBonusBuyProductSelectionConditionCode 60246 data type. A RetailBonusBuyProductSelectionConditionCode is a coded representation of a condition for product selection within a retail bonus buy.

The Product 60248 package is an <MT>OffrBuyProdGrpProd 60252 data type. The Product 60248 package includes a Product 60250 entity. The Product 60250 entity includes various attributes, namely an InternalID 60254, a StandardID 60258, a ProductCategoryInternalID 60262, a ProductCategoryHierarchyTypeCode 60266, a ProductCategoryHierarchyID 60270 and a RequirementQuantity 60274. The InternalID 60254 attribute is an NOSC_ProductInternalID 60256 data type. An InternalID is a proprietary identifier for a product. The StandardID 60258 attribute is an NOSC_ProductStandardID 60260 data type. A StandardID is a standardized identifier for a product. In some implementations, the AgencySchemeID is fixed by Provider and Consumer (e.g., typically, nine characters (International Article Number, or EAN) and does not need to be specified). The ProductCategoryInternalID 60262 attribute is an NOSC_ProductCategoryInternalID 60264 data type. A ProductCategoryInternalID is a proprietary identifier for a product category. The ProductCategoryHierarchyTypeCode 60266 attribute is a ProductCategoryHierarchyTypeCode 60268 data type. A ProductCategoryHierarchyTypeCode is a coded representation of the type of a product category hierarchy. The ProductCategoryHierarchyID 60270 attribute is an NOSC_ProductCategoryHierarchyID 60272 data type. A ProductCategoryHierarchyID is a unique identifier for a product category hierarchy. The RequirementQuantity 60274 attribute is a Quantity 60276 data type. A RequirementQuantity represents a non-monetary numerical specification of an amount in a unit of measurement.

The Get 60278 package is an <MT>OffrGet 60282 data type. The Get 60278 package includes a Get 60280 entity. The Get 60278 package includes a ProductGroup 60308 package. The Get 60280 entity includes various attributes, namely an AndOrBusinessRuleExpressionTypeCode 60284, a SalesPriceBaseQuantity 60288, a PriceAmount 60292, a DiscountAmount 60296, a DiscountPercent 60300 and an InBuyIncludedIndicator 60304. The AndOrBusinessRuleExpressionTypeCode 60284 attribute is an AndOrBusinessRuleExpressionTypeCode 60286 data type. An AndOrBusinessRuleExpressionTypeCode is a coded representation of the type of a Business Rule Expression of type AndOr. The SalesPriceBaseQuantity 60288 attribute is a Quantity 60290 data type. A SalesPriceBaseQuantity represents a quantity that is defined as a base of another quantity or amount. The PriceAmount 60292 attribute is an Amount 60294 data type. A PriceAmount represents the amount of a price. The DiscountAmount 60296 attribute is an Amount 60298 data type. A DiscountAmount represents the amount of a discount. The DiscountPercent 60300 attribute is a Percent 60302 data type. A DiscountPercent represents a discount expressed as a percent. The InBuyIncludedIndicator 60304 attribute is an Indicator 60306 data type. An InBuyIncludedIndicator indicates whether something is included.

The ProductGroup 60308 package is an <MT>OffrGetProdGrp 60312 data type. The ProductGroup 60308 package includes a ProductGroup 60310 entity. The ProductGroup 60308 package includes a Product 60330 package. The ProductGroup 60310 entity includes various attributes, namely a GrantedQuantity 60314, an IntervalBoundaryTypeCode 60318, a GrantedQuantityLowerBoundaryDecimalValue 60322 and a GrantedQuantityUpperBoundaryDecimalValue 60326. The GrantedQuantity 60314 attribute is a Quantity 60316 data type. A GrantedQuantity represents a quantity that has been granted by someone. The IntervalBoundaryTypeCode 60318 attribute is an IntervalBoundaryTypeCode 60320 data type. An IntervalBoundaryTypeCode is a coded representation of an interval boundary type. The GrantedQuantityLowerBoundaryDecimalValue 60322 attribute is a DecimalValue 60324 data type. A GrantedQuantityLowerBoundaryDecimalValue represents a multiplier for product granted quantities. The GrantedQuantityUpperBoundaryDecimalValue 60326 attribute is a DecimalValue 60328 data type. A GrantedQuantityUpperBoundaryDecimalValue represents the multiplier for the product granted quantities.

The Product 60330 package is an <MT>OffrGetProdGrpProd 60334 data type. The Product 60330 package includes a Product 60332 entity. The Product 60330 package includes a StoreQuantities 60384 package. The Product 60332 entity includes various attributes, namely an InternalID 60336, a StandardID 60340, a ProductCategoryInternalID 60344, a ProductCategoryHierarchyTypeCode 60348, a ProductCategoryHierarchyID 60352, a ConsumerProductGroupHierarchyID 60356, a ConsumerProductGroupID 60360, a SeasonCategoryCode 60364, a SeasonYearID 60368, a GrantedQuantity 60372, a PlannedSalesQuantity 60376 and a RetailEventThemeCode 60380. The InternalID 60336 attribute is an NOSC_ProductInternalID 60338 data type. An InternalID is a proprietary identifier for a product. The StandardID 60340 attribute is an NOSC_ProductStandardID 60342 data type. A StandardID is a standardized identifier for a product. In some implementations, the AgencySchemeID is fixed by Provider and Consumer (e.g., typically, nine characters (International Article Number, or EAN) and does not need to be specified). The ProductCategoryInternalID 60344 attribute is an NOSC_ProductCategoryInternalID 60346 data type. A ProductCategoryInternalID is a proprietary identifier for a product category. The ProductCategoryHierarchyTypeCode 60348 attribute is a ProductCategoryHierarchyTypeCode 60350 data type. A ProductCategoryHierarchyTypeCode is a coded representation of the type of a product category hierarchy. The ProductCategoryHierarchyID 60352 attribute is an NOSC_ProductCategoryHierarchyID 60354 data type. A ProductCategoryHierarchyID is a unique identifier for a product category hierarchy. The ConsumerProductGroupHierarchyID 60356 attribute is a ConsumerProductGroupHierarchyID 60358 data type. A ConsumerProductGroupHierarchyID is an identifier for a consumer product group hierarchy. The ConsumerProductGroupID 60360 attribute is a ConsumerProductGroupID 60362 data type. A ConsumerProductGroupID is an identifier for a consumer product group. The SeasonCategoryCode 60364 attribute is an NOSC_SeasonCategoryCode 60366 data type. A SeasonCategoryCode is a coded representation of a season category. The SeasonYearID 60368 attribute is an NOSC_SeasonYearID 60370 data type. A SeasonYearID is an identifier for a season year. The GrantedQuantity 60372 attribute is a Quantity 60374 data type. A GrantedQuantity represents a quantity that has been granted by someone. The PlannedSalesQuantity 60376 attribute is a Quantity 60378 data type. A PlannedSalesQuantity denotes a quantity of products that is planned to be sold. The RetailEventThemeCode 60380 attribute is a RetailEventThemeCode 60382 data type. A RetailEventThemeCode represents an assigned retail event theme.

The StoreQuantities 60384 package is an <MT>OffrGetProdGrpProdStoreQts 60388 data type. The StoreQuantities 60384 package includes a StoreQuantities 60386 entity. The StoreQuantities 60386 entity includes various attributes, namely a StoreInternalID 60390 and a PlannedSalesQuantity 60394. The StoreInternalID 60390 attribute is an NOSC_StoreInternalID 60392 data type. A StoreInternalID is a proprietary identifier for a store. The PlannedSalesQuantity 60394 attribute is a Quantity 60396 data type. A PlannedSalesQuantity denotes the quantity of products that is planned to be sold.

The SalesPriceSpecification 60398 package is an <MT>OffrSlsPrSpec 60402 data type. The SalesPriceSpecification 60398 package includes a SalesPriceSpecification 60400 entity. The SalesPriceSpecification 60398 package includes various packages, namely a PropertyValuation 60428 and a ScaleLine 60446. The SalesPriceSpecification 60400 entity includes various attributes, namely a PriceSpecificationElementTypeCode 60404, a ValidityPeriod 60408, an Amount 60412, a BaseQuantity 60416, a BaseQuantityTypeCode 60420 and a Percent 60424. The PriceSpecificationElementTypeCode 60404 attribute is an NOSC_PriceSpecificationElementTypeCode 60406 data type. A PriceSpecificationElementTypeCode is a coded representation of the type of a PriceSpecificationElement. The ValidityPeriod 60408 attribute is a TimePointPeriod 60410 data type. A ValidityPeriod represents a period in which something is valid. The Amount 60412 attribute is an Amount 60414 data type. An Amount represents an amount with a corresponding currency unit. The BaseQuantity 60416 attribute is a Quantity 60418 data type. A BaseQuantity represents a quantity that is defined as a base of another quantity or amount. The BaseQuantityTypeCode 60420 attribute is an NOSC_QuantityTypeCode 60422 data type. A BaseQuantityTypeCode is a coded representation of a type of quantity that is based on a measurable characteristic of an object or physical phenomenon. The Percent 60424 attribute is a Percent 60426 data type. A Percent represents a number that relates to the comparison figure one hundred.

The PropertyValuation 60428 package is an <MT>OffrSlsPrSpecPrptyValn 60432 data type. The PropertyValuation 60428 package includes a PropertyValuation 60430 entity. The PropertyValuation 60430 entity includes various attributes, namely a PriceSpecificationElementPropertyReference 60434, a PriceSpecificationElementPropertyValue 60438 and a Description 60442. The PriceSpecificationElementPropertyReference 60434 attribute is a PriceSpecificationElementPropertyReference 60436 data type. A PriceSpecificationElementPropertyReference is a unique reference of a property for the specification of a price, discount or surcharge within a property definition class. The PriceSpecificationElementPropertyValue 60438 attribute is a PriceSpecificationElementPropertyValue 60440 data type. A PriceSpecificationElementPropertyValue is a value that is assigned to a property within a property valuation of a PriceSpecificationElement. The Description 60442 attribute is a SHORT_Description 60444 data type. A Description is a representation of the properties of an object in natural language.

The ScaleLine 60446 package is an <MT>OffrSlsPrSpecScLine 60450 data type. The ScaleLine 60446 package includes a ScaleLine 60448 entity. The ScaleLine 60448 entity includes various attributes, namely a ScaleAxisStep 60452, an Amount 60456 and a Percent 60460. The ScaleAxisStep 60452 attribute is an NOSC_ScaleAxisStep 60454 data type. A ScaleAxisStep represents a step (e.g., scale dimension value) of a scale axis. The Amount 60456 attribute is an Amount 60458 data type. An Amount represents an amount with a corresponding currency unit. The Percent 60460 attribute is a Percent 60462 data type. A Percent represents a number that relates to the comparison figure one hundred.

The Store 60464 package is an <MT>OffrStore 60468 data type. The Store 60464 package includes a Store 60466 entity. The Store 60466 entity includes an InternalID 60470 attribute. The InternalID 60470 attribute is an NOSC_StoreInternalID 60472 data type. An InternalID is a proprietary identifier for a store.

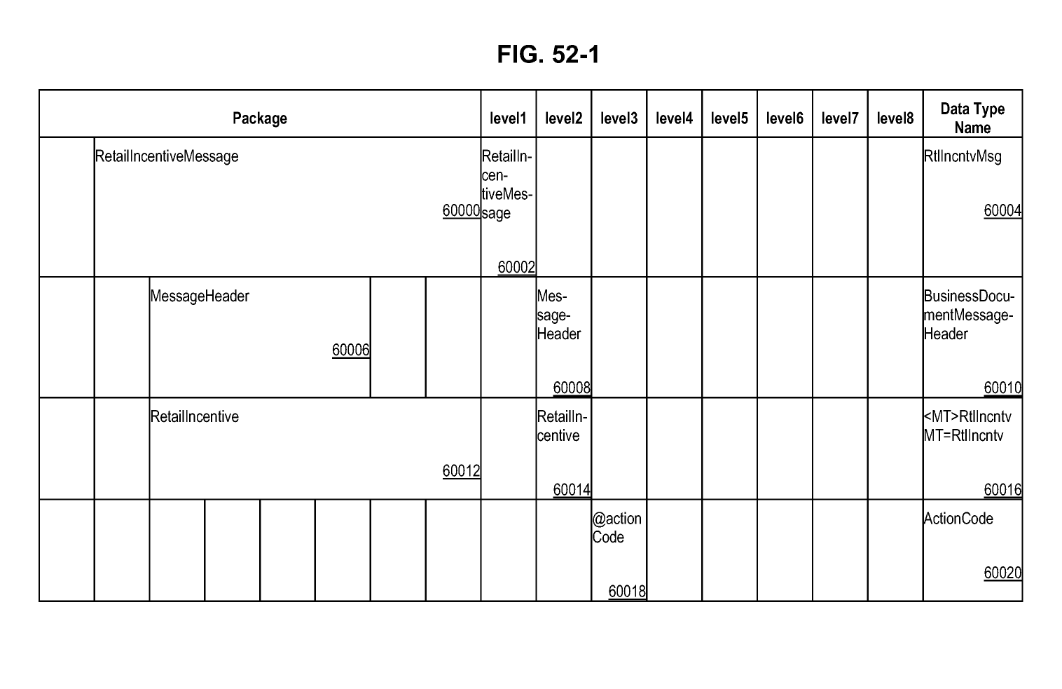

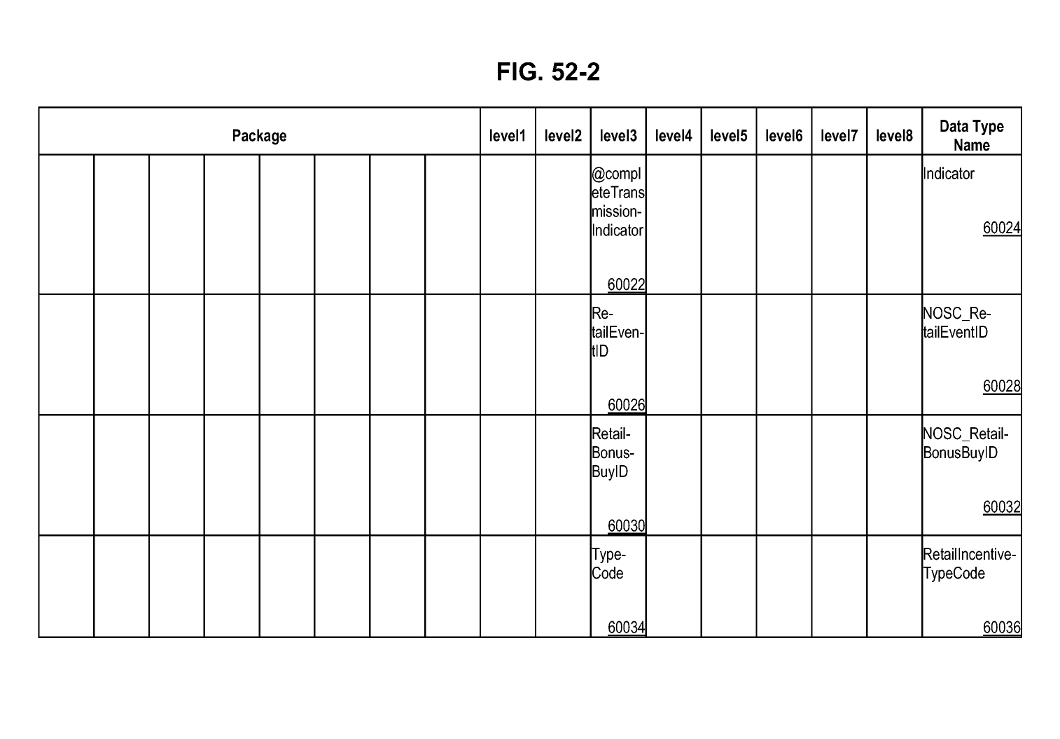

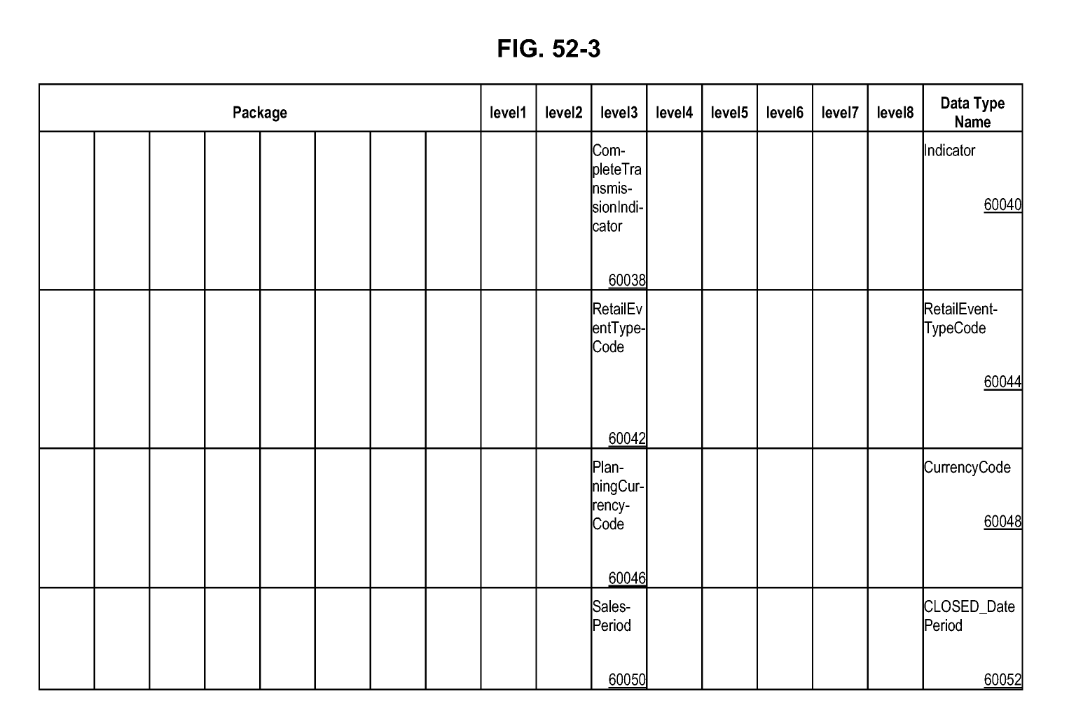

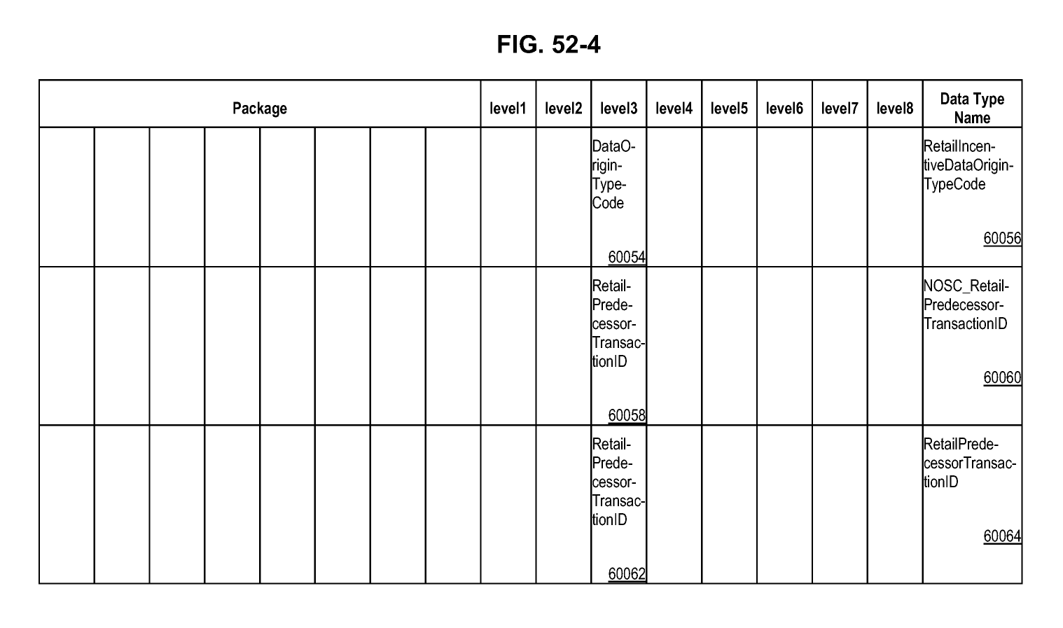

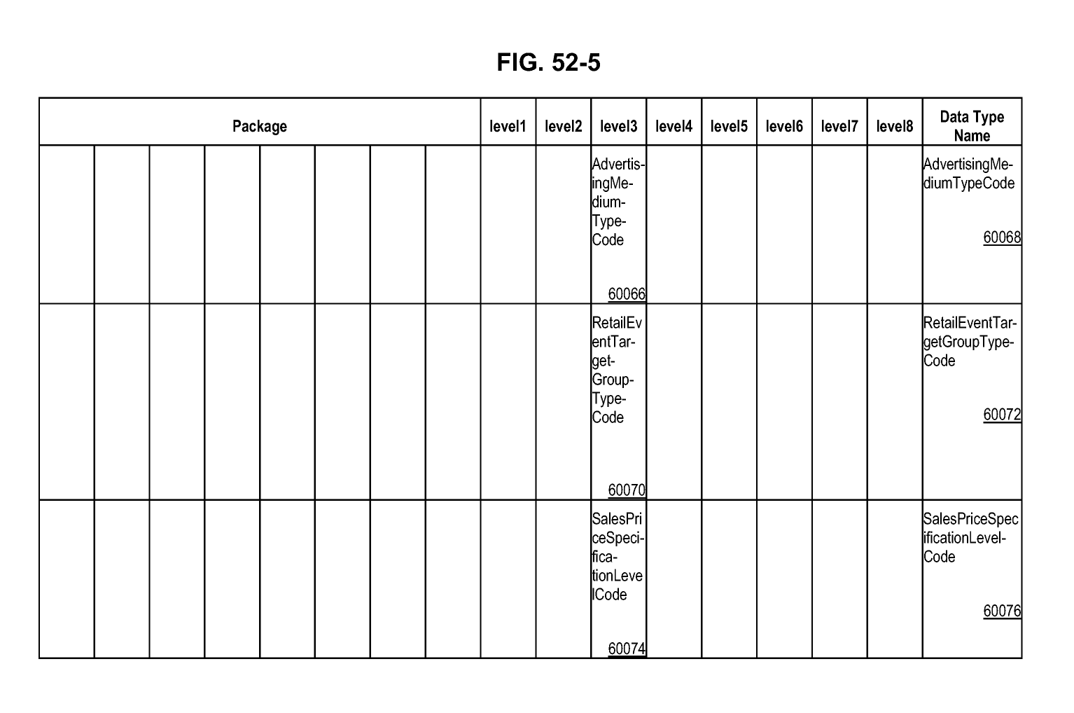

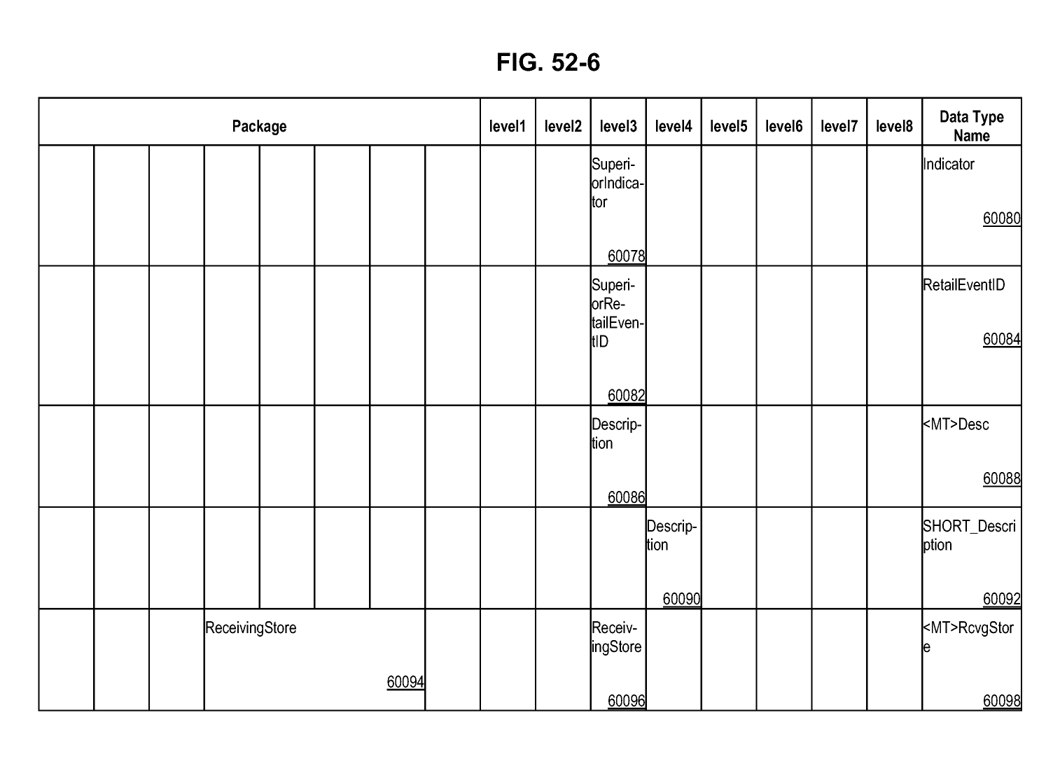

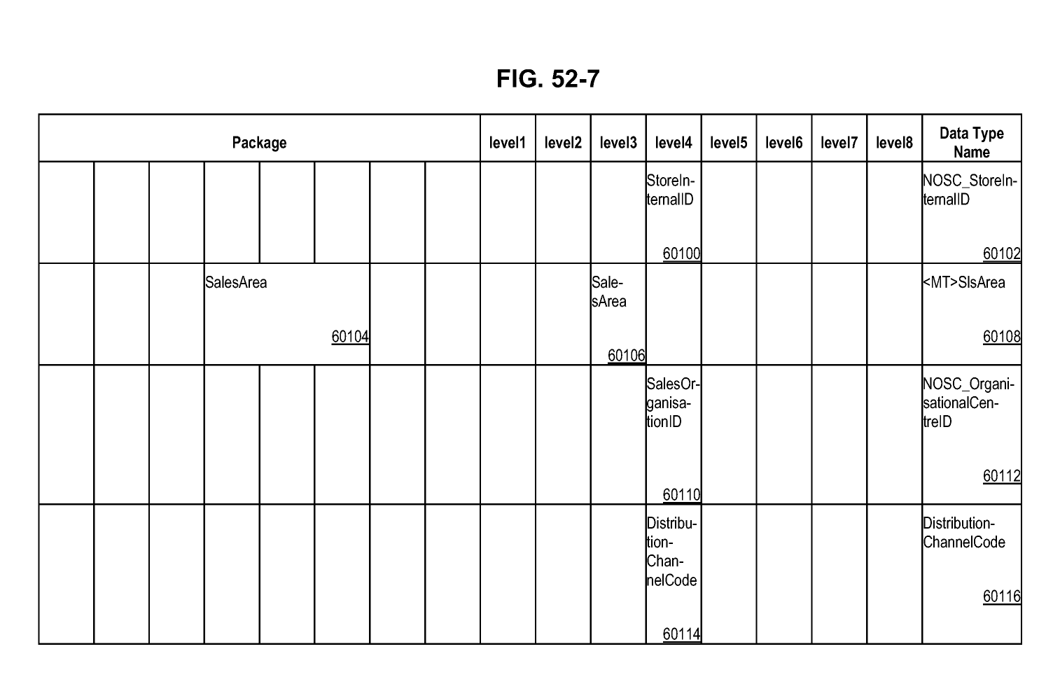

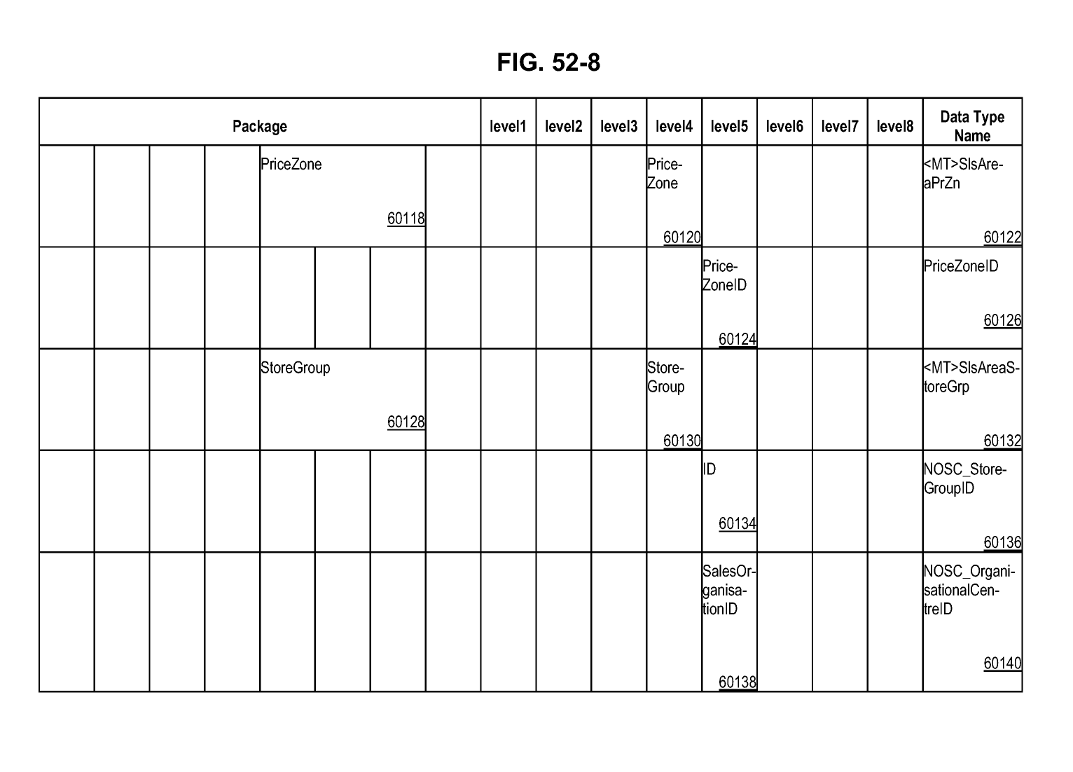

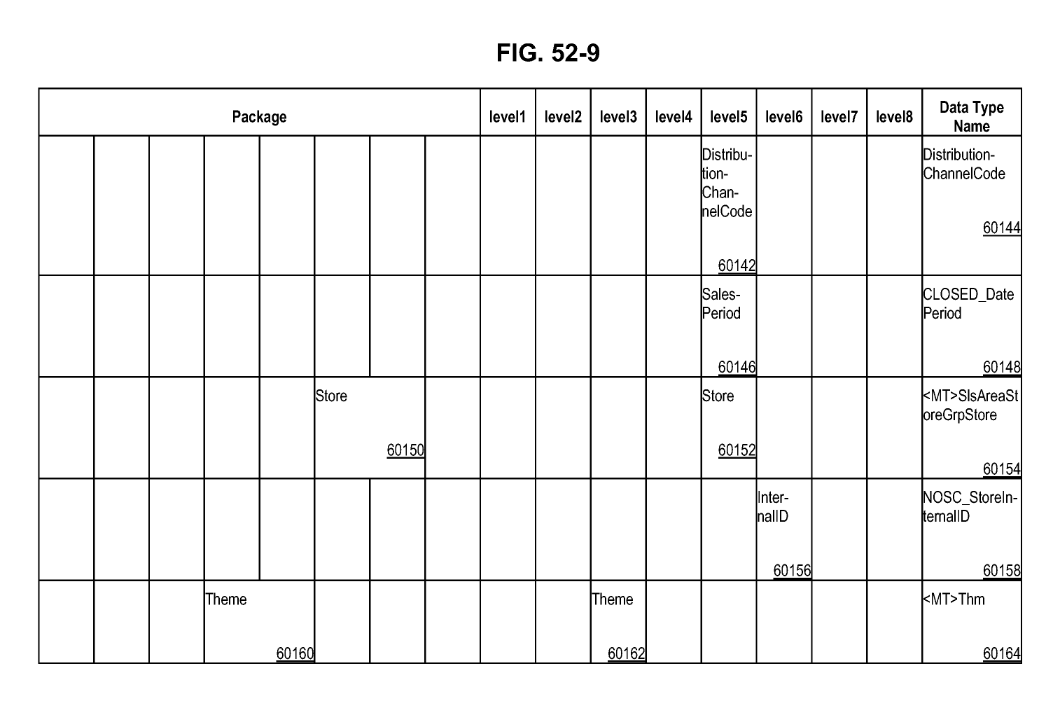

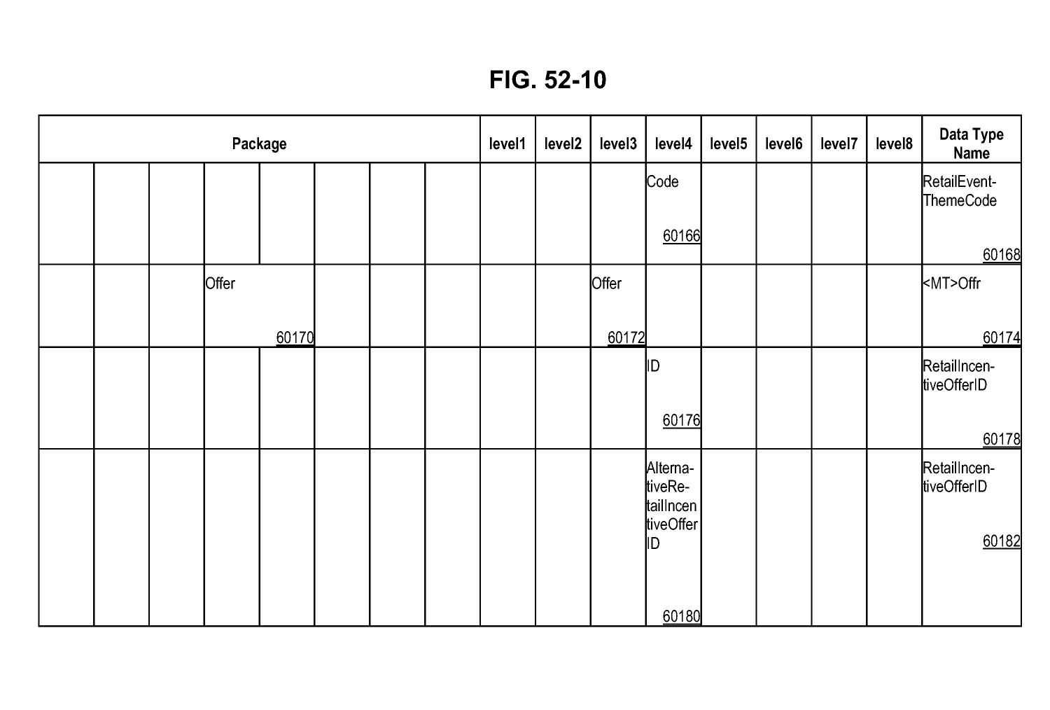

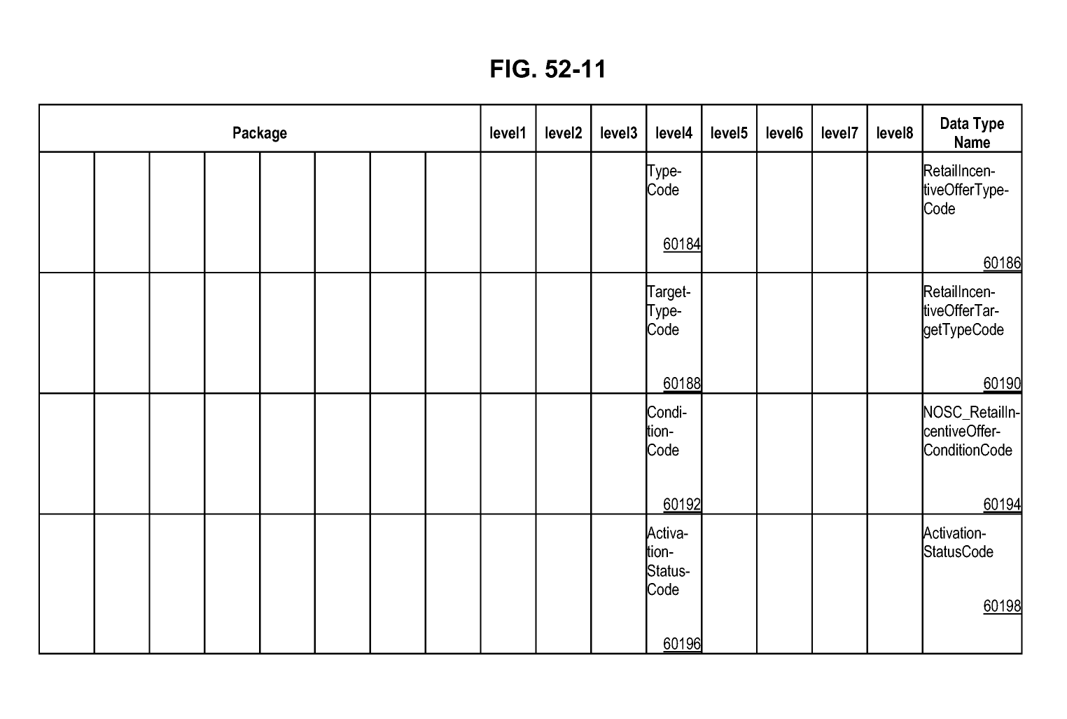

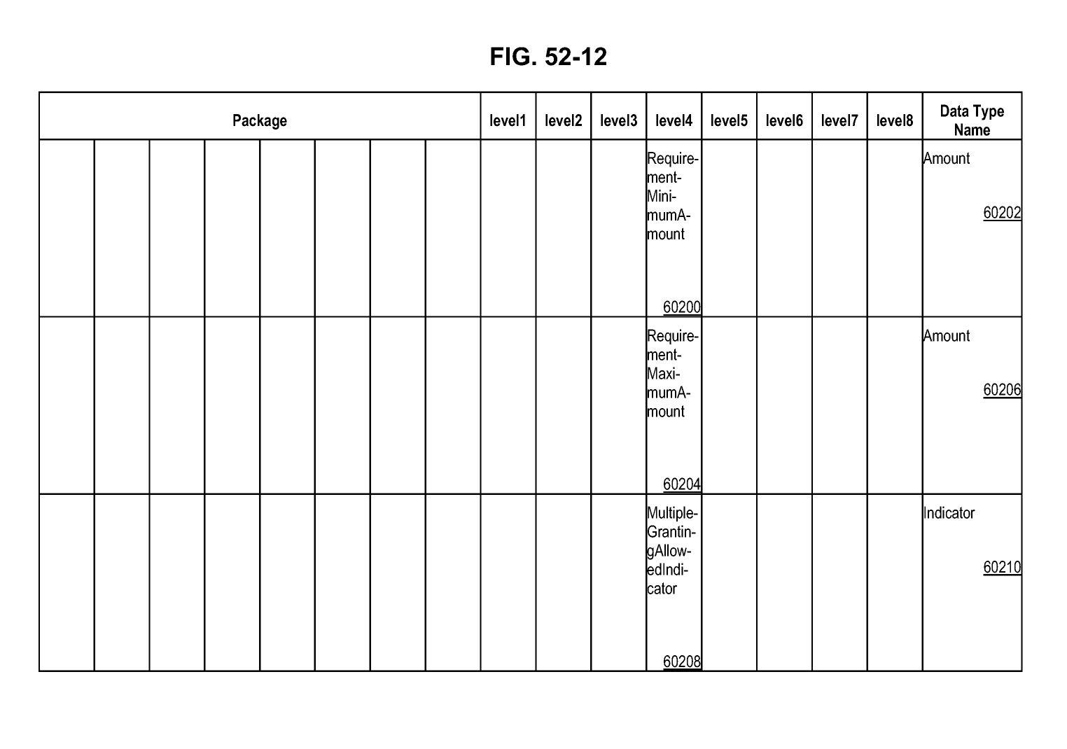

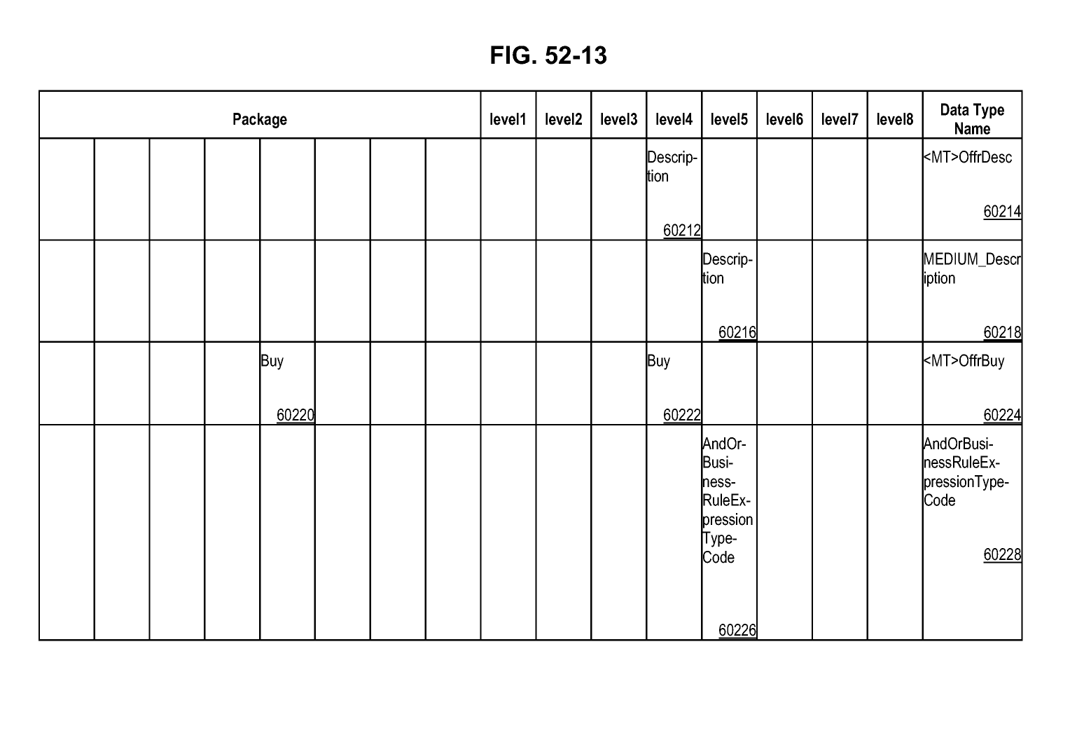

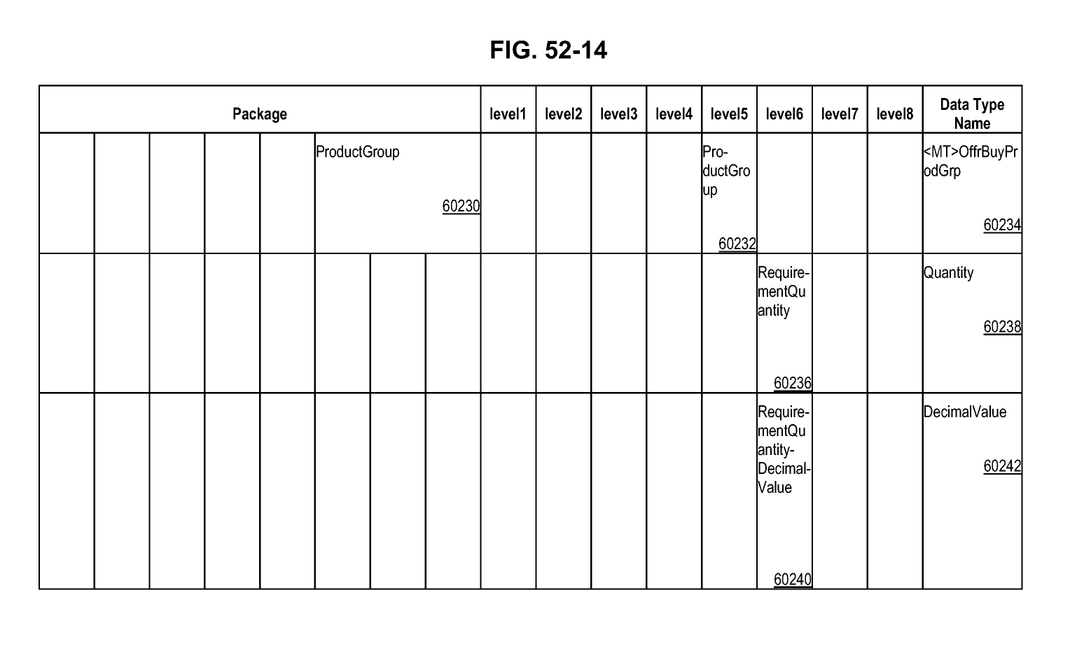

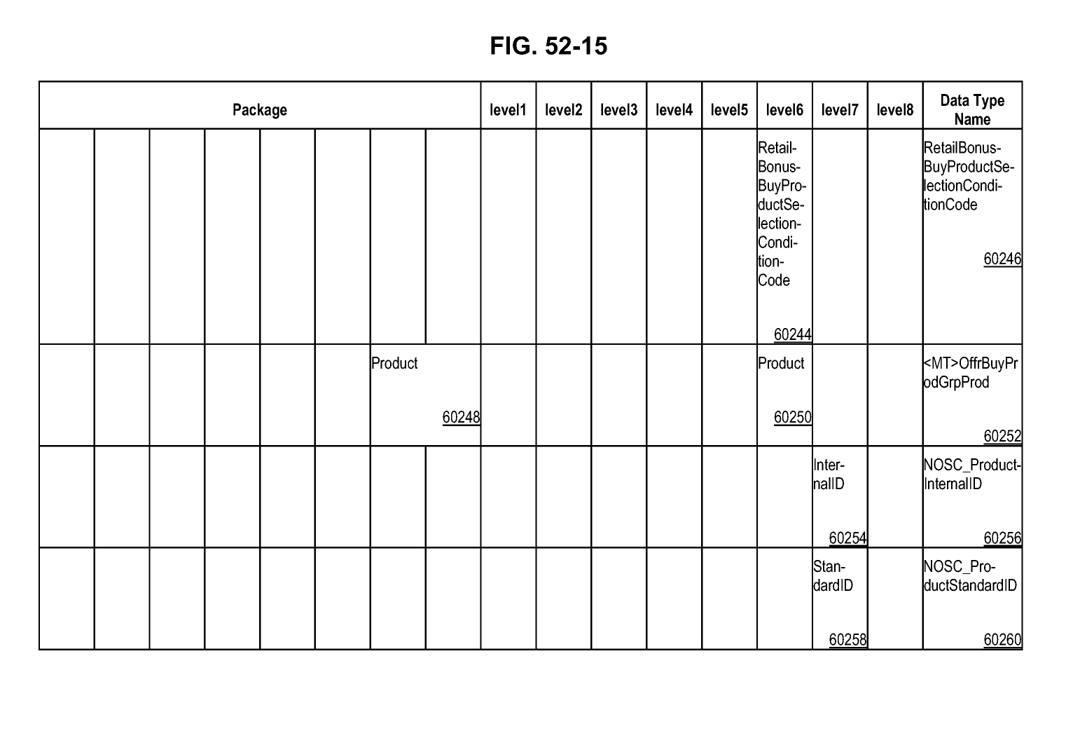

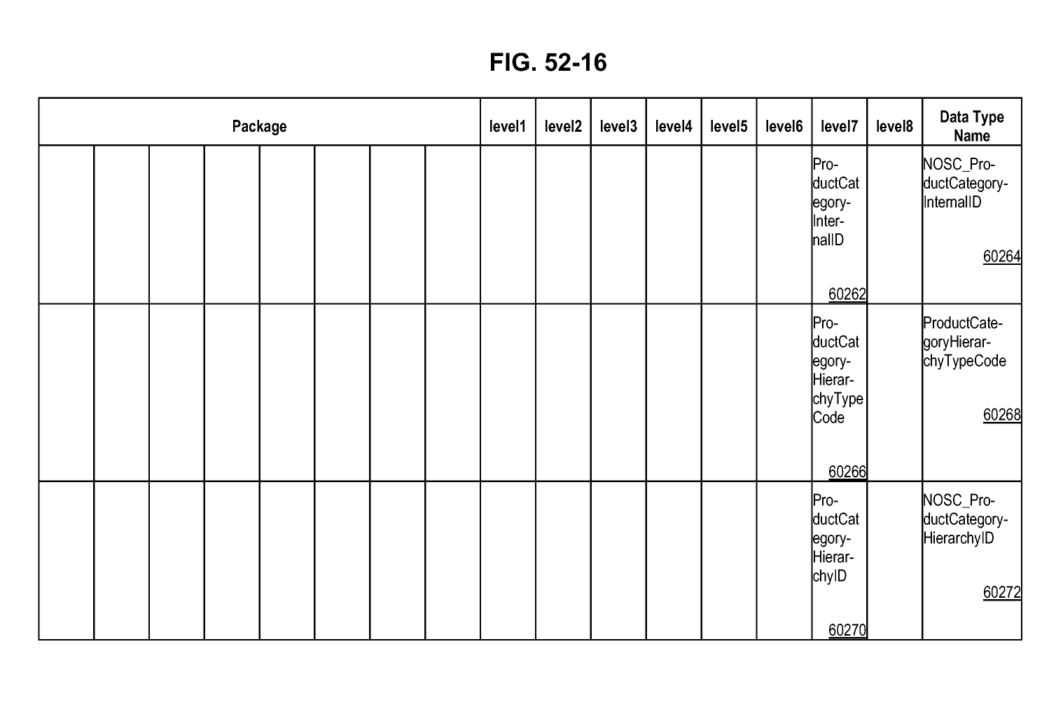

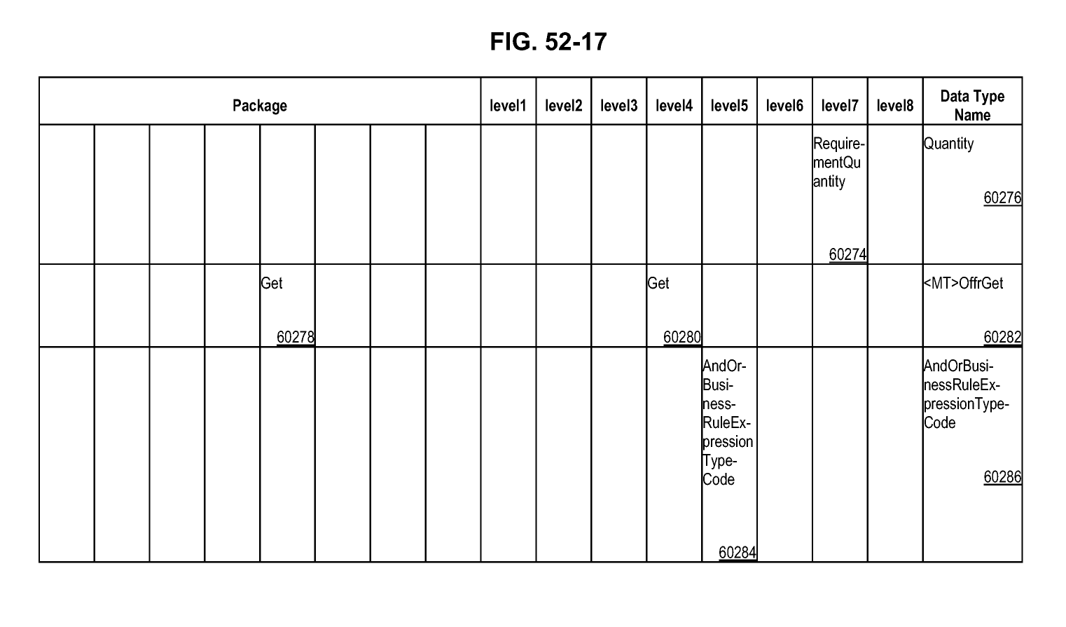

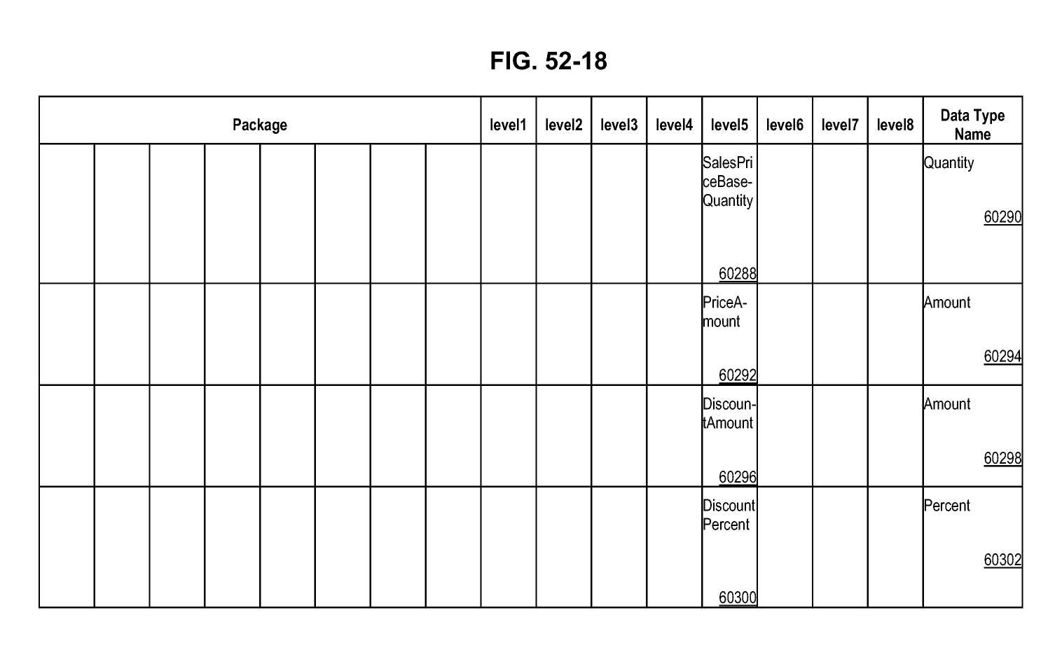

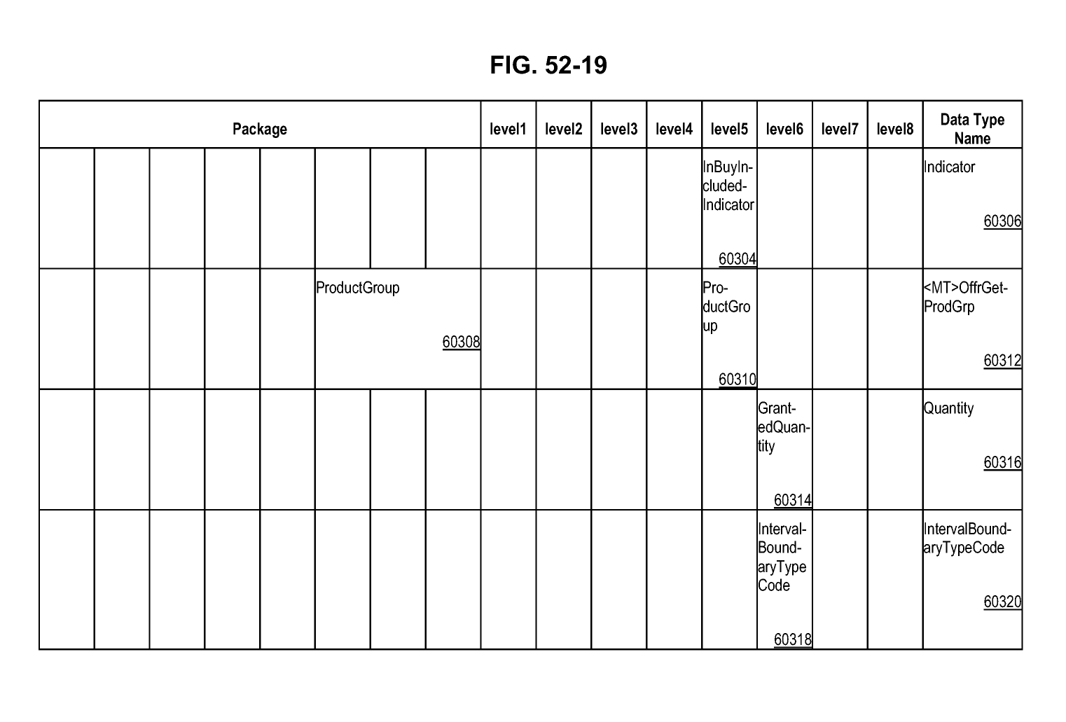

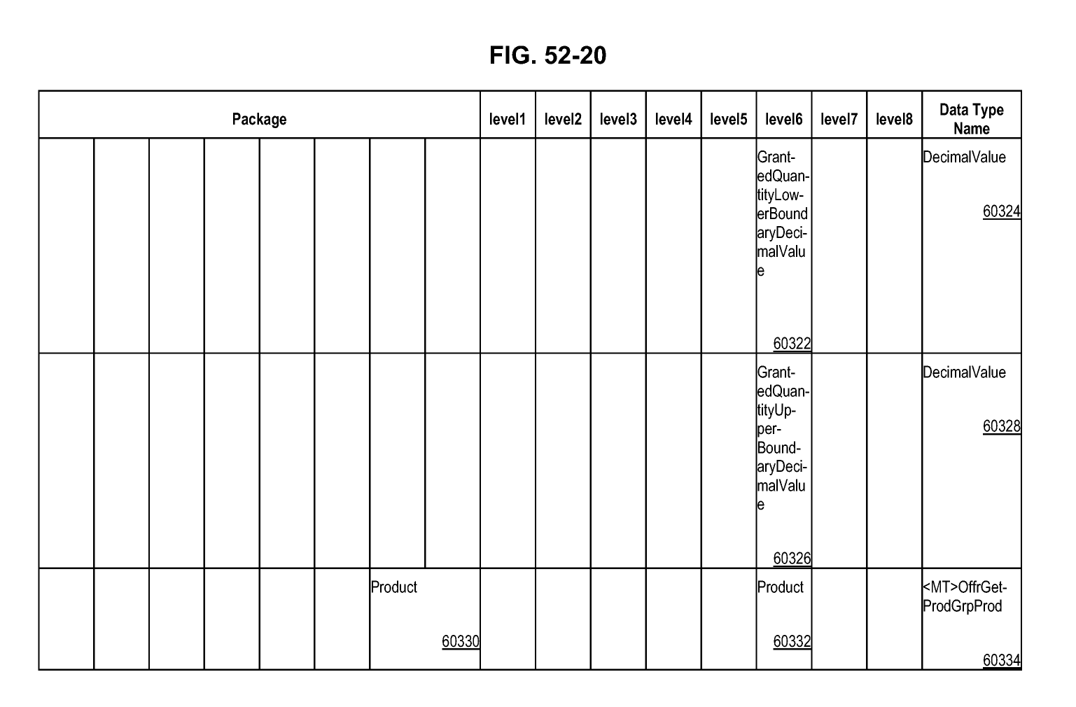

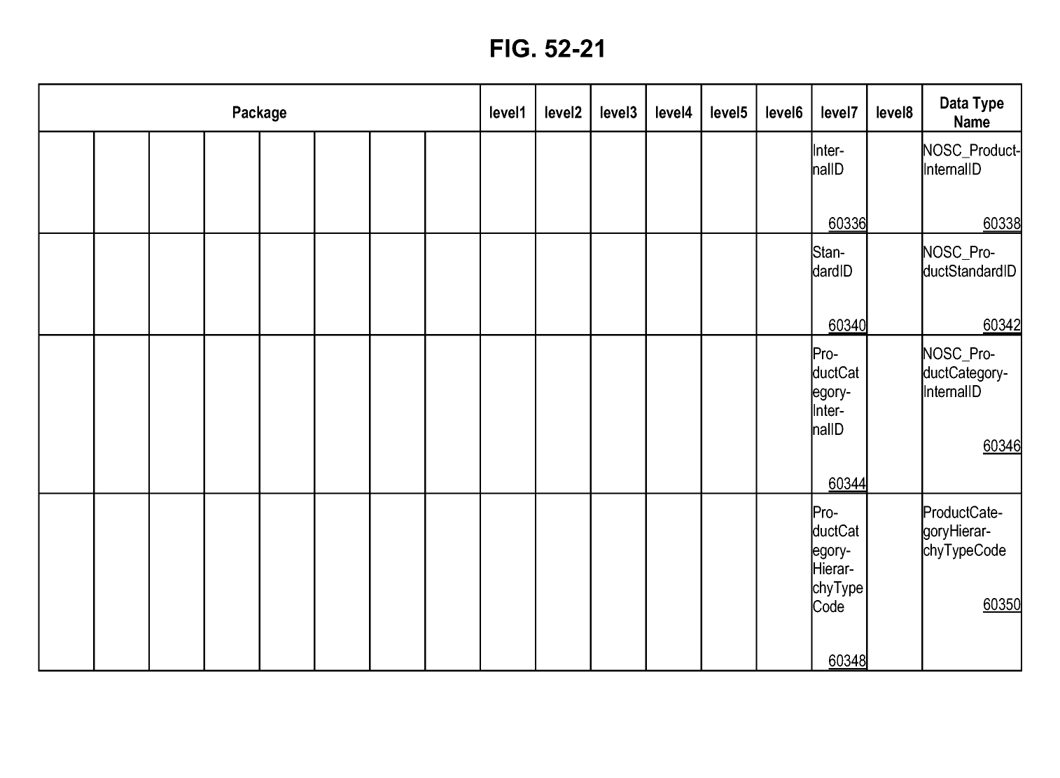

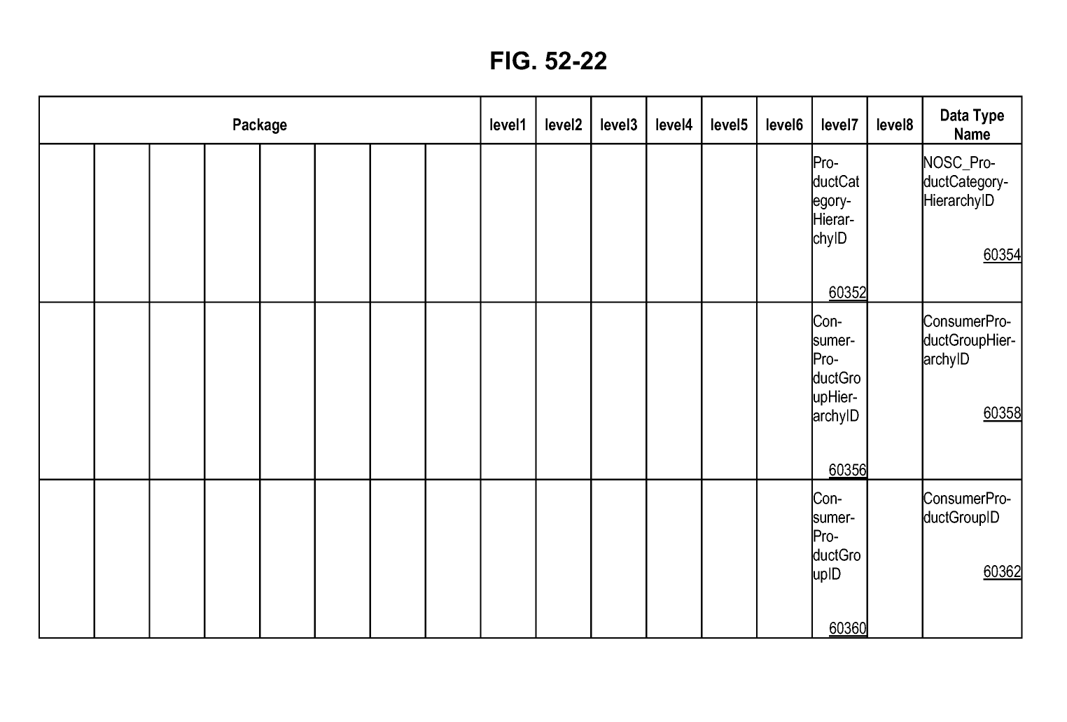

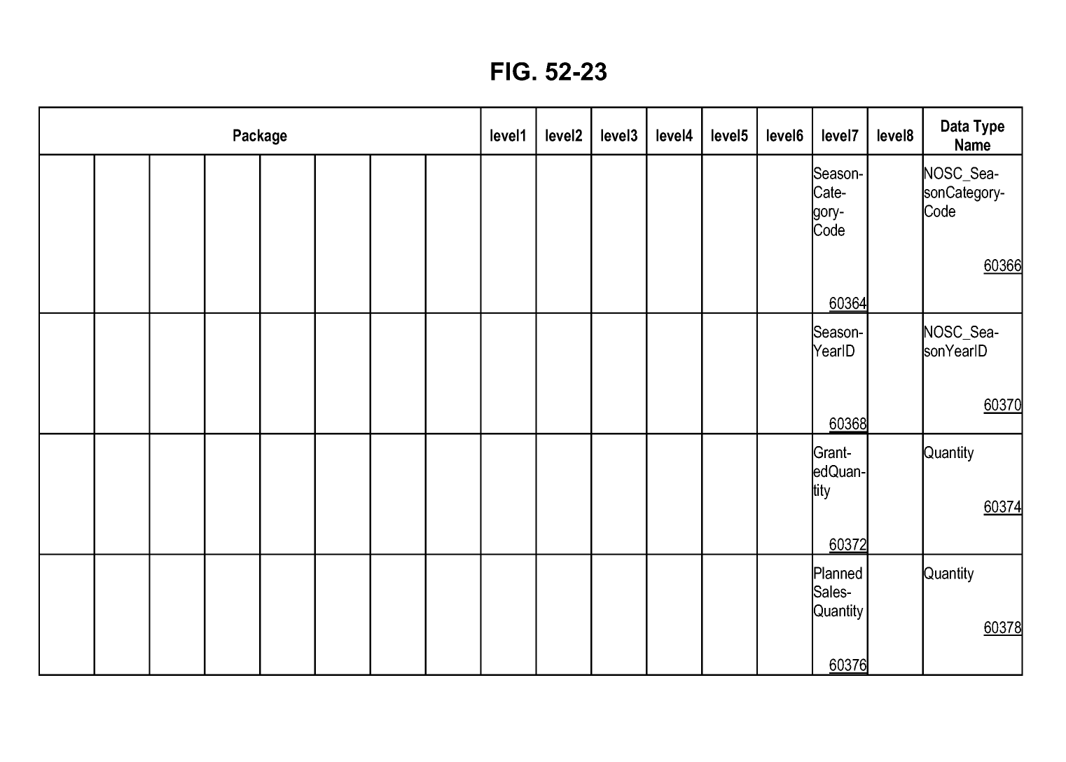

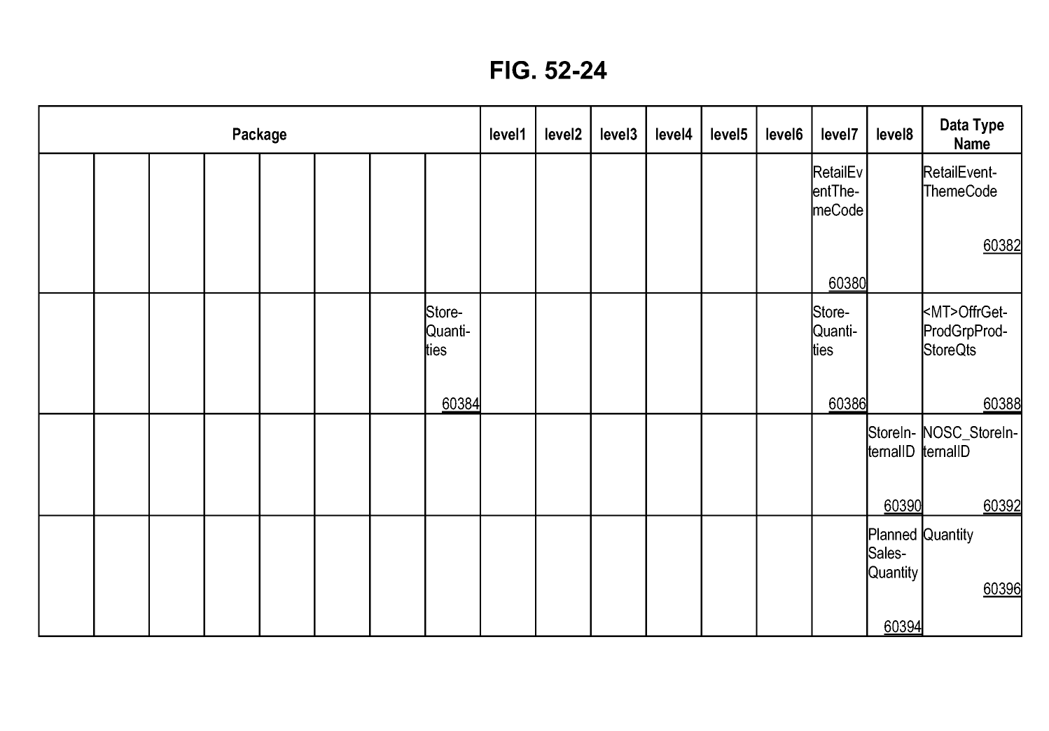

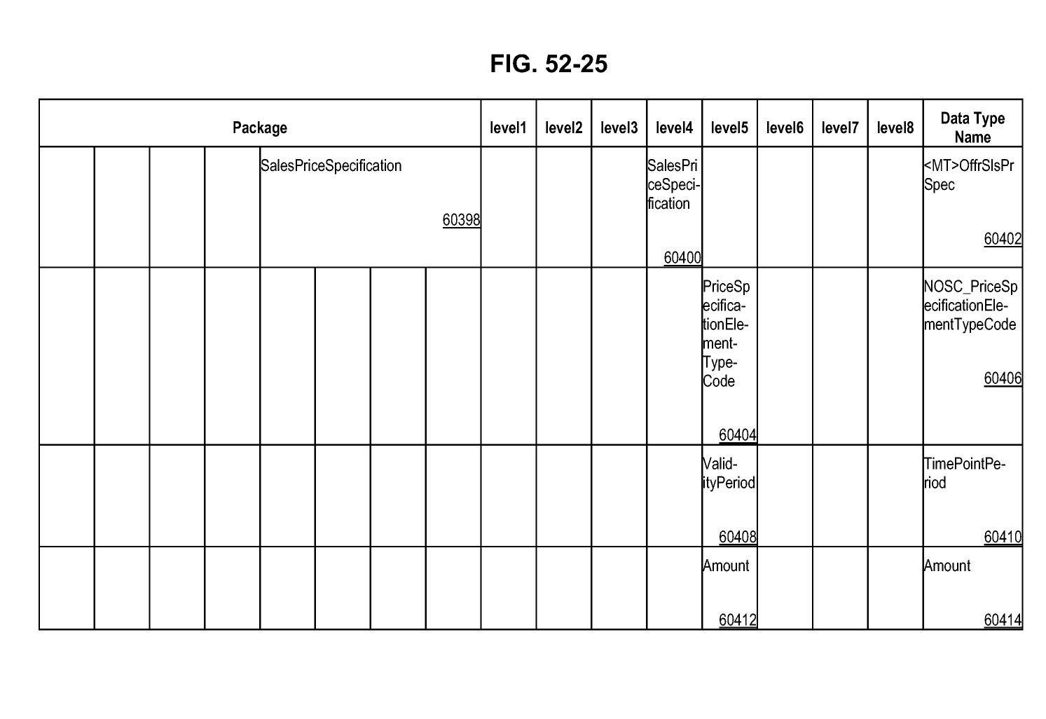

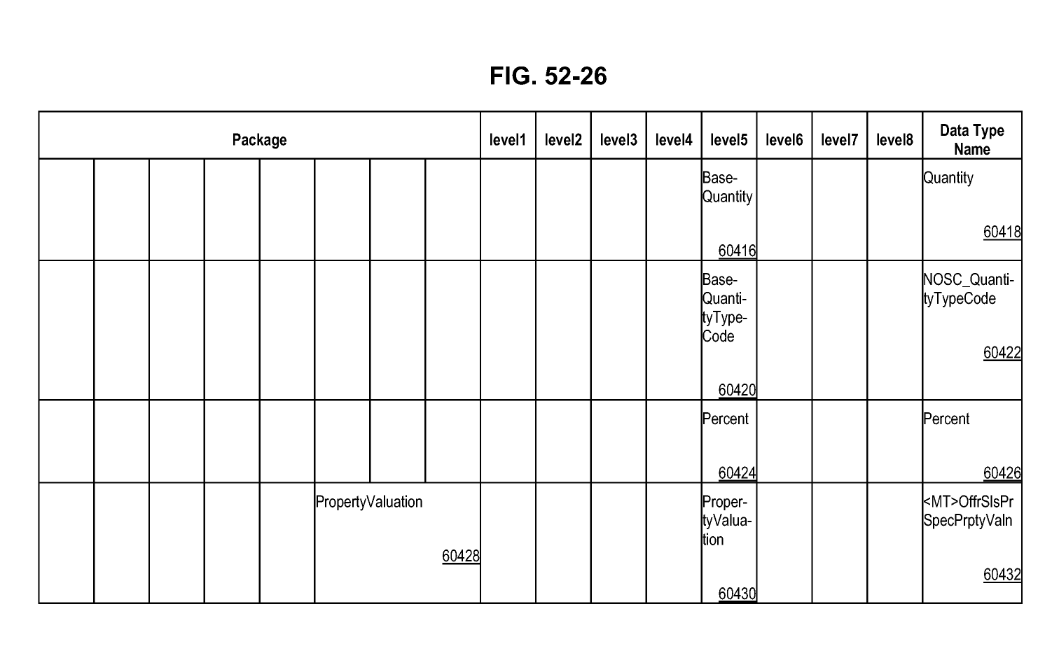

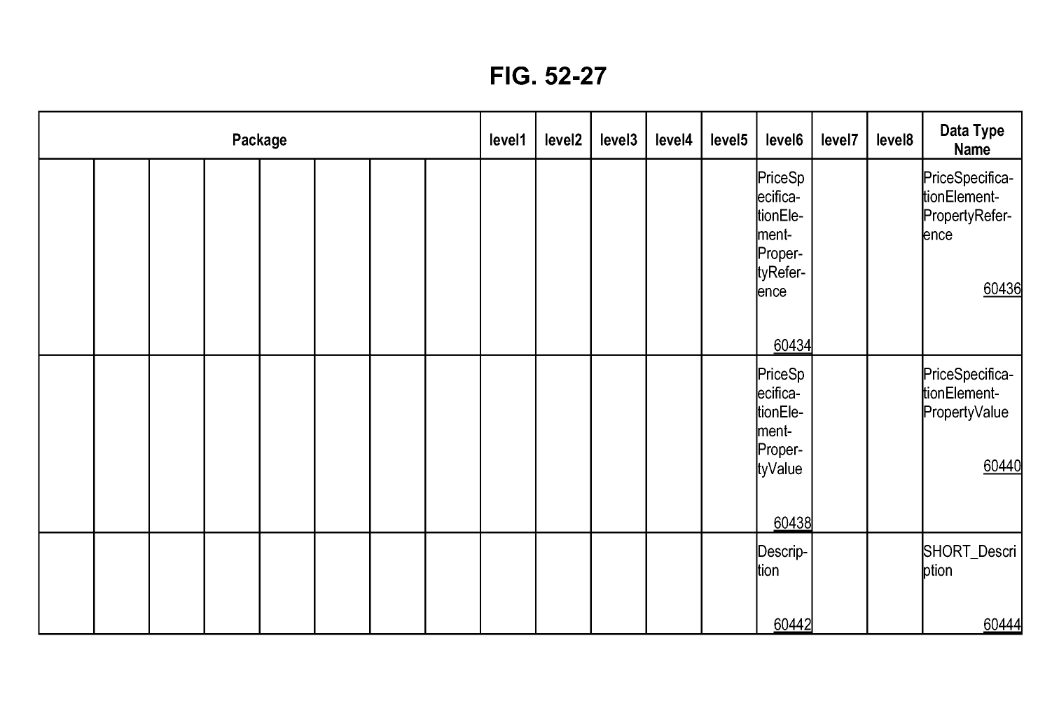

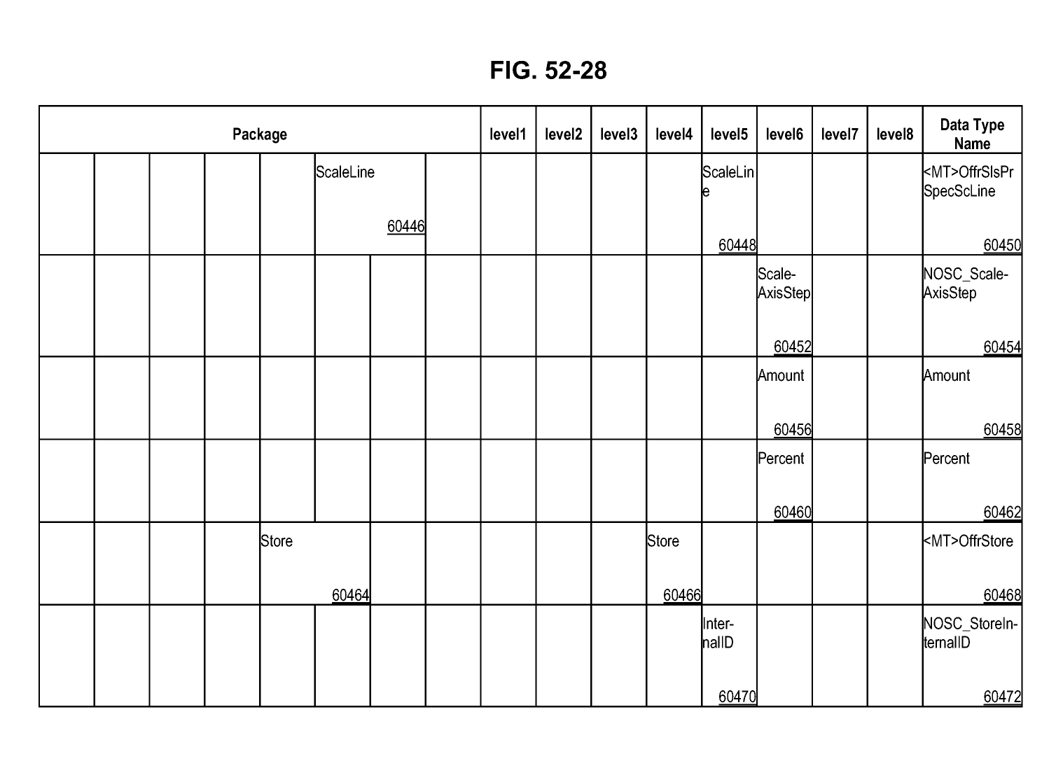

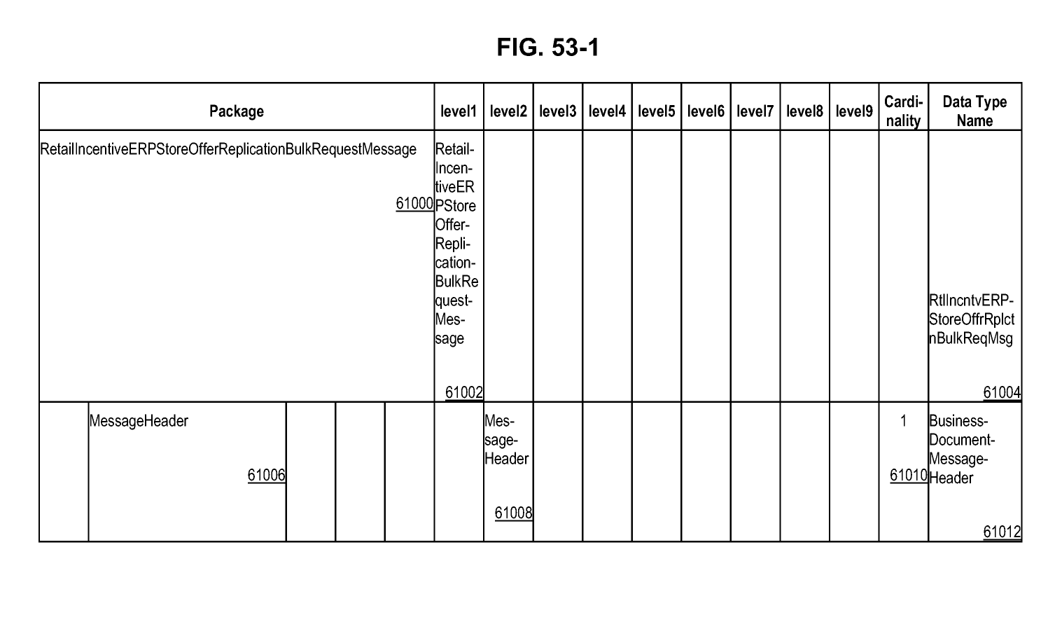

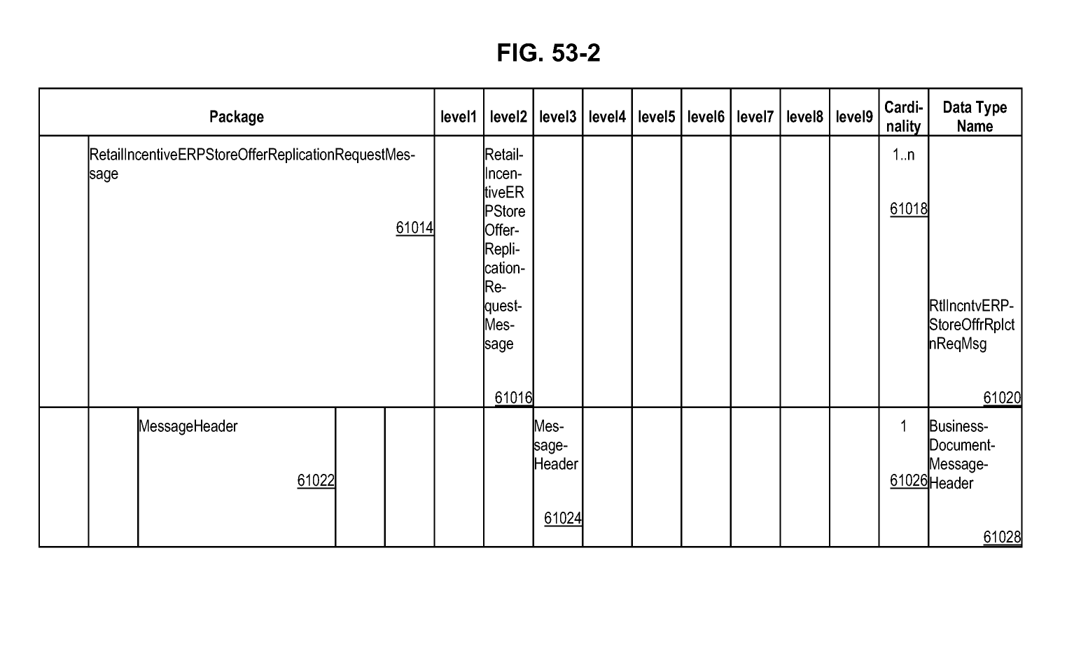

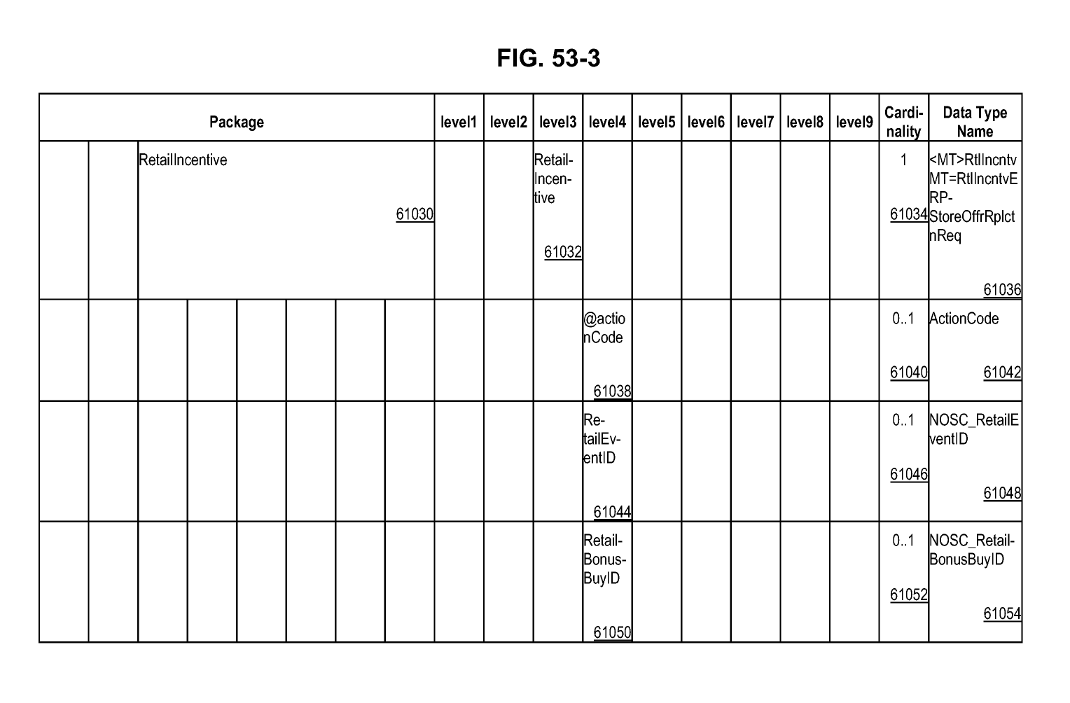

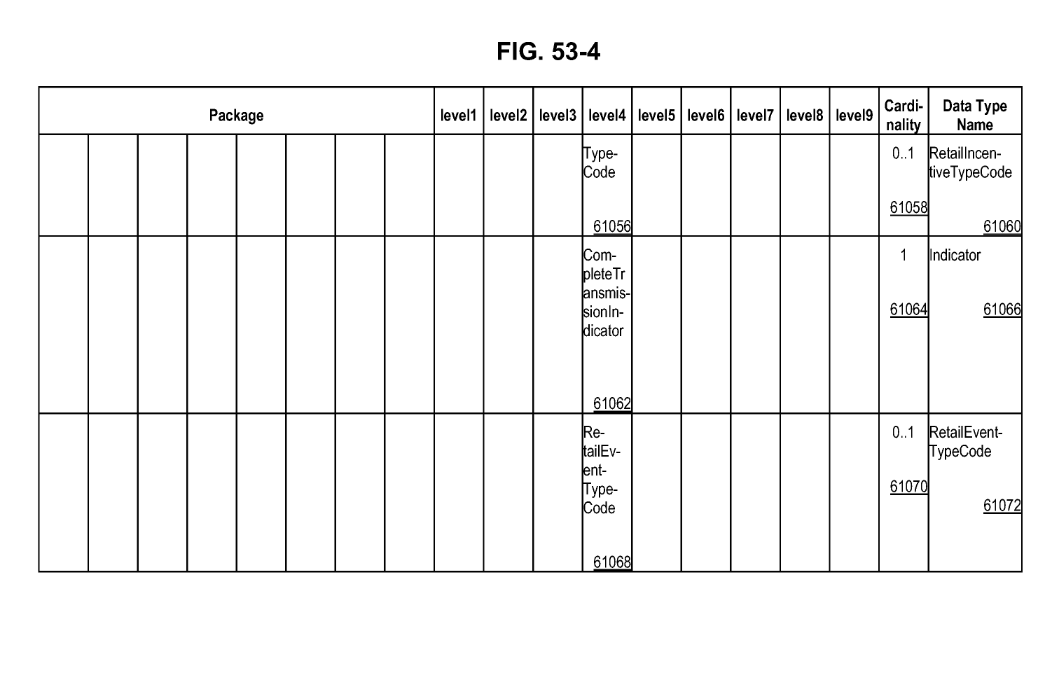

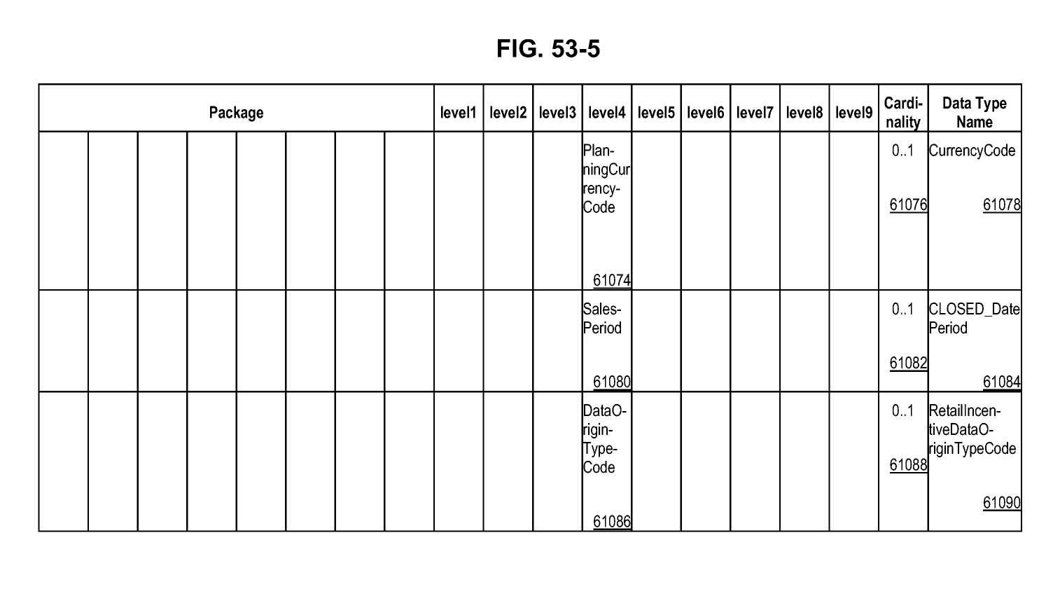

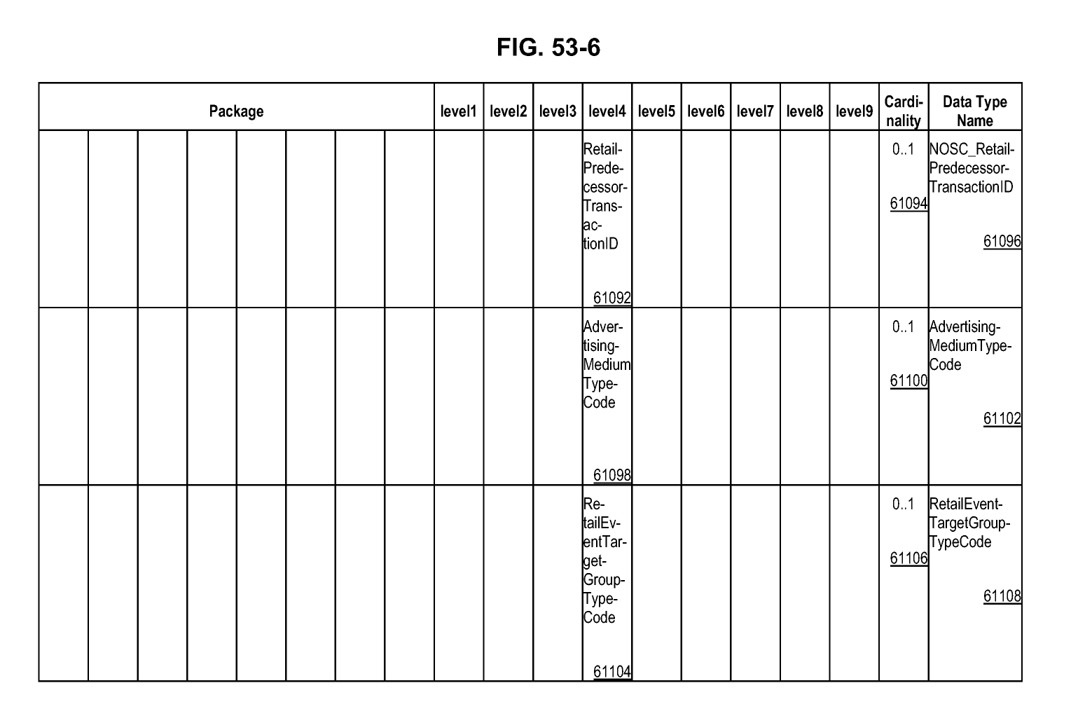

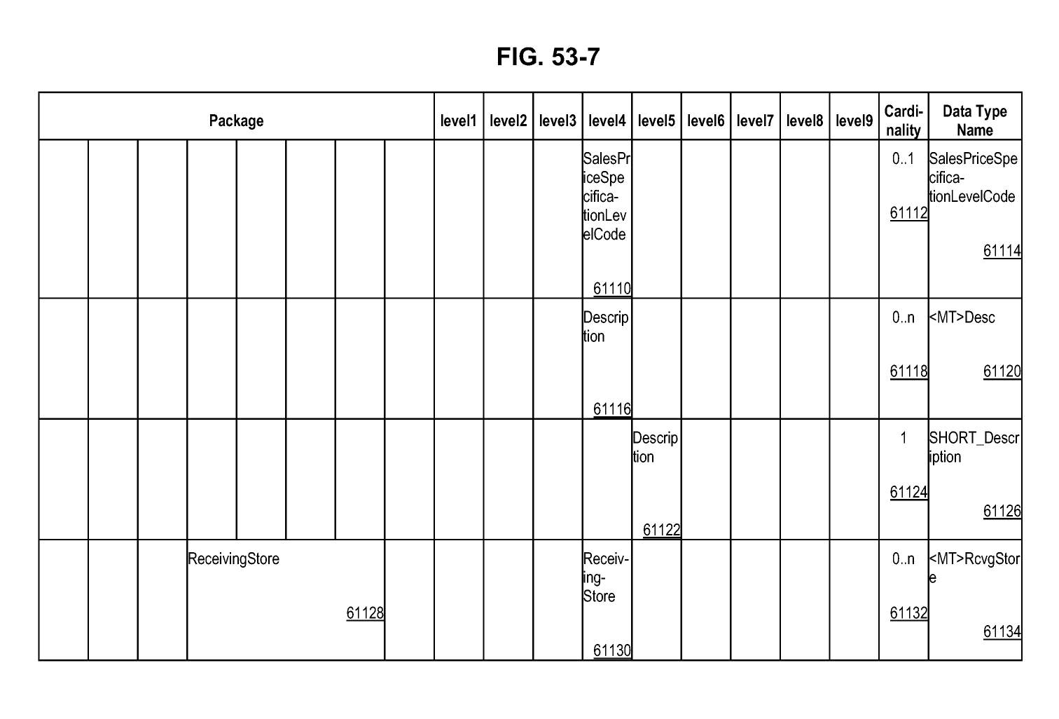

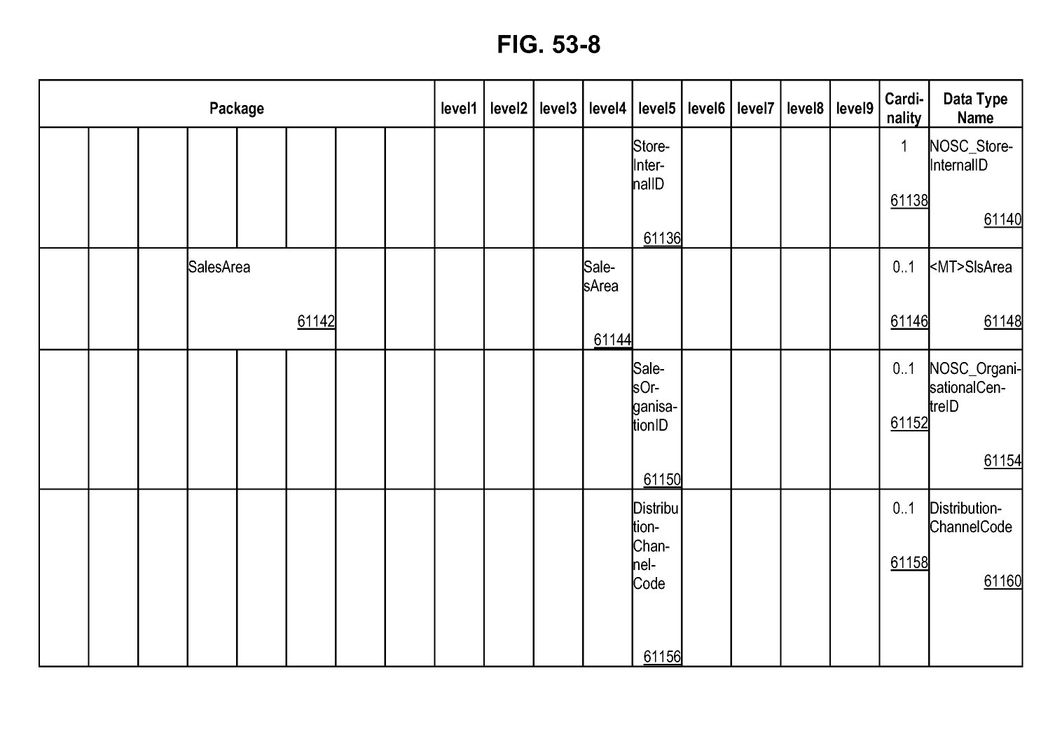

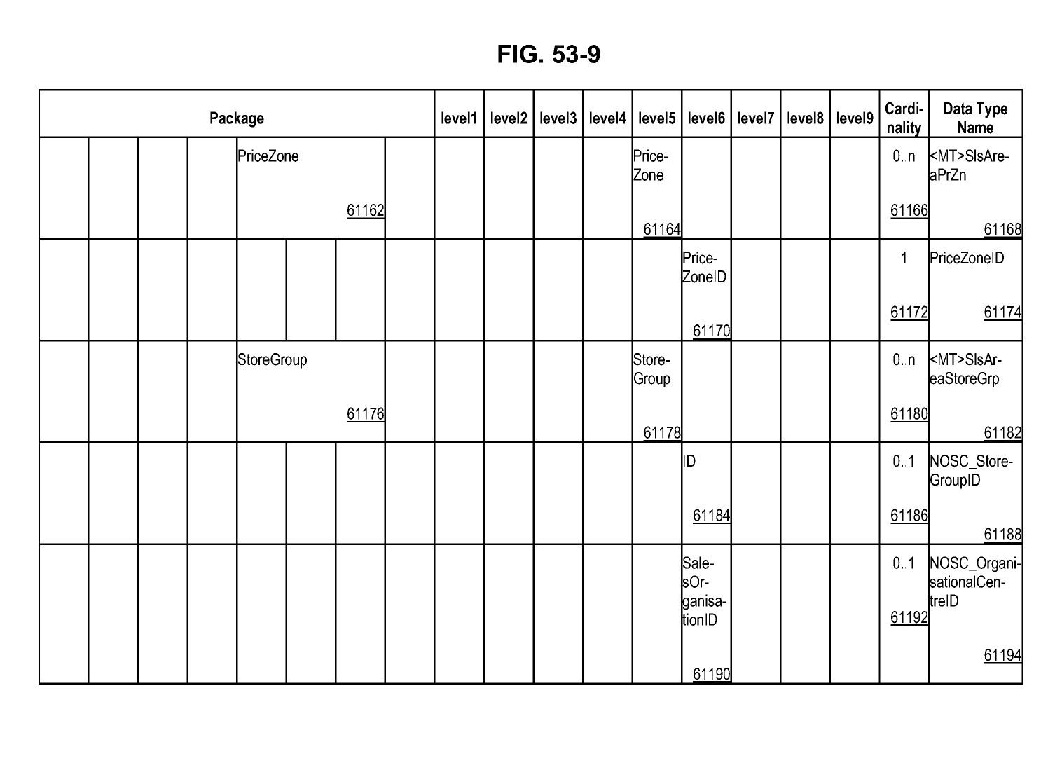

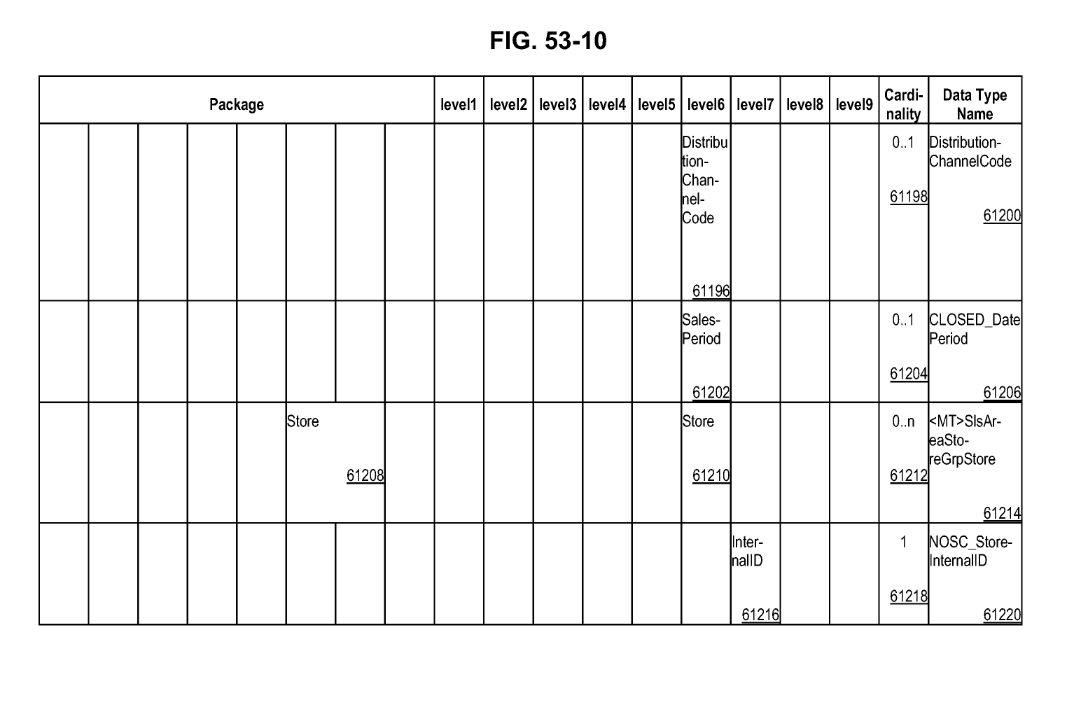

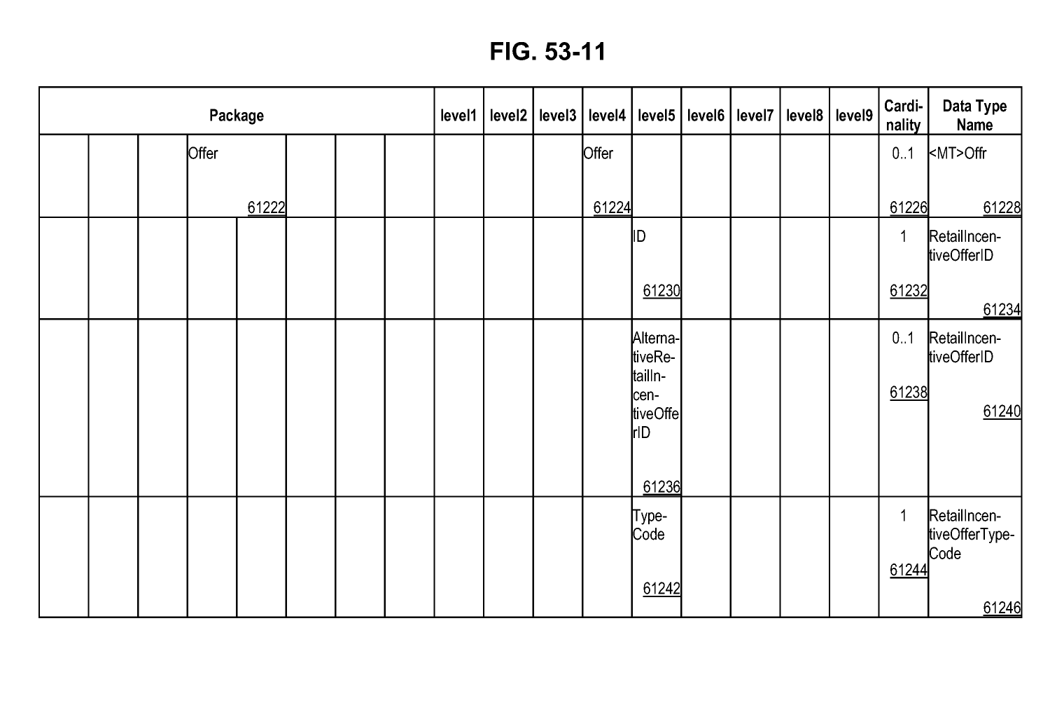

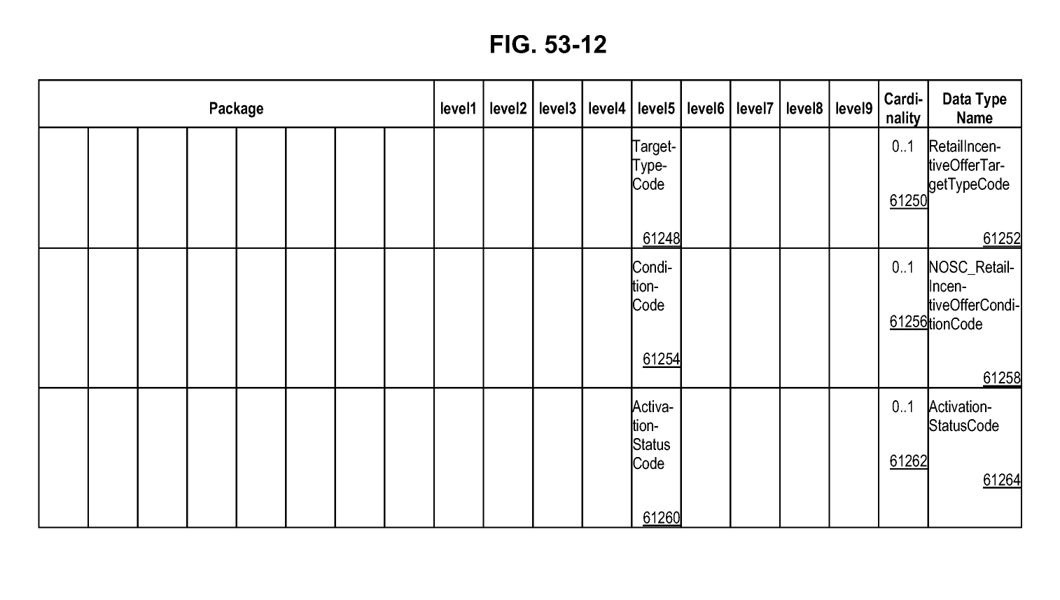

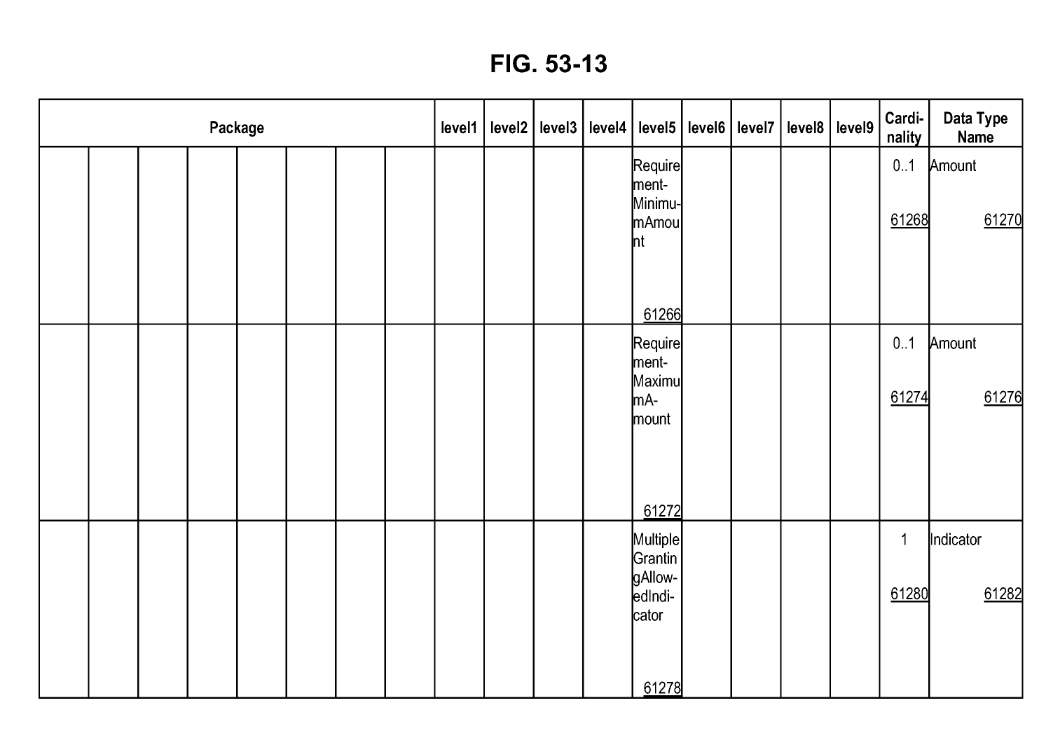

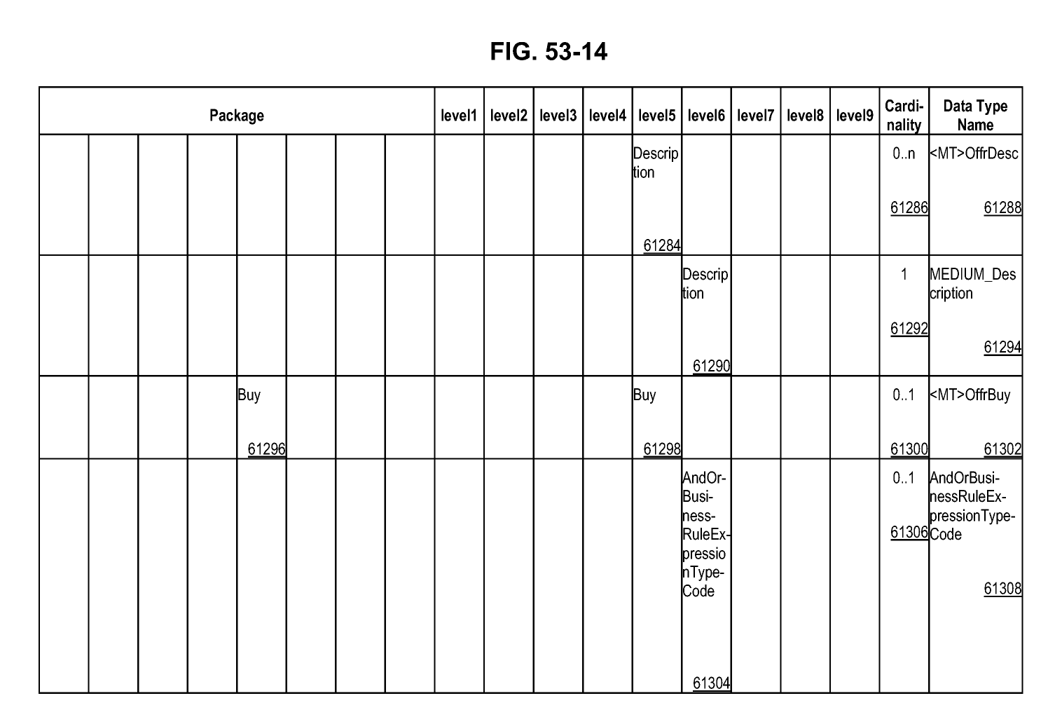

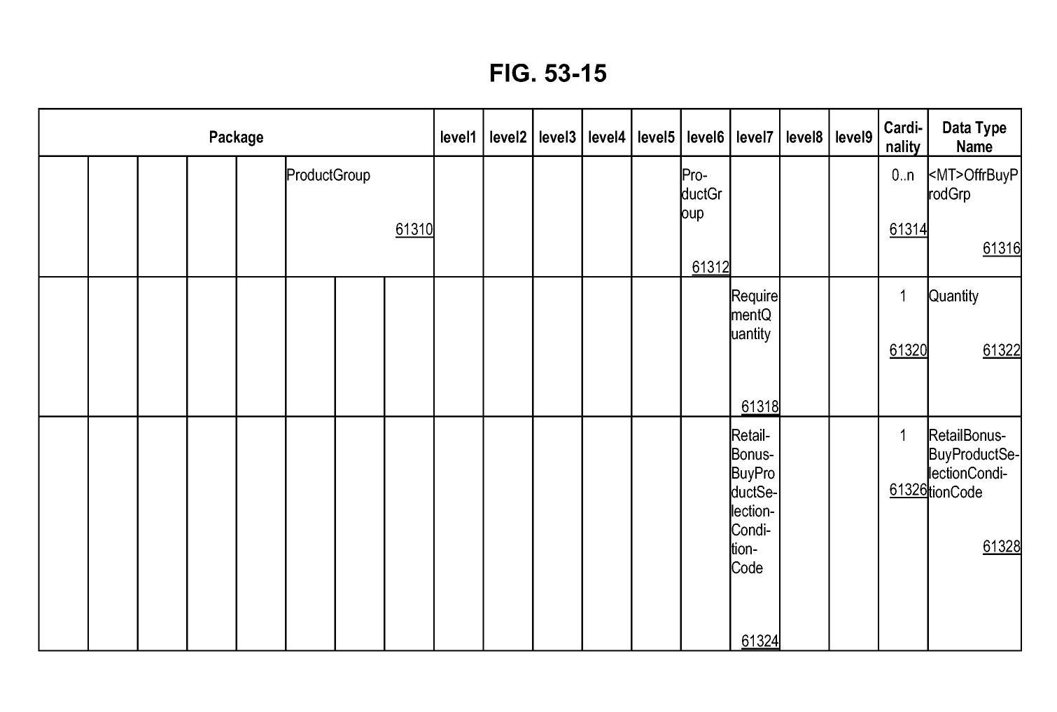

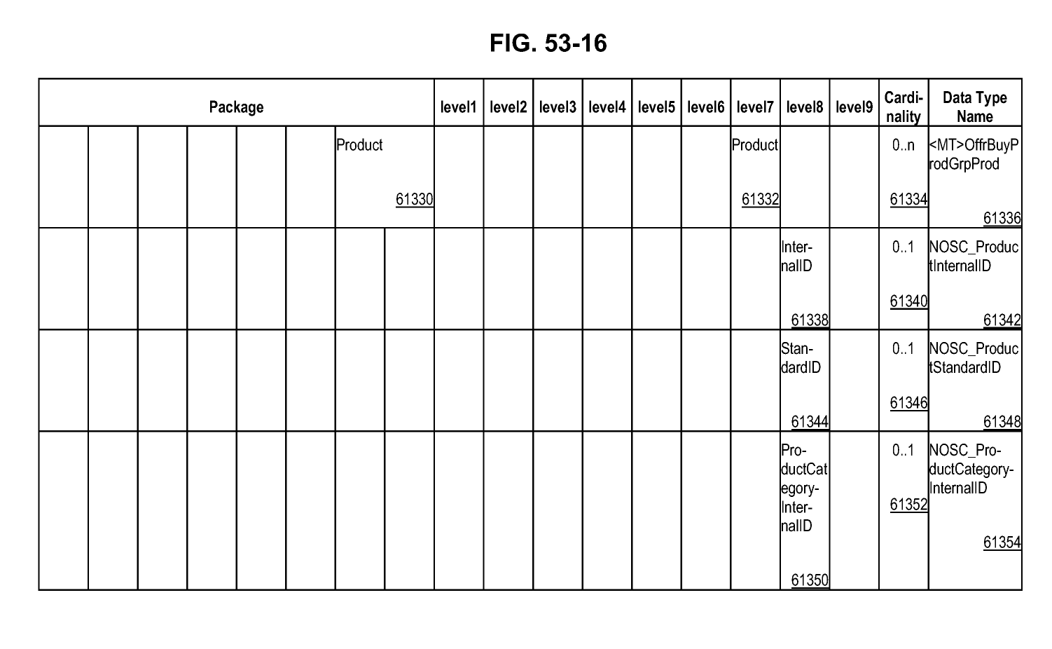

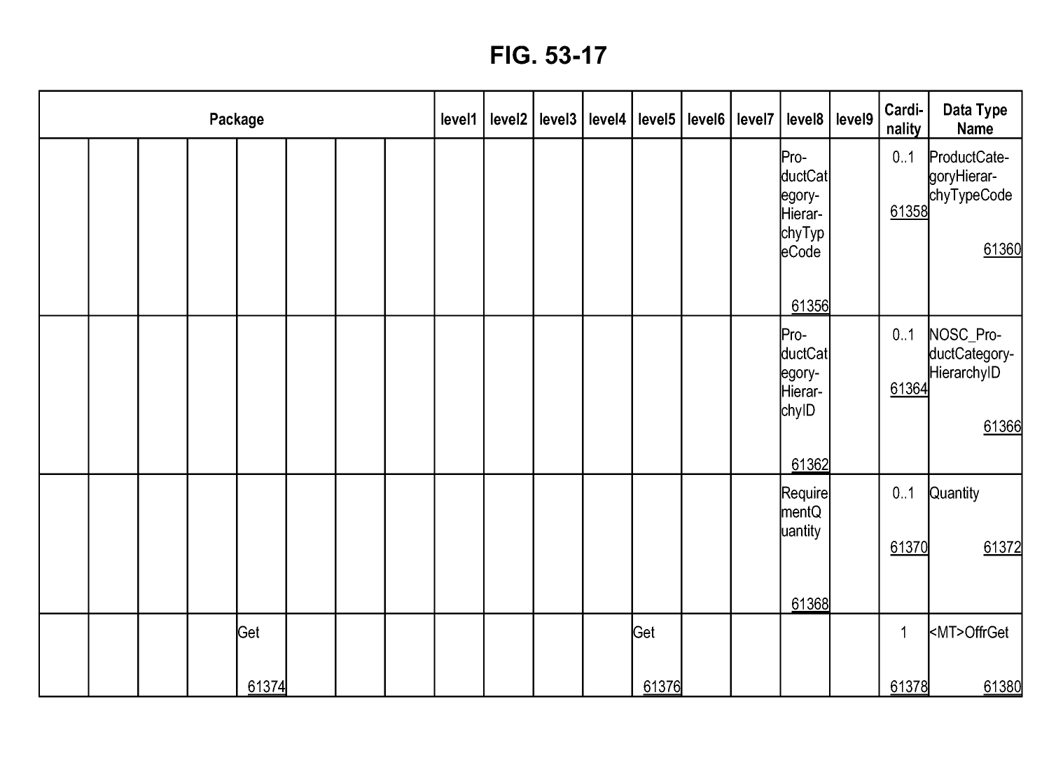

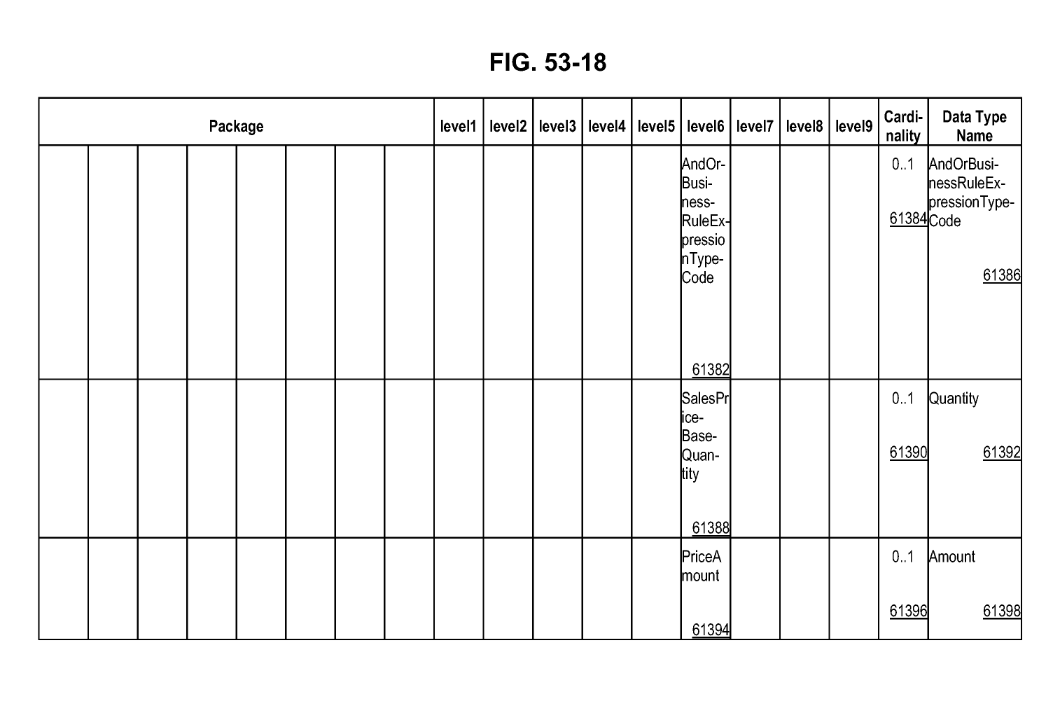

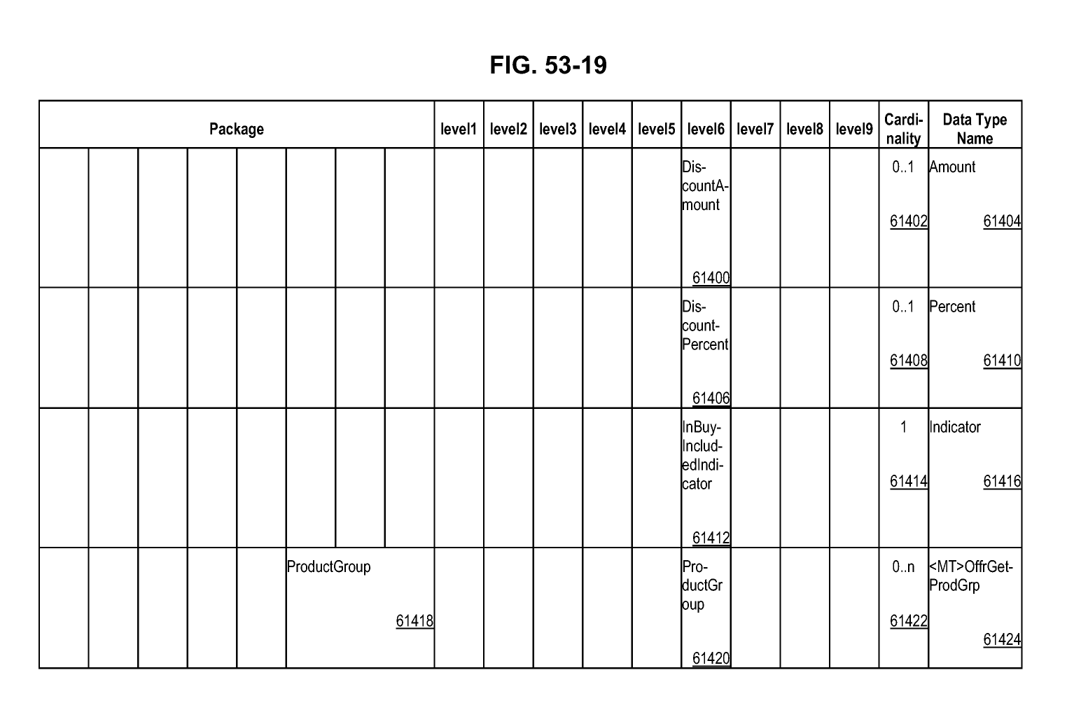

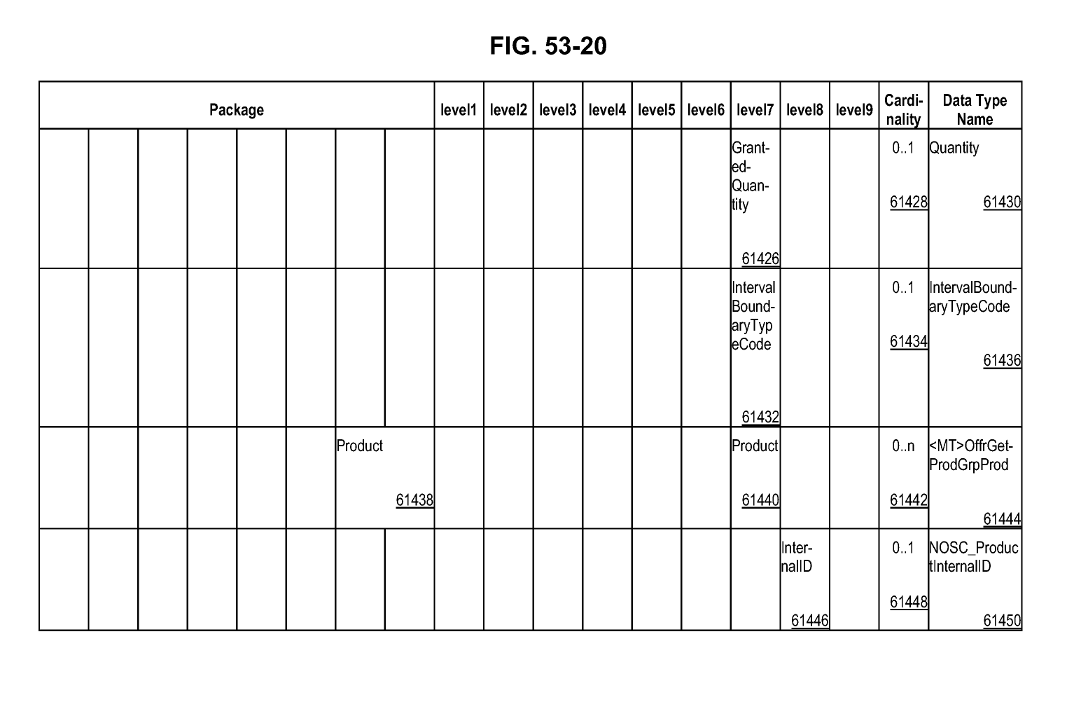

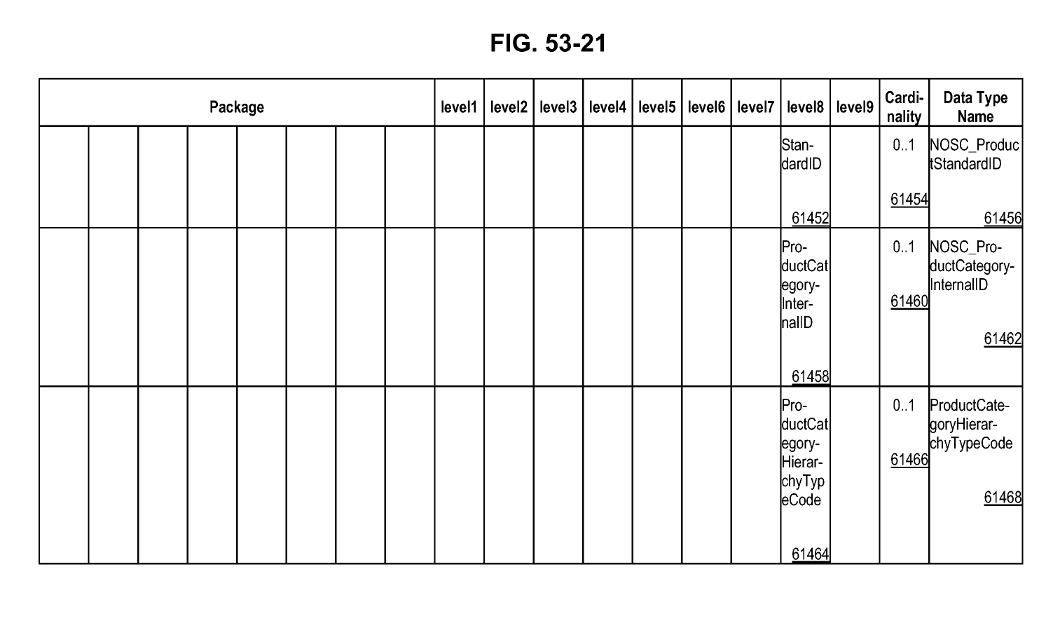

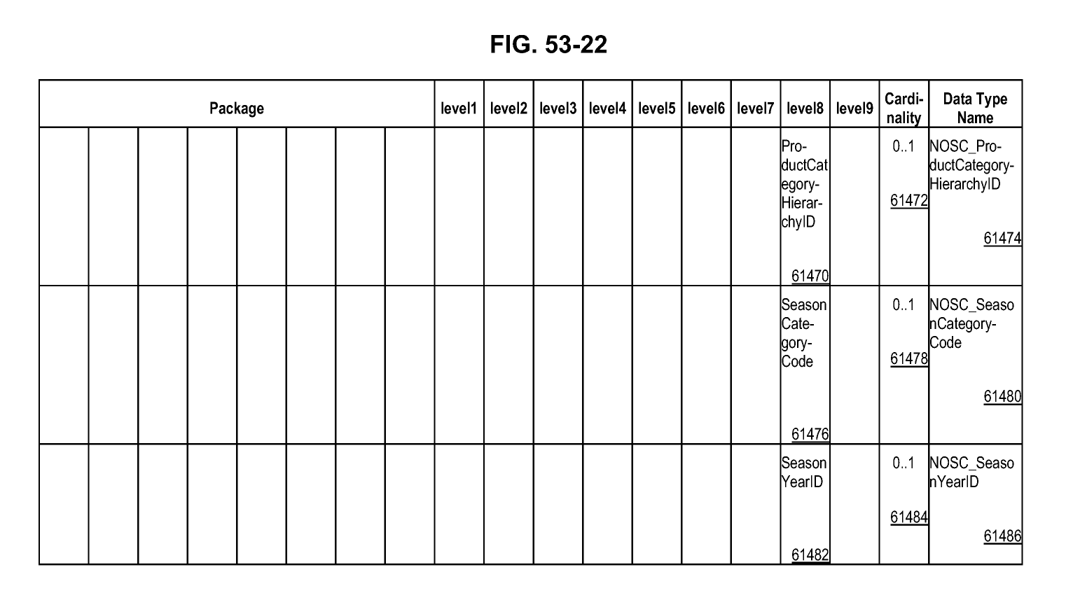

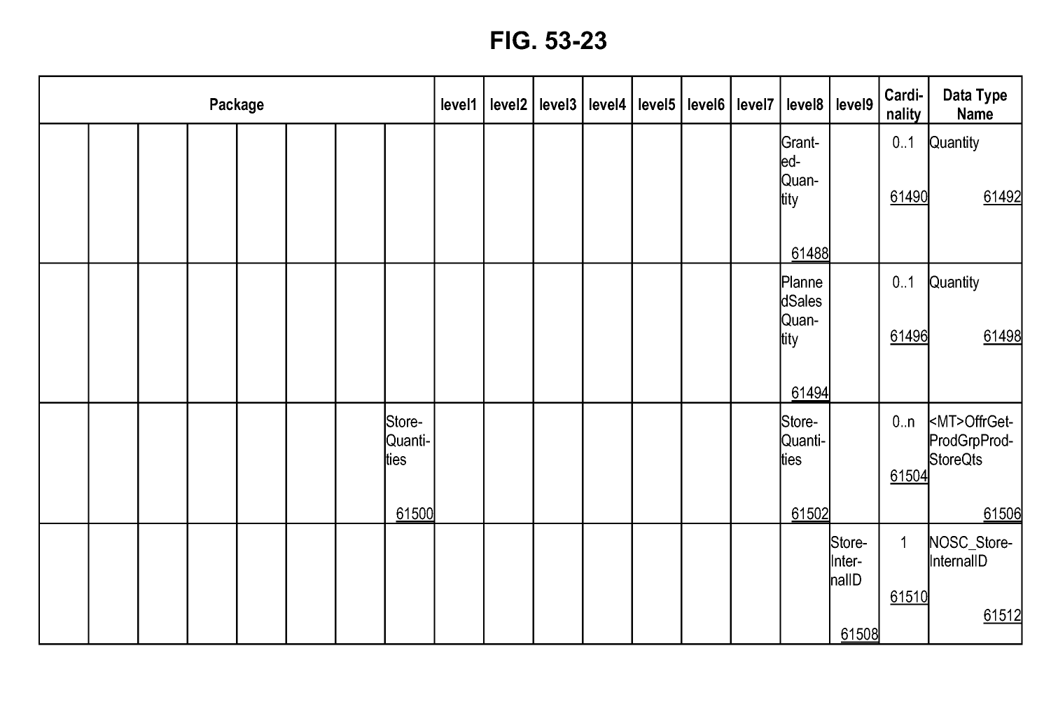

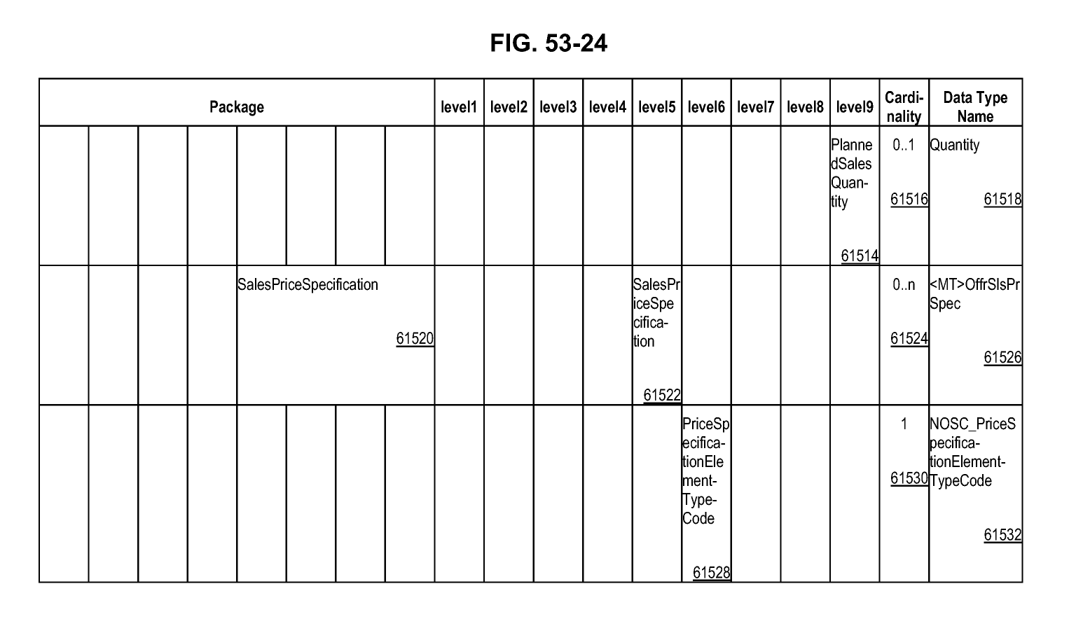

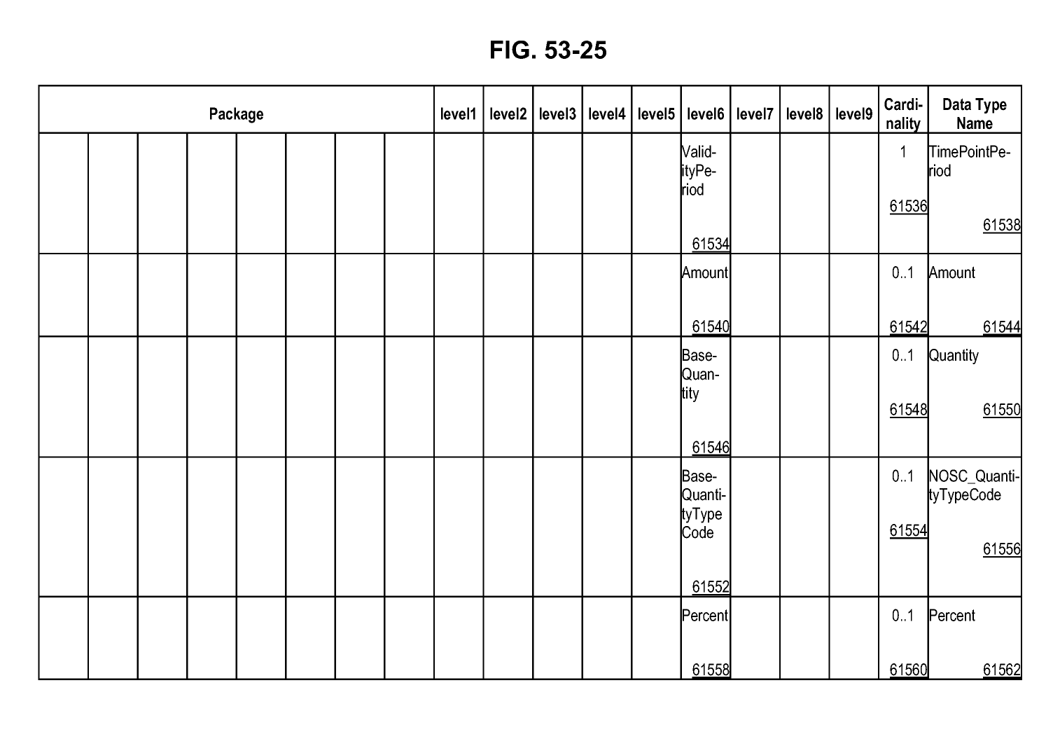

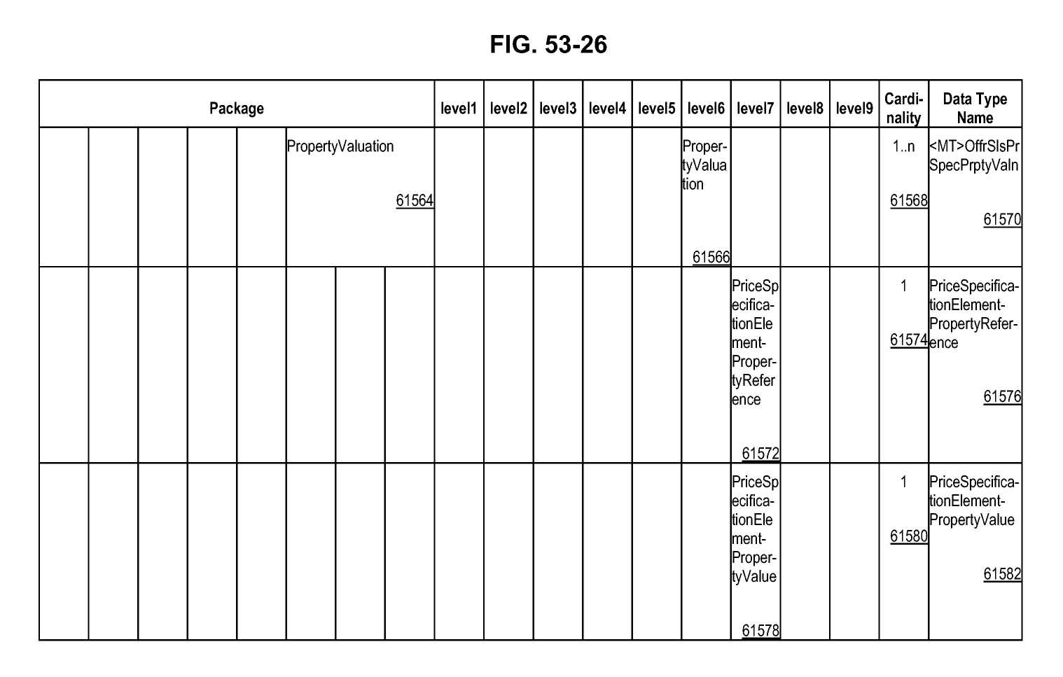

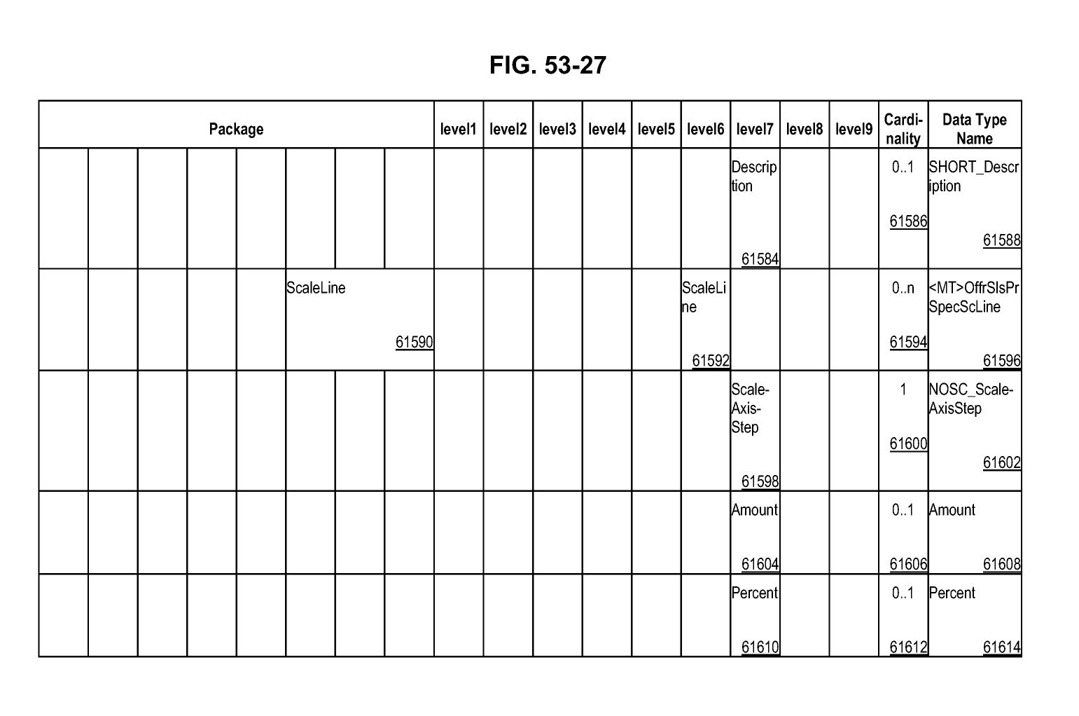

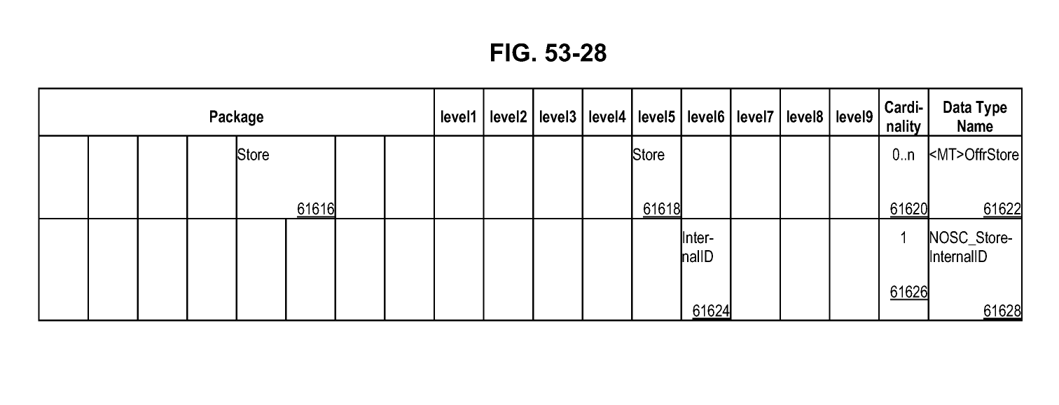

Additionally, FIGS. 53-1 through 53-28 show an example configuration of an Element Structure that includes a RetailIncentiveERPStoreOfferReplicationBulkRequestMessage 61000 package. The RetailIncentiveERPStoreOfferReplicationBulkRequestMessage 61000 package is a RtlIncntvERPStoreOffrRplctnBulkReqMsg 61004 data type. The data types of the various packages, entities, and attributes mentioned below are described in more detail above with respect to FIG. 52. The RetailIncentiveERPStoreOfferReplicationBulkRequestMessage 61000 package includes a RetailIncentiveERPStoreOfferReplicationBulkRequestMessage 61002 entity. The RetailIncentiveERPStoreOfferReplicationBulkRequestMessage 61000 package includes various packages, namely a MessageHeader 61006, and a RetailIncentiveERPStoreOfferReplicationRequestMessage 61014.

The MessageHeader 61006 package is a BusinessDocumentMessageHeader 61012 data type. The MessageHeader 61006 package includes a MessageHeader 61008 entity. The MessageHeader 61008 entity has a cardinality of 1 61010 meaning that for each instance of the MessageHeader 61006 package there is one MessageHeader 61008 entity.

The RetailIncentiveERPStoreOfferReplicationRequestMessage 61014 package is a RtlIncntvERPStoreOffrRplctnReqMsg 61020 data type. The RetailIncentiveERPStoreOfferReplicationRequestMessage 61014 package includes a RetailIncentiveERPStoreOfferReplicationRequestMessage 61016 entity. The RetailIncentiveERPStoreOfferReplicationRequestMessage 61014 package includes various packages, namely a MessageHeader 61022 and a RetailIncentive 61030. The RetailIncentiveERPStoreOfferReplicationRequestMessage 61016 entity has a cardinality of 1 . . . n 61018 meaning that for each instance of the RetailIncentiveERPStoreOfferReplicationRequestMessage 61014 package there are one or more RetailIncentiveERPStoreOfferReplicationRequestMessage 61016 entities.

The MessageHeader 61022 package is a BusinessDocumentMessageHeader 61028 data type. The MessageHeader 61022 package includes a MessageHeader 61024 entity. The MessageHeader 61024 entity has a cardinality of 1 61026 meaning that for each instance of the MessageHeader 61022 package there is one MessageHeader 61024 entity.

The RetailIncentive 61030 package is an <MT>RtlIncntvMT=RtlIncntvERPStoreOffrRplctnReq 61036 data type. The RetailIncentive 61030 package includes a RetailIncentive 61032 entity. The RetailIncentive 61030 package includes various packages, namely a ReceivingStore 61128, a SalesArea 61142 and an Offer 61222. The RetailIncentive 61032 entity has a cardinality of 1 61034 meaning that for each instance of the RetailIncentive 61030 package there is one RetailIncentive 61032 entity. The RetailIncentive 61032 entity includes various attributes, namely an @actionCode 61038, a RetailEventID 61044, a RetailBonusBuyID 61050, a TypeCode 61056, a CompleteTransmissionIndicator 61062, a RetailEventTypeCode 61068, a PlanningCurrencyCode 61074, a SalesPeriod 61080, a DataOriginTypeCode 61086, a RetailPredecessorTransactionID 61092, an AdvertisingMediumTypeCode 61098, a RetailEventTargetGroupTypeCode 61104 and a SalesPriceSpecificationLevelCode 61110. The RetailIncentive 61032 entity includes a Description 61116 subordinate entity. The @actionCode 61038 attribute is an ActionCode 61042 data type. The @actionCode 61038 attribute has a cardinality of 0 . . . 1 61040 meaning that for each instance of the RetailIncentive 61032 entity there may be one @actionCode 61038 attribute. The RetailEventID 61044 attribute is an NOSC_RetailEventID 61048 data type. The RetailEventID 61044 attribute has a cardinality of 0 . . . 1 61046 meaning that for each instance of the RetailIncentive 61032 entity there may be one RetailEventID 61044 attribute. The RetailBonusBuyID 61050 attribute is an NOSC_RetailBonusBuyID 61054 data type. The RetailBonusBuyID 61050 attribute has a cardinality of 0 . . . 1 61052 meaning that for each instance of the RetailIncentive 61032 entity there may be one RetailBonusBuyID 61050 attribute. The TypeCode 61056 attribute is a RetailIncentiveTypeCode 61060 data type. The TypeCode 61056 attribute has a cardinality of 0 . . . 1 61058 meaning that for each instance of the RetailIncentive 61032 entity there may be one TypeCode 61056 attribute. The CompleteTransmissionIndicator 61062 attribute is an Indicator 61066 data type. The CompleteTransmissionIndicator 61062 attribute has a cardinality of 1 61064 meaning that for each instance of the RetailIncentive 61032 entity there is one CompleteTransmissionIndicator 61062 attribute. The RetailEventTypeCode 61068 attribute is a RetailEventTypeCode 61072 data type. The RetailEventTypeCode 61068 attribute has a cardinality of 0 . . . 1 61070 meaning that for each instance of the RetailIncentive 61032 entity there may be one RetailEventTypeCode 61068 attribute. The PlanningCurrencyCode 61074 attribute is a CurrencyCode 61078 data type. The PlanningCurrencyCode 61074 attribute has a cardinality of 0 . . . 1 61076 meaning that for each instance of the RetailIncentive 61032 entity there may be one PlanningCurrencyCode 61074 attribute. The SalesPeriod 61080 attribute is a CLOSED_DatePeriod 61084 data type. The SalesPeriod 61080 attribute has a cardinality of 0 . . . 1 61082 meaning that for each instance of the RetailIncentive 61032 entity there may be one SalesPeriod 61080 attribute. The DataOriginTypeCode 61086 attribute is a RetailIncentiveDataOriginTypeCode 61090 data type. The DataOriginTypeCode 61086 attribute has a cardinality of 0 . . . 1 61088 meaning that for each instance of the RetailIncentive 61032 entity there may be one DataOriginTypeCode 61086 attribute. The RetailPredecessorTransactionID 61092 attribute is an NOSC_RetailPredecessorTransactionID 61096 data type. The RetailPredecessorTransactionID 61092 attribute has a cardinality of 0 . . . 1 61094 meaning that for each instance of the RetailIncentive 61032 entity there may be one RetailPredecessorTransactionID 61092 attribute. The AdvertisingMediumTypeCode 61098 attribute is an AdvertisingMediumTypeCode 61102 data type. The AdvertisingMediumTypeCode 61098 attribute has a cardinality of 0 . . . 1 61100 meaning that for each instance of the RetailIncentive 61032 entity there may be one AdvertisingMediumTypeCode 61098 attribute. The RetailEventTargetGroupTypeCode 61104 attribute is a RetailEventTargetGroupTypeCode 61108 data type. The RetailEventTargetGroupTypeCode 61104 attribute has a cardinality of 0 . . . 1 61106 meaning that for each instance of the RetailIncentive 61032 entity there may be one RetailEventTargetGroupTypeCode 61104 attribute. The SalesPriceSpecificationLevelCode 61110 attribute is a SalesPriceSpecificationLevelCode 61114 data type. The SalesPriceSpecificationLevelCode 61110 attribute has a cardinality of 0 . . . 1 61112 meaning that for each instance of the RetailIncentive 61032 entity there may be one SalesPriceSpecificationLevelCode 61110 attribute. The Description 61116 entity has a cardinality of 0 . . . n 61118 meaning that for each instance of the RetailIncentive 61032 entity there may be one or more Description 61116 entities. The Description 61116 entity includes a Description 61122 attribute. The Description 61122 attribute is a SHORT_Description 61126 data type. The Description 61122 attribute has a cardinality of 1 61124 meaning that for each instance of the Description 61116 entity there is one Description 61122 attribute.

The ReceivingStore 61128 package is an <MT>RcvgStore 61134 data type. The ReceivingStore 61128 package includes a ReceivingStore 61130 entity. The ReceivingStore 61130 entity has a cardinality of 0 . . . n 61132 meaning that for each instance of the ReceivingStore 61128 package there may be one or more ReceivingStore 61130 entities. The ReceivingStore 61130 entity includes a StoreInternalID 61136 attribute. The StoreInternalID 61136 attribute is an NOSC_StoreInternalID 61140 data type. The StoreInternalID 61136 attribute has a cardinality of 1 61138 meaning that for each instance of the ReceivingStore 61130 entity there is one StoreInternalID 61136 attribute.

The SalesArea 61142 package is an <MT>SlsArea 61148 data type. The SalesArea 61142 package includes a SalesArea 61144 entity. The SalesArea 61142 package includes various packages, namely a PriceZone 61162 and a StoreGroup 61176. The SalesArea 61144 entity has a cardinality of 0 . . . 1 61146 meaning that for each instance of the SalesArea 61142 package there may be one SalesArea 61144 entity. The SalesArea 61144 entity includes various attributes, namely a SalesOrganisationID 61150 and a DistributionChannelCode 61156. The SalesOrganisationID 61150 attribute is an NOSC_OrganisationalCentreID 61154 data type. The SalesOrganisationID 61150 attribute has a cardinality of 0 . . . 1 61152 meaning that for each instance of the SalesArea 61144 entity there may be one SalesOrganisationID 61150 attribute. The DistributionChannelCode 61156 attribute is a DistributionChannelCode 61160 data type. The DistributionChannelCode 61156 attribute has a cardinality of 0 . . . 1 61158 meaning that for each instance of the SalesArea 61144 entity there may be one DistributionChannelCode 61156 attribute.

The PriceZone 61162 package is an <MT>SlsAreaPrZn 61168 data type. The PriceZone 61162 package includes a PriceZone 61164 entity. The PriceZone 61164 entity has a cardinality of 0 . . . n 61166 meaning that for each instance of the PriceZone 61162 package there may be one or more PriceZone 61164 entities. The PriceZone 61164 entity includes a PriceZoneID 61170 attribute. The PriceZoneID 61170 attribute is a PriceZoneID 61174 data type. The PriceZoneID 61170 attribute has a cardinality of 1 61172 meaning that for each instance of the PriceZone 61164 entity there is one PriceZoneID 61170 attribute.

The StoreGroup 61176 package is an <MT>SlsAreaStoreGrp 61182 data type. The StoreGroup 61176 package includes a StoreGroup 61178 entity. The StoreGroup 61176 package includes a Store 61208 package. The StoreGroup 61178 entity has a cardinality of 0 . . . n 61180 meaning that for each instance of the StoreGroup 61176 package there may be one or more StoreGroup 61178 entities. The StoreGroup 61178 entity includes various attributes, namely an ID 61184, a SalesOrganisationID 61190, a DistributionChannelCode 61196 and a SalesPeriod 61202. The ID 61184 attribute is an NOSC_StoreGroupID 61188 data type. The ID 61184 attribute has a cardinality of 0 . . . 1 61186 meaning that for each instance of the StoreGroup 61178 entity there may be one ID 61184 attribute. The SalesOrganisationID 61190 attribute is a NOSC_OrganisationalCentreID 61194 data type. The SalesOrganisationID 61190 attribute has a cardinality of 0 . . . 1 61192 meaning that for each instance of the StoreGroup 61178 entity there may be one SalesOrganisationID 61190 attribute. The DistributionChannelCode 61196 attribute is a DistributionChannelCode 61200 data type. The DistributionChannelCode 61196 attribute has a cardinality of 0 . . . 1 61198 meaning that for each instance of the StoreGroup 61178 entity there may be one DistributionChannelCode 61196 attribute. The SalesPeriod 61202 attribute is a CLOSED_DatePeriod 61206 data type. The SalesPeriod 61202 attribute has a cardinality of 0 . . . 1 61204 meaning that for each instance of the StoreGroup 61178 entity there may be one SalesPeriod 61202 attribute.

The Store 61208 package is an <MT>SlsAreaStoreGrpStore 61214 data type. The Store 61208 package includes a Store 61210 entity. The Store 61210 entity has a cardinality of 0 . . . n 61212 meaning that for each instance of the Store 61208 package there may be one or more Store 61210 entities. The Store 61210 entity includes an InternalID 61216 attribute. The InternalID 61216 attribute is an NOSC_StoreInternalID 61220 data type. The InternalID 61216 attribute has a cardinality of 1 61218 meaning that for each instance of the Store 61210 entity there is one InternalID 61216 attribute.

The Offer 61222 package is an <MT>Offr 61228 data type. The Offer 61222 package includes an Offer 61224 entity. The Offer 61222 package includes various packages, namely a Buy 61296, a Get 61374, a SalesPriceSpecification 61520 and a Store 61616. The Offer 61224 entity has a cardinality of 0 . . . 1 61226 meaning that for each instance of the Offer 61222 package there may be one Offer 61224 entity. The Offer 61224 entity includes various attributes, namely an ID 61230, an AlternativeRetailIncentiveOfferID 61236, a TypeCode 61242, a TargetTypeCode 61248, a ConditionCode 61254, an ActivationStatusCode 61260, a RequirementMinimumAmount 61266, a RequirementMaximumAmount 61272 and a MultipleGrantingAllowedIndicator 61278. The Offer 61224 entity includes a Description 61284 subordinate entity. The ID 61230 attribute is a RetailIncentiveOfferID 61234 data type. The ID 61230 attribute has a cardinality of 1 61232 meaning that for each instance of the Offer 61224 entity there is one ID 61230 attribute. The AlternativeRetailIncentiveOfferID 61236 attribute is a RetailIncentiveOfferID 61240 data type. The AlternativeRetailIncentiveOfferID 61236 attribute has a cardinality of 0 . . . 1 61238 meaning that for each instance of the Offer 61224 entity there may be one AlternativeRetailIncentiveOfferID 61236 attribute. The TypeCode 61242 attribute is a RetailIncentiveOfferTypeCode 61246 data type. The TypeCode 61242 attribute has a cardinality of 1 61244 meaning that for each instance of the Offer 61224 entity there is one TypeCode 61242 attribute. The TargetTypeCode 61248 attribute is a RetailIncentiveOfferTargetTypeCode 61252 data type. The TargetTypeCode 61248 attribute has a cardinality of 0 . . . 1 61250 meaning that for each instance of the Offer 61224 entity there may be one TargetTypeCode 61248 attribute. The ConditionCode 61254 attribute is an NOSC_RetailIncentiveOfferConditionCode 61258 data type. The ConditionCode 61254 attribute has a cardinality of 0 . . . 1 61256 meaning that for each instance of the Offer 61224 entity there may be one ConditionCode 61254 attribute. The ActivationStatusCode 61260 attribute is an ActivationStatusCode 61264 data type. The ActivationStatusCode 61260 attribute has a cardinality of 0 . . . 1 61262 meaning that for each instance of the Offer 61224 entity there may be one ActivationStatusCode 61260 attribute. The RequirementMinimumAmount 61266 attribute is an Amount 61270 data type. The RequirementMinimumAmount 61266 attribute has a cardinality of 0 . . . 1 61268 meaning that for each instance of the Offer 61224 entity there may be one RequirementMinimumAmount 61266 attribute. The RequirementMaximumAmount 61272 attribute is an Amount 61276 data type. The RequirementMaximumAmount 61272 attribute has a cardinality of 0 . . . 1 61274 meaning that for each instance of the Offer 61224 entity there may be one RequirementMaximumAmount 61272 attribute. The MultipleGrantingAllowedIndicator 61278 attribute is an Indicator 61282 data type. The MultipleGrantingAllowedIndicator 61278 attribute has a cardinality of 1 61280 meaning that for each instance of the Offer 61224 entity there is one MultipleGrantingAllowedIndicator 61278 attribute. The Description 61284 entity has a cardinality of 0 . . . n 61286 meaning that for each instance of the Offer 61224 entity there may be one or more Description 61284 entities. The Description 61284 entity includes a Description 61290 attribute. The Description 61290 attribute is a MEDIUM_Description 61294 data type. The Description 61290 attribute has a cardinality of 1 61292 meaning that for each instance of the Description 61284 entity there is one Description 61290 attribute.

The Buy 61296 package is an <MT>OffrBuy 61302 data type. The Buy 61296 package includes a Buy 61298 entity. The Buy 61296 package includes a ProductGroup 61310 package. The Buy 61298 entity has a cardinality of 0 . . . 1 61300 meaning that for each instance of the Buy 61296 package there may be one Buy 61298 entity. The Buy 61298 entity includes an AndOrBusinessRuleExpressionTypeCode 61304 attribute. The AndOrBusinessRuleExpressionTypeCode 61304 attribute is an AndOrBusinessRuleExpressionTypeCode 61308 data type. The AndOrBusinessRuleExpressionTypeCode 61304 attribute has a cardinality of 0 . . . 1 61306 meaning that for each instance of the Buy 61298 entity there may be one AndOrBusinessRuleExpressionTypeCode 61304 attribute.

The ProductGroup 61310 package is an <MT>OffrBuyProdGrp 61316 data type. The ProductGroup 61310 package includes a ProductGroup 61312 entity. The ProductGroup 61310 package includes a Product 61330 package. The ProductGroup 61312 entity has a cardinality of 0 . . . n 61314 meaning that for each instance of the ProductGroup 61310 package there may be one or more ProductGroup 61312 entities. The ProductGroup 61312 entity includes various attributes, namely a RequirementQuantity 61318 and a RetailBonusBuyProductSelectionConditionCode 61324. The RequirementQuantity 61318 attribute is a Quantity 61322 data type. The RequirementQuantity 61318 attribute has a cardinality of 1 61320 meaning that for each instance of the ProductGroup 61312 entity there is one RequirementQuantity 61318 attribute. The RetailBonusBuyProductSelectionConditionCode 61324 attribute is a RetailBonusBuyProductSelectionConditionCode 61328 data type. The RetailBonusBuyProductSelectionConditionCode 61324 attribute has a cardinality of 1 61326 meaning that for each instance of the ProductGroup 61312 entity there is one RetailBonusBuyProductSelectionConditionCode 61324 attribute.

The Product 61330 package is an <MT>OffrBuyProdGrpProd 61336 data type. The Product 61330 package includes a Product 61332 entity. The Product 61332 entity has a cardinality of 0 . . . n 61334 meaning that for each instance of the Product 61330 package there may be one or more Product 61332 entities. The Product 61332 entity includes various attributes, namely an InternalID 61338, a StandardID 61344, a ProductCategoryInternalID 61350, a ProductCategoryHierarchyTypeCode 61356, a ProductCategoryHierarchyID 61362 and a RequirementQuantity 61368. The InternalID 61338 attribute is an NOSC_ProductInternalID 61342 data type. The InternalID 61338 attribute has a cardinality of 0 . . . 1 61340 meaning that for each instance of the Product 61332 entity there may be one InternalID 61338 attribute. The StandardID 61344 attribute is an NOSC_ProductStandardID 61348 data type. The StandardID 61344 attribute has a cardinality of 0 . . . 1 61346 meaning that for each instance of the Product 61332 entity there may be one StandardID 61344 attribute. The ProductCategoryInternalID 61350 attribute is an NOSC_ProductCategoryInternalID 61354 data type. The ProductCategoryInternalID 61350 attribute has a cardinality of 0 . . . 1 61352 meaning that for each instance of the Product 61332 entity there may be one ProductCategoryInternalID 61350 attribute. The ProductCategoryHierarchyTypeCode 61356 attribute is a ProductCategoryHierarchyTypeCode 61360 data type. The ProductCategoryHierarchyTypeCode 61356 attribute has a cardinality of 0 . . . 1 61358 meaning that for each instance of the Product 61332 entity there may be one ProductCategoryHierarchyTypeCode 61356 attribute. The ProductCategoryHierarchyID 61362 attribute is an NOSC_ProductCategoryHierarchyID 61366 data type. The ProductCategoryHierarchyID 61362 attribute has a cardinality of 0 . . . 1 61364 meaning that for each instance of the Product 61332 entity there may be one ProductCategoryHierarchyID 61362 attribute. The RequirementQuantity 61368 attribute is a Quantity 61372 data type. The RequirementQuantity 61368 attribute has a cardinality of 0 . . . 1 61370 meaning that for each instance of the Product 61332 entity there may be one RequirementQuantity 61368 attribute.

The Get 61374 package is an <MT>OffrGet 61380 data type. The Get 61374 package includes a Get 61376 entity. The Get 61374 package includes a ProductGroup 61418 package. The Get 61376 entity has a cardinality of 1 61378 meaning that for each instance of the Get 61374 package there is one Get 61376 entity. The Get 61376 entity includes various attributes, namely an AndOrBusinessRuleExpressionTypeCode 61382, a SalesPriceBaseQuantity 61388, a PriceAmount 61394, a DiscountAmount 61400, a DiscountPercent 61406 and an InBuyIncludedIndicator 61412. The AndOrBusinessRuleExpressionTypeCode 61382 attribute is an AndOrBusinessRuleExpressionTypeCode 61386 data type. The AndOrBusinessRuleExpressionTypeCode 61382 attribute has a cardinality of 0 . . . 1 61384 meaning that for each instance of the Get 61376 entity there may be one AndOrBusinessRuleExpressionTypeCode 61382 attribute. The SalesPriceBaseQuantity 61388 attribute is a Quantity 61392 data type. The SalesPriceBaseQuantity 61388 attribute has a cardinality of 0 . . . 1 61390 meaning that for each instance of the Get 61376 entity there may be one SalesPriceBaseQuantity 61388 attribute. The PriceAmount 61394 attribute is an Amount 61398 data type. The PriceAmount 61394 attribute has a cardinality of 0 . . . 1 61396 meaning that for each instance of the Get 61376 entity there may be one PriceAmount 61394 attribute. The DiscountAmount 61400 attribute is an Amount 61404 data type. The DiscountAmount 61400 attribute has a cardinality of 0 . . . 1 61402 meaning that for each instance of the Get 61376 entity there may be one DiscountAmount 61400 attribute. The DiscountPercent 61406 attribute is a Percent 61410 data type. The DiscountPercent 61406 attribute has a cardinality of 0 . . . 1 61408 meaning that for each instance of the Get 61376 entity there may be one DiscountPercent 61406 attribute. The InBuyIncludedIndicator 61412 attribute is an Indicator 61416 data type. The InBuyIncludedIndicator 61412 attribute has a cardinality of 1 61414 meaning that for each instance of the Get 61376 entity there is one InBuyIncludedIndicator 61412 attribute.

The ProductGroup 61418 package is an <MT>OffrGetProdGrp 61424 data type. The ProductGroup 61418 package includes a ProductGroup 61420 entity. The ProductGroup 61418 package includes a Product 61438 package. The ProductGroup 61420 entity has a cardinality of 0 . . . n 61422 meaning that for each instance of the ProductGroup 61418 package there may be one or more ProductGroup 61420 entities. The ProductGroup 61420 entity includes various attributes, namely a GrantedQuantity 61426 and an IntervalBoundaryTypeCode 61432. The GrantedQuantity 61426 attribute is a Quantity 61430 data type. The GrantedQuantity 61426 attribute has a cardinality of 0 . . . 1 61428 meaning that for each instance of the ProductGroup 61420 entity there may be one GrantedQuantity 61426 attribute. The IntervalBoundaryTypeCode 61432 attribute is an IntervalBoundaryTypeCode 61436 data type. The IntervalBoundaryTypeCode 61432 attribute has a cardinality of 0 . . . 1 61434 meaning that for each instance of the ProductGroup 61420 entity there may be one IntervalBoundaryTypeCode 61432 attribute.

The Product 61438 package is an <MT>OffrGetProdGrpProd 61444 data type. The Product 61438 package includes a Product 61440 entity. The Product 61438 package includes a StoreQuantities 61500 package. The Product 61440 entity has a cardinality of 0 . . . n 61442 meaning that for each instance of the Product 61438 package there may be one or more Product 61440 entities. The Product 61440 entity includes various attributes, namely an InternalID 61446, a StandardID 61452, a ProductCategoryInternalID 61458, a ProductCategoryHierarchyTypeCode 61464, a ProductCategoryHierarchyID 61470, a SeasonCategoryCode 61476, a SeasonYearID 61482, a GrantedQuantity 61488 and a PlannedSalesQuantity 61494. The InternalID 61446 attribute is an NOSC_ProductInternalID 61450 data type. The InternalID 61446 attribute has a cardinality of 0 . . . 1 61448 meaning that for each instance of the Product 61440 entity there may be one InternalID 61446 attribute. The StandardID 61452 attribute is an NOSC_ProductStandardID 61456 data type. The StandardID 61452 attribute has a cardinality of 0 . . . 1 61454 meaning that for each instance of the Product 61440 entity there may be one StandardID 61452 attribute. The ProductCategoryInternalID 61458 attribute is an NOSC_ProductCategoryInternalID 61462 data type. The ProductCategoryInternalID 61458 attribute has a cardinality of 0 . . . 1 61460 meaning that for each instance of the Product 61440 entity there may be one ProductCategoryInternalID 61458 attribute. The ProductCategoryHierarchyTypeCode 61464 attribute is a ProductCategoryHierarchyTypeCode 61468 data type. The ProductCategoryHierarchyTypeCode 61464 attribute has a cardinality of 0 . . . 1 61466 meaning that for each instance of the Product 61440 entity there may be one ProductCategoryHierarchyTypeCode 61464 attribute. The ProductCategoryHierarchyID 61470 attribute is an NOSC_ProductCategoryHierarchyID 61474 data type. The ProductCategoryHierarchyID 61470 attribute has a cardinality of 0 . . . 1 61472 meaning that for each instance of the Product 61440 entity there may be one ProductCategoryHierarchyID 61470 attribute. The SeasonCategoryCode 61476 attribute is an NOSC_SeasonCategoryCode 61480 data type. The SeasonCategoryCode 61476 attribute has a cardinality of 0 . . . 1 61478 meaning that for each instance of the Product 61440 entity there may be one SeasonCategoryCode 61476 attribute. The SeasonYearID 61482 attribute is an NOSC_SeasonYearID 61486 data type. The SeasonYearID 61482 attribute has a cardinality of 0 . . . 1 61484 meaning that for each instance of the Product 61440 entity there may be one SeasonYearID 61482 attribute. The GrantedQuantity 61488 attribute is a Quantity 61492 data type. The GrantedQuantity 61488 attribute has a cardinality of 0 . . . 1 61490 meaning that for each instance of the Product 61440 entity there may be one GrantedQuantity 61488 attribute. The PlannedSalesQuantity 61494 attribute is a Quantity 61498 data type. The PlannedSalesQuantity 61494 attribute has a cardinality of 0 . . . 1 61496 meaning that for each instance of the Product 61440 entity there may be one PlannedSalesQuantity 61494 attribute.

The StoreQuantities 61500 package is an <MT>OffrGetProdGrpProdStoreQts 61506 data type. The StoreQuantities 61500 package includes a StoreQuantities 61502 entity. The StoreQuantities 61502 entity has a cardinality of 0 . . . n 61504 meaning that for each instance of the StoreQuantities 61500 package there may be one or more StoreQuantities 61502 entities. The StoreQuantities 61502 entity includes various attributes, namely a StoreInternalID 61508 and a PlannedSalesQuantity 61514. The StoreInternalID 61508 attribute is an NOSC_StoreInternalID 61512 data type. The StoreInternalID 61508 attribute has a cardinality of 1 61510 meaning that for each instance of the StoreQuantities 61502 entity there is one StoreInternalID 61508 attribute. The PlannedSalesQuantity 61514 attribute is a Quantity 61518 data type. The PlannedSalesQuantity 61514 attribute has a cardinality of 0 . . . 1 61516 meaning that for each instance of the StoreQuantities 61502 entity there may be one PlannedSalesQuantity 61514 attribute.

The SalesPriceSpecification 61520 package is an <MT>OffrSlsPrSpec 61526 data type. The SalesPriceSpecification 61520 package includes a SalesPriceSpecification 61522 entity. The SalesPriceSpecification 61520 package includes various packages, namely a PropertyValuation 61564 and a ScaleLine 61590. The SalesPriceSpecification 61522 entity has a cardinality of 0 . . . n 61524 meaning that for each instance of the SalesPriceSpecification 61520 package there may be one or more SalesPriceSpecification 61522 entities. The SalesPriceSpecification 61522 entity includes various attributes, namely a PriceSpecificationElementTypeCode 61528, a ValidityPeriod 61534, an Amount 61540, a BaseQuantity 61546, a BaseQuantityTypeCode 61552 and a Percent 61558. The PriceSpecificationElementTypeCode 61528 attribute is an NOSC_PriceSpecificationElementTypeCode 61532 data type. The PriceSpecificationElementTypeCode 61528 attribute has a cardinality of 1 61530 meaning that for each instance of the SalesPriceSpecification 61522 entity there is one PriceSpecificationElementTypeCode 61528 attribute. The ValidityPeriod 61534 attribute is a TimePointPeriod 61538 data type. The ValidityPeriod 61534 attribute has a cardinality of 1 61536 meaning that for each instance of the SalesPriceSpecification 61522 entity there is one ValidityPeriod 61534 attribute. The Amount 61540 attribute is an Amount 61544 data type. The Amount 61540 attribute has a cardinality of 0 . . . 1 61542 meaning that for each instance of the SalesPriceSpecification 61522 entity there may be one Amount 61540 attribute. The BaseQuantity 61546 attribute is a Quantity 61550 data type. The BaseQuantity 61546 attribute has a cardinality of 0 . . . 1 61548 meaning that for each instance of the SalesPriceSpecification 61522 entity there may be one BaseQuantity 61546 attribute. The BaseQuantityTypeCode 61552 attribute is an NOSC_QuantityTypeCode 61556 data type. The BaseQuantityTypeCode 61552 attribute has a cardinality of 0 . . . 1 61554 meaning that for each instance of the SalesPriceSpecification 61522 entity there may be one BaseQuantityTypeCode 61552 attribute. The Percent 61558 attribute is a Percent 61562 data type. The Percent 61558 attribute has a cardinality of 0 . . . 1 61560 meaning that for each instance of the SalesPriceSpecification 61522 entity there may be one Percent 61558 attribute.

The PropertyValuation 61564 package is an <MT>OffrSlsPrSpecPrptyValn 61570 data type. The PropertyValuation 61564 package includes a PropertyValuation 61566 entity. The PropertyValuation 61566 entity has a cardinality of 1 . . . n 61568 meaning that for each instance of the PropertyValuation 61564 package there are one or more PropertyValuation 61566 entities. The PropertyValuation 61566 entity includes various attributes, namely a PriceSpecificationElementPropertyReference 61572, a PriceSpecificationElementPropertyValue 61578 and a Description 61584. The PriceSpecificationElementPropertyReference 61572 attribute is a PriceSpecificationElementPropertyReference 61576 data type. The PriceSpecificationElementPropertyReference 61572 attribute has a cardinality of 1 61574 meaning that for each instance of the PropertyValuation 61566 entity there is one PriceSpecificationElementPropertyReference 61572 attribute. The PriceSpecificationElementPropertyValue 61578 attribute is a PriceSpecificationElementPropertyValue 61582 data type. The PriceSpecificationElementPropertyValue 61578 attribute has a cardinality of 1 61580 meaning that for each instance of the PropertyValuation 61566 entity there is one PriceSpecificationElementPropertyValue 61578 attribute. The Description 61584 attribute is a SHORT_Description 61588 data type. The Description 61584 attribute has a cardinality of 0 . . . 1 61586 meaning that for each instance of the PropertyValuation 61566 entity there may be one Description 61584 attribute.

The ScaleLine 61590 package is an <MT>OffrSlsPrSpecScLine 61596 data type. The ScaleLine 61590 package includes a ScaleLine 61592 entity. The ScaleLine 61592 entity has a cardinality of 0 . . . n 61594 meaning that for each instance of the ScaleLine 61590 package there may be one or more ScaleLine 61592 entities. The ScaleLine 61592 entity includes various attributes, namely a ScaleAxisStep 61598, an Amount 61604 and a Percent 61610. The ScaleAxisStep 61598 attribute is an NOSC_ScaleAxisStep 61602 data type. The ScaleAxisStep 61598 attribute has a cardinality of 1 61600 meaning that for each instance of the ScaleLine 61592 entity there is one ScaleAxisStep 61598 attribute. The Amount 61604 attribute is an Amount 61608 data type. The Amount 61604 attribute has a cardinality of 0 . . . 1 61606 meaning that for each instance of the ScaleLine 61592 entity there may be one Amount 61604 attribute. The Percent 61610 attribute is a Percent 61614 data type. The Percent 61610 attribute has a cardinality of 0 . . . 1 61612 meaning that for each instance of the ScaleLine 61592 entity there may be one Percent 61610 attribute.

The Store 61616 package is a <MT>OffrStore 61622 data type. The Store 61616 package includes a Store 61618 entity. The Store 61618 entity has a cardinality of 0 . . . n 61620 meaning that for each instance of the Store 61616 package there may be one or more Store 61618 entities. The Store 61618 entity includes an InternalID 61624 attribute. The InternalID 61624 attribute is an NOSC_StoreInternalID 61628 data type. The InternalID 61624 attribute has a cardinality of 1 61626 meaning that for each instance of the Store 61618 entity there is one InternalID 61624 attribute.

A number of implementations have been described. Nevertheless, it will be understood that various modifications may be made without departing from the spirit and scope of the disclosure. Accordingly, other implementations are within the scope of the following claims.

What is claimed is:

1. A computer readable medium including program code for providing a message-based interface for exchanging information for retail events, including business activity, demand management, planning and optimization of sales, and promotions to increase retail sales, the medium comprising:
program code for receiving via a message-based interface exposing at least one service as defined in a service registry and from a heterogeneous application executing in an environment of computer systems providing message-based services, a first message for providing a notification of one or more retail events that includes a message package hierarchically organized as:
a retail event message entity; and
a retail event package comprising a retail event entity, where the retail event entity includes an ID, a complete transmission indicator, and a superior indicator; and
program code for sending a second message to the heterogeneous application responsive to the first message.

2. The computer readable medium of claim 1, wherein the retail event package further comprises at least one of the following: a description entity, a receiving store package, a sales area package, a theme package, and an offer package.

3. The computer readable medium of claim 1, wherein the retail event entity further includes an action code, a type code, a planning currency code, a sales period, a data origin type code, a retail predecessor transaction ID, a predecessor business transaction ID, an advertising medium type code, a retail event target group type code, a sales price specification level code, and a superior retail event ID.

4. A computer readable medium including program code for providing a message-based interface for exchanging information among all offer nodes of a retail bonus buy business object, including separate offers, and a retail event business object, including all offers, the medium comprising:
program code for receiving via a message-based interface exposing at least one service as defined in a service registry and from a heterogeneous application executing in an environment of computer systems providing message-based services, a first message for providing a notification of one or more retail incentives that includes a message package hierarchically organized as:
a retail incentive ERP store offer replication bulk request message entity; and
a retail incentive ERP store offer replication request message package comprising a retail incentive ERP store offer replication request message entity and a retail incentive package, the retail incentive package comprising a retail incentive entity, where the retail incentive entity includes a complete transmission indicator; and
program code for sending a second message to the heterogeneous application responsive to the first message.

5. The computer readable medium of claim 4, wherein the retail incentive package further comprises at least one of the following: a description entity, a receiving store package, a sales area package, and an offer package.

6. The computer readable medium of claim 4, wherein the retail incentive entity further includes an action code, a retail event ID, a retail bonus buy ID, a type code, a retail event type code, a planning currency code, a sales period, a data origin type code, a retail predecessor transaction ID, an advertising medium type code, a retail event target group type code, and a sales price specification level code.

7. A distributed system operating in a landscape of computer systems providing message-based services defined in a service registry, the system comprising:
a graphical user interface comprising computer readable instructions, embedded on tangible media, for exchanging information for retail events, including business activity, demand management, planning and optimization of sales, and promotions to increase retail sales using a request;
a first memory storing a user interface controller for processing the request and involving a message including a message package hierarchically organized as:
a retail event message entity; and
a retail event package comprising a retail event entity, where the retail event entity includes an ID, a complete transmission indicator, and a superior indicator; and
a second memory, remote from the graphical user interface, storing a plurality of service interfaces, where one of the service interfaces is operable to process the message via the service interface.

8. The distributed system of claim 7, wherein the first memory is remote from the graphical user interface.

9. The distributed system of claim 7, wherein the first memory is remote from the second memory.

10. A distributed system operating in a landscape of computer systems providing message-based services defined in a service registry, the system comprising:
a graphical user interface comprising computer readable instructions, embedded on tangible media, for exchanging information among all offer nodes of a retail bonus buy business object, including separate offers, and a retail event business object, including all offers;
a first memory storing a user interface controller for processing the request and involving a message including a message package hierarchically organized as:
a retail incentive ERP store offer replication bulk request message entity; and
a retail incentive ERP store offer replication request message package comprising a retail incentive ERP store offer replication request message entity and a retail incentive package, the retail incentive package comprising a retail incentive entity, where the retail incentive entity includes a complete transmission indicator; and
a second memory, remote from the graphical user interface, storing a plurality of service interfaces, where one of the service interfaces is operable to process the message via the service interface.

11. The distributed system of claim 10, wherein the first memory is remote from the graphical user interface.

12. The distributed system of claim 10, wherein the first memory is remote from the second memory.
